(19) United States
(12) Patent Application Publication
(10) Pub. No.: US 2016/0093173 A1
(43) Pub. Date: Mar. 31, 2016

(54) GAMING MACHINE FOR EXECUTING A FIGHTING GAME BASED ON A CHOICE SELECTED BY A PLAYER

(71) Applicants: Universal Entertainment Corporation, Tokyo (JP); Aruze Gaming America, Inc., Las Vegas, NV (US)

(72) Inventors: Akira OSAWA, Tokyo (JP); Kenta KITAMURA, Tokyo (JP); Hidekazu SUZUKI, Tokyo (JP)

(21) Appl. No.: 14/865,963

(22) Filed: Sep. 25, 2015

(30) Foreign Application Priority Data
Sep. 25, 2014 (JP) 2014-195630

(51) Int. Cl. G07F 17/32

(52) U.S. Cl. CPC G07F 17/3295; G07F 17/3262; G07F 17/3244

(57) ABSTRACT

In a process (1-1), a plurality of choices, in each of which the content of fighting between the first moving body object and the second moving body object is assigned, are displayed on the display so as not to allow a player to recognize the content of the fighting; in a process (1-2), when one choice among the plurality of choices is selected by a player, the content of the fighting assigned in the one choice is displayed so as to allow a player to recognize the content of the fighting; and in a process (1-3), based on the content of the fighting assigned in the one choice, a view in which the first moving body object and the second moving body object fight is displayed.

### CROSS-REFERENCE TO RELATED APPLICATION

This application claims the benefit of Japanese Patent Application No. 2014-195630, filed on Sep. 25, 2014 which application is incorporated herein by reference in its entirety.

### FIELD OF THE INVENTION

The present invention relates to a gaming machine in which symbols are rearranged.

### BACKGROUND OF THE INVENTION

Conventionally, there has been a gaming machine in which a game such as a mini game being different from a slot game can be executed as a bonus game. For example, in such a gaming machine, as the mini game, a penalty kick battle is executed. In this mini game, based on an operation performed by a player, it is determined whether or not the mini game is initiated, and a drawing process is executed by the operation performed by a player. In a base game mode, when random numbers in a range of 0 to 156 are extracted, the mini game is initiated; and when random numbers in a range of 157 to 256 are extracted, the mini game is not initiated. In addition, in a free game mode, when random numbers in a range of 0 to 199 are extracted, the mini game is initiated, and when random numbers in a range of 200 to 256 are extracted, the mini game is not initiated (for example, refer to US Patent Application Laid-Open Publication No. 2011-312396).

As in the above-described conventional gaming machine, in a case where based on the operation performed by a player, it is determined whether or not the mini game is executed, even when the mini game itself is a fighting game like a penalty kick battle, in reality, the fighting game automatically proceeds. Therefore, a player just observes the progress of the mini game, and a player cannot actively participate in the the progress of the game.

In view of the above-described point, the present invention was made, and an object of the present invention is to provide a gaming machine which is capable of causing a game to proceed by a player's operation, thereby allowing a player to actively participate in the progress of the game.

### BRIEF SUMMARY OF THE INVENTION

A first aspect of the present invention is a gaming machine which includes:

a display for displaying a first moving body object and a second moving body object;

an input device for detecting an operation by a player; and

a controller for controlling the display and the input device, and

the controller is programmed to execute processes described below:

a process (1-1) in which a plurality of choices, in each of which the content of fighting between the first moving body object and the second moving body object is assigned, are displayed on the display so as not to allow a player to recognize the content of the fighting;

a process (1-2) in which when one choice among the plurality of choices is selected by a player, the content of the fighting assigned in the one choice is displayed so as to allow a player to recognize the content of the fighting; and

a process (1-3) in which based on the content of the fighting assigned in the one choice, a view in which the first moving body object and the second moving body object fight is displayed.

Since a player selects the one choice among the plurality of choices, the content of the fighting is determined by the operation by a player and the fighting progresses, thereby allowing a player to actively participate in the game and enabling a player to hardly get bored.

A second aspect of the present invention is configured such that

the content of the fighting includes information pertinent to an attacking side of the first moving body object and the second moving body object and to an attacking strength of the attacking side, and

the process (1-3) includes:

a process (2-1) in which based on the attacking side, a pattern of attacking by the attacking side is determined; and

a process (2-2) in which when the first moving body object attacks the second moving body object, a view in which after fighting in the pattern of attacking, the first moving body object wins is displayed, and when the second moving body object attacks the first moving body object, a view in which after fighting in the pattern of attacking, the second moving body object wins is displayed.

In the fighting, either case of the case where the first moving body object attacks the second moving body object (the case of attacking) and the case where the second moving body object attacks the first moving body object (the case of defending) can be determined by the selection by a player, thereby allowing a feeling of tension to be imparted to the progress of a game.

A third aspect of the present invention is configured such that

the process (1-3) further includes:

a process (3-1) in which when the first moving body object attacks the second moving body object, a physical strength of the second moving body object is decreased in accordance with the attacking strength, and when the second moving body object attacks the first moving body object, a physical strength of the first moving body object is decreased in accordance with the attacking strength;

a process (3-2) in which being superimposed on the display of the fighting in the process (2-2), information indicating the attacking strength is displayed; and

a process (3-3) in which a payout based on the pattern of attacking is added.

The physical strength is gradually decreased by the attacking strength assigned in the choice selected by a player, thereby allowing a feeling of tension to be imparted to a player when a player selects any choice.

A fourth aspect of the present invention is configured such that

the second moving body object includes a plurality of kinds of second moving body objects whose attacking strengths are different from one another, and

the process (1-3) further includes:

a process (4-1) in which when a physical strength of a first kind of the second moving body object among the plurality of kinds of the second moving body objects comes to be zero, the first kind of the second moving body object is changed to a second kind of the second moving body object whose attacking strength is higher than the attacking strength of the first kind of the second moving body object, and the changed kind of the second moving body object and the first moving body object fight; and

a process (4-2) in which the process (4-1) is repeatedly executed, the kind of the second moving body object is sequentially changed, and when each of physical strengths of all of the plurality of kinds of the second moving body objects comes to be zero, the game is finished.

Upon defeating the second moving body object, each of the second moving body objects whose attacking strengths are high sequentially appears, thereby allowing a feeling of tension and a feeling of expectation of a player to be gradually enhanced.

A fifth aspect of the present invention is configured such that

a payout based on the attacking strength is assigned to each of the plurality of kinds of the second moving body objects, and

the process (1-3) further includes

a process (5-1) in which when a physical strength of each of the second moving body objects comes to be zero, a payout assigned to each of the second moving body objects is added.

Upon defeating the second moving body object, the payout based on the attacking strength is added, thereby allowing a feeling of expectation of a player to be enhanced.

The game can be caused to proceed by a player's operation, thereby allowing a player to actively participate in the progress of the game.

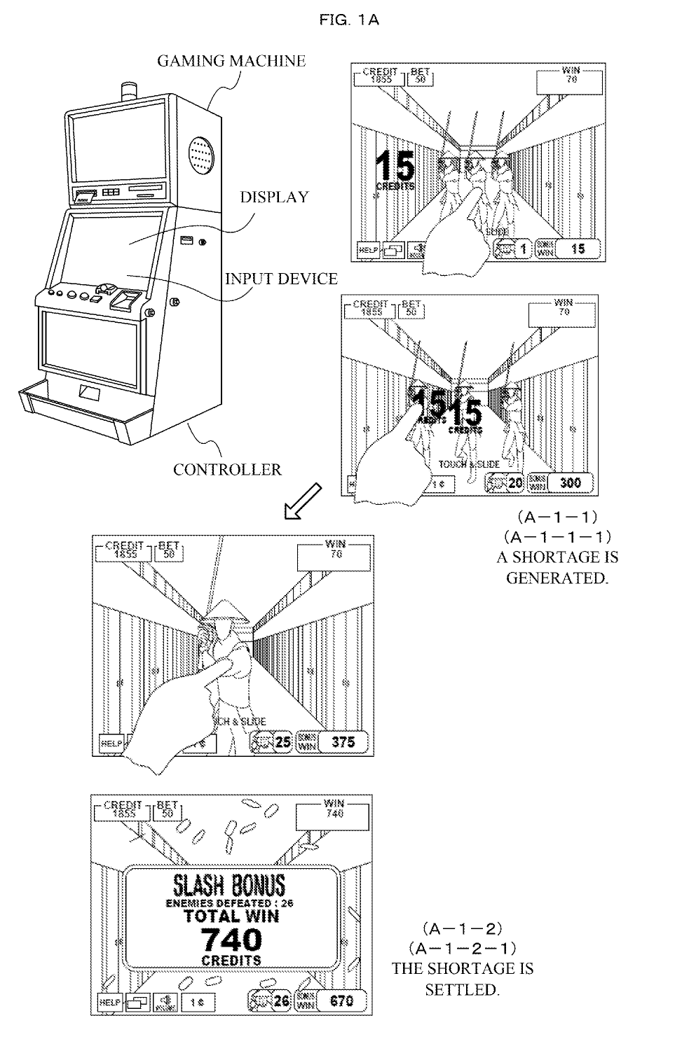

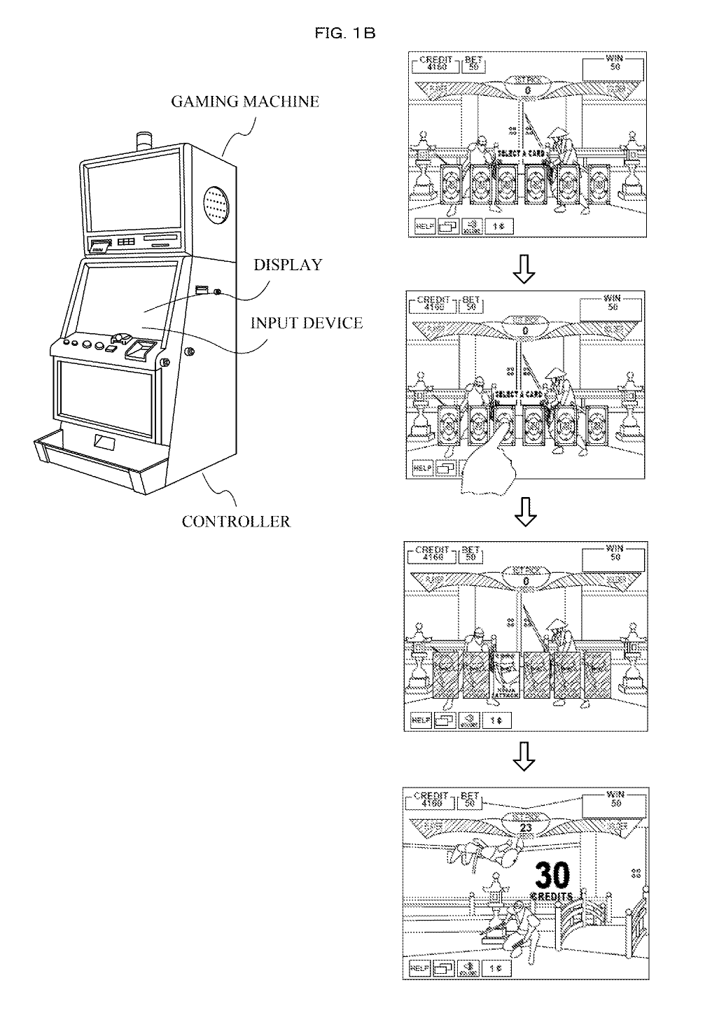

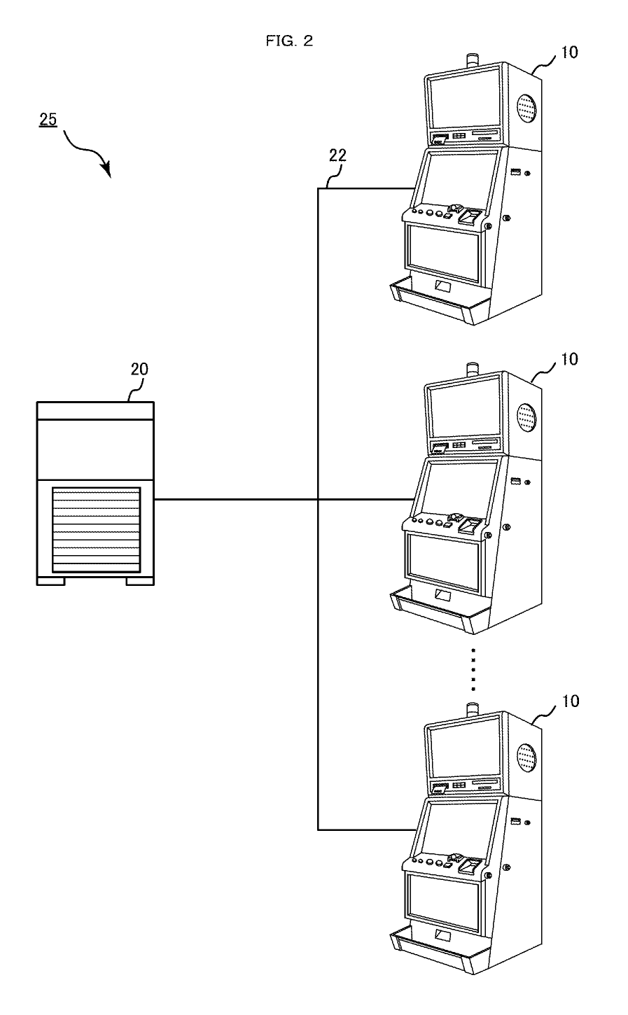

FIG. 1A is a diagram illustrating an outline of a configuration of a gaming machine;

FIG. 1B is a diagram illustrating an outline of the configuration of the gaming machine;

FIG. 2 is a diagram illustrating an outline of a game system including slot machines;

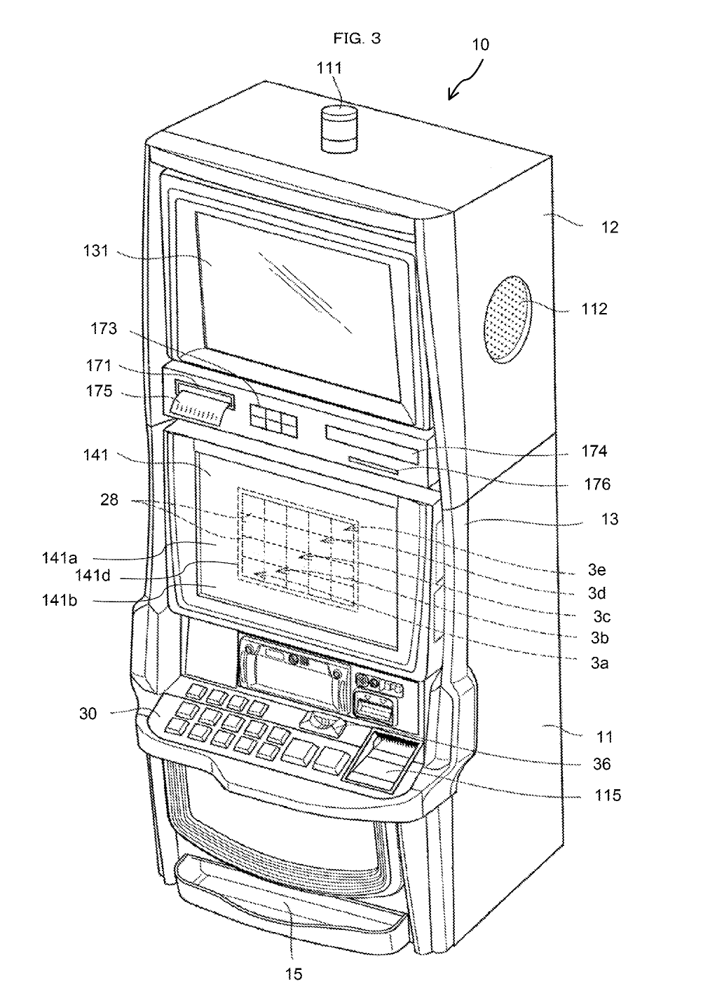

FIG. 3 is a diagram illustrating an overall configuration of a slot machine;

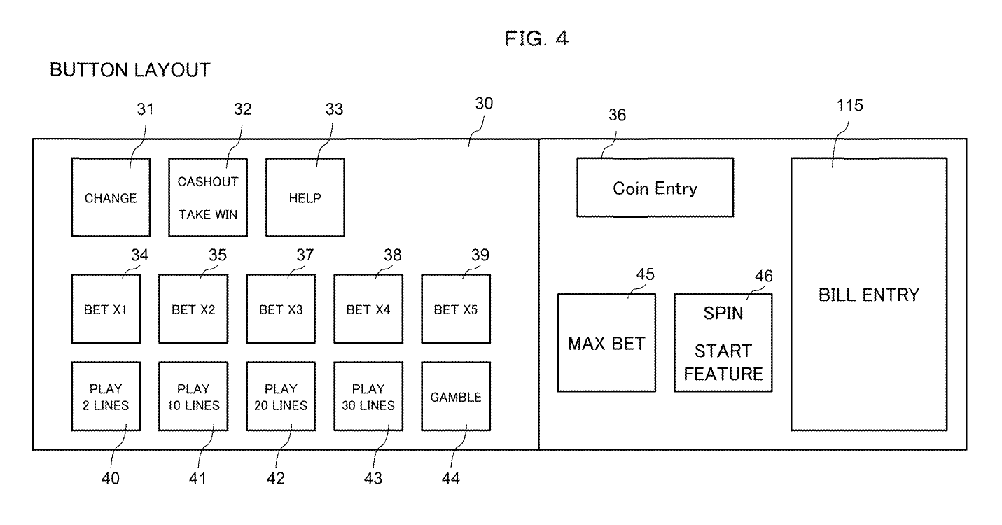

FIG. 4 is a diagram illustrating a control panel of the slot machine according to the present embodiment;

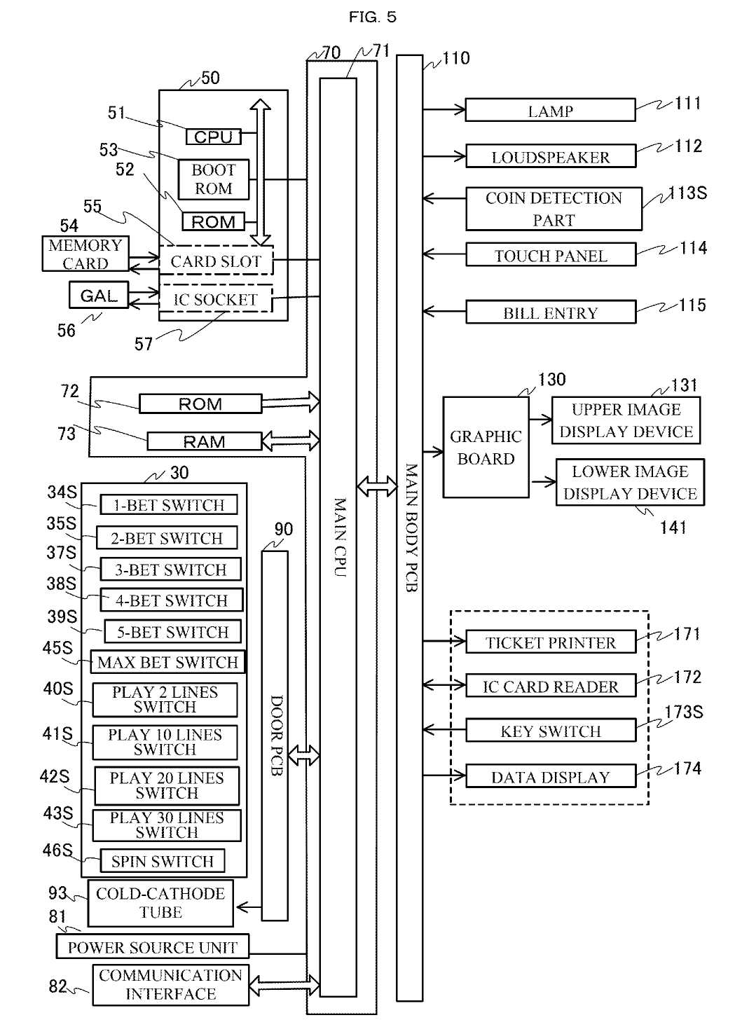

FIG. 5 a block diagram illustrating an internal configuration of the slot machine according to the present embodiment;

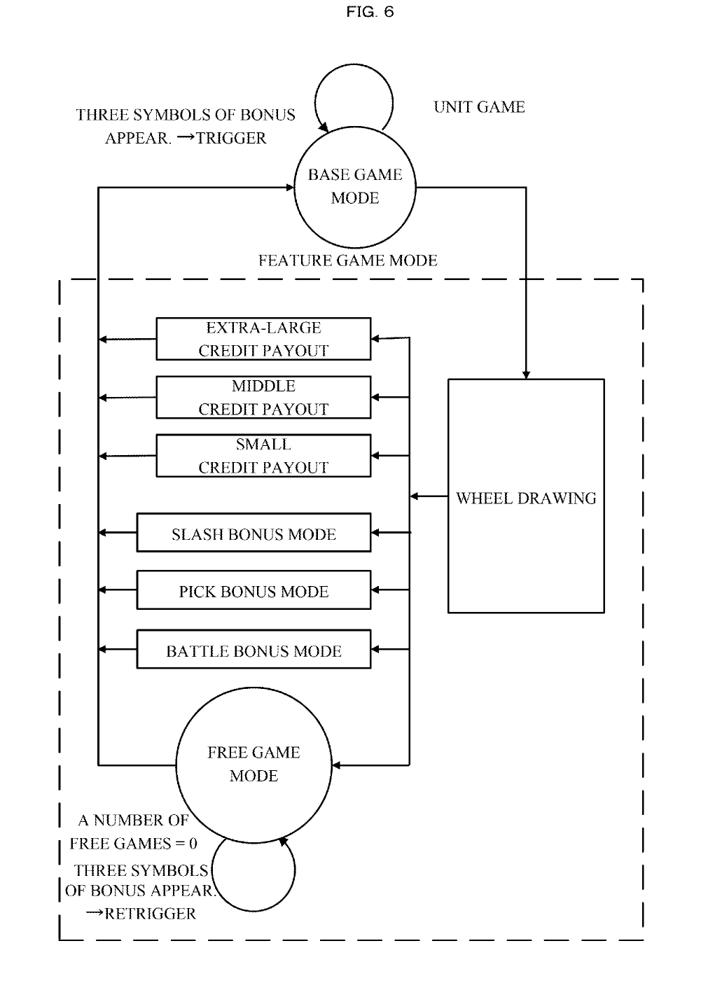

FIG. 6 is a diagram illustrating state transition in the slot machine;

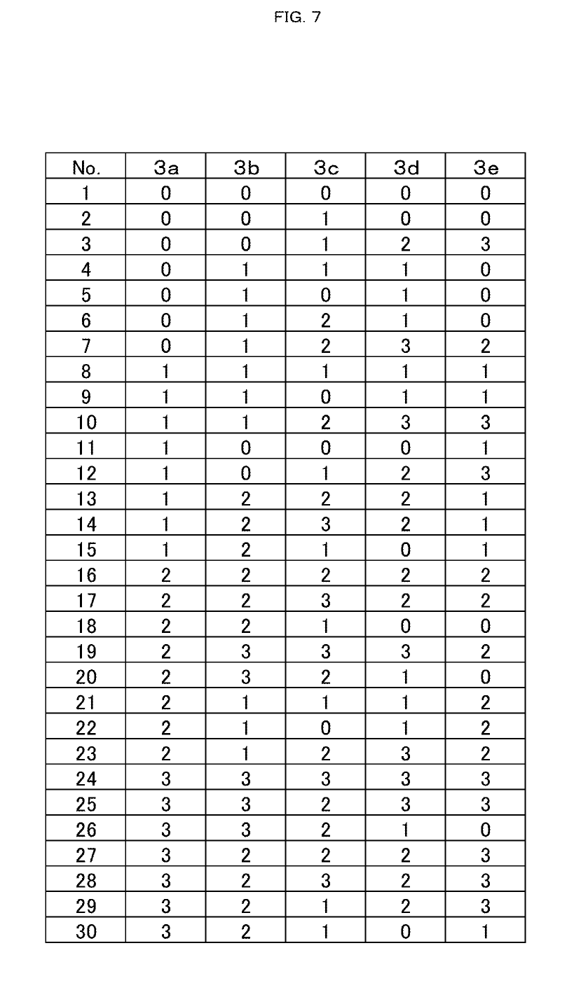

FIG. 7 is a table showing an example of a payline definition table;

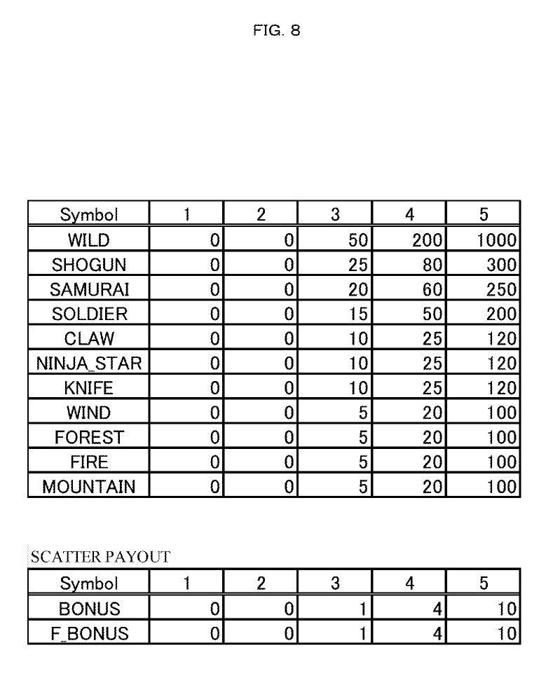

FIG. 8 is a table showing an example of a payout table;

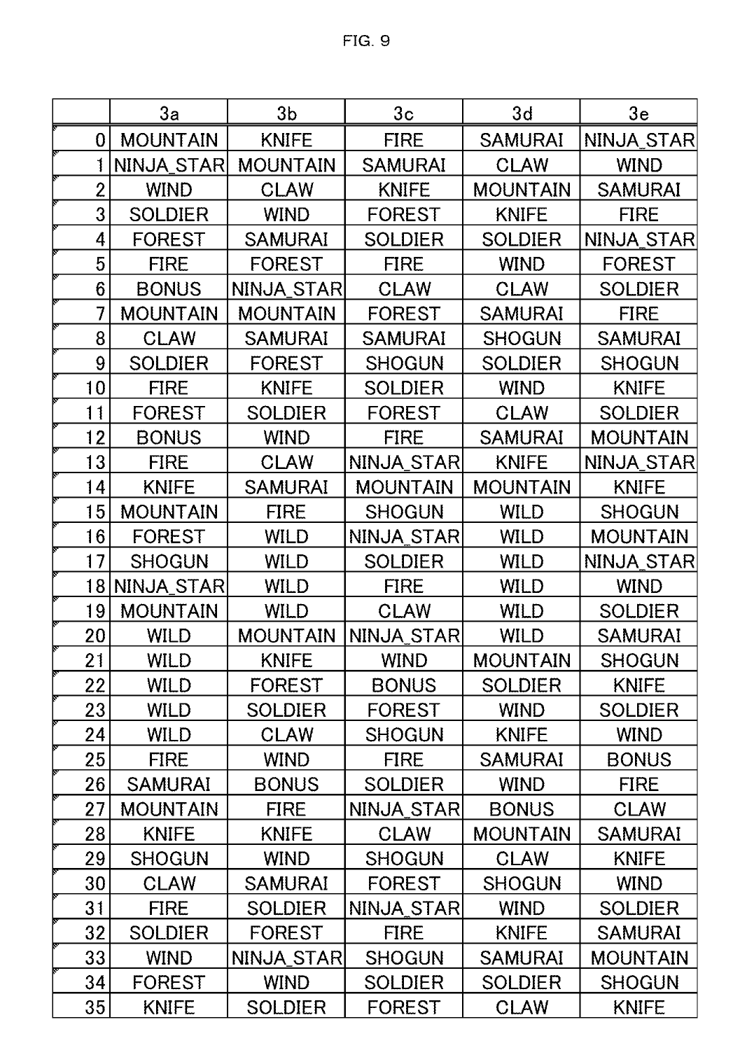

FIG. 9 is a table showing a group of reel strips (symbol determination table) constituting five video reels 3a to 3e;

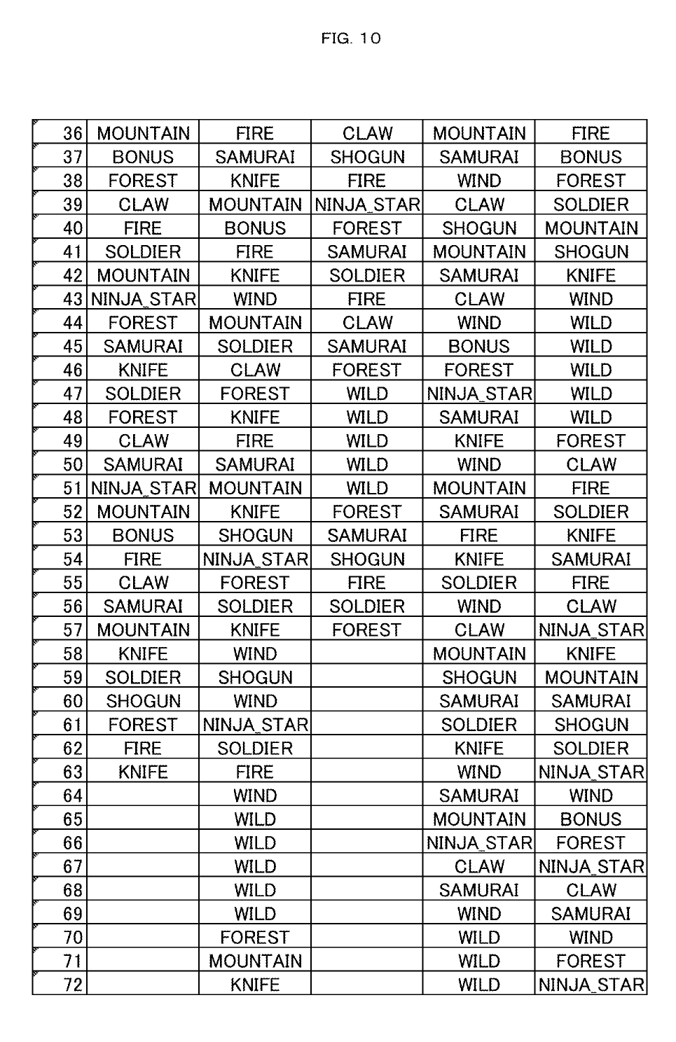

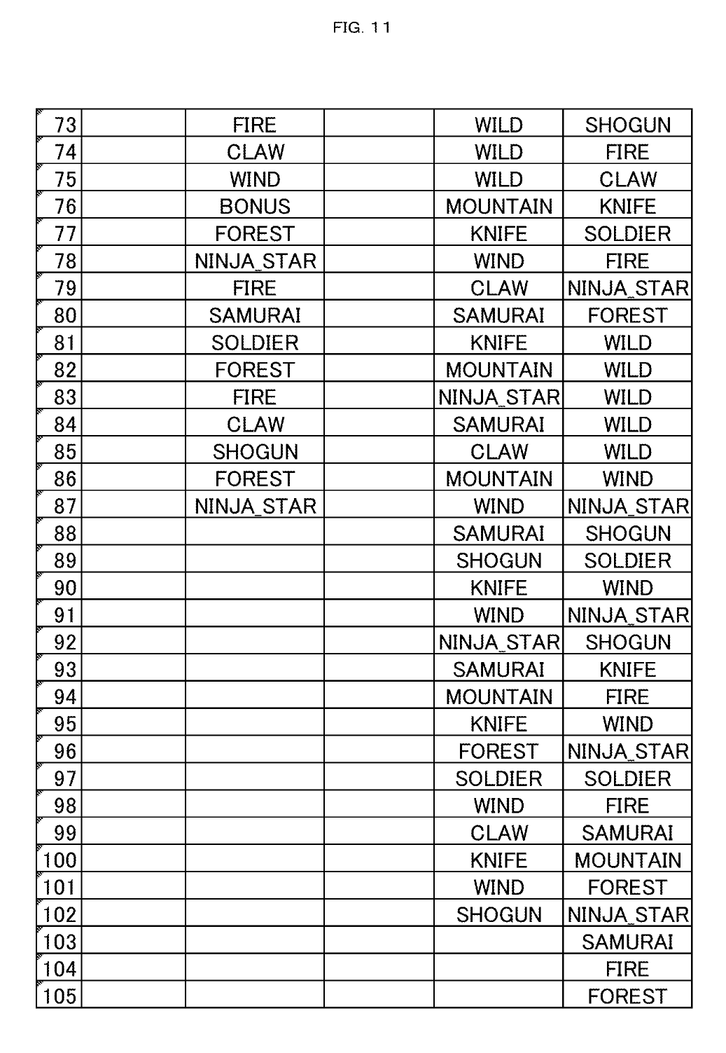

FIG. 10 is the table showing a group of reel strips (symbol determination table) constituting the five video reels 3a to 3e;

FIG. 11 is the table showing a group of reel strips (symbol determination table) constituting the five video reels 3a to 3e;

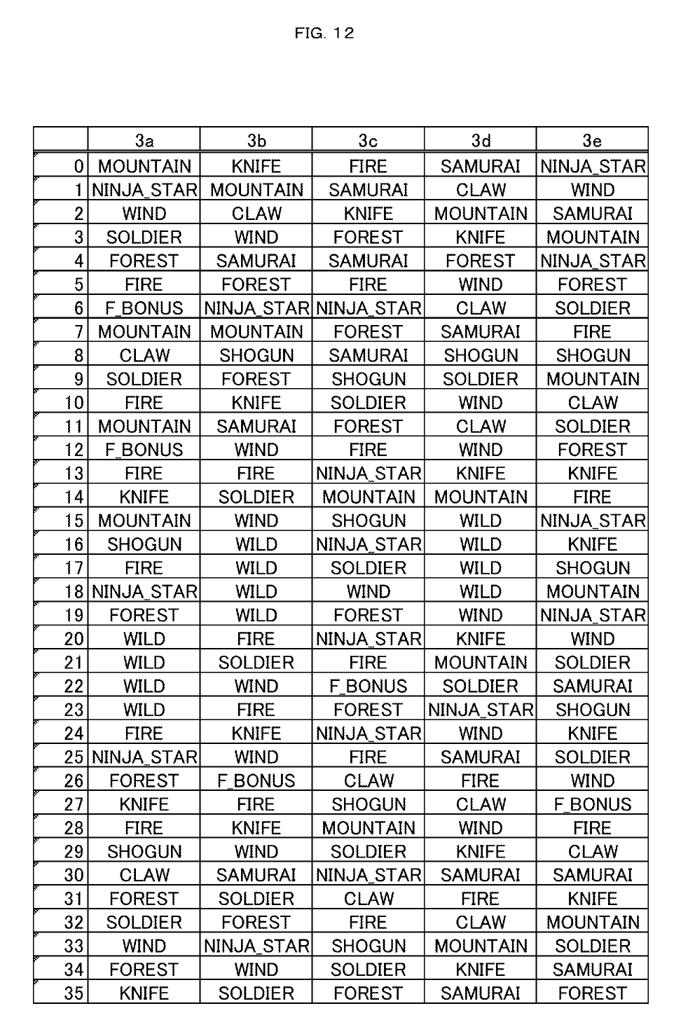

FIG. 12 is a table showing a group of reel strips (symbol determination table) constituting the five video reels 3a to 3e;

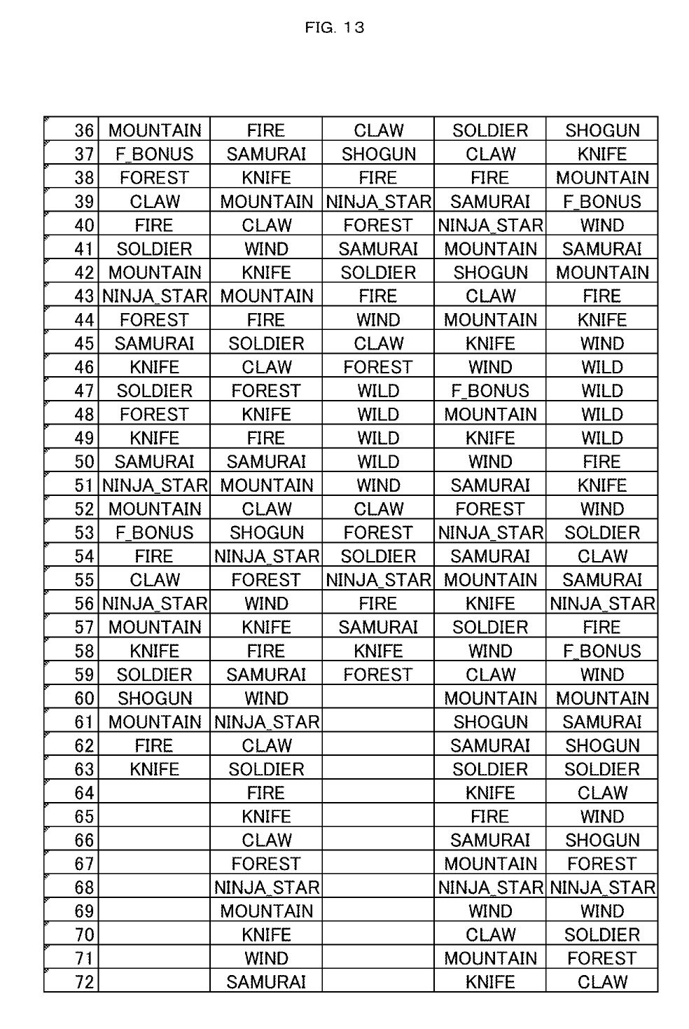

FIG. 13 is the table showing a group of reel strips (symbol determination table) constituting the five video reels 3a to 3e;

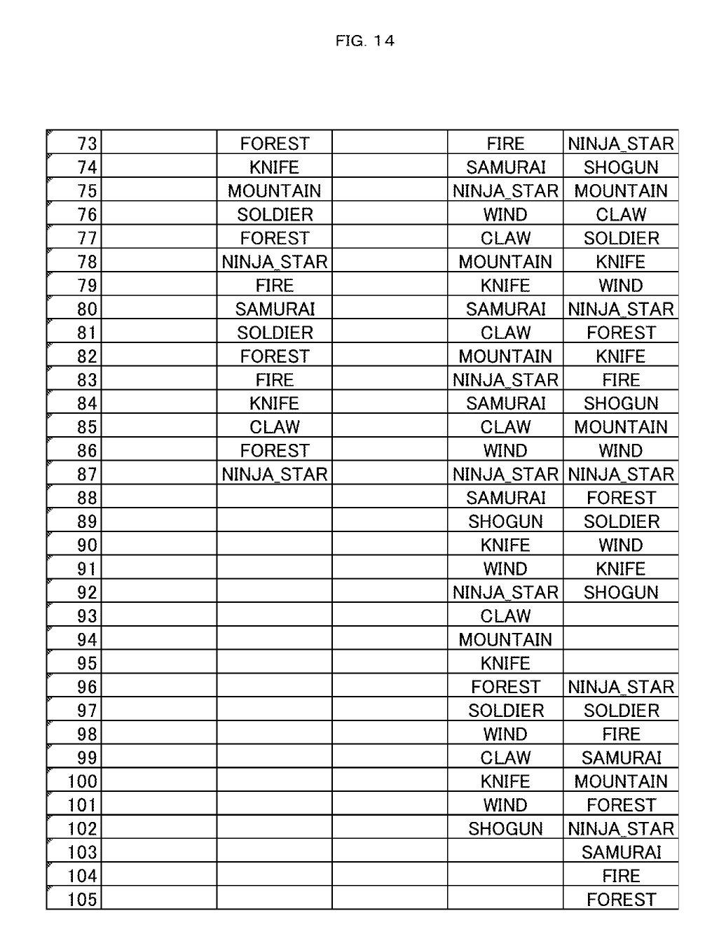

FIG. 14 is the table showing a group of reel strips (symbol determination table) constituting the five video reels 3a to 3e;

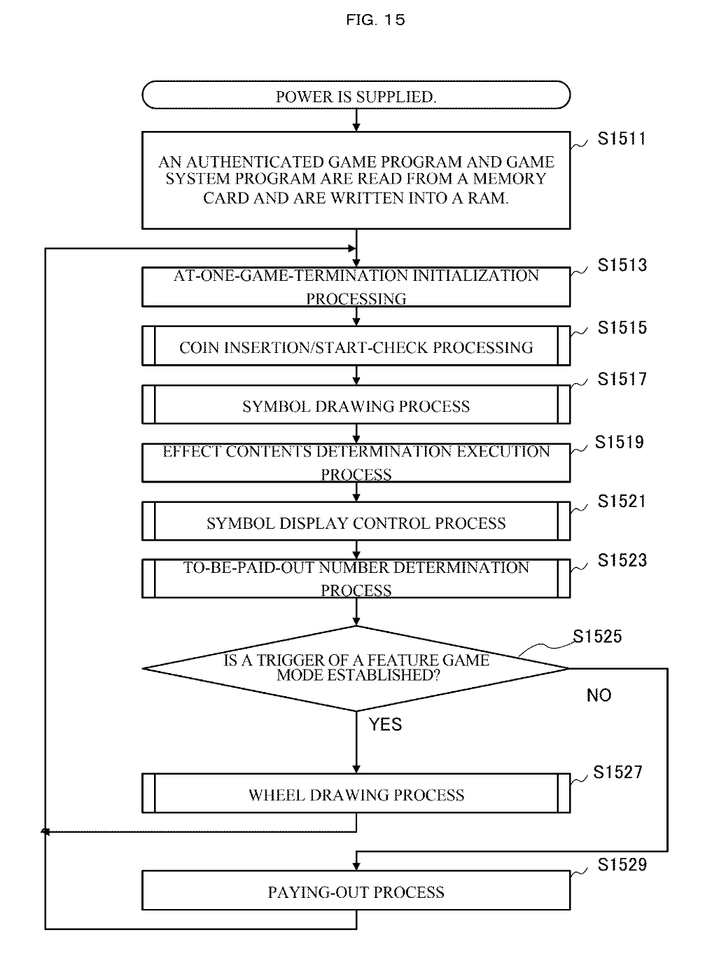

FIG. 15 is a flowchart of a main control process;

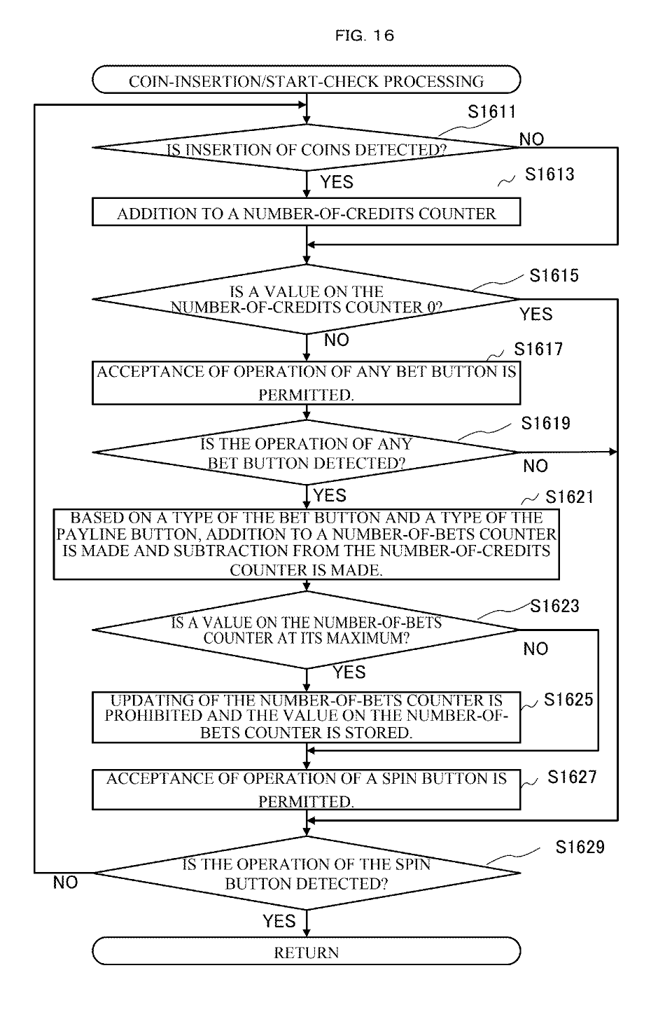

FIG. 16 is a flowchart of a coin-insertion/start-check process;

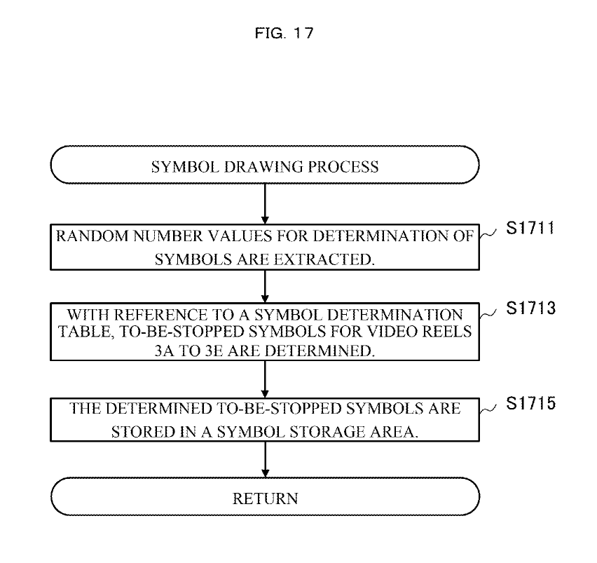

FIG. 17 is a flowchart of a symbol drawing process;

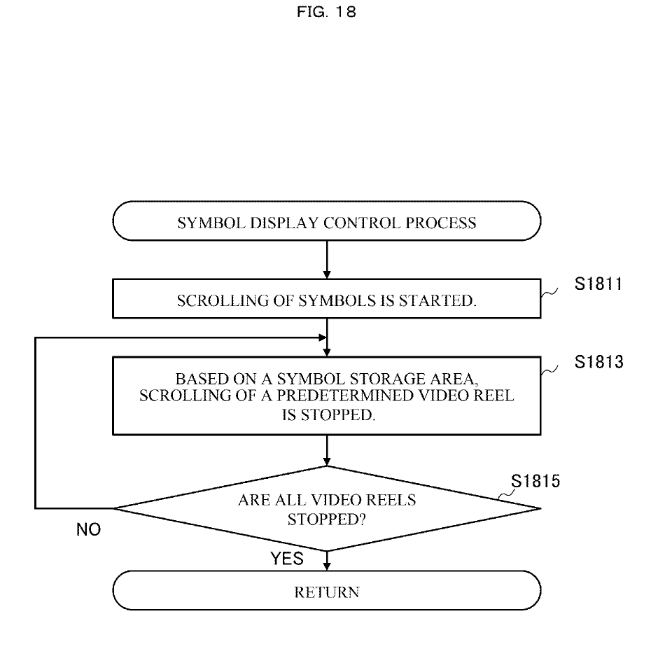

FIG. 18 is a flowchart of a symbol display control process;

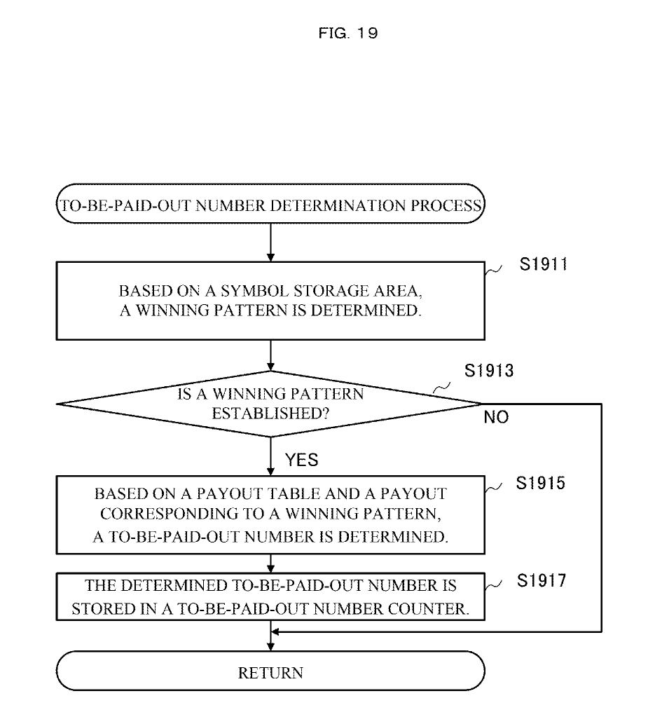

FIG. 19 is a flowchart of a to-be-paid-out number determination process;

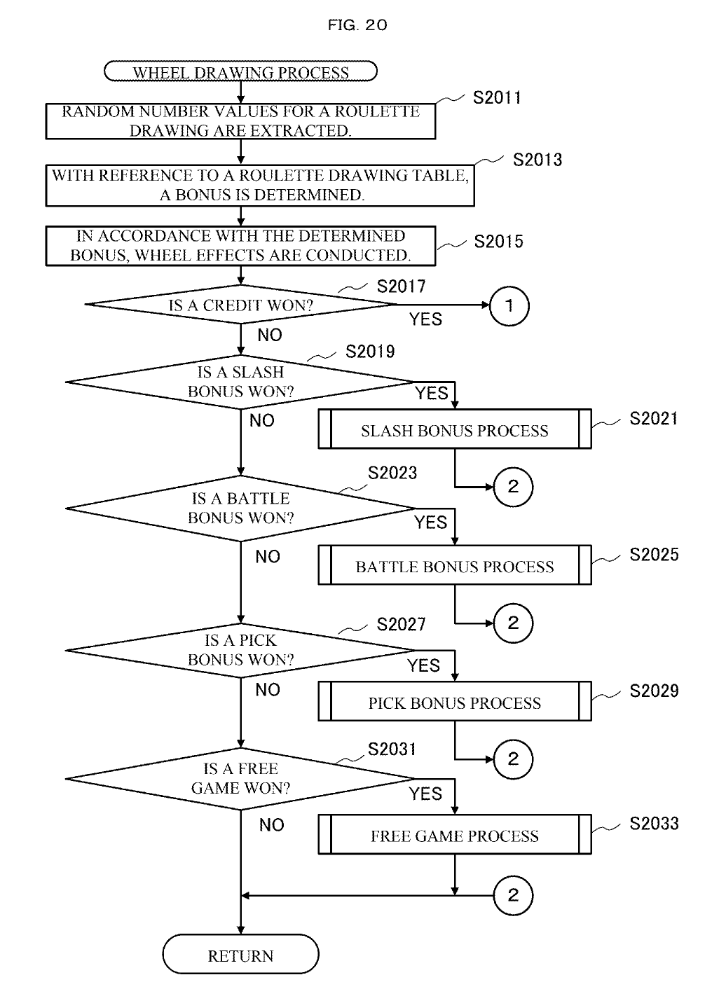

FIG. 20 is a flowchart of a wheel drawing process;

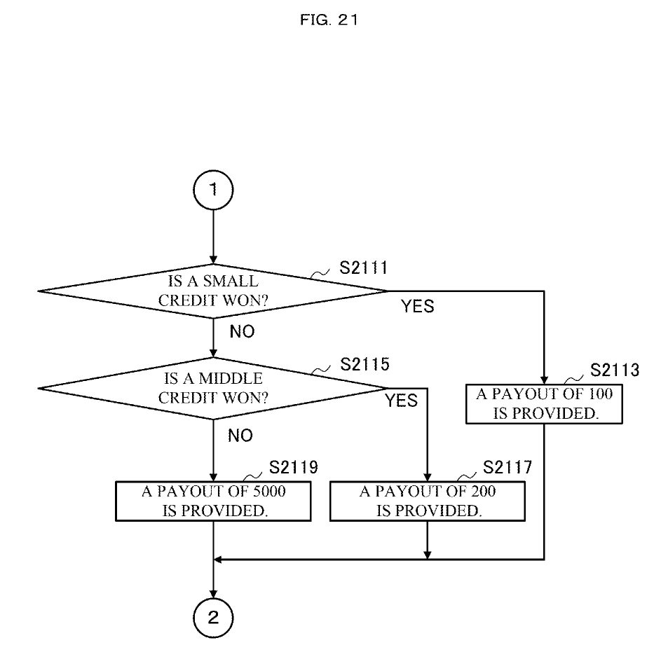

FIG. 21 is a flowchart of a wheel drawing process;

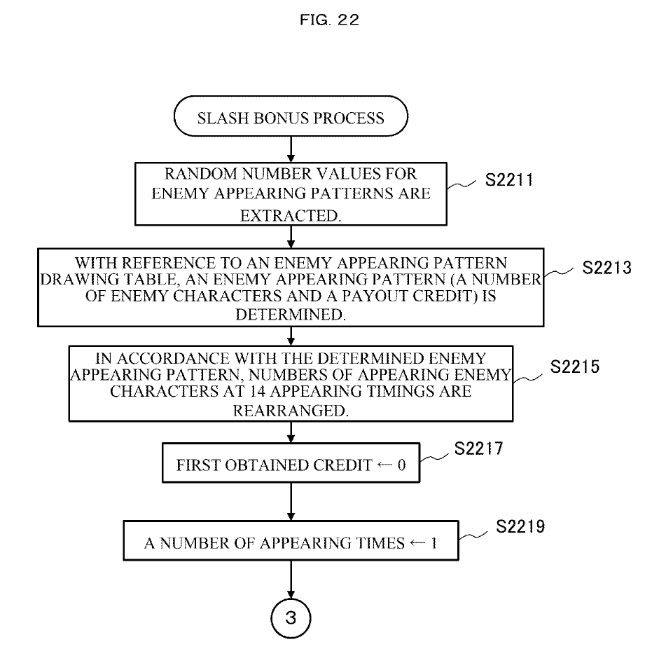

FIG. 22 is a flowchart of a slash bonus process;

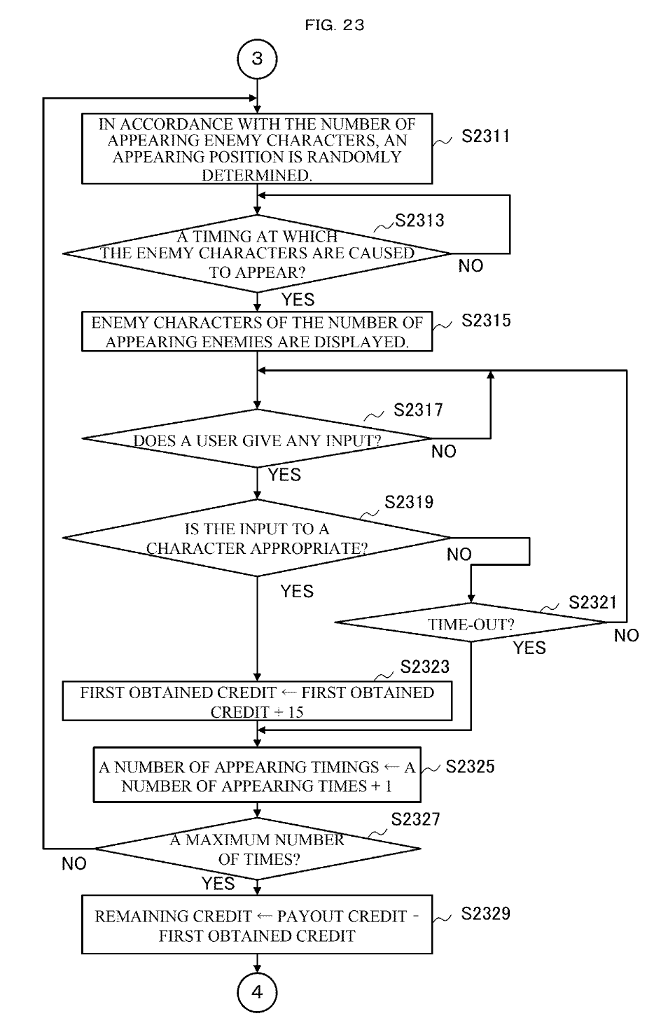

FIG. 23 is a flowchart of the slash bonus process;

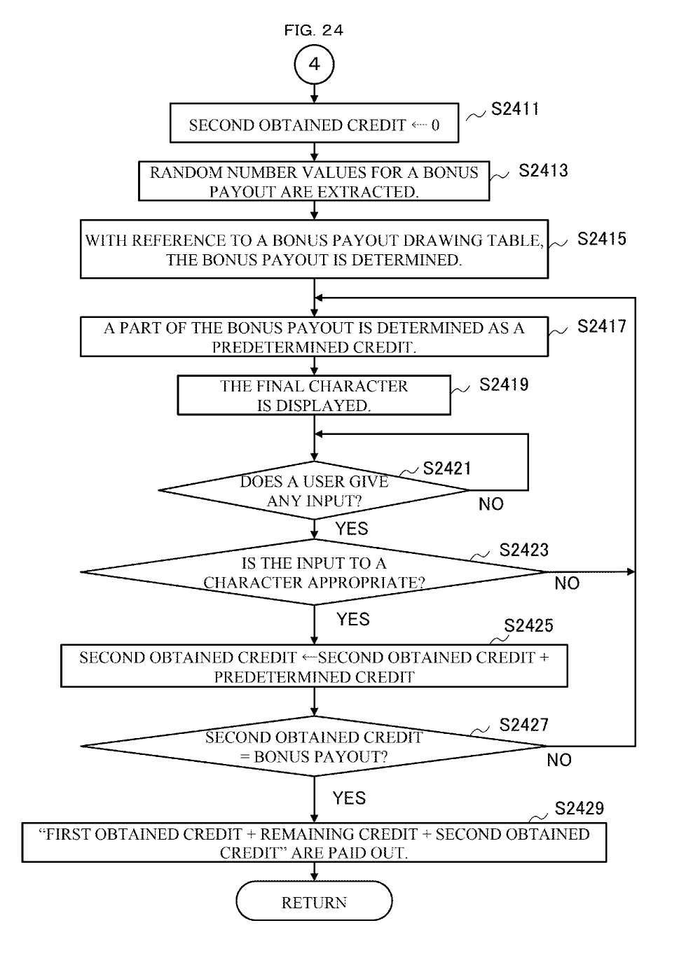

FIG. 24 is a flowchart of the slash bonus process;

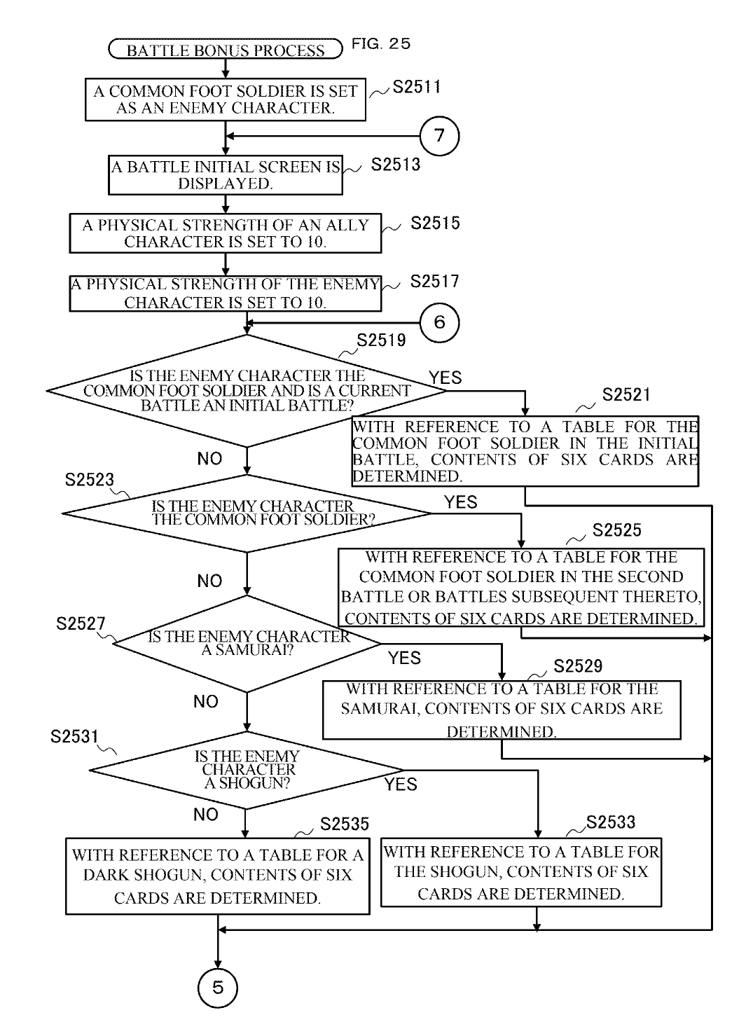

FIG. 25 is a flowchart of a battle bonus process;

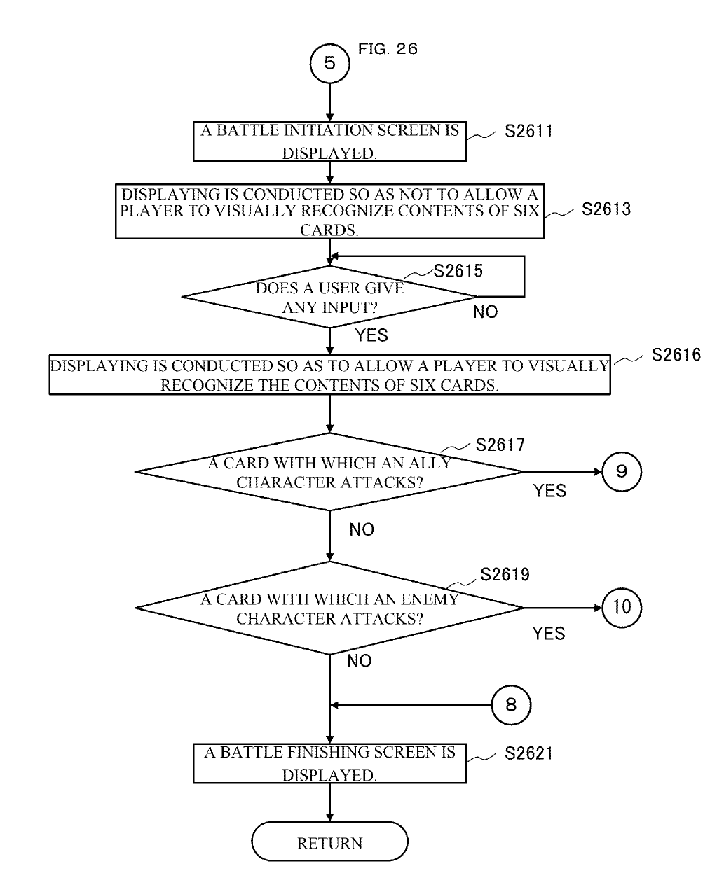

FIG. 26 is a flowchart of the battle bonus process;

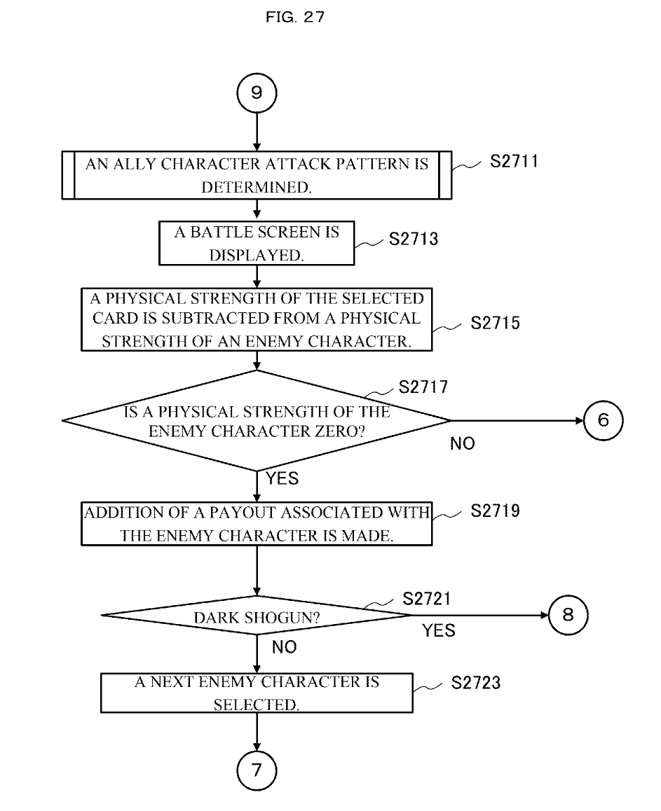

FIG. 27 is a flowchart of the battle bonus process;

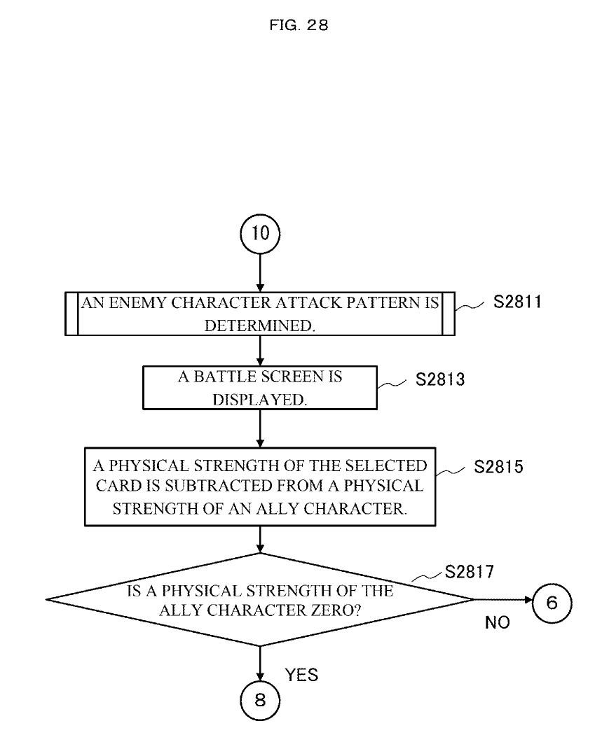

FIG. 28 is a flowchart of the battle bonus process;

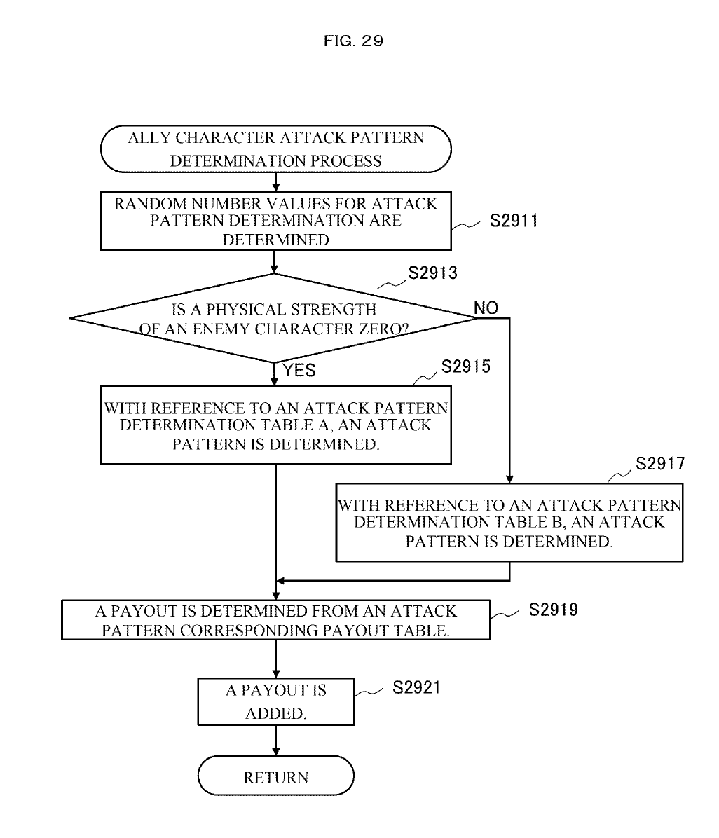

FIG. 29 is a flowchart of an ally character attack pattern determination process;

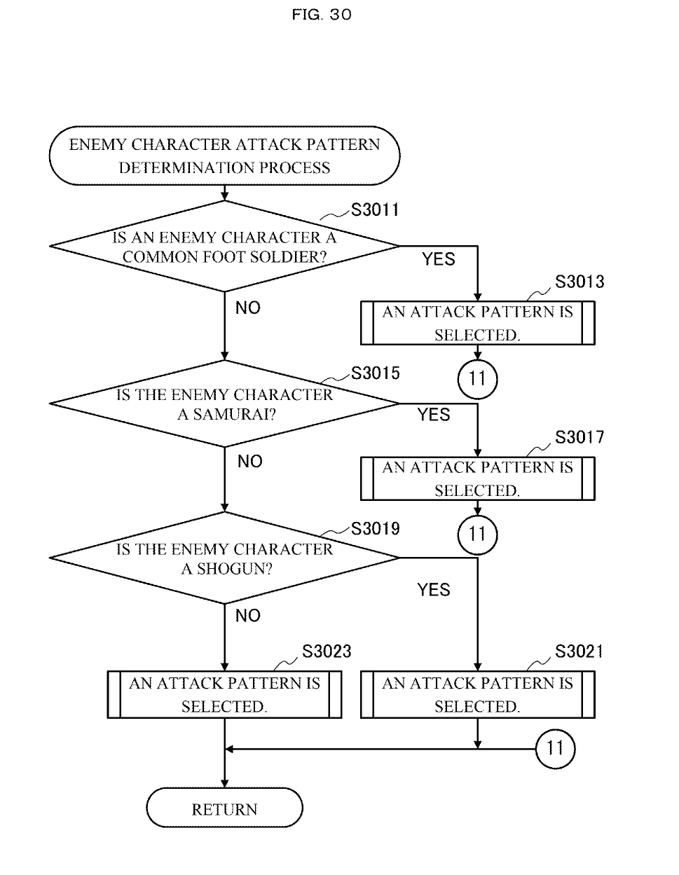

FIG. 30 is a flowchart of an enemy character attack pattern determination process;

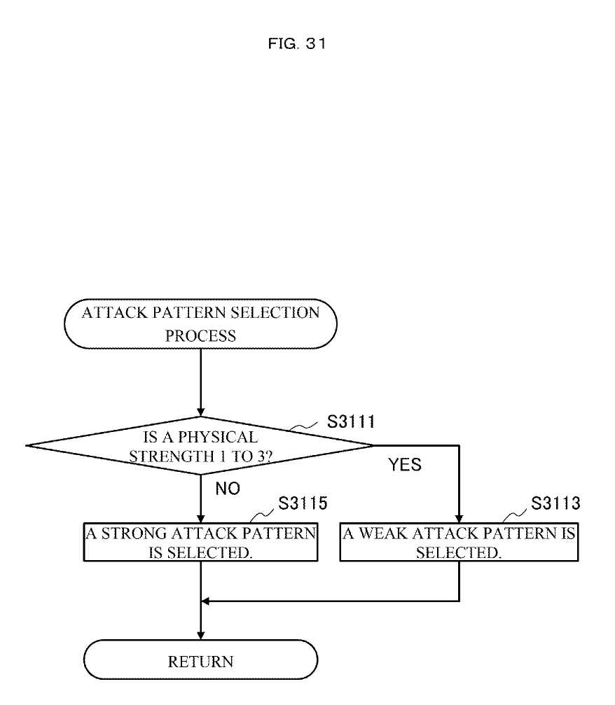

FIG. 31 is a flowchart of an attack pattern selection process;

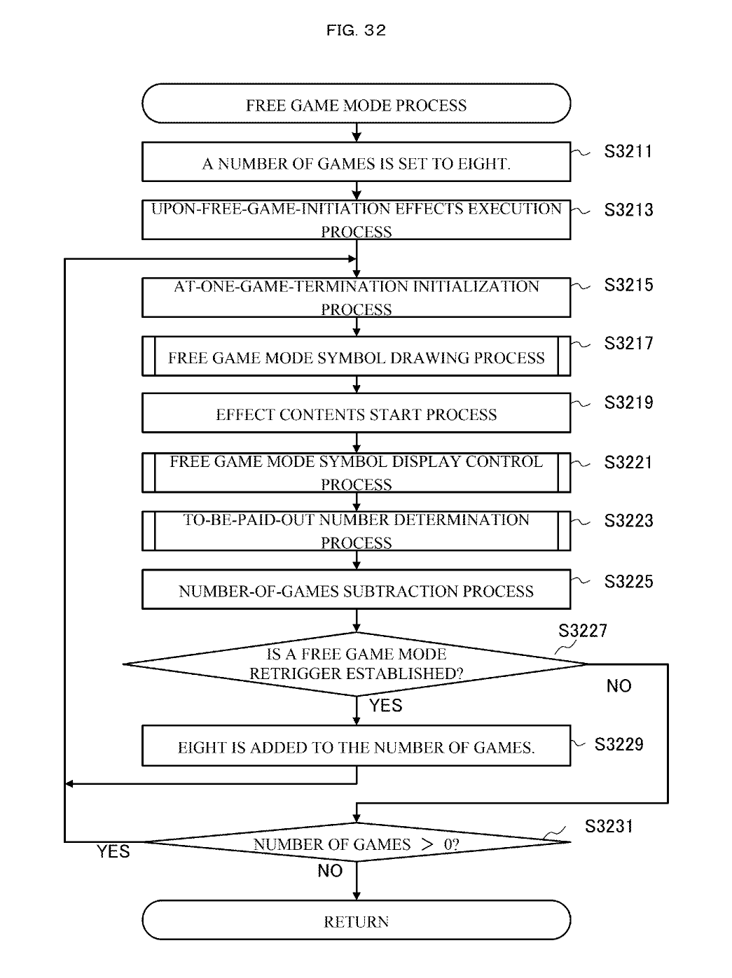

FIG. 32 is a flowchart of a free game mode process;

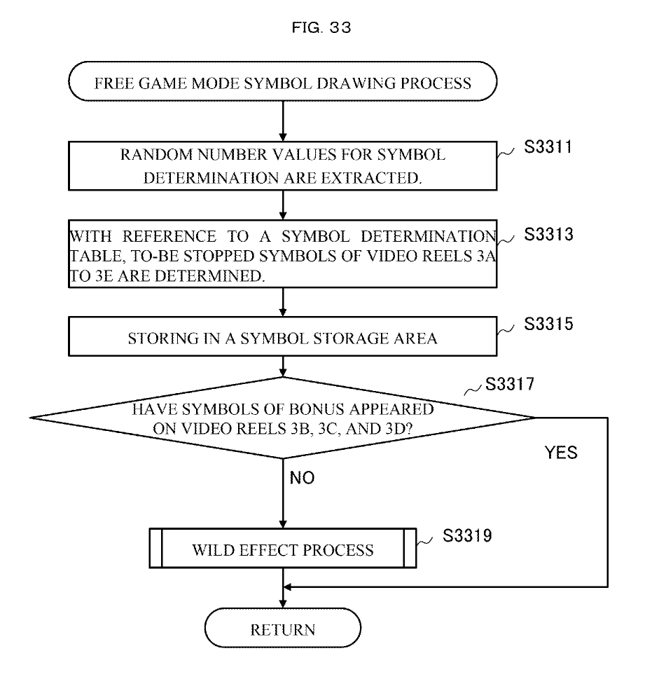

FIG. 33 is a flowchart of a free game mode symbol drawing process;

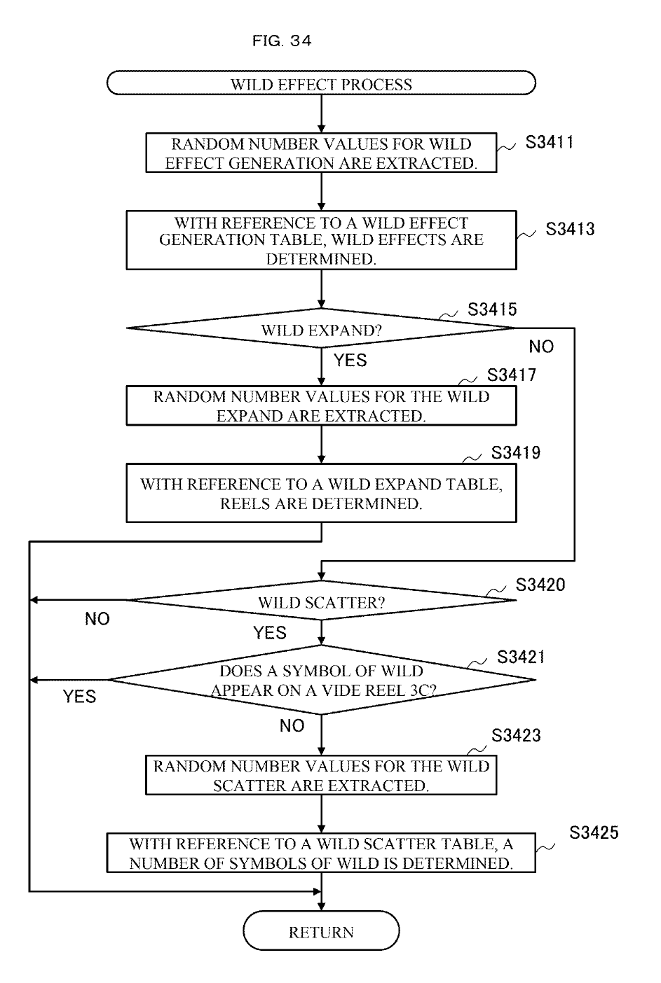

FIG. 34 is a flowchart of a WILD effect process;

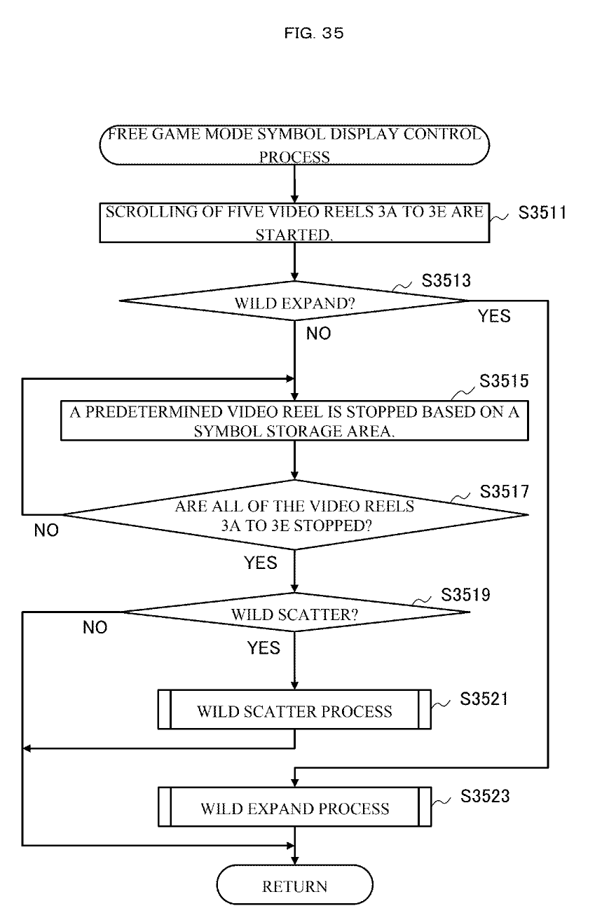

FIG. 35 is a flowchart of a free game mode symbol display control process;

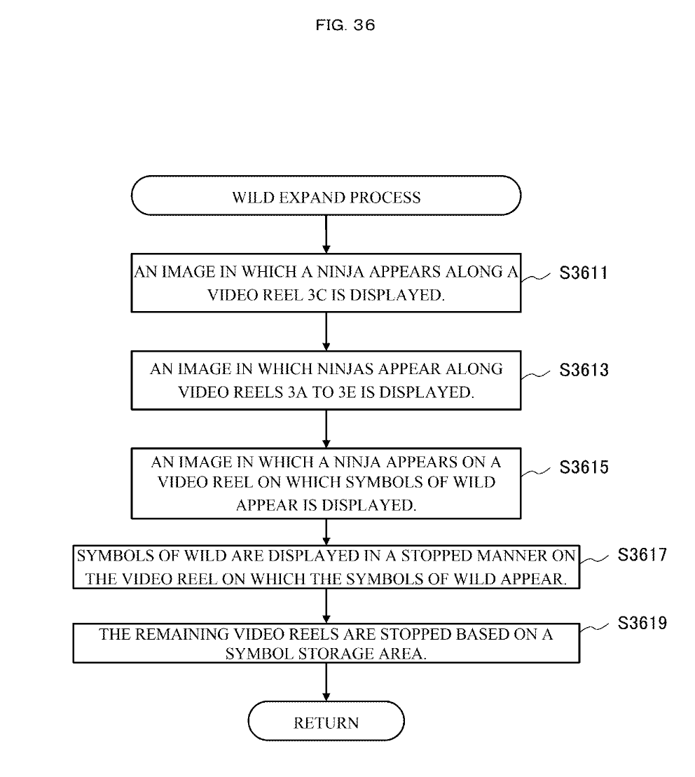

FIG. 36 is a flowchart of a WILD expand process;

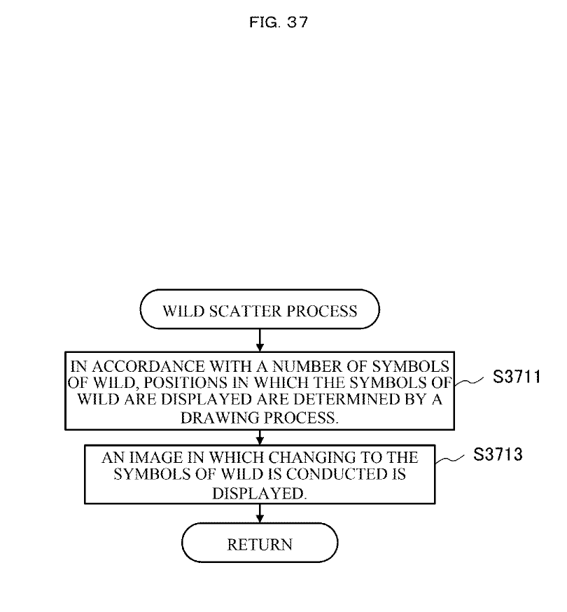

FIG. 37 is a flowchart of a WILD scatter process;

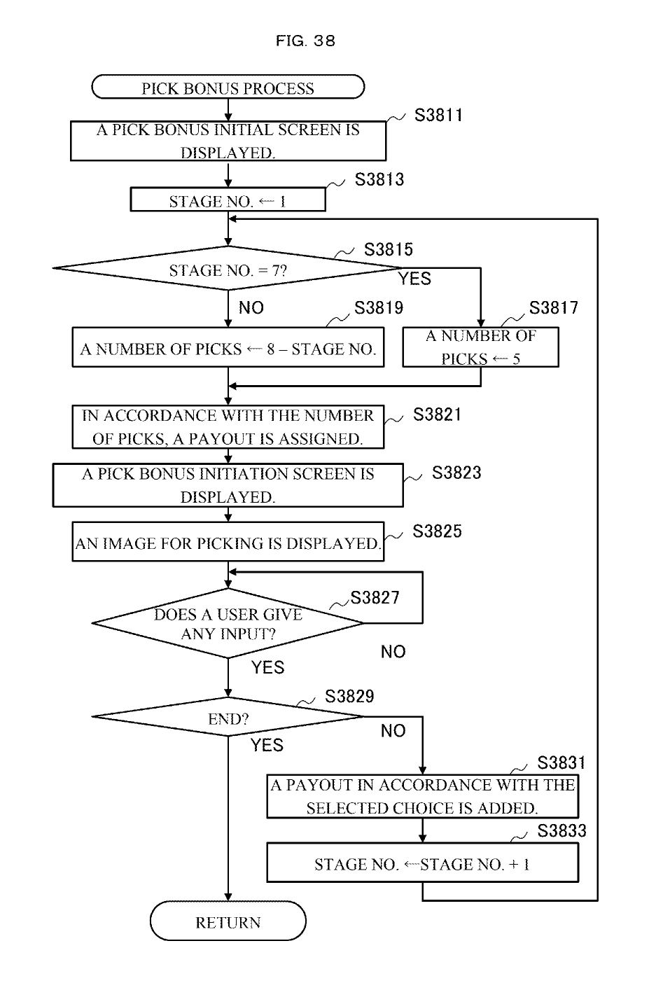

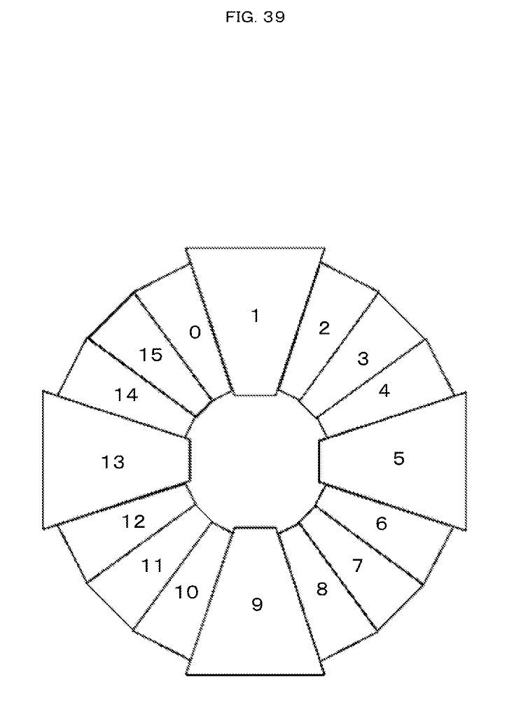

FIG. 38 is a flowchart of a pick bonus process;

FIG. 39 is a front view illustrating an outline of a wheel;

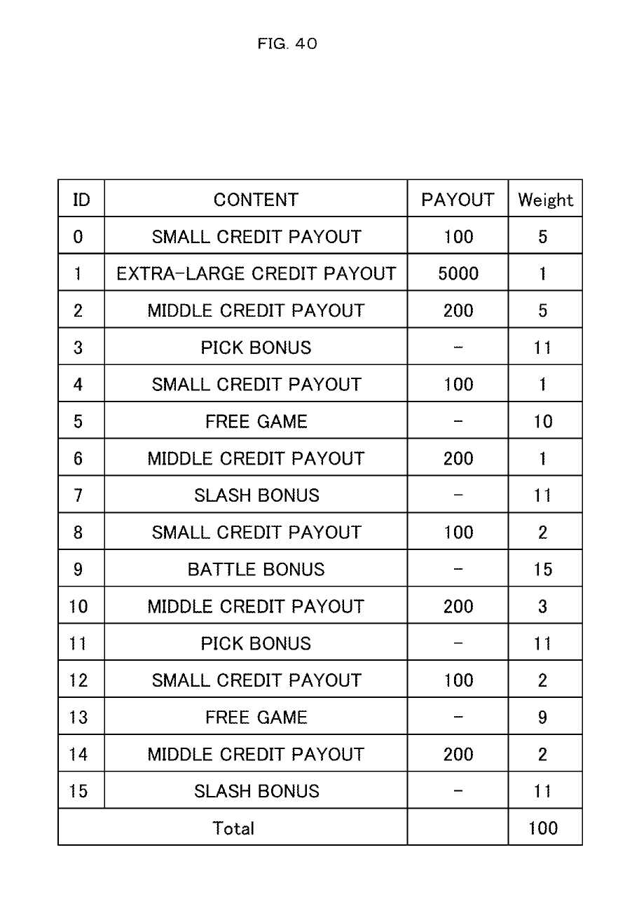

FIG. 40 is a table of the wheel drawing process;

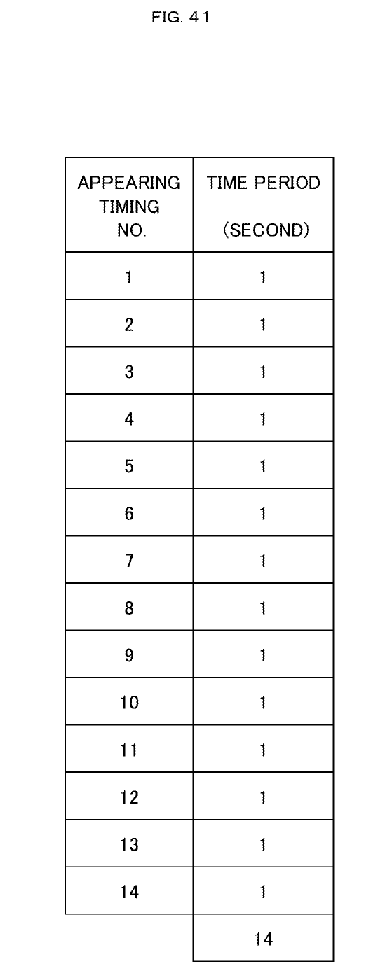

FIG. 41 is a table showing appearing timings in the slash bonus process;

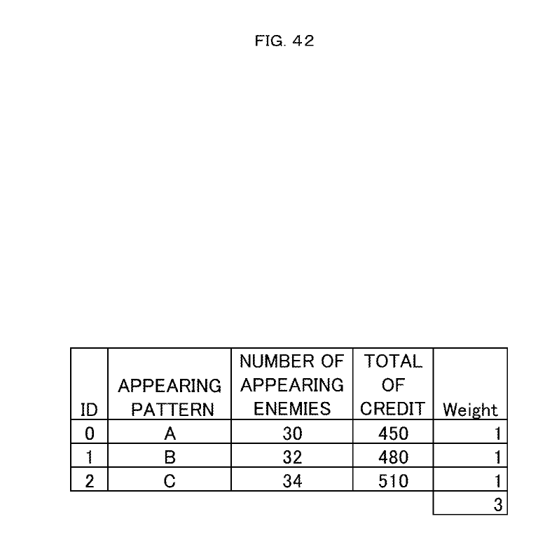

FIG. 42 shows an example of an enemy appearing pattern drawing table;

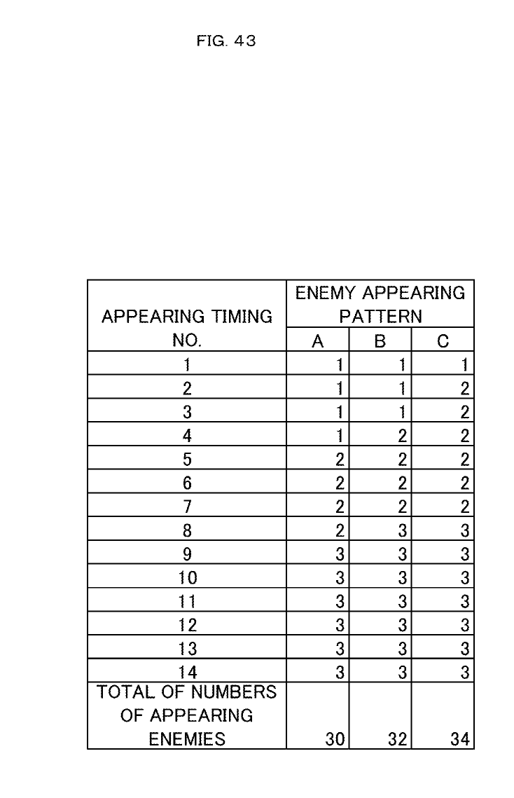

FIG. 43 is a table showing an example of numbers of appearing enemies;

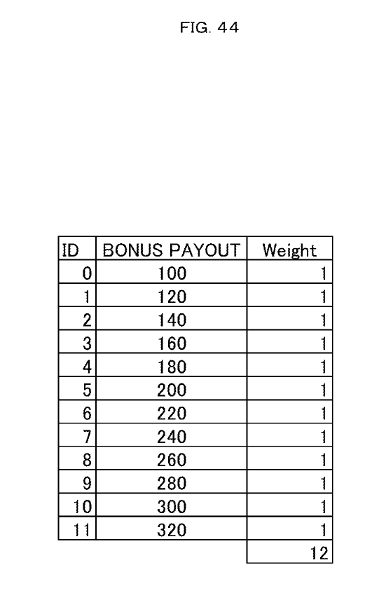

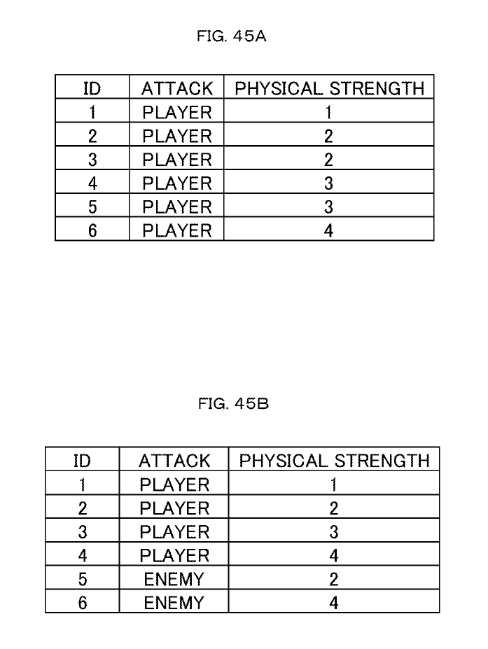

FIG. 44 shows an example of a bonus payout drawing table;

FIG. 45A shows an example of a table for a common foot soldier in an initial battle and FIG. 45B shows an example of a table for the common foot soldier in the second battle and battles subsequent thereto;

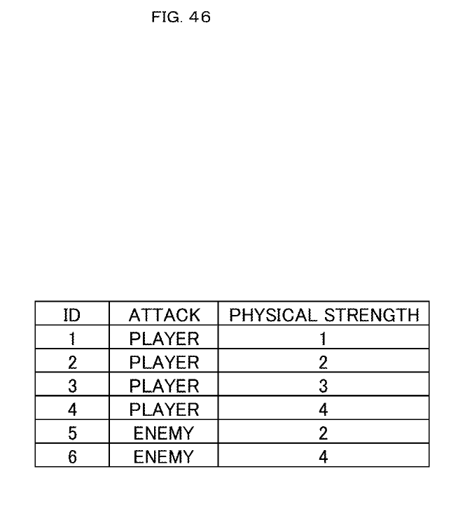

FIG. 46 shows an example of a table for a samurai;

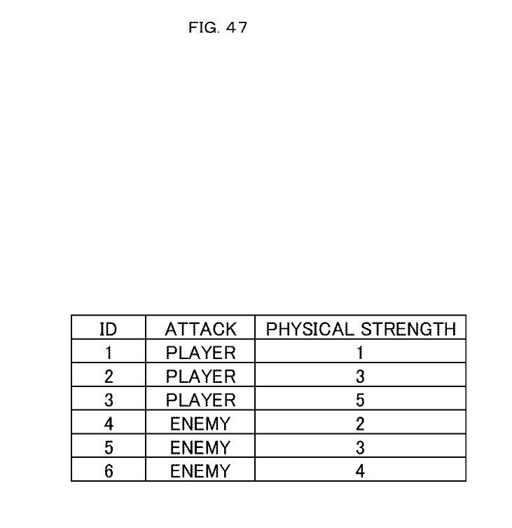

FIG. 47 shows an example of a table for a shogun;

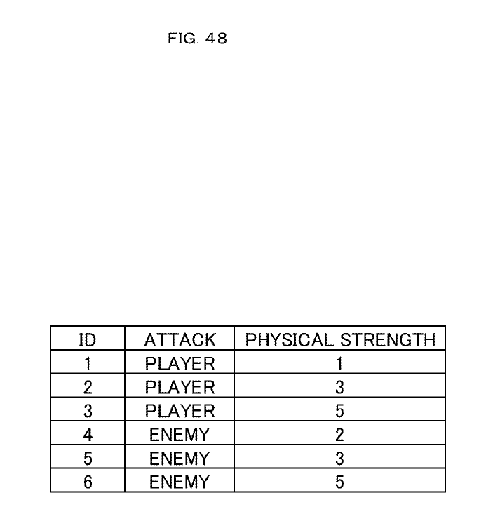

FIG. 48 shows an example of a table for a dark shogun;

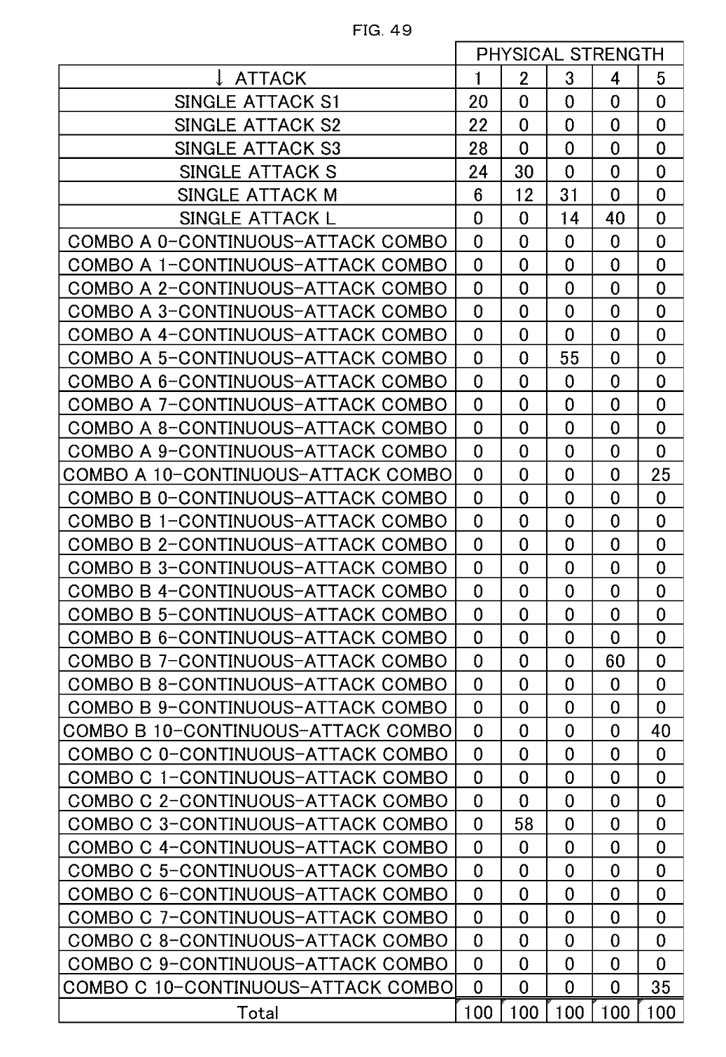

FIG. 49 shows an attack pattern determination table A;

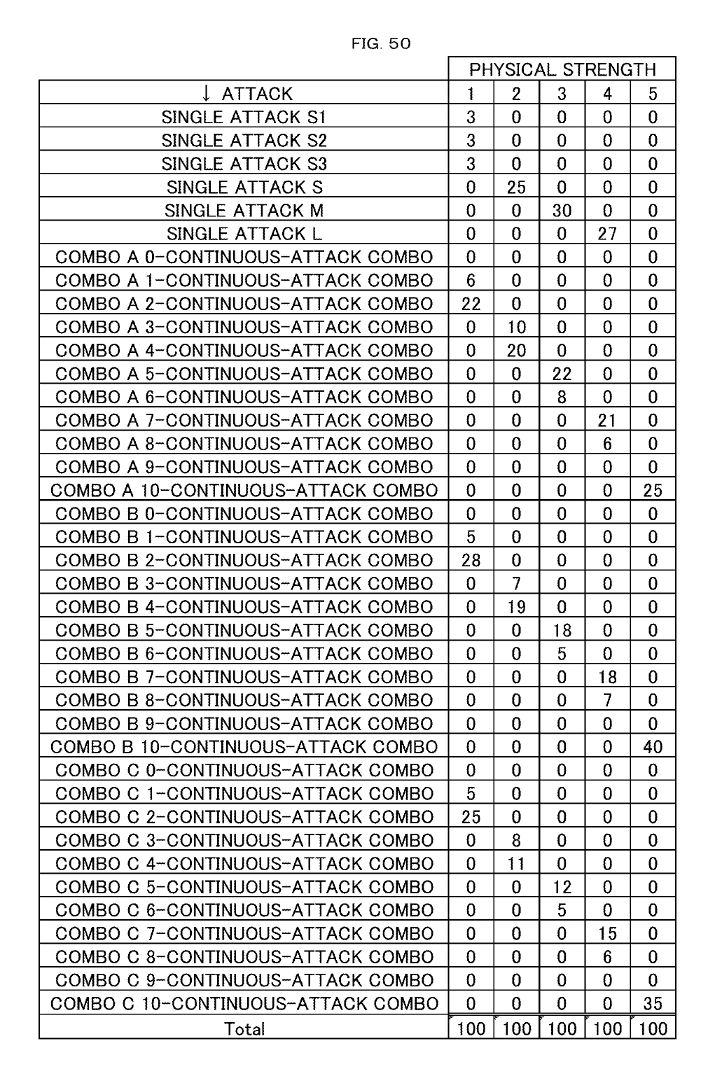

FIG. 50 shows an attack pattern determination table B;

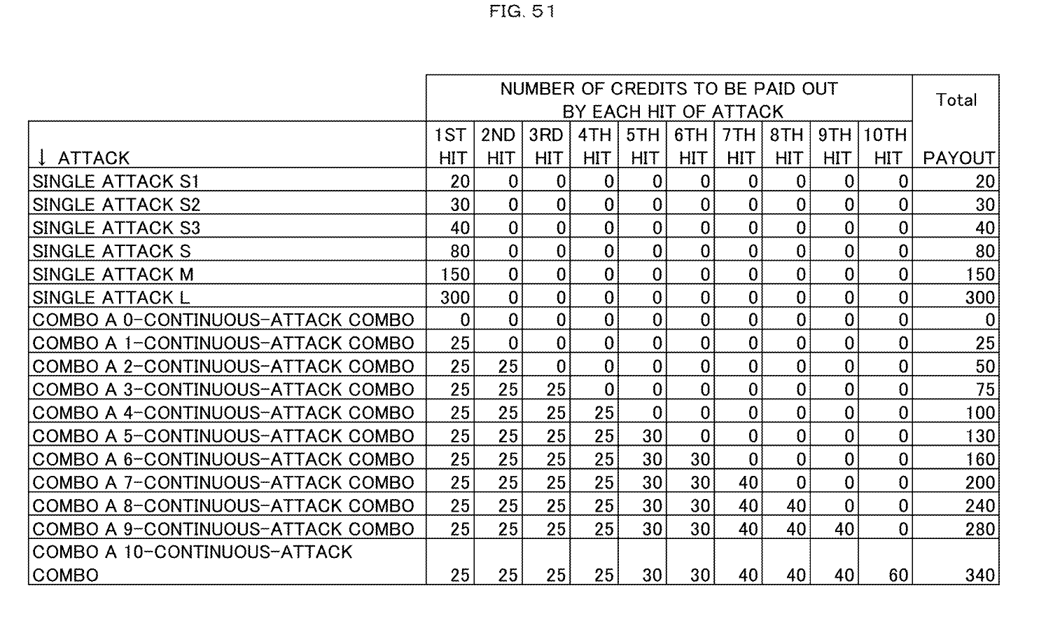

FIG. 51 shows an attack pattern corresponding payout table;

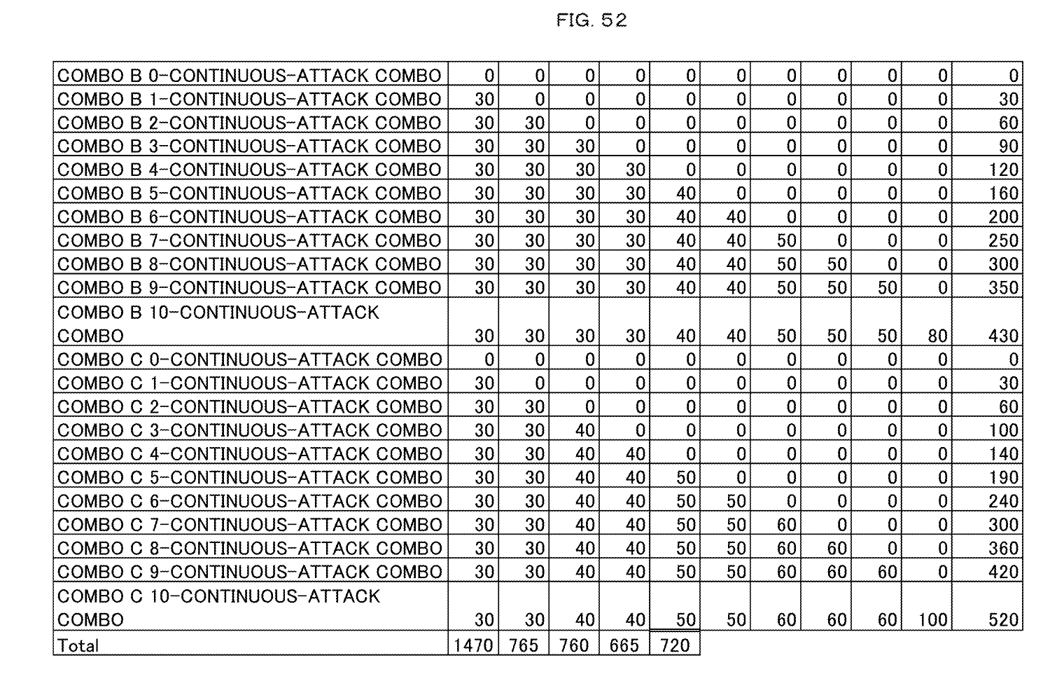

FIG. 52 shows the attack pattern corresponding payout table;

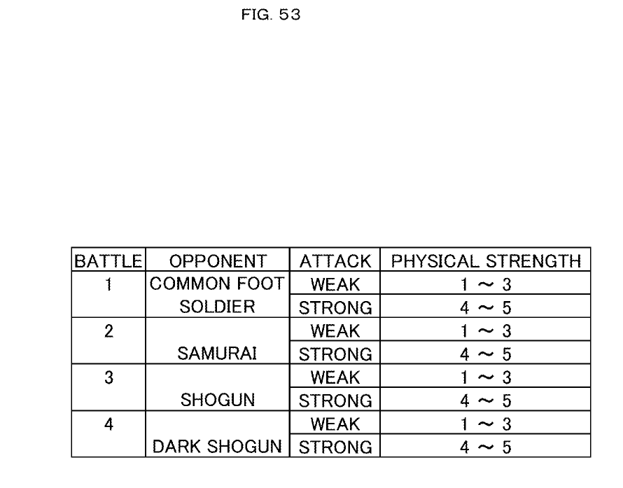

FIG. 53 is a table showing attack patterns of enemy characters;

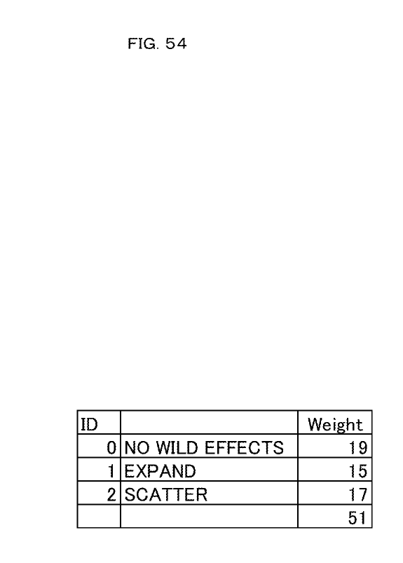

FIG. 54 is a WILD effect generation table;

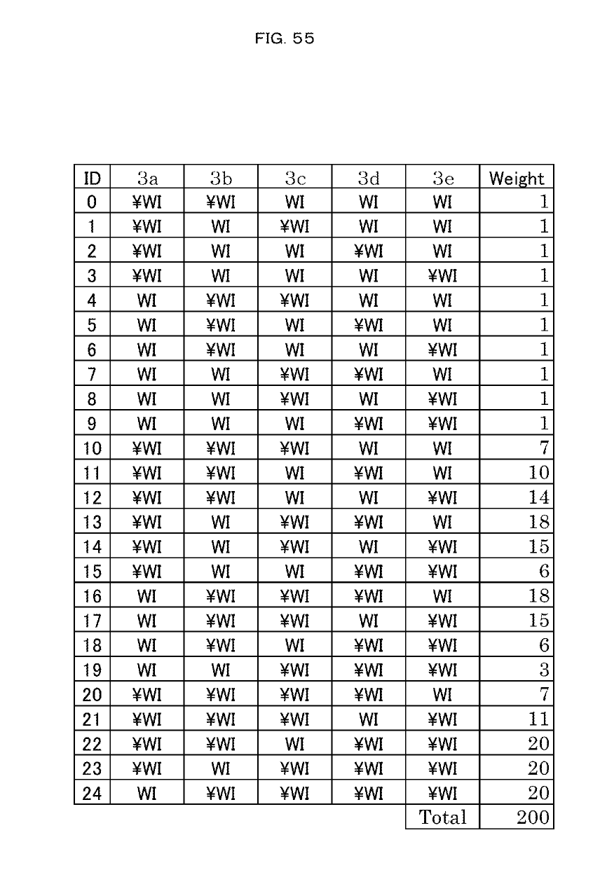

FIG. 55 is a WILD expand table;

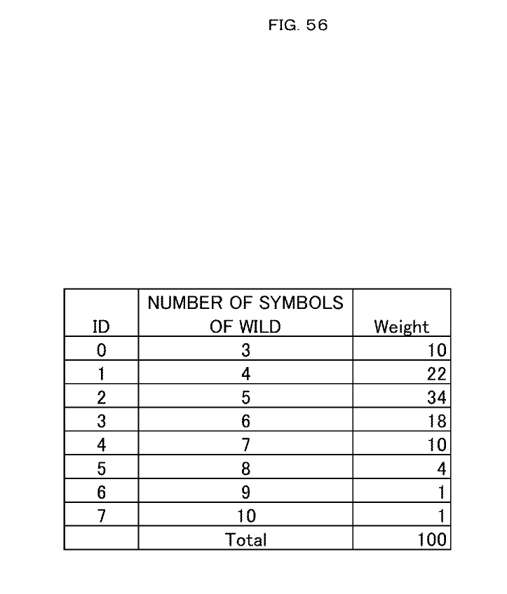

FIG. 56 is a WILD scatter table;

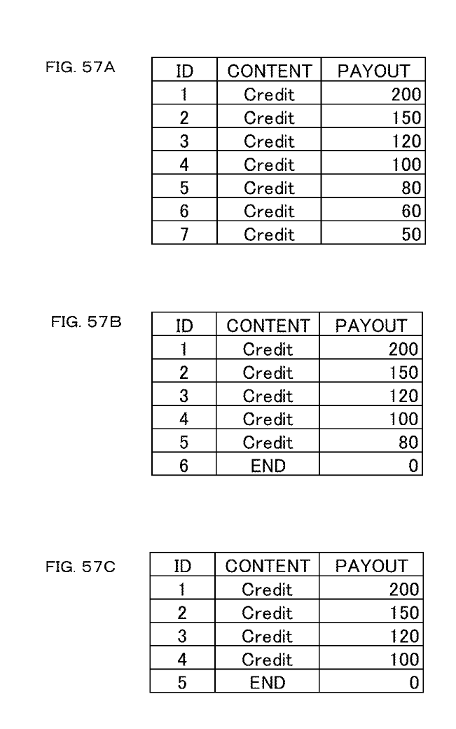

FIG. 57A is a table showing contents of choices available when a stage No. is 1; FIG. 57B is a table showing contents of choices available when a stage No. is 2; and FIG. 57C is a table showing contents of choices available when a stage No. is 3;

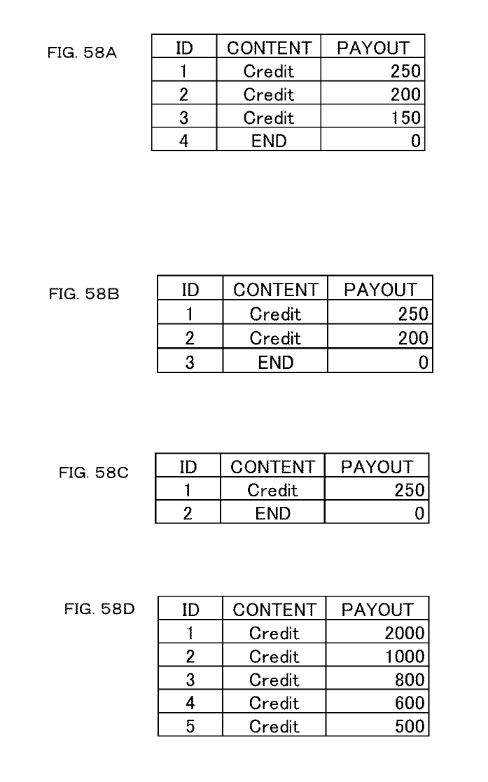

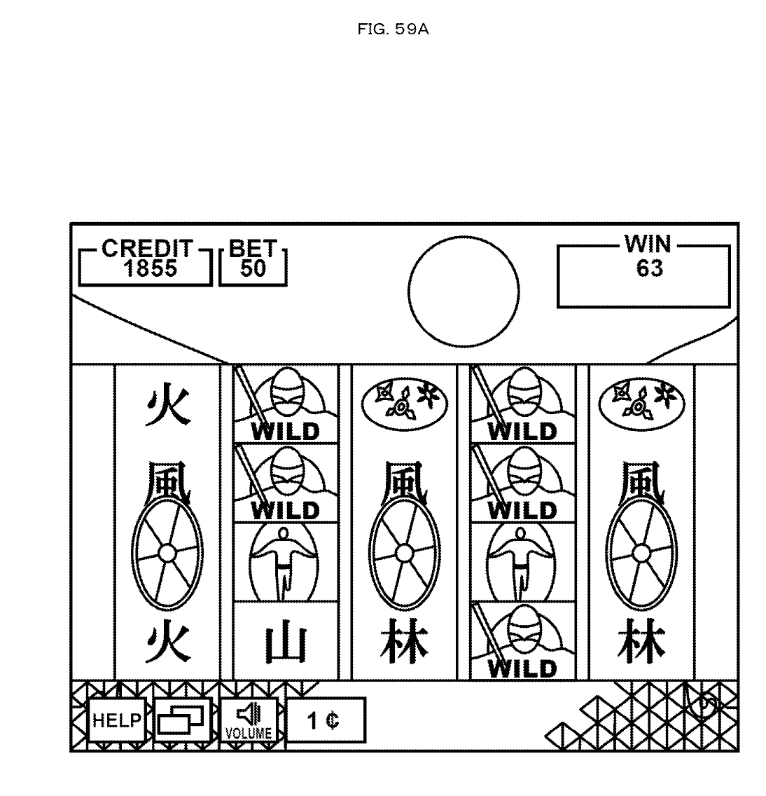

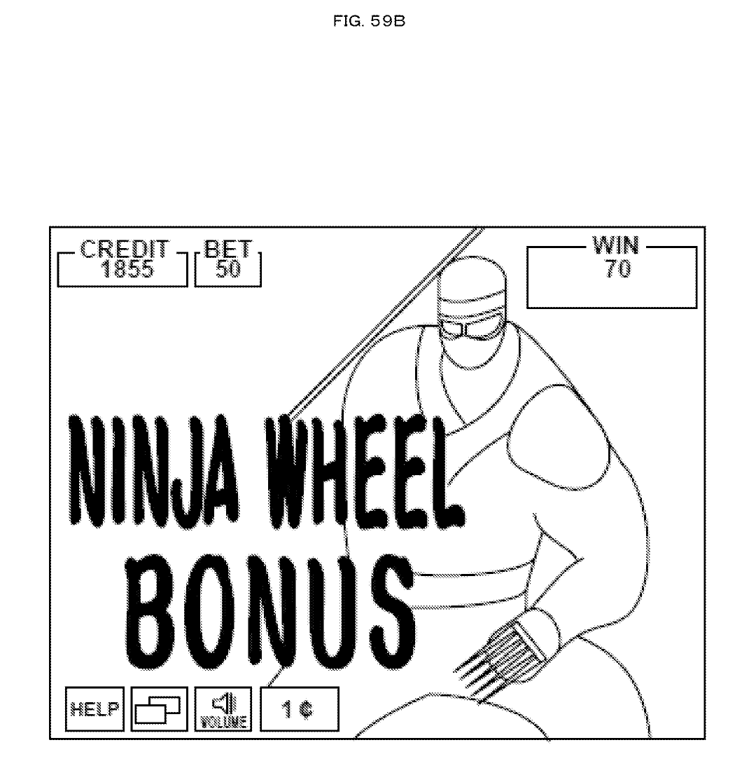

FIG. 58A is a table showing contents of choices available when a stage No. is 4; FIG. 58B is a table showing contents of choices available when a stage No. is 5; FIG. 58C is a table showing contents of choices available when a stage No. is 6; and FIG. 58D is a table showing contents of choices available when a stage No. is 7;

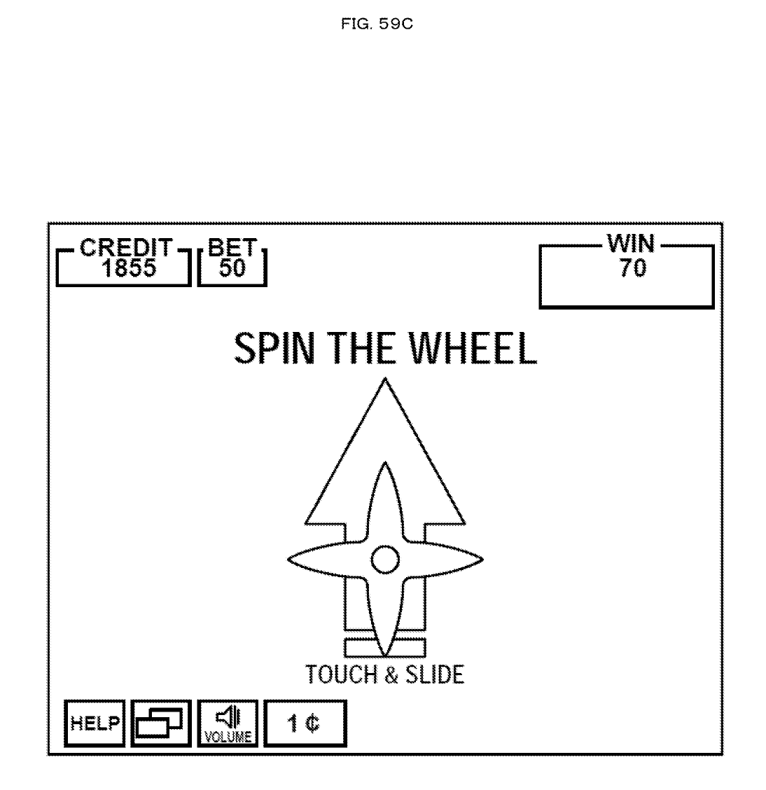

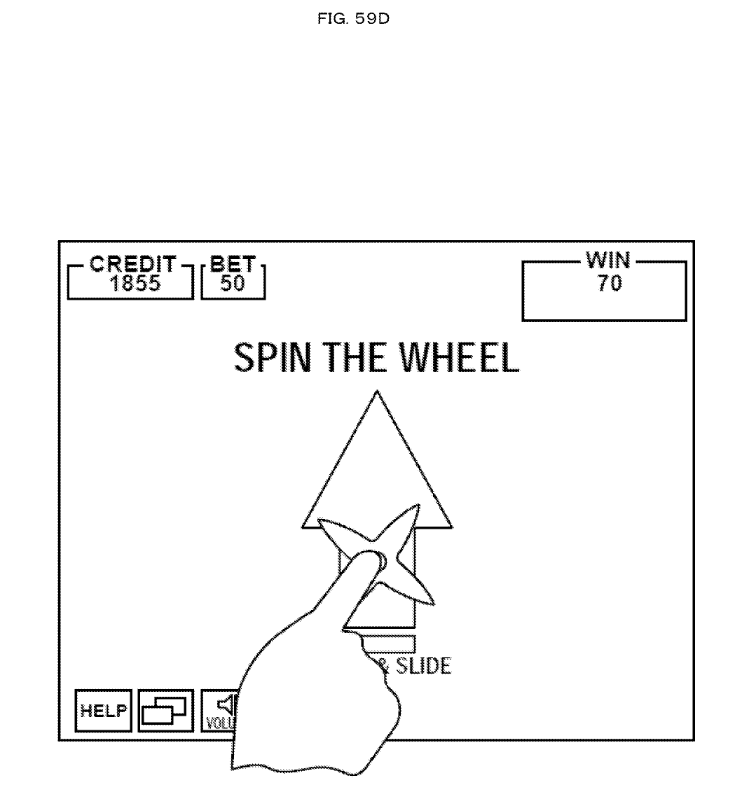

FIG. 59A is a diagram illustrating an example of an image displayed before a wheel drawing process is started;

FIG. 59B is a diagram illustrating an example of an image displayed before the wheel drawing process is started;

FIG. 59C is a diagram illustrating an example of an image displayed before the wheel drawing process is started;

FIG. 59D is a diagram illustrating an example of an image displayed before the wheel drawing process is started;

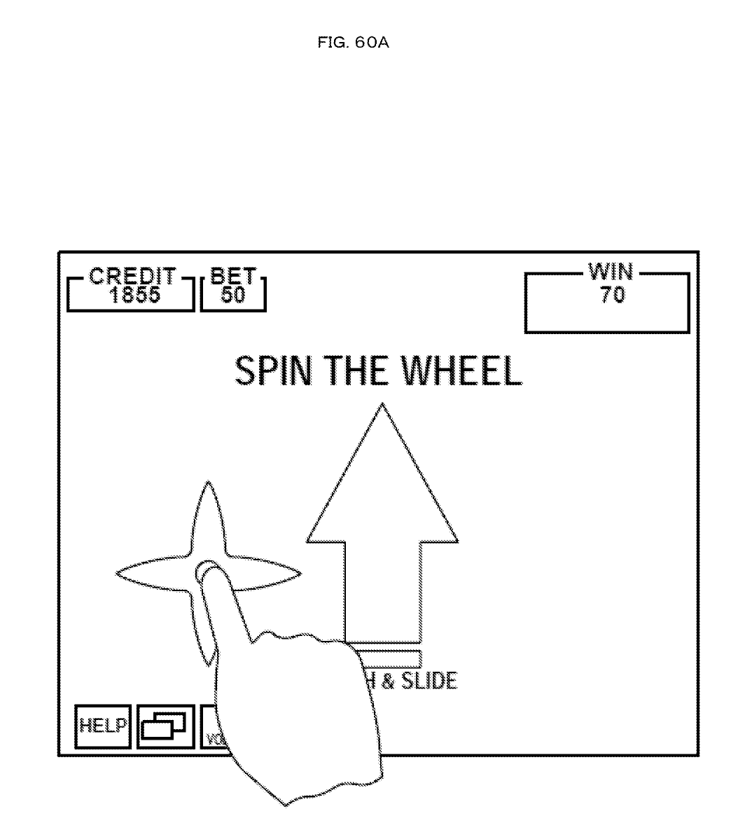

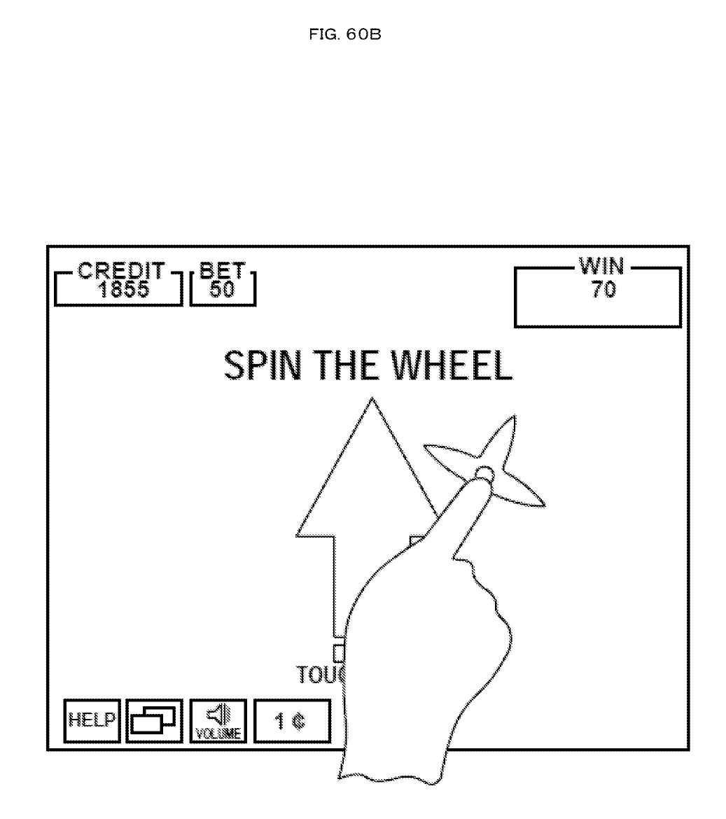

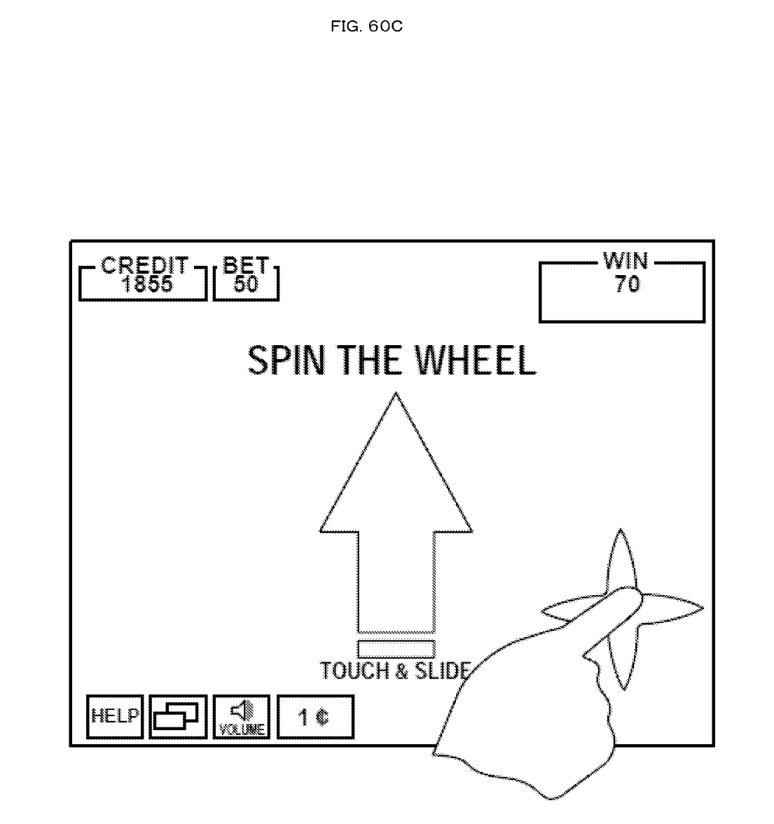

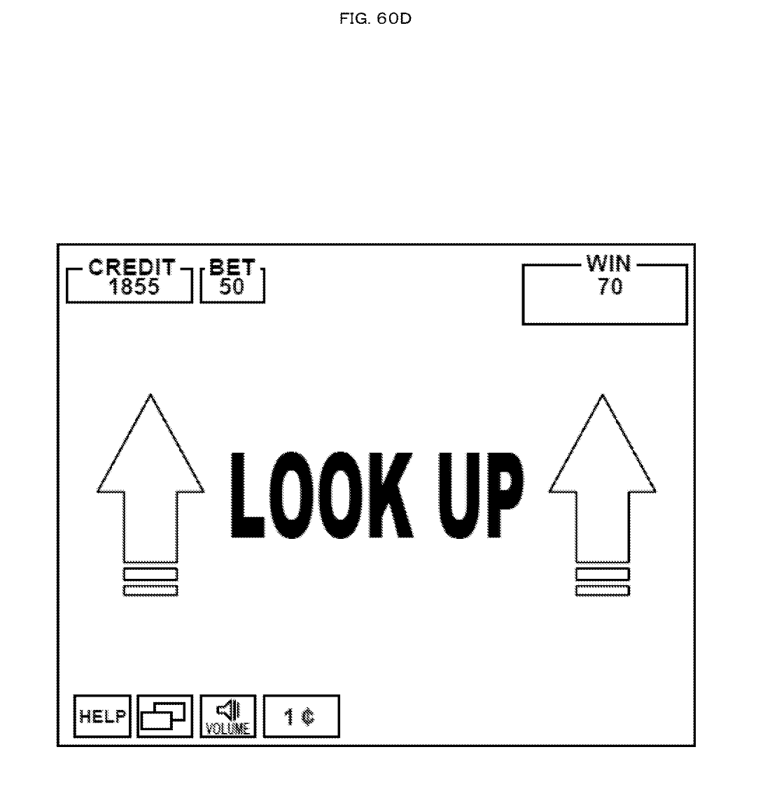

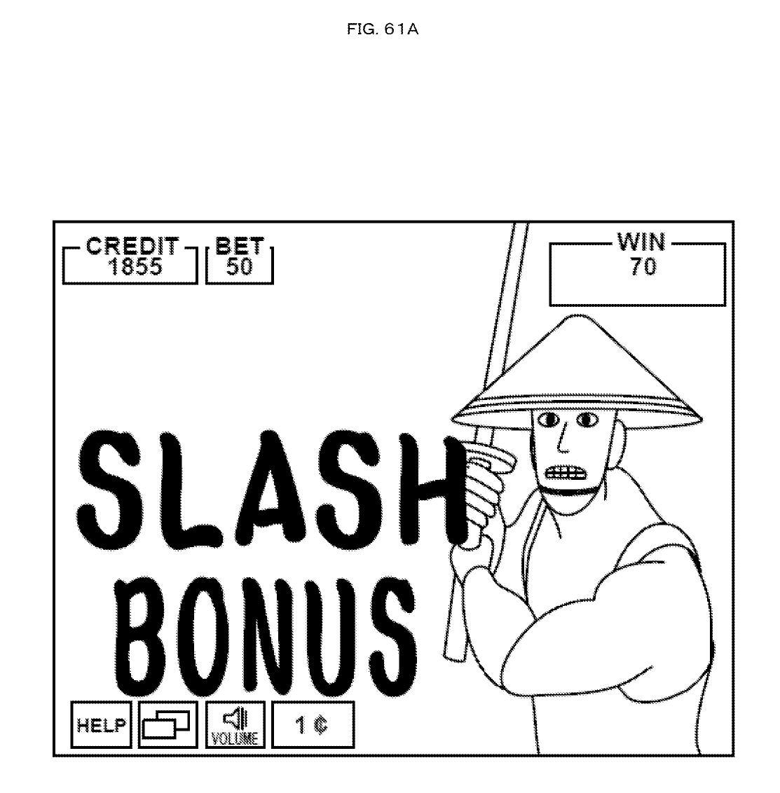

FIG. 60A is a diagram illustrating an example of an image displayed before the wheel drawing process is started;

FIG. 60B is a diagram illustrating an example of an image displayed before the wheel drawing process is started;

FIG. 60C is a diagram illustrating an example of an image displayed before the wheel drawing process is started;

FIG. 60D is a diagram illustrating an example of an image displayed before the wheel drawing process is started;

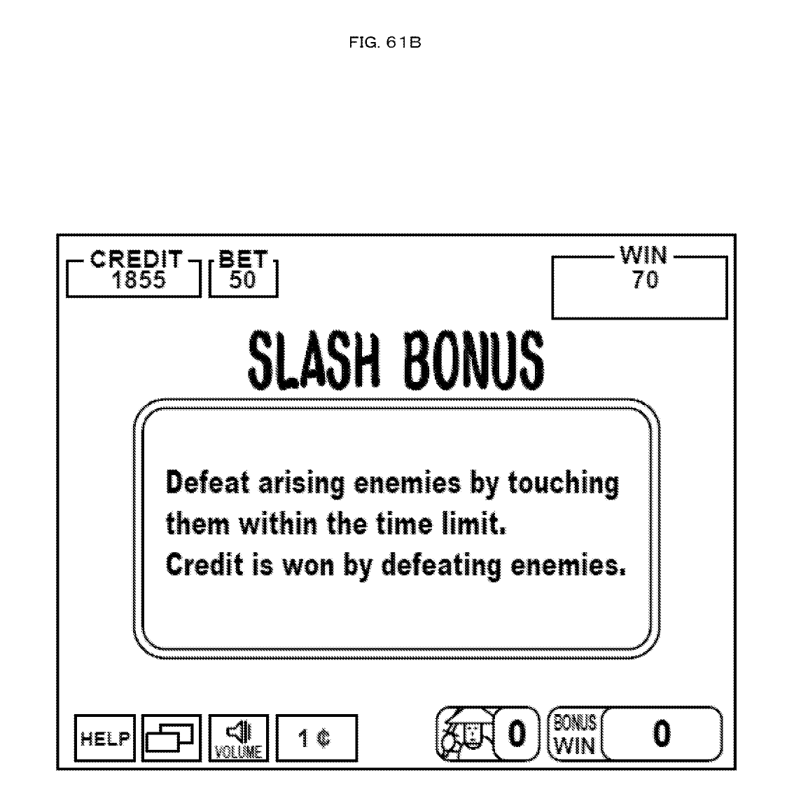

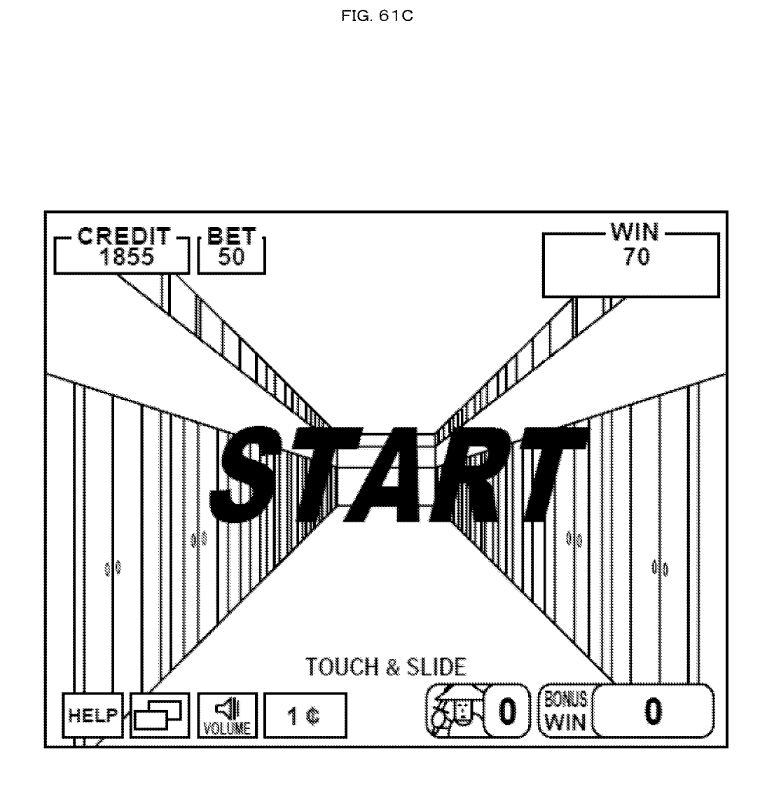

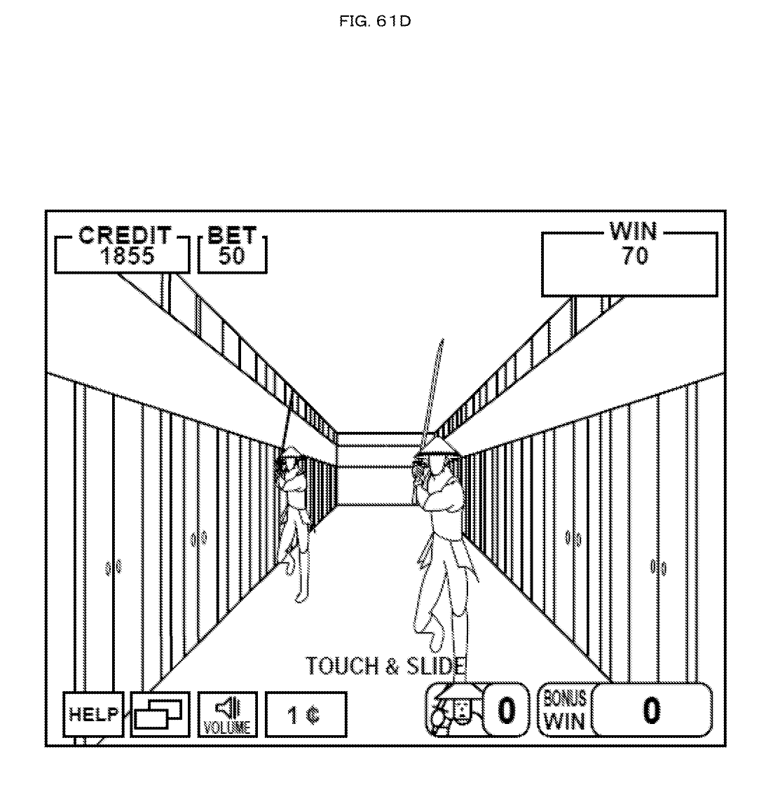

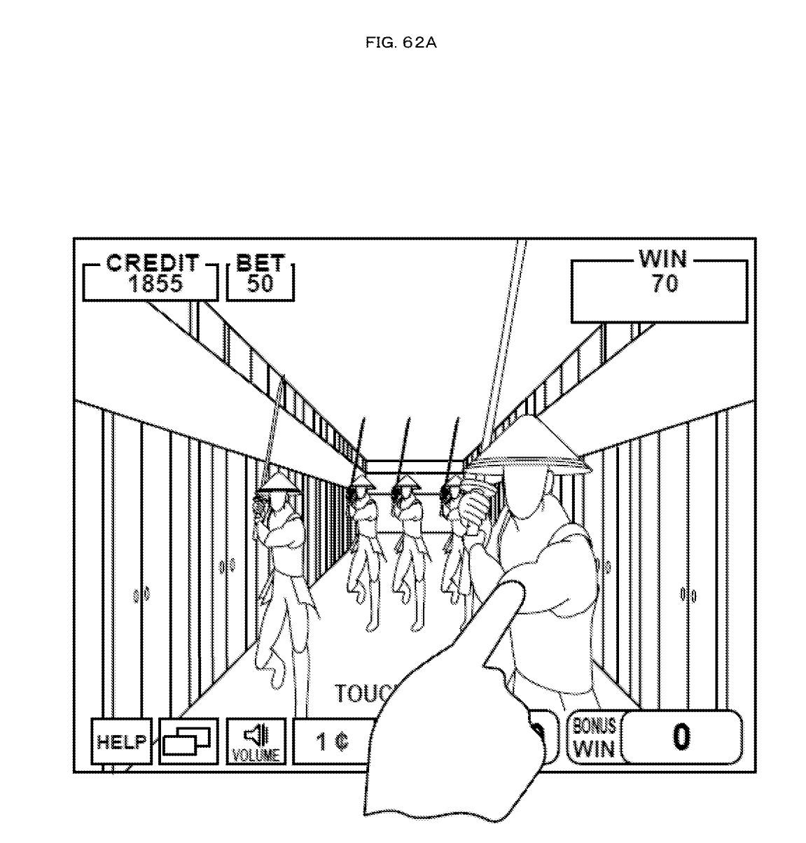

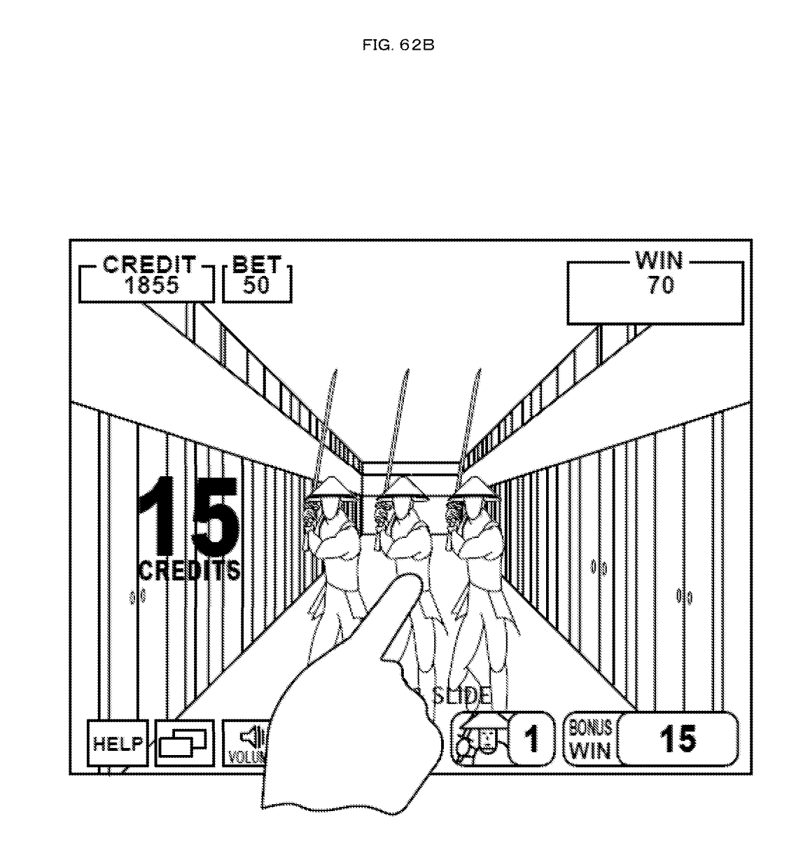

FIG. 61A is a diagram illustrating an example of an image displayed in a slash bonus process;

FIG. 61B is a diagram illustrating an example of an image displayed in the slash bonus process;

FIG. 61C is a diagram illustrating an example of an image displayed in the slash bonus process;

FIG. 61D is a diagram illustrating an example of an image displayed in the slash bonus process;

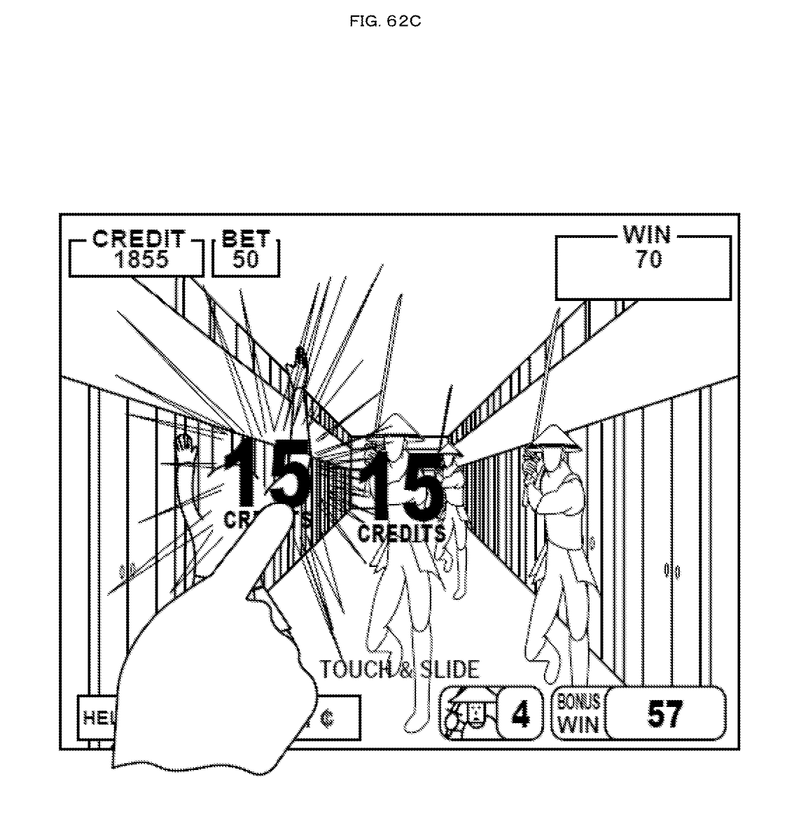

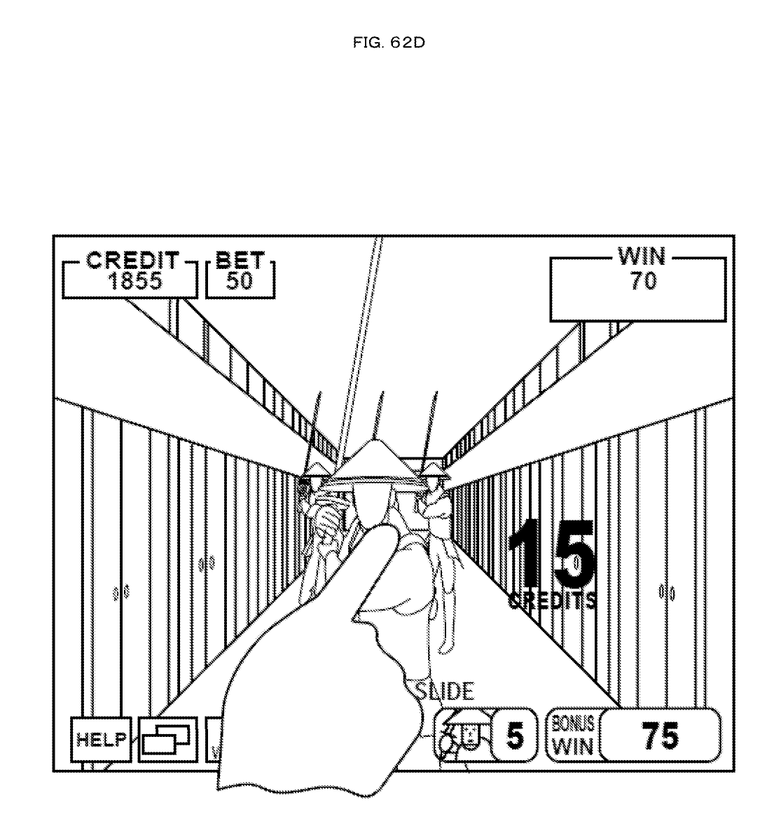

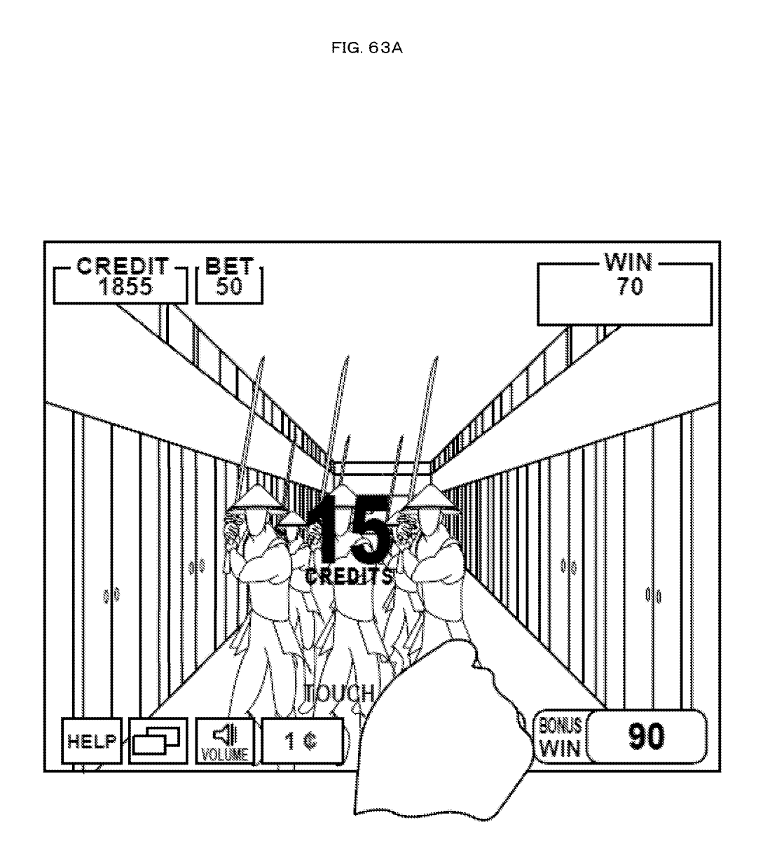

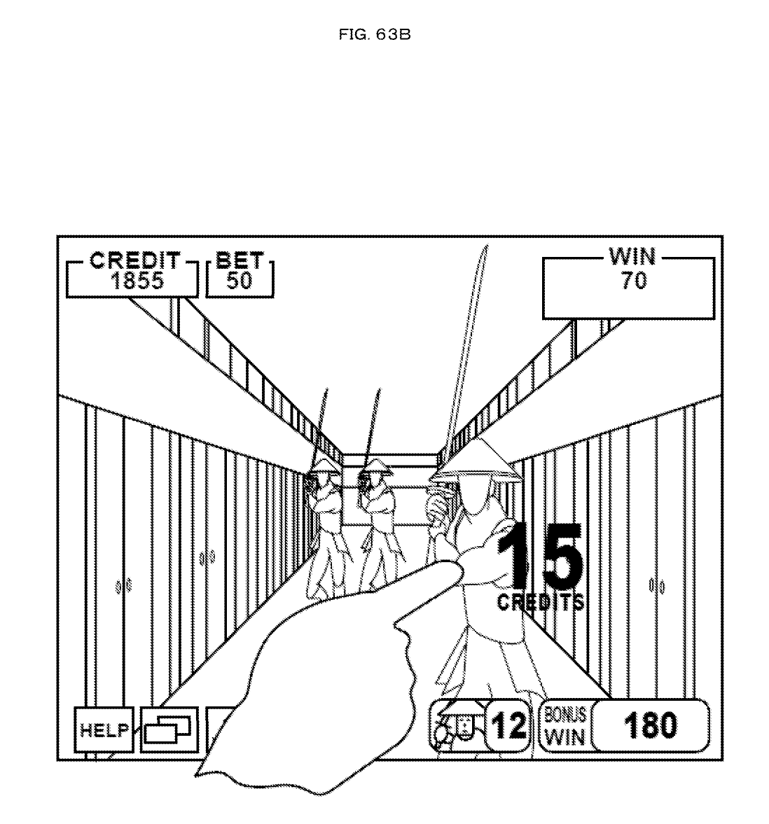

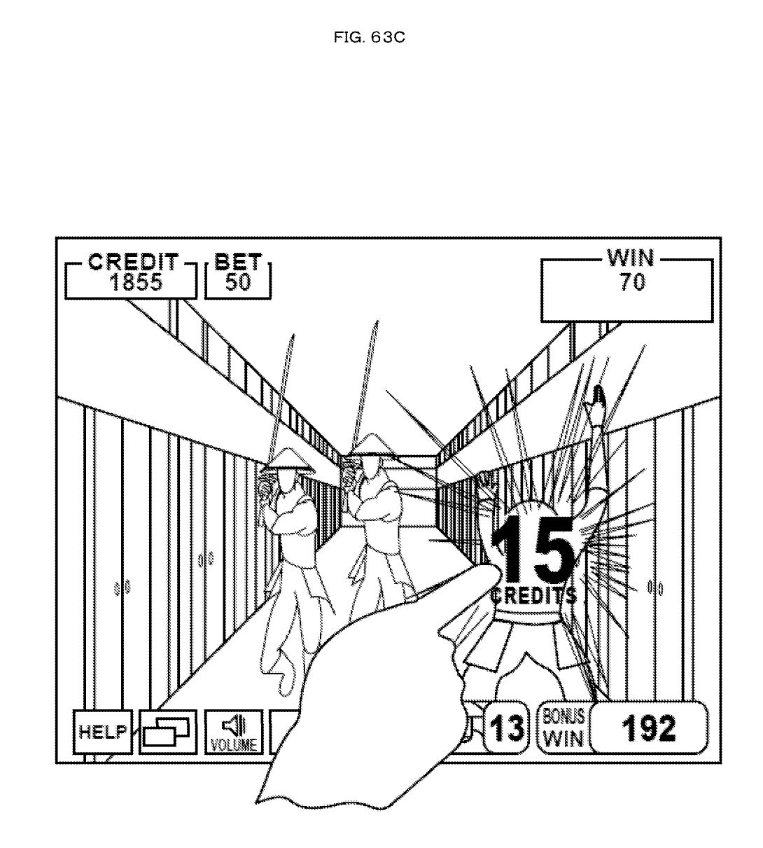

FIG. 62A is a diagram illustrating an example of an image displayed in the slash bonus process;

FIG. 62B is a diagram illustrating an example of an image displayed in the slash bonus process;

FIG. 62C is a diagram illustrating an example of an image displayed in the slash bonus process;

FIG. 62D is a diagram illustrating an example of an image displayed in the slash bonus process;

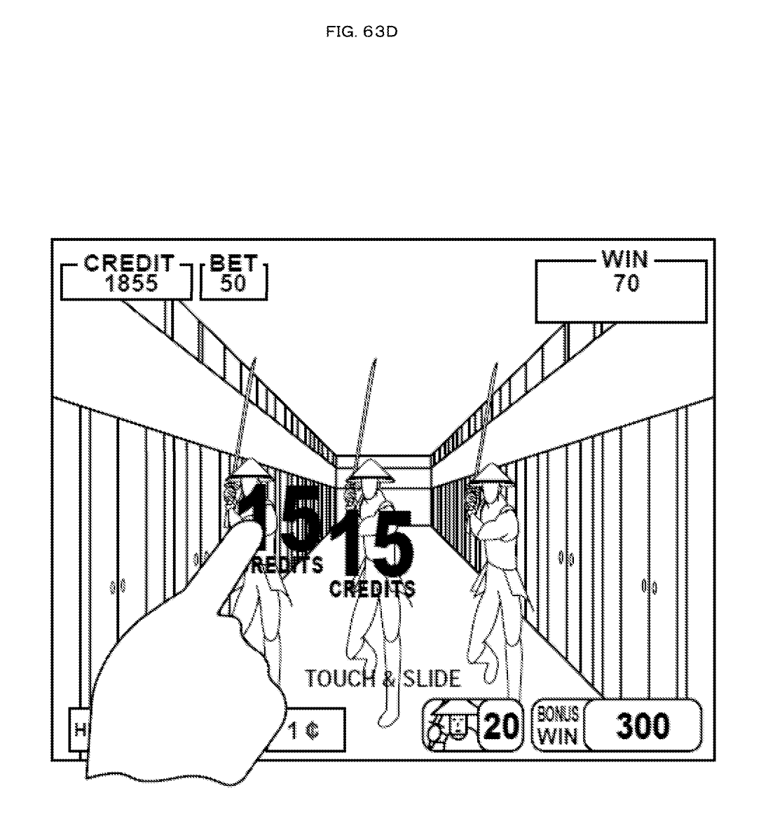

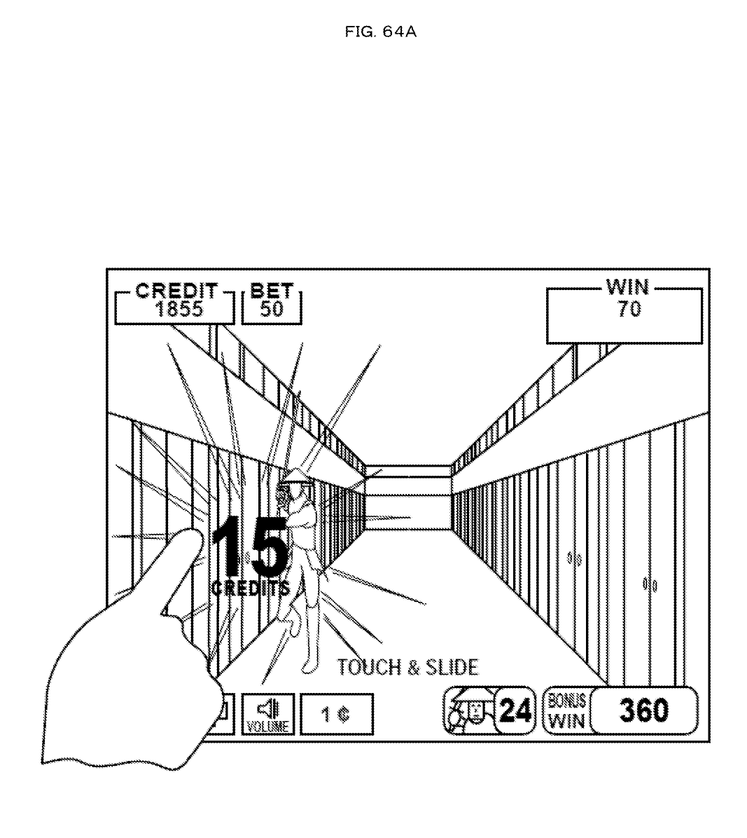

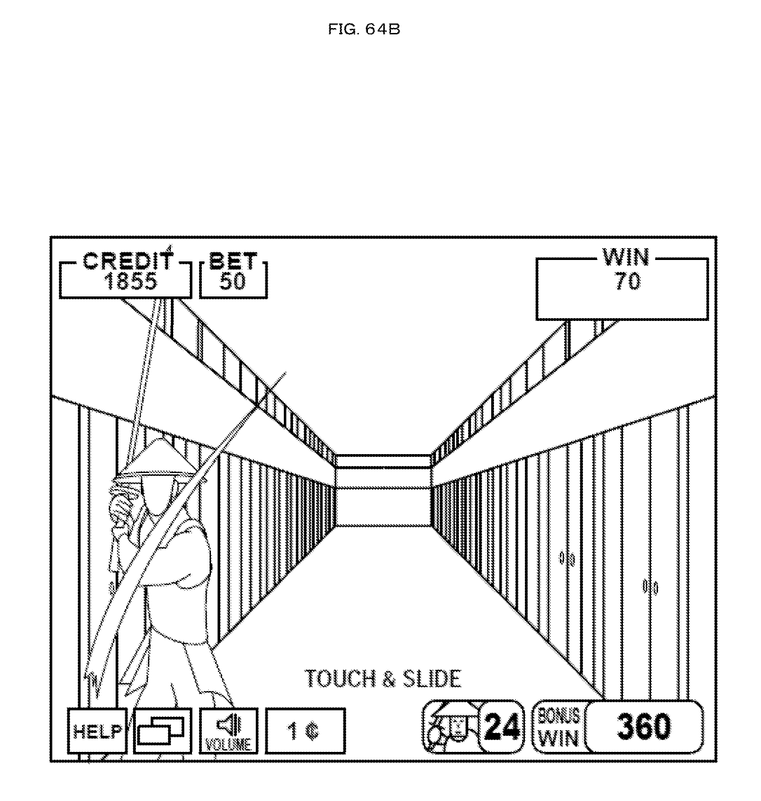

FIG. 63A is a diagram illustrating an example of an image displayed in the slash bonus process;

FIG. 63B is a diagram illustrating an example of an image displayed in the slash bonus process;

FIG. 63C is a diagram illustrating an example of an image displayed in the slash bonus process;

FIG. 63D is a diagram illustrating an example of an image displayed in the slash bonus process;

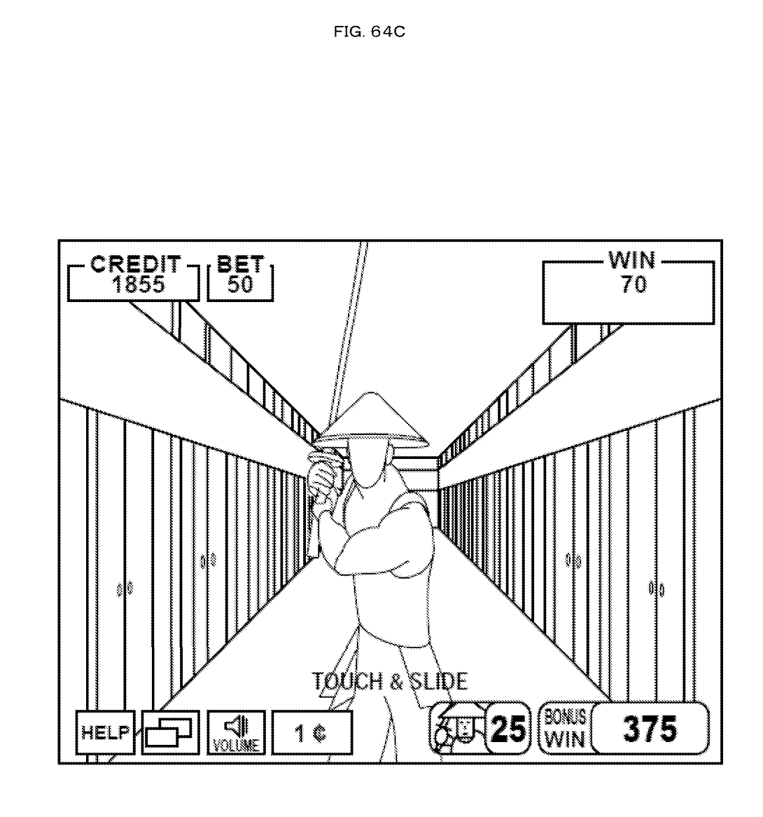

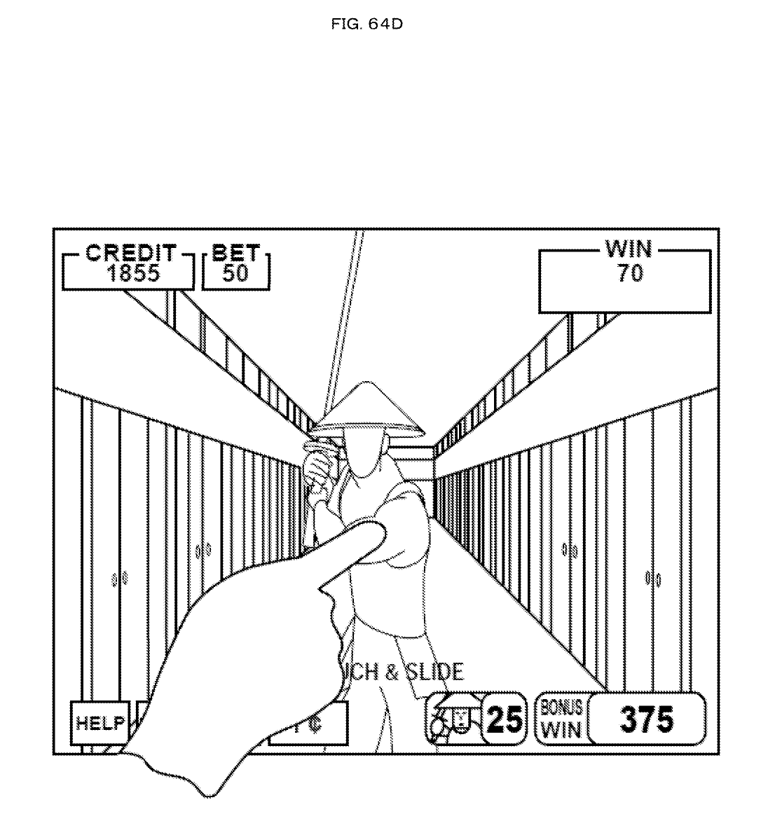

FIG. 64A is a diagram illustrating an example of an image displayed in the slash bonus process;

FIG. 64B is a diagram illustrating an example of an image displayed in the slash bonus process;

FIG. 64C is a diagram illustrating an example of an image displayed in the slash bonus process;

FIG. 64D is a diagram illustrating an example of an image displayed in the slash bonus process;

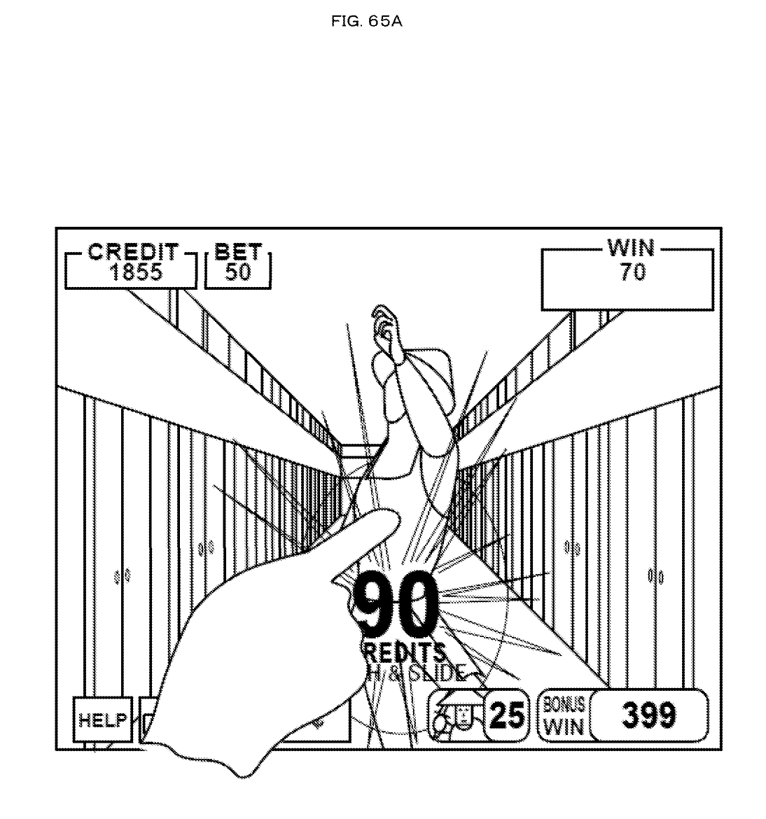

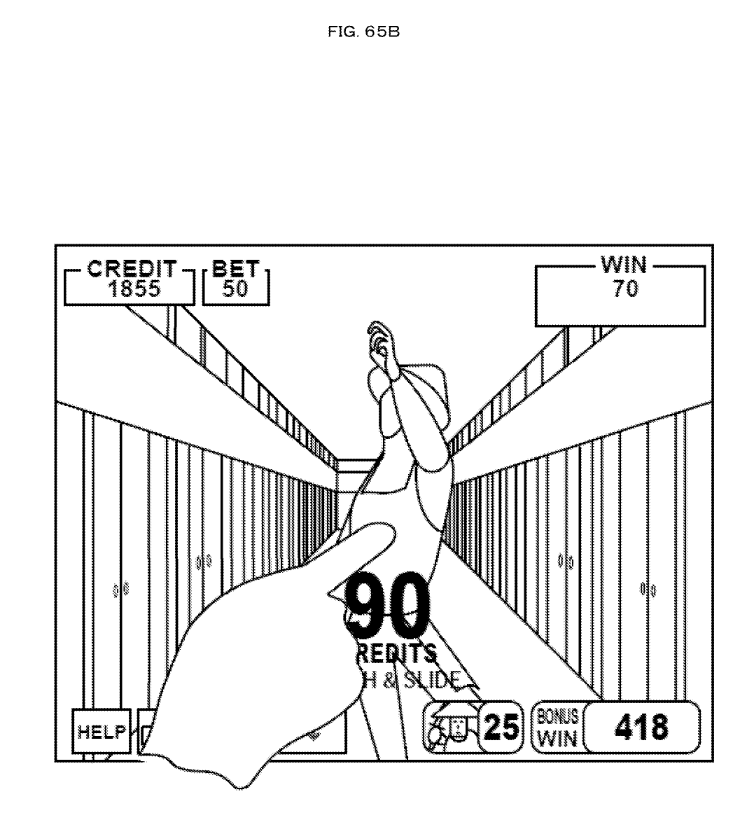

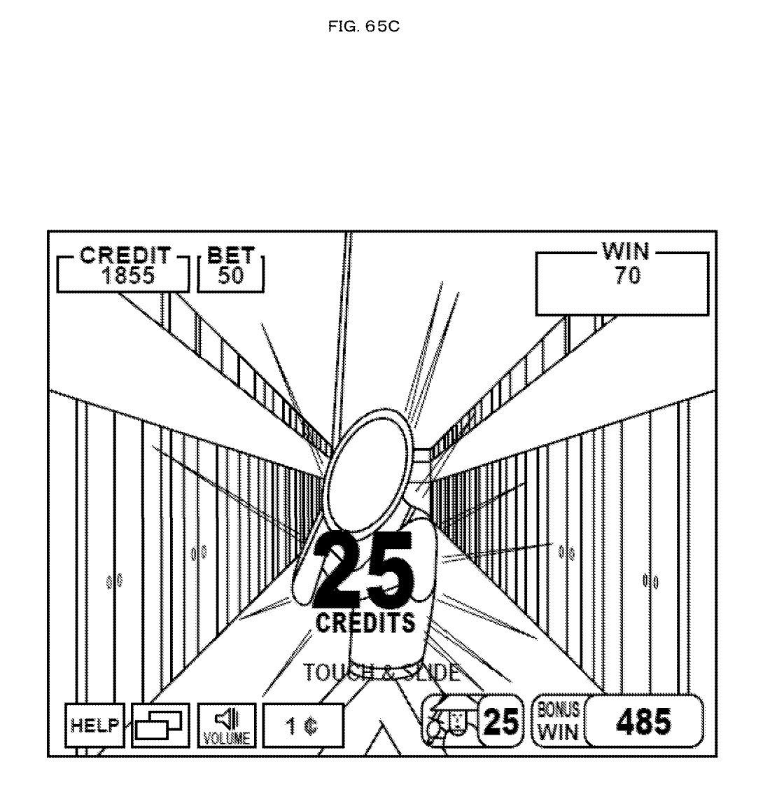

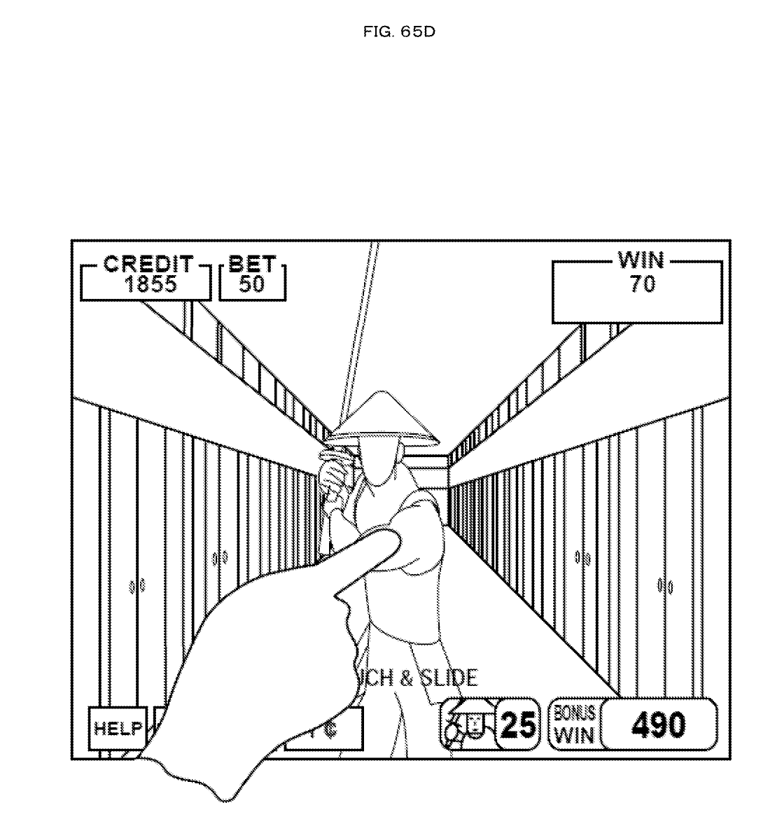

FIG. 65A is a diagram illustrating an example of an image displayed in the slash bonus process;

FIG. 65B is a diagram illustrating an example of an image displayed in the slash bonus process;

FIG. 65C is a diagram illustrating an example of an image displayed in the slash bonus process;

FIG. 65D is a diagram illustrating an example of an image displayed in the slash bonus process;

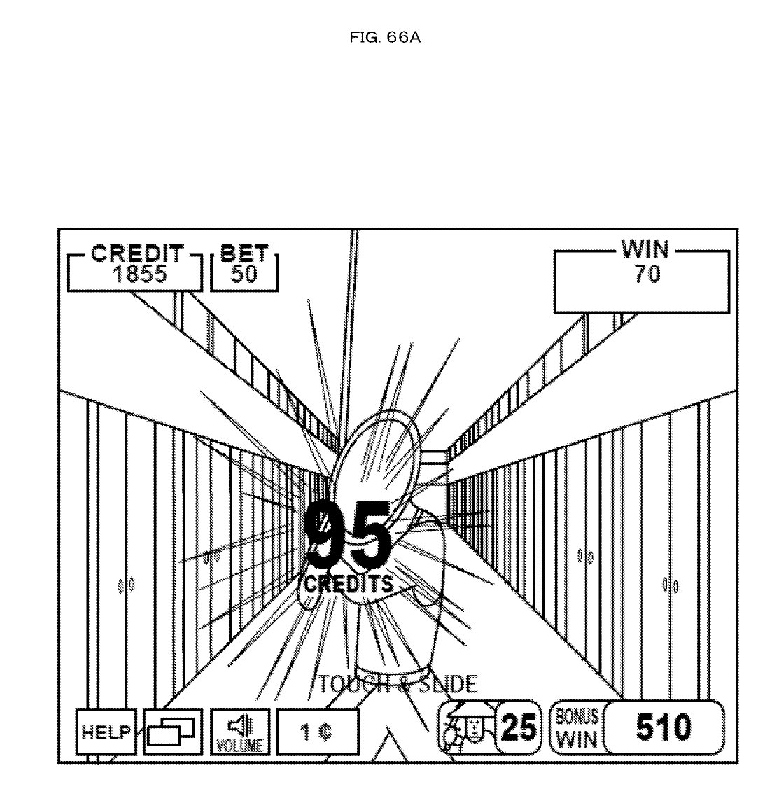

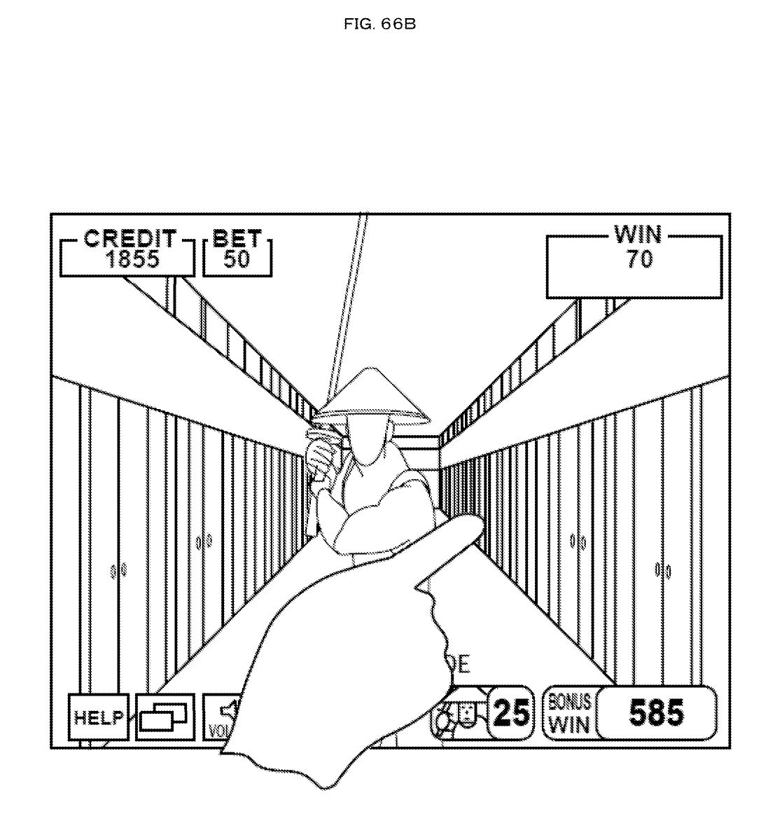

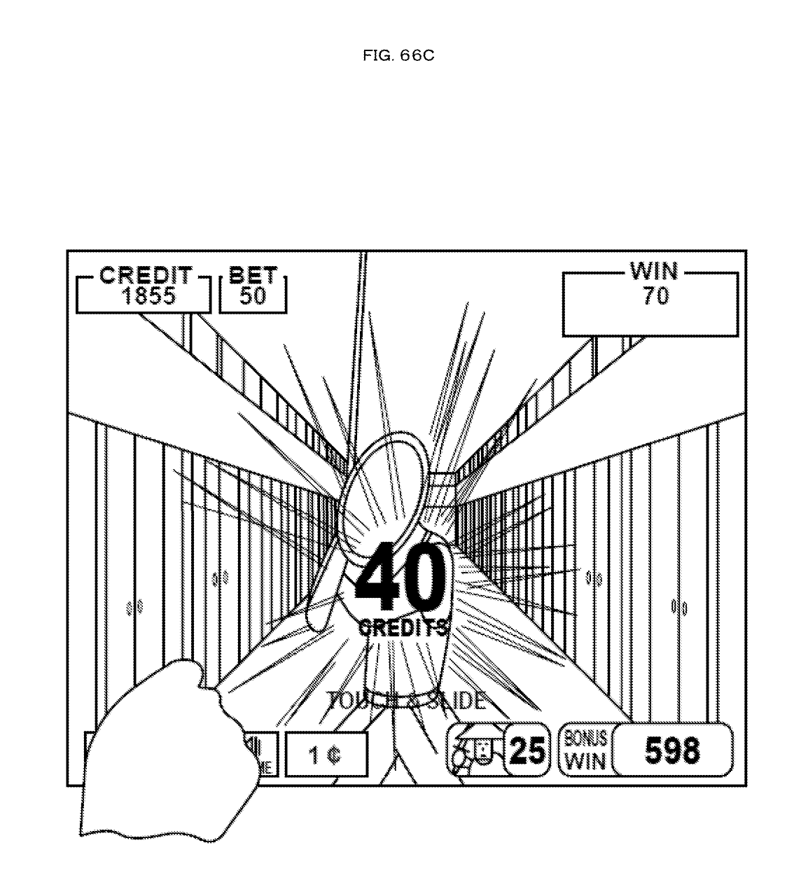

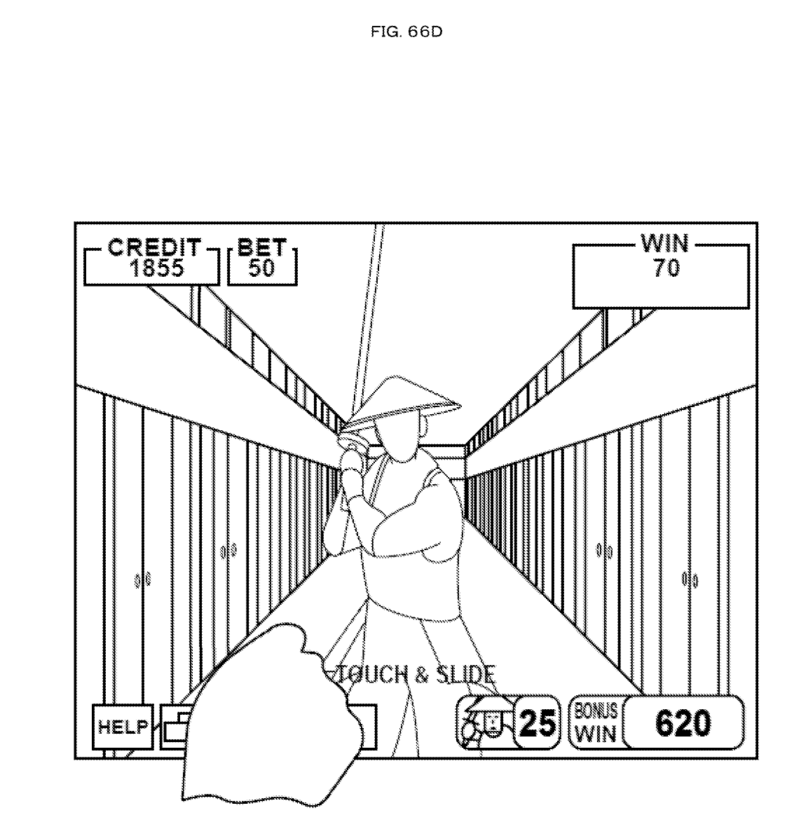

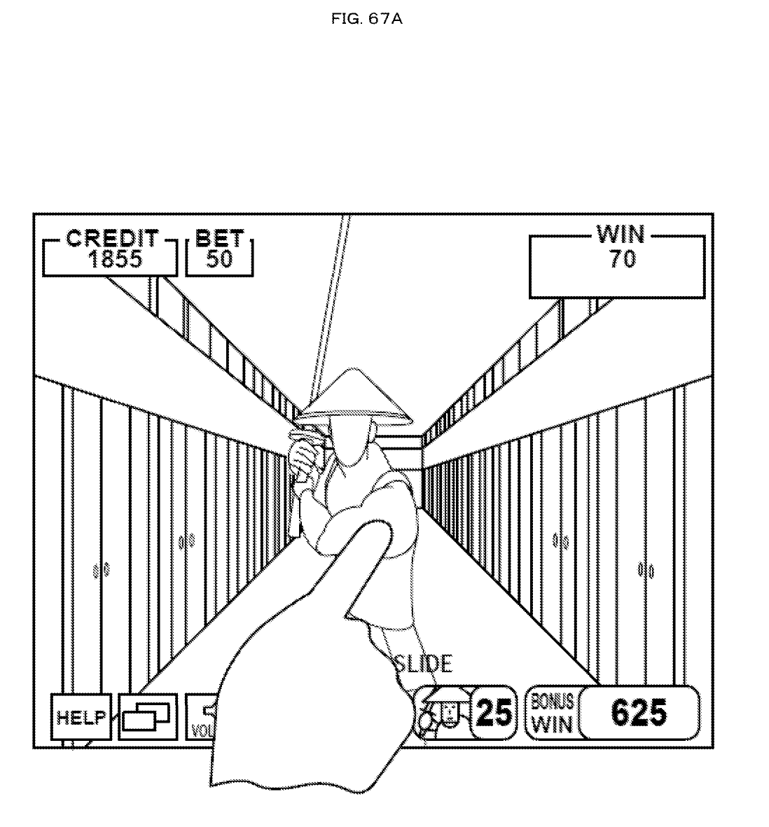

FIG. 66A is a diagram illustrating an example of an image displayed in the slash bonus process;

FIG. 66B is a diagram illustrating an example of an image displayed in the slash bonus process;

FIG. 66C is a diagram illustrating an example of an image displayed in the slash bonus process;

FIG. 66D is a diagram illustrating an example of an image displayed in the slash bonus process;

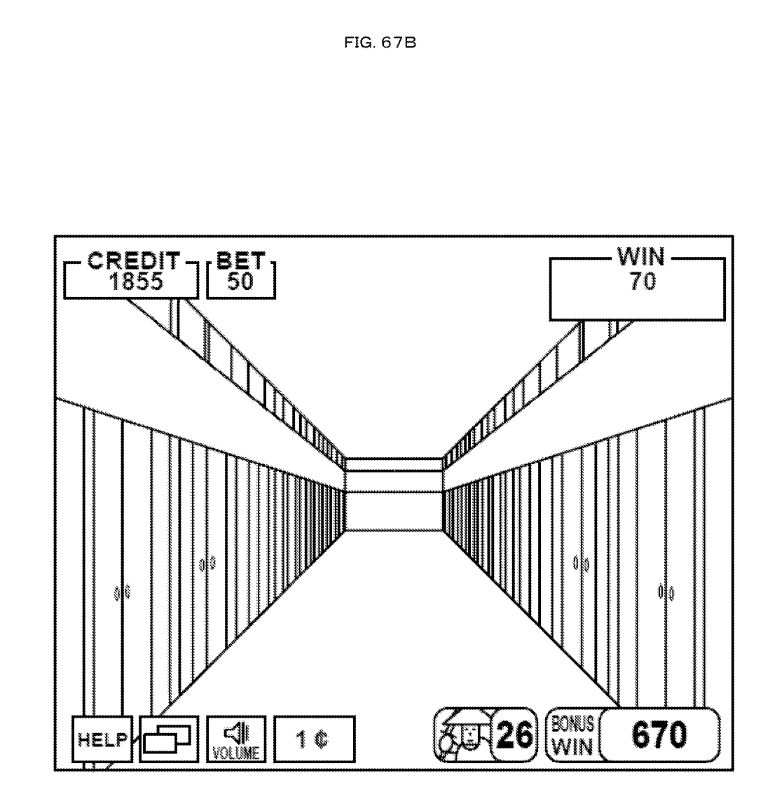

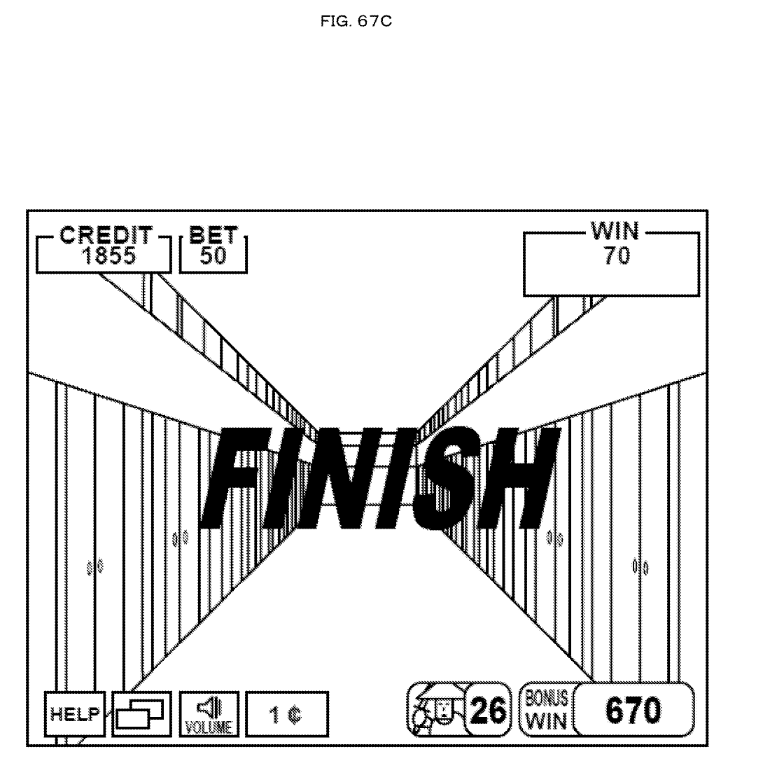

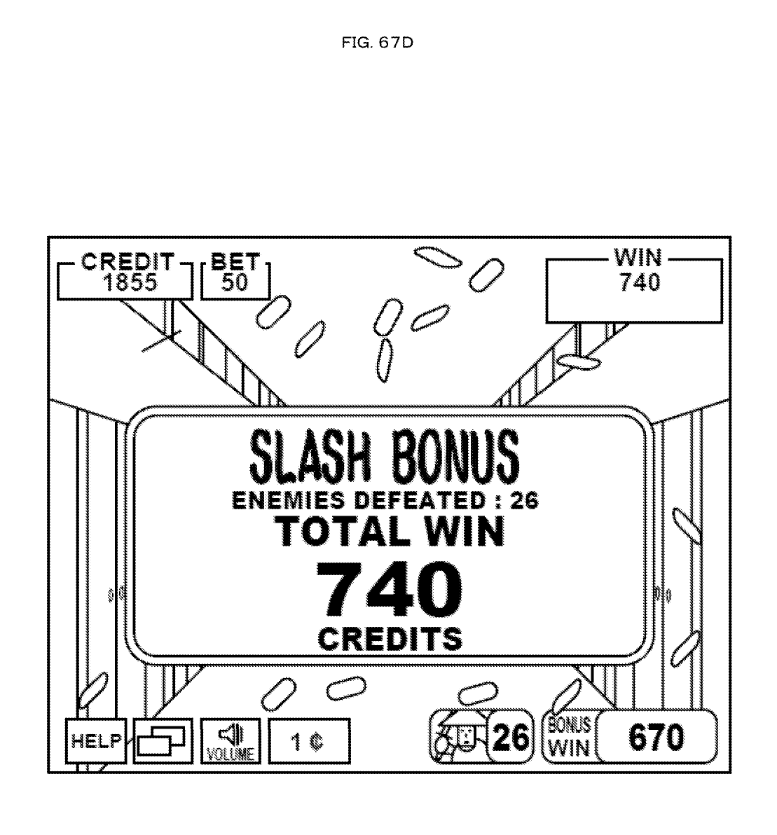

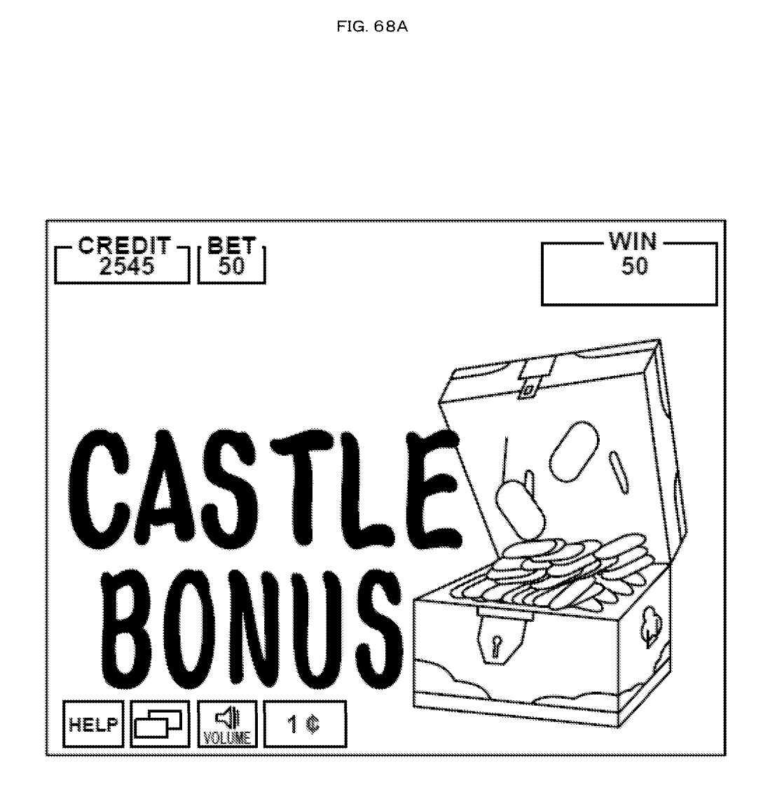

FIG. 67A is a diagram illustrating an example of an image displayed in the slash bonus process;

FIG. 67B is a diagram illustrating an example of an image displayed in the slash bonus process;

FIG. 67C is a diagram illustrating an example of an image displayed in the slash bonus process;

FIG. 67D is a diagram illustrating an example of an image displayed in the slash bonus process;

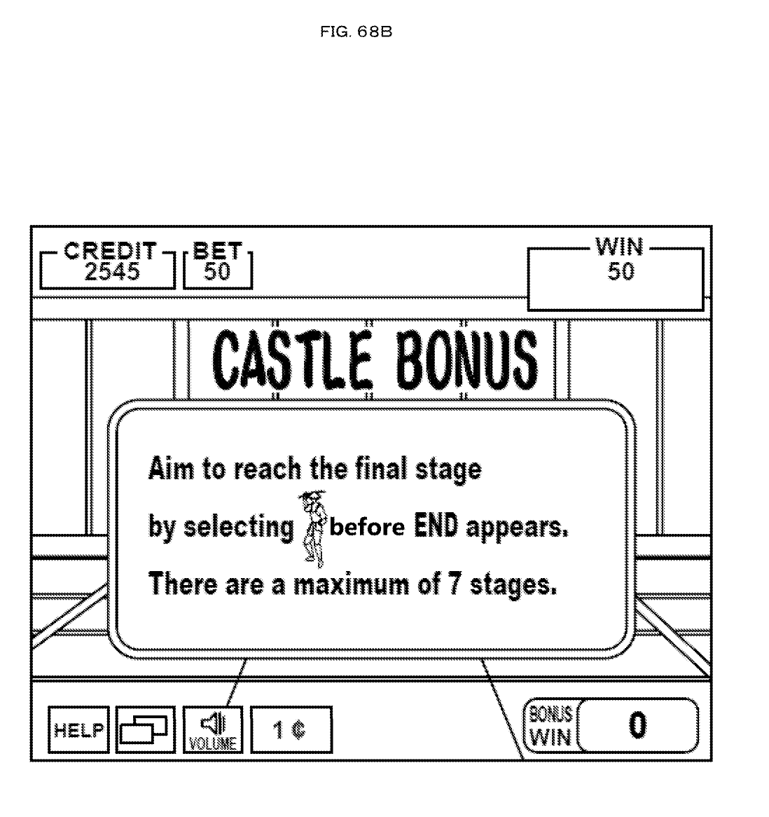

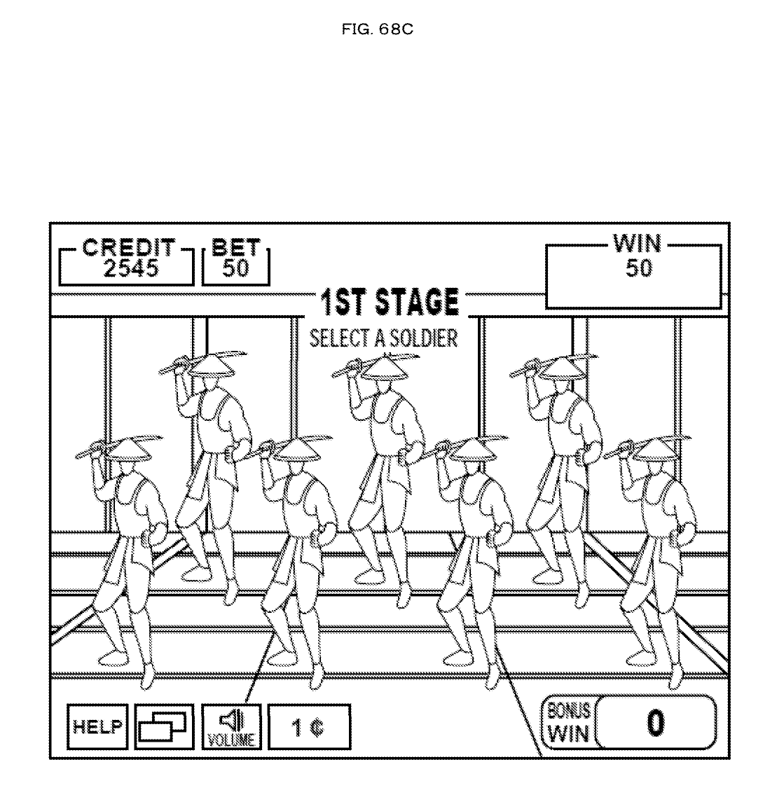

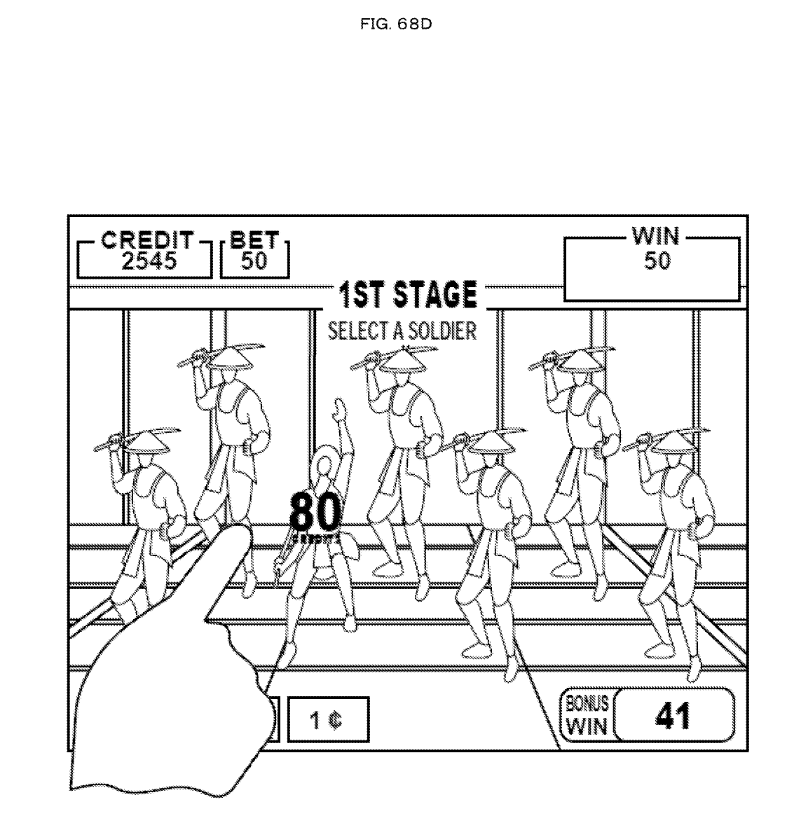

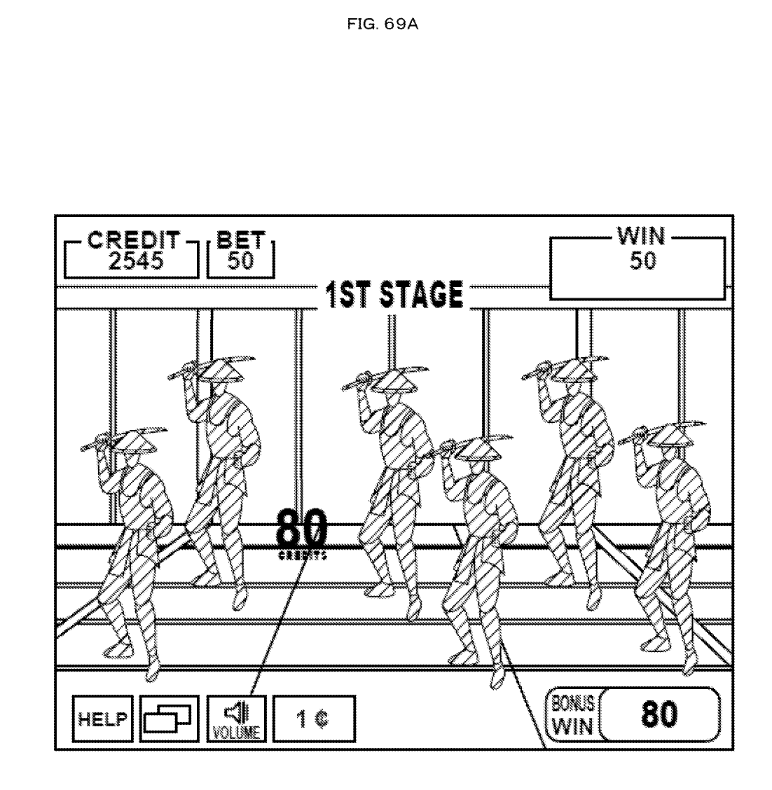

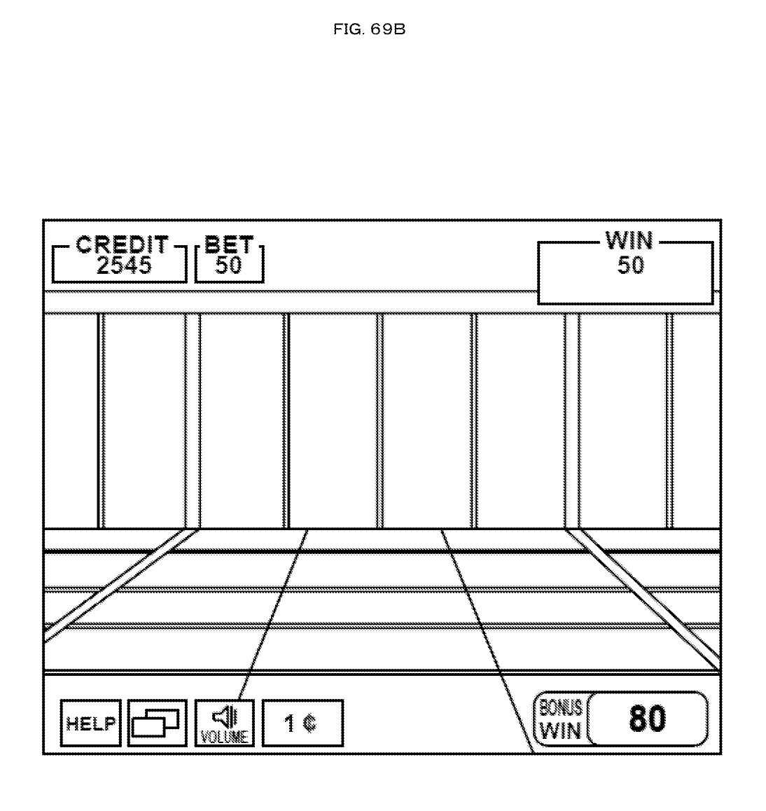

FIG. 68A is a diagram illustrating an example of an image displayed in a pick bonus process;

FIG. 68B is a diagram illustrating an example of an image displayed in the pick bonus process;

FIG. 68C is a diagram illustrating an example of an image displayed in the pick bonus process;

FIG. 68D is a diagram illustrating an example of an image displayed in the pick bonus process;

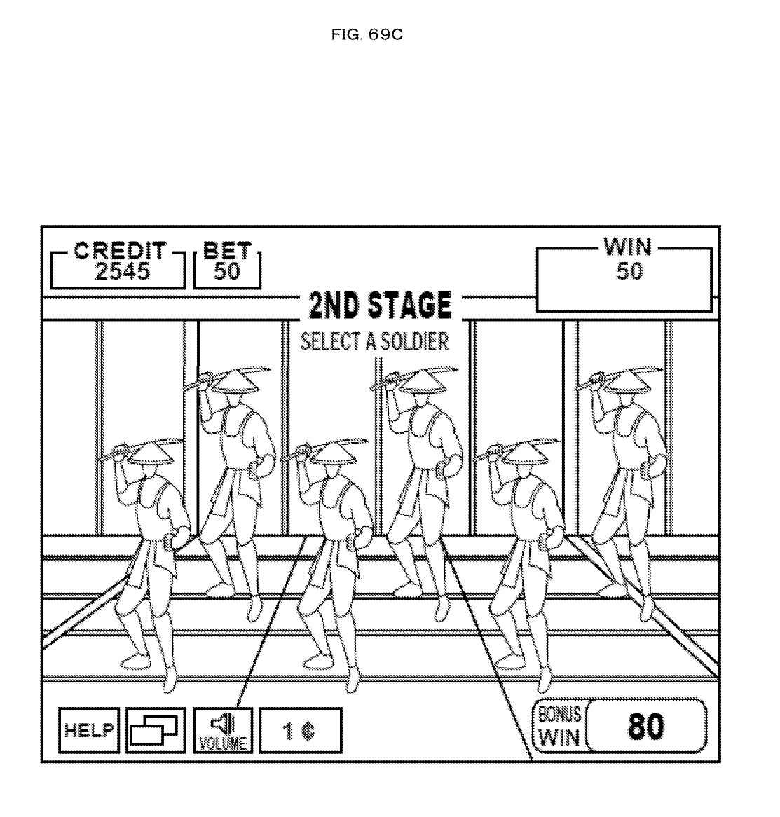

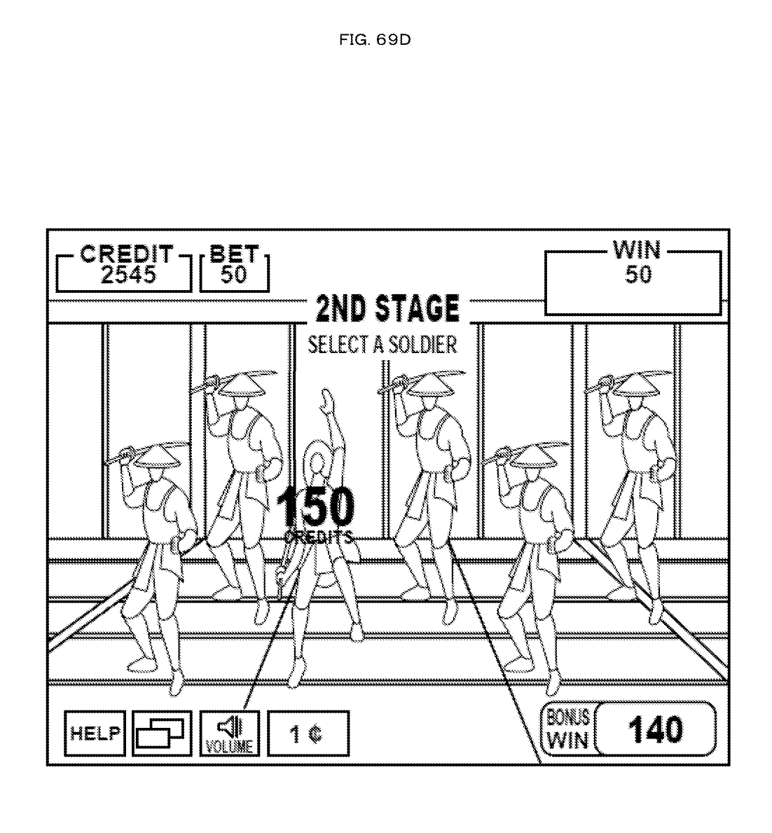

FIG. 69A is a diagram illustrating an example of an image displayed in the pick bonus process;

FIG. 69B is a diagram illustrating an example of an image displayed in the pick bonus process;

FIG. 69C is a diagram illustrating an example of an image displayed in the pick bonus process;

FIG. 69D is a diagram illustrating an example of an image displayed in the pick bonus process;

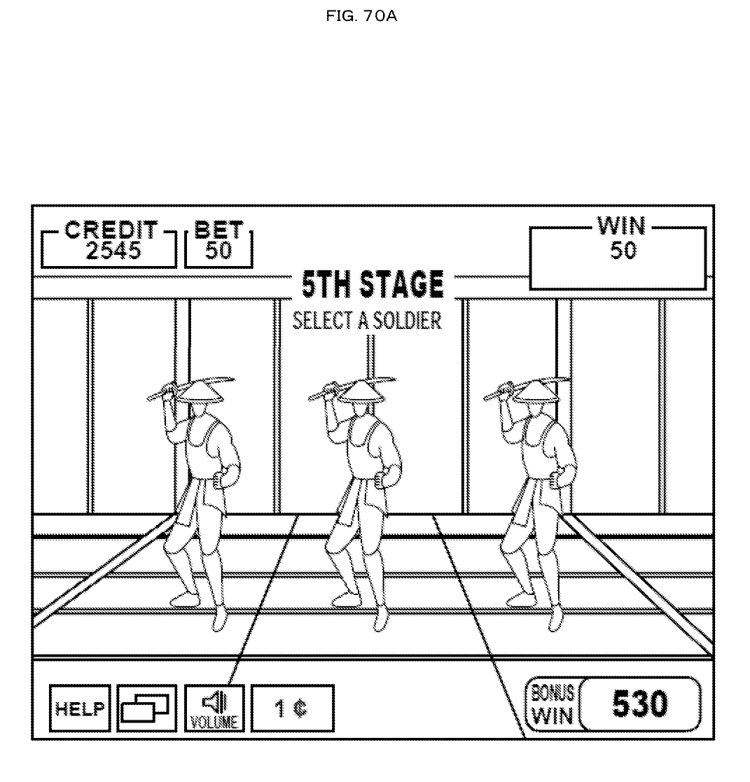

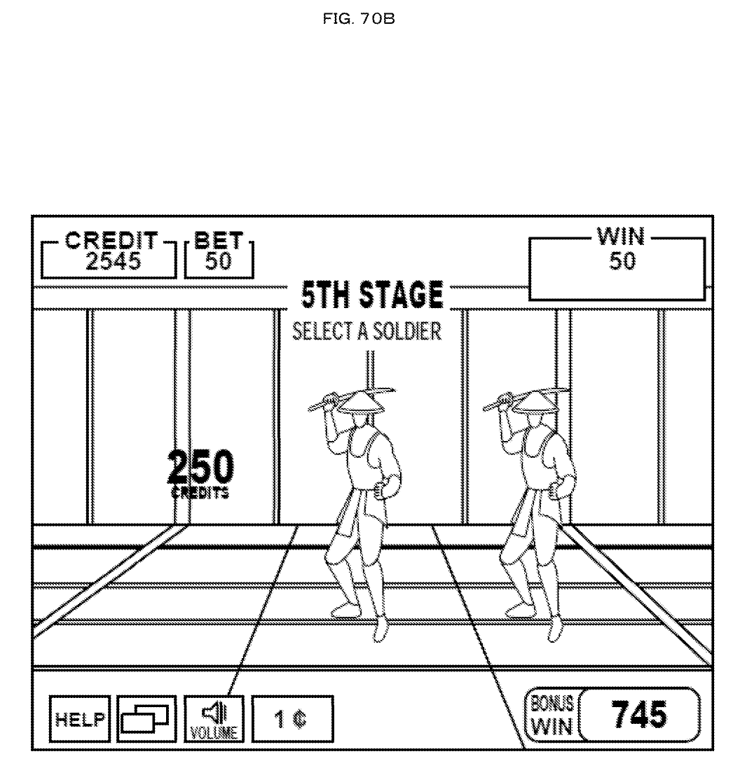

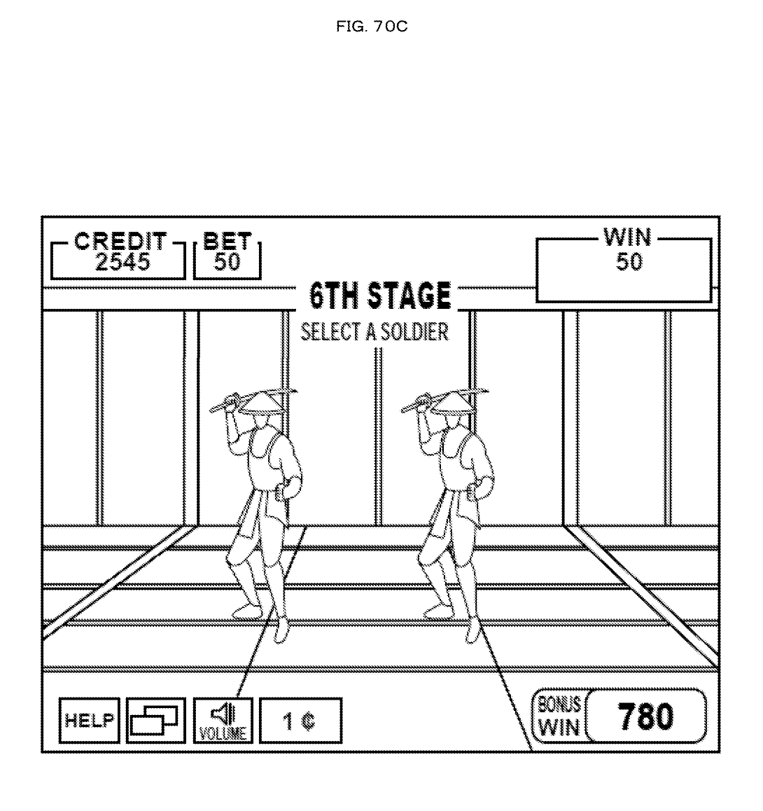

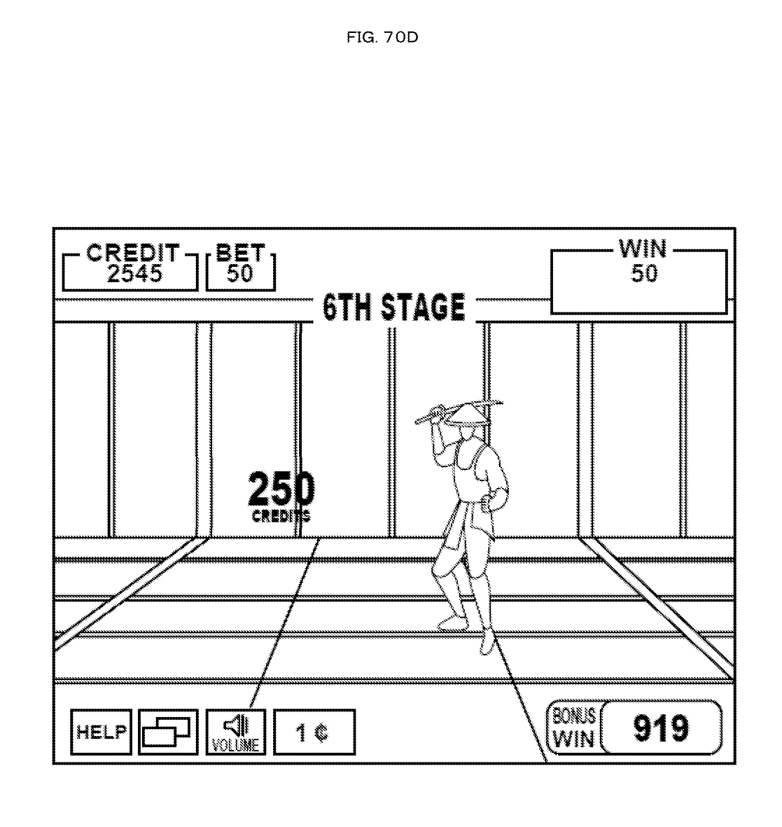

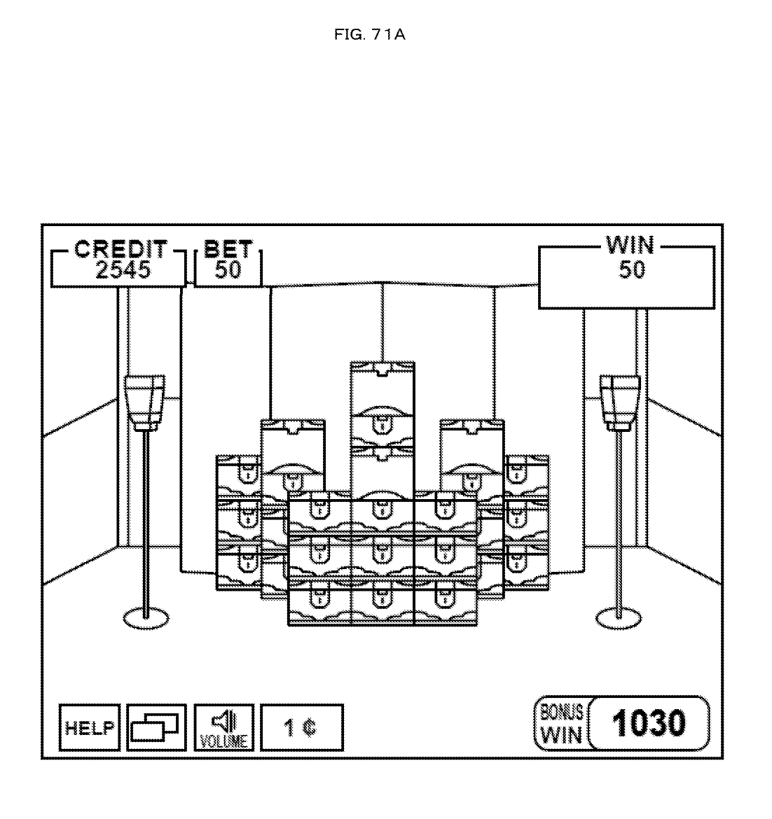

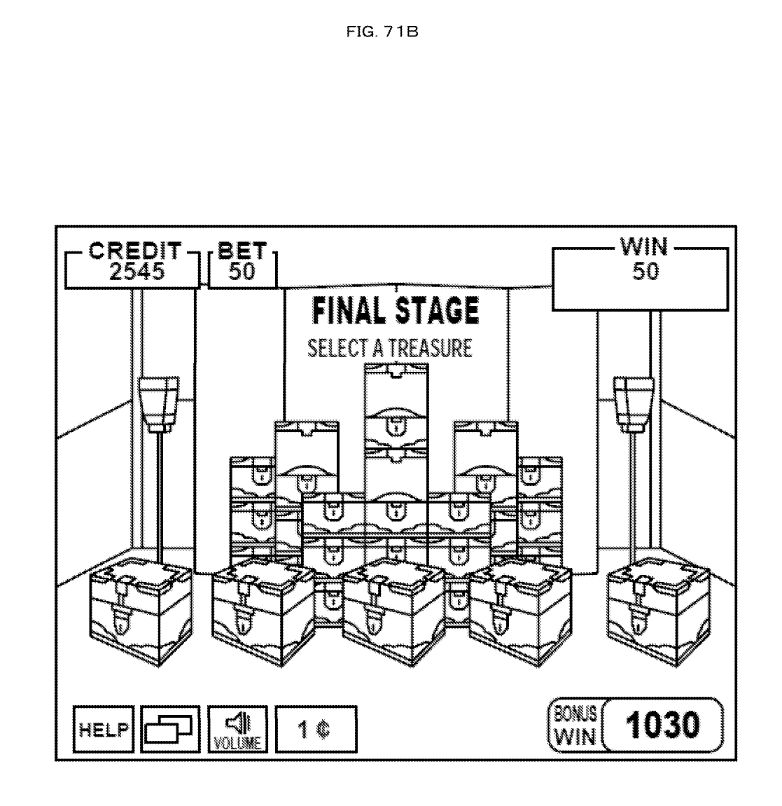

FIG. 70A is a diagram illustrating an example of an image displayed in the pick bonus process;

FIG. 70B is a diagram illustrating an example of an image displayed in the pick bonus process;

FIG. 70C is a diagram illustrating an example of an image displayed in the pick bonus process;

FIG. 70D is a diagram illustrating an example of an image displayed in the pick bonus process;

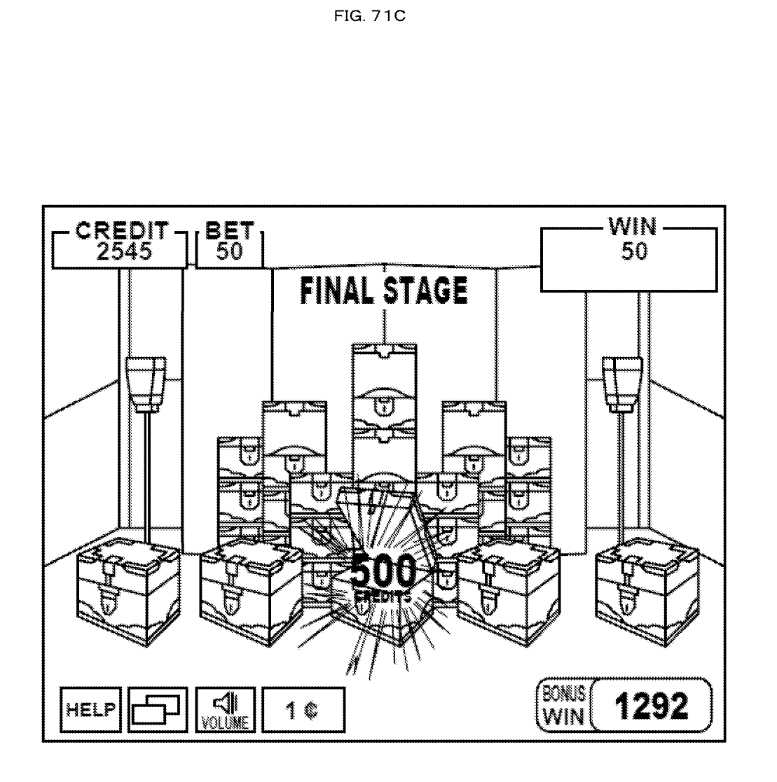

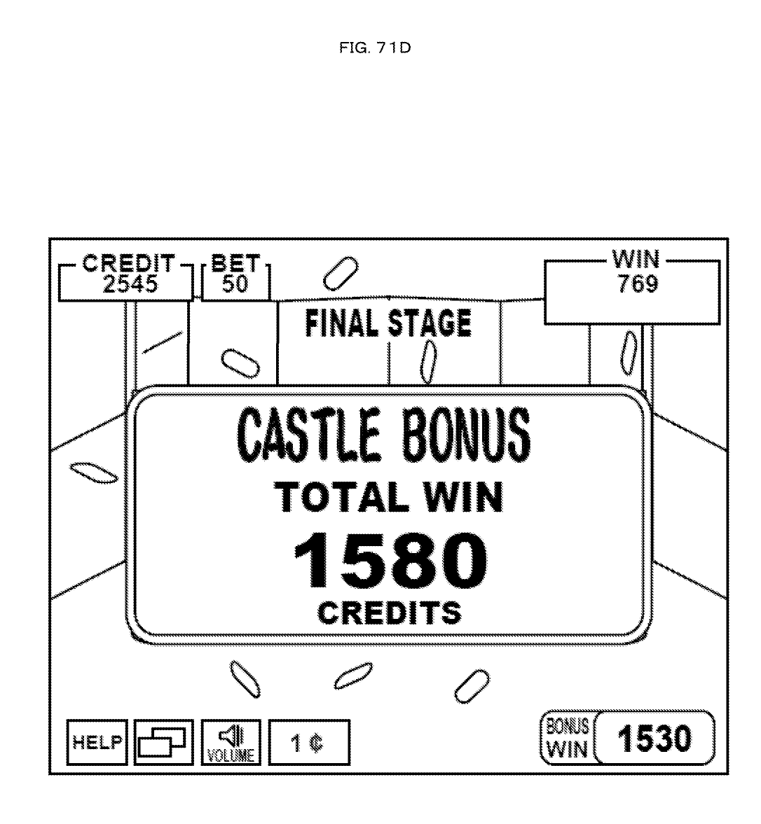

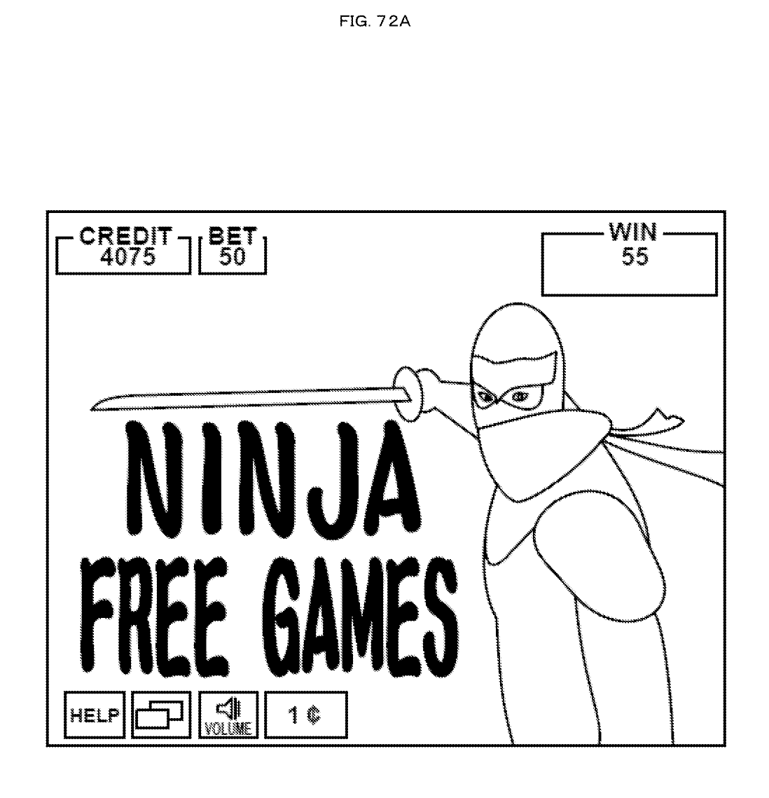

FIG. 71A is a diagram illustrating an example of an image displayed in the pick bonus process;

FIG. 71B is a diagram illustrating an example of an image displayed in the pick bonus process;

FIG. 71C is a diagram illustrating an example of an image displayed in the pick bonus process;

FIG. 71D is a diagram illustrating an example of an image displayed in the pick bonus process;

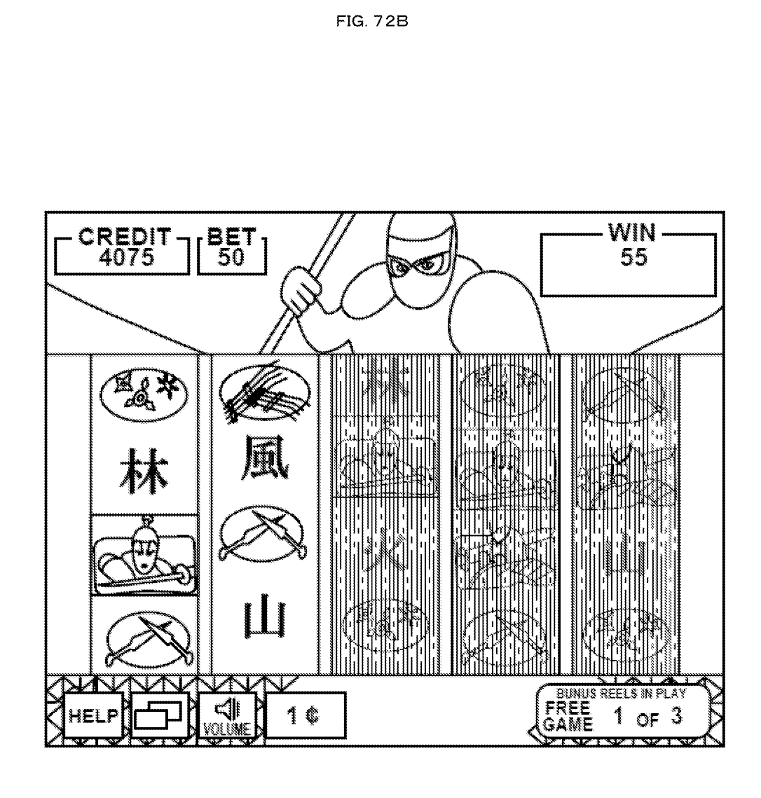

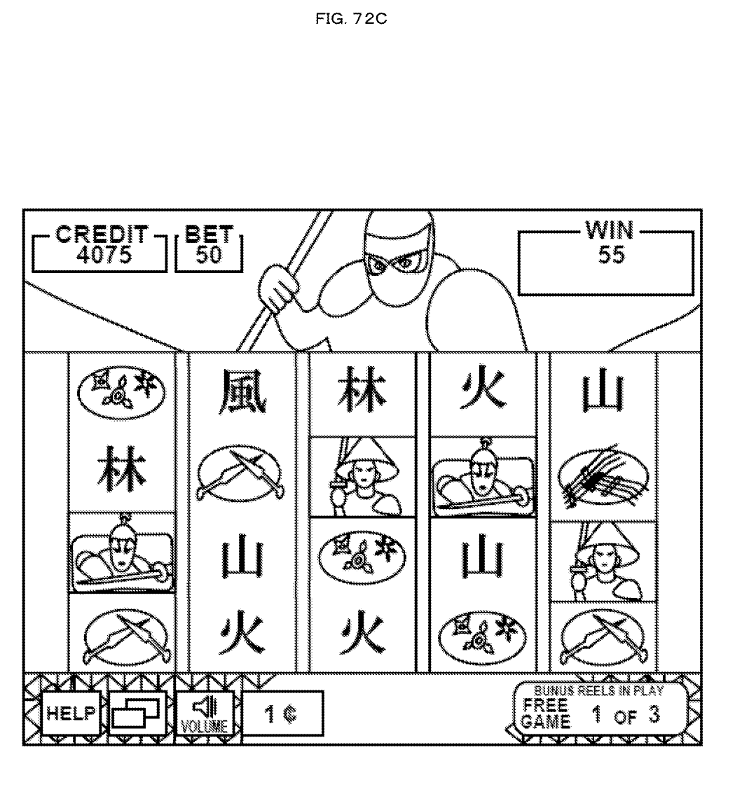

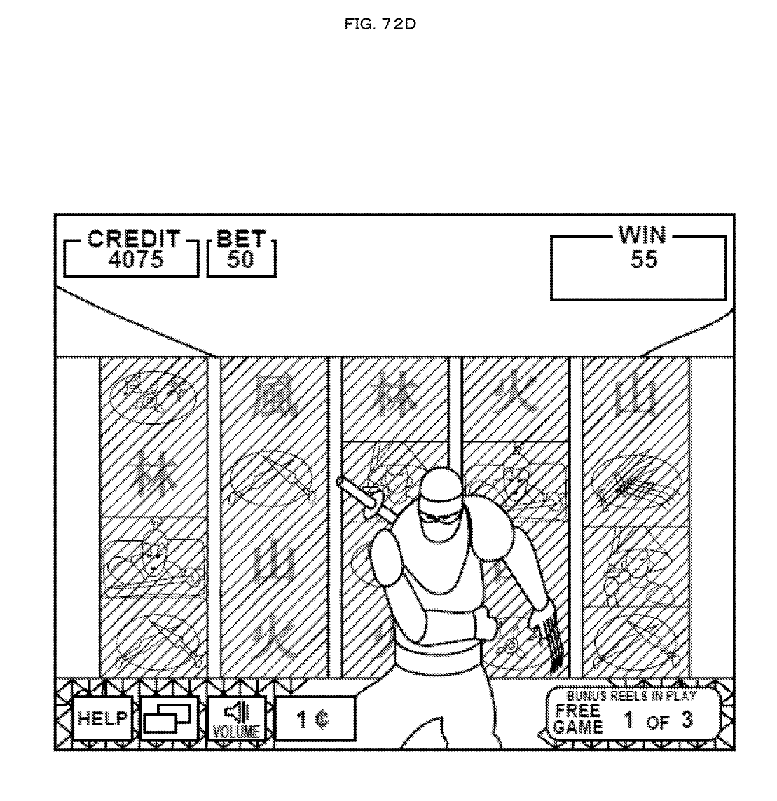

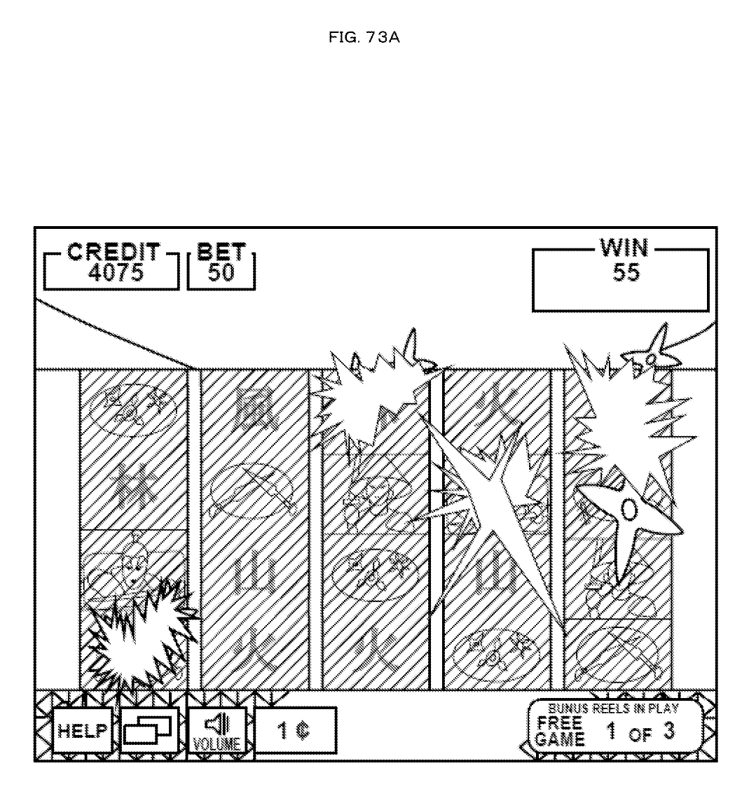

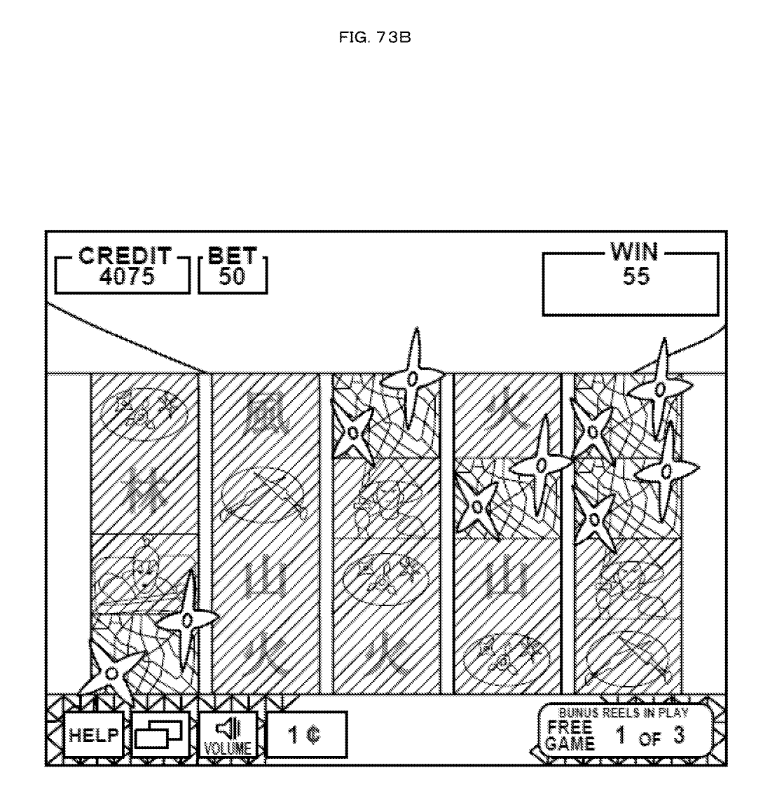

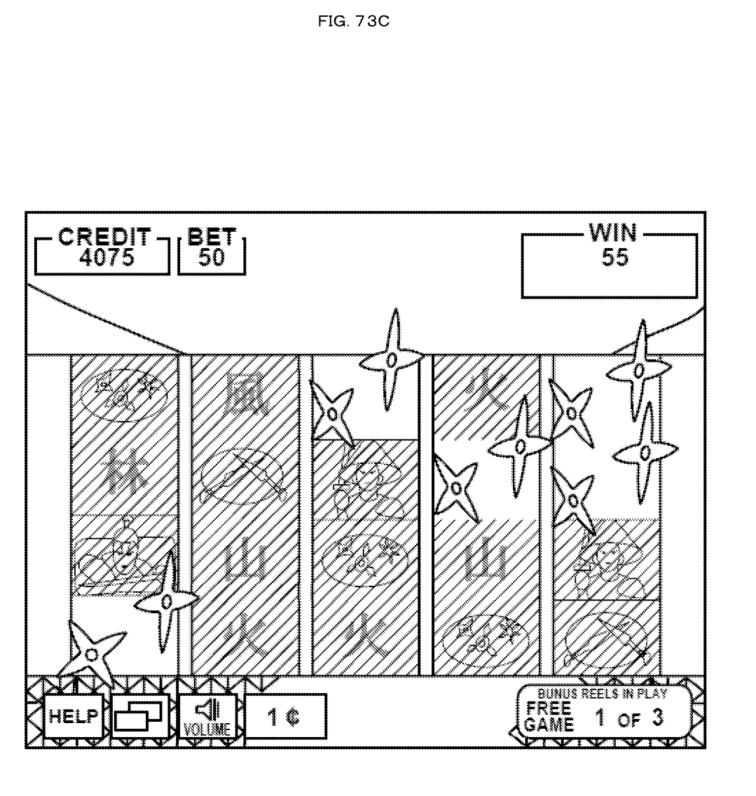

FIG. 72A is a diagram illustrating an example of an image displayed in a WILD scatter process;

FIG. 72B is a diagram illustrating an example of an image displayed in the WILD scatter process;

FIG. 72C is a diagram illustrating an example of an image displayed in the WILD scatter process;

FIG. 72D is a diagram illustrating an example of an image displayed in the WILD scatter process;

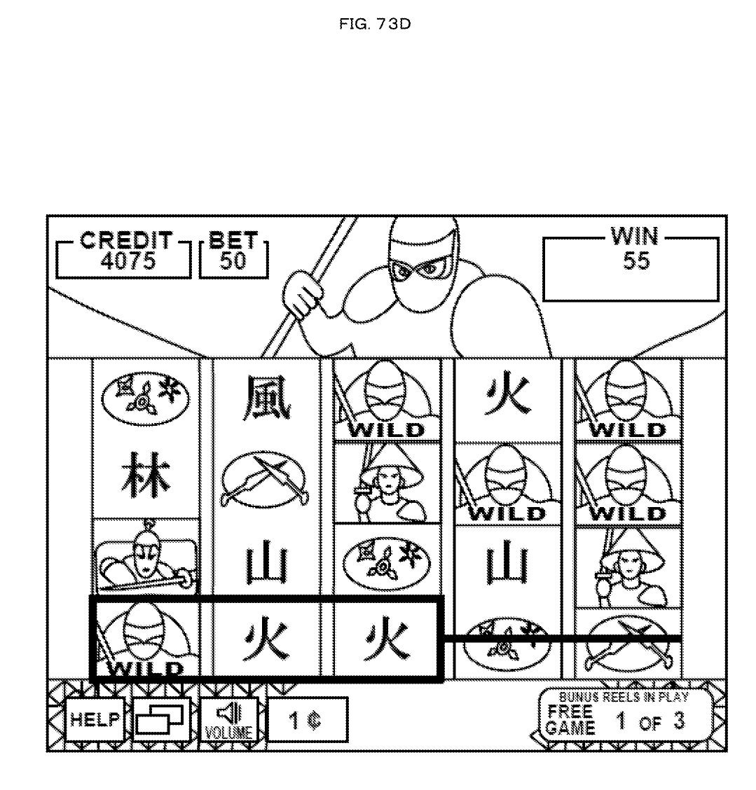

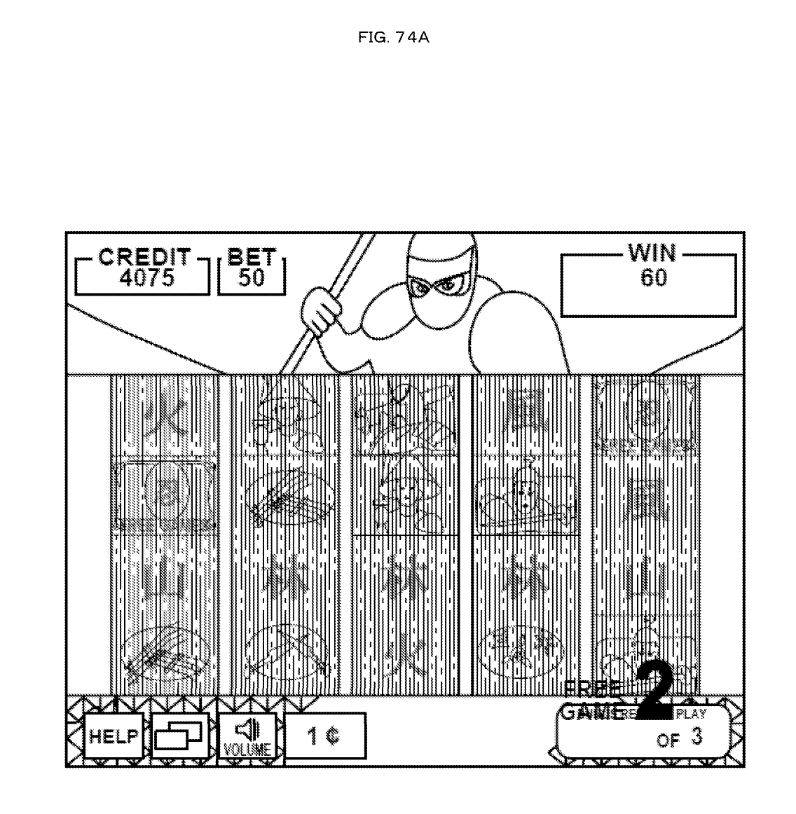

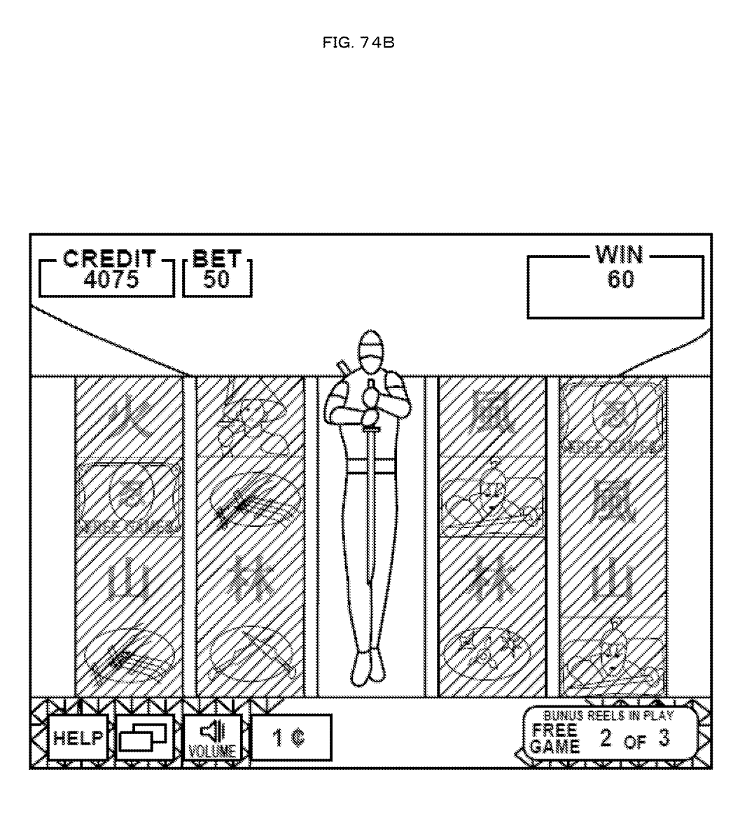

FIG. 73A is a diagram illustrating an example of an image displayed in the WILD scatter process;

FIG. 73B is a diagram illustrating an example of an image displayed in the WILD scatter process;

FIG. 73C is a diagram illustrating an example of an image displayed in the WILD scatter process;

FIG. 73D is a diagram illustrating an example of an image displayed in the WILD scatter process;

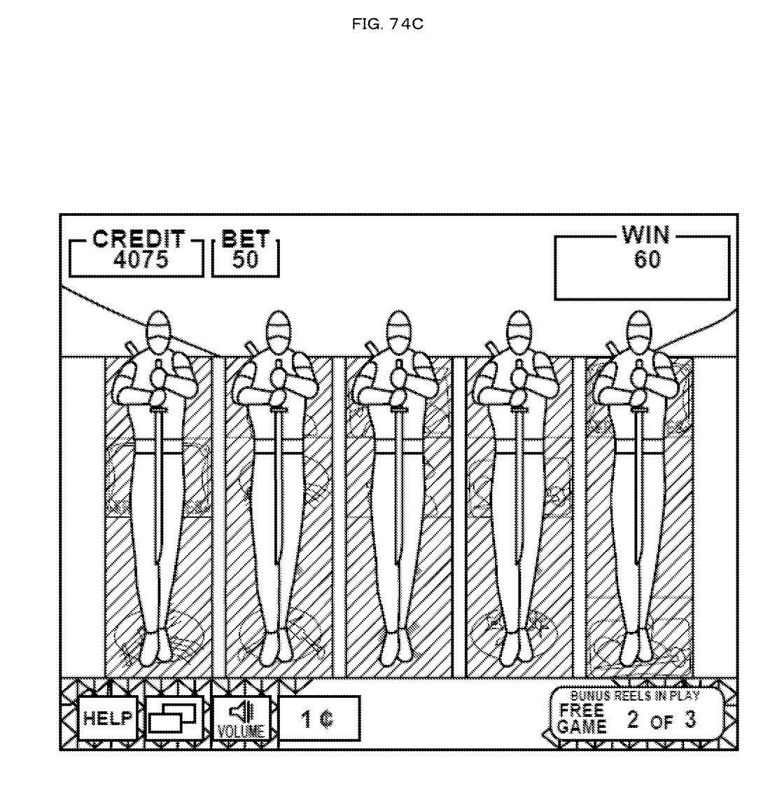

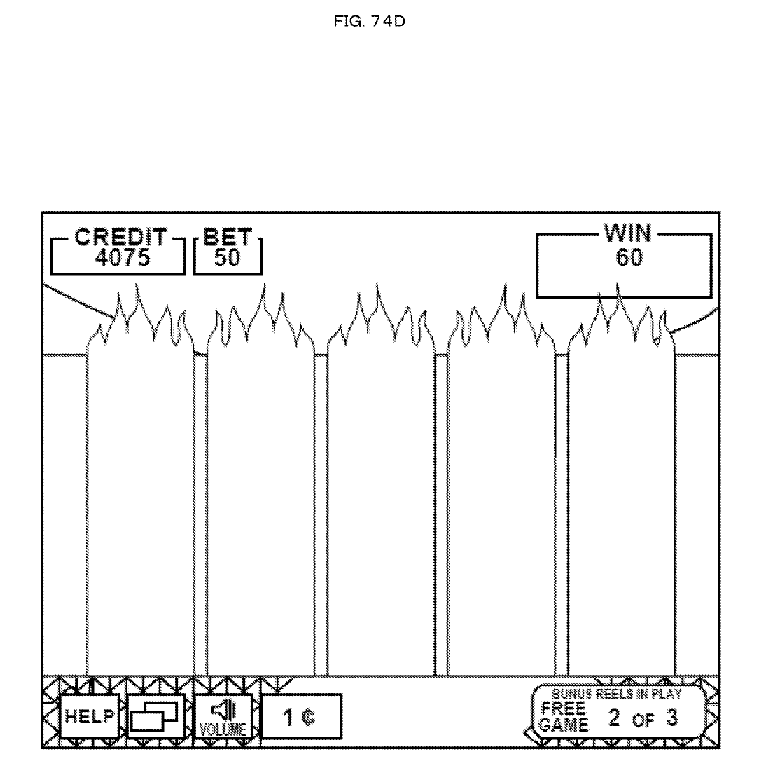

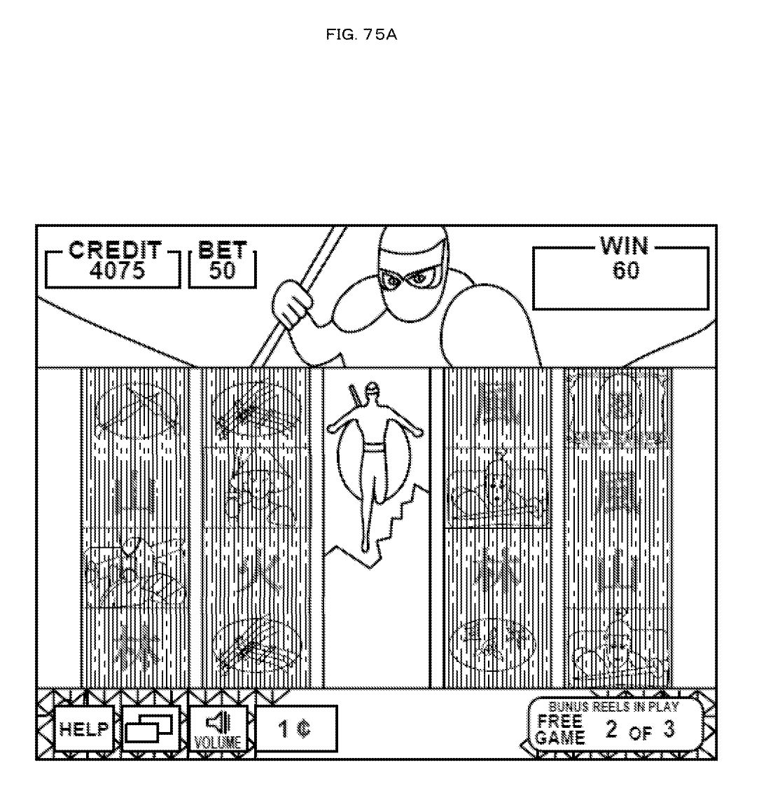

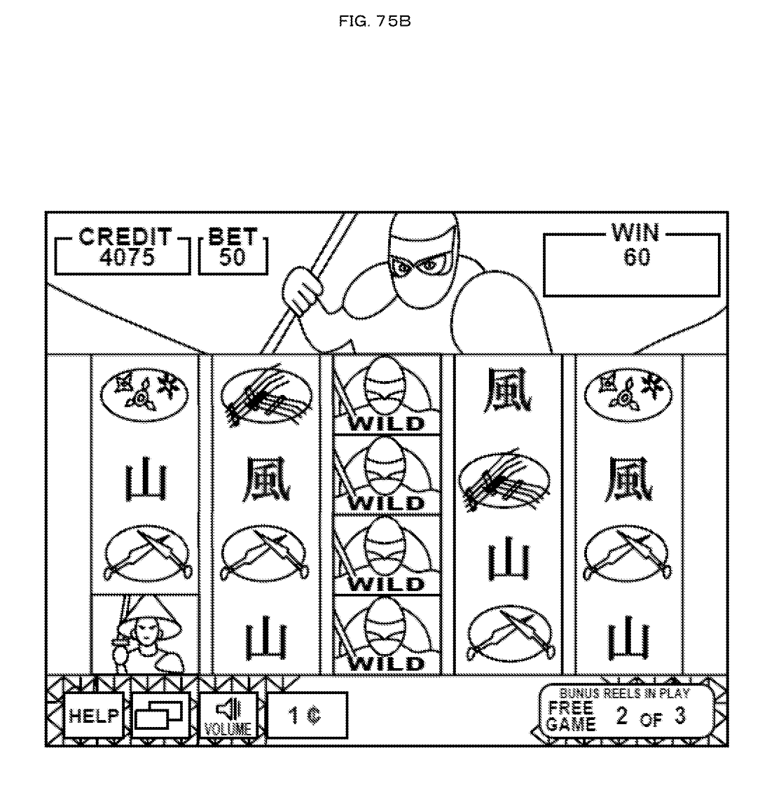

FIG. 74A is a diagram illustrating an example of an image displayed in a WILD expand process;

FIG. 74B is a diagram illustrating an example of an image displayed in the WILD expand process;

FIG. 74C is a diagram illustrating an example of an image displayed in the WILD expand process;

FIG. 74D is a diagram illustrating an example of an image displayed in the WILD expand process;

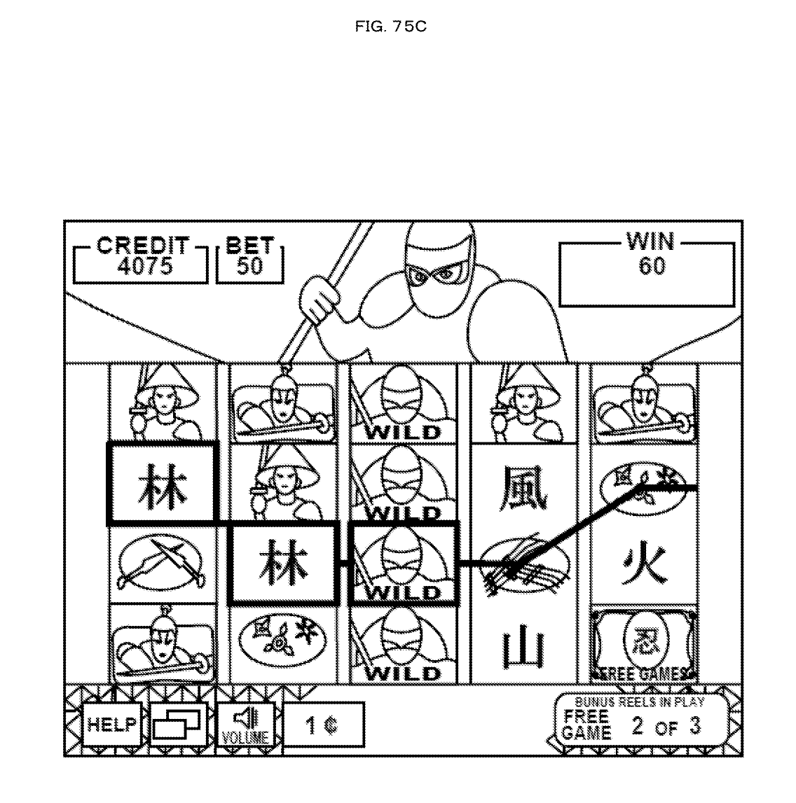

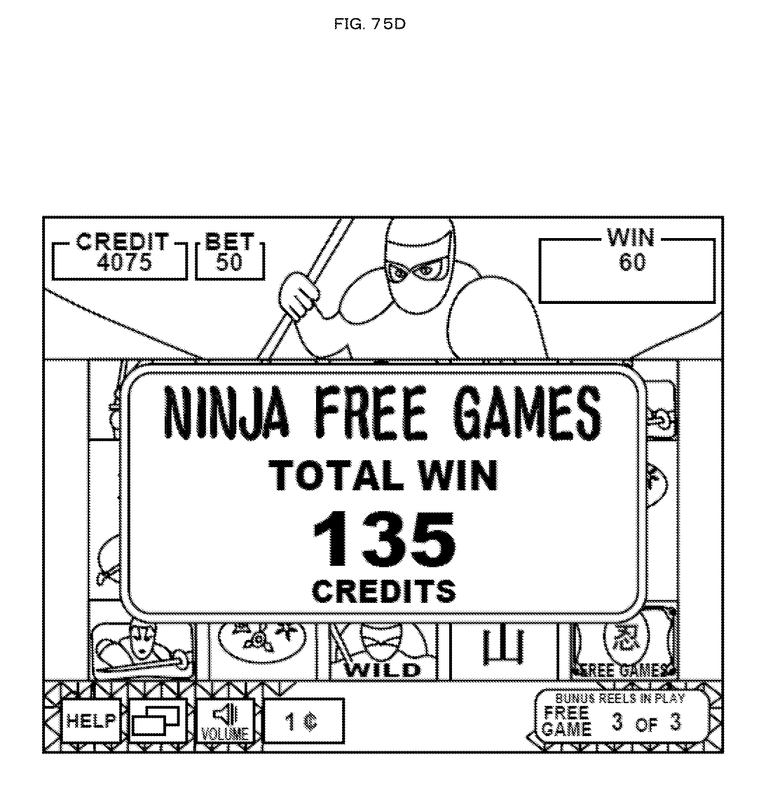

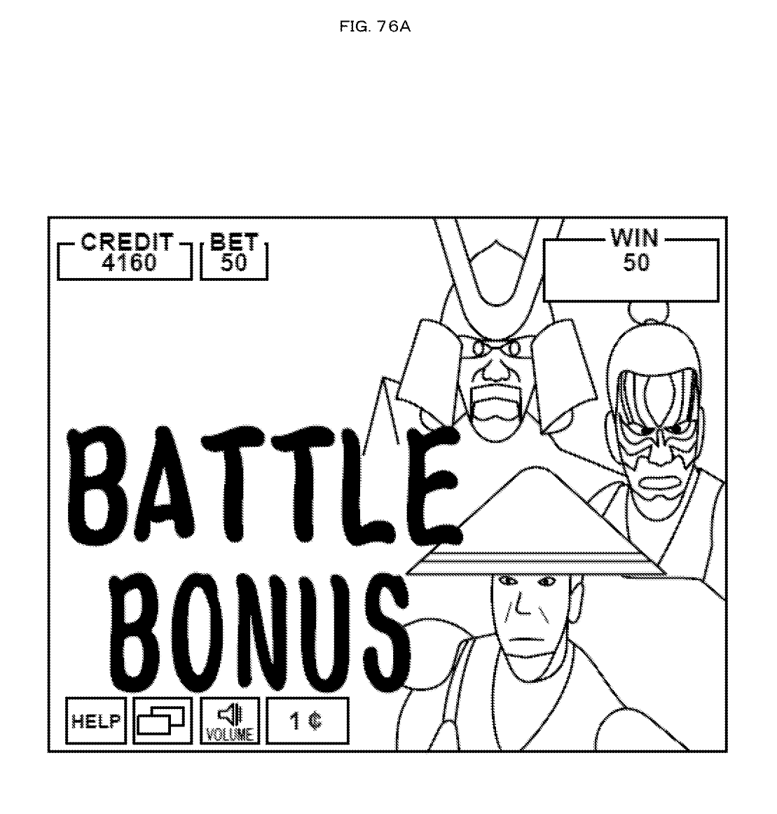

FIG. 75A is a diagram illustrating an example of an image displayed in the WILD expand process;

FIG. 75B is a diagram illustrating an example of an image displayed in the WILD expand process;

FIG. 75C is a diagram illustrating an example of an image displayed in the WILD expand process;

FIG. 75D is a diagram illustrating an example of an image displayed in the WILD expand process;

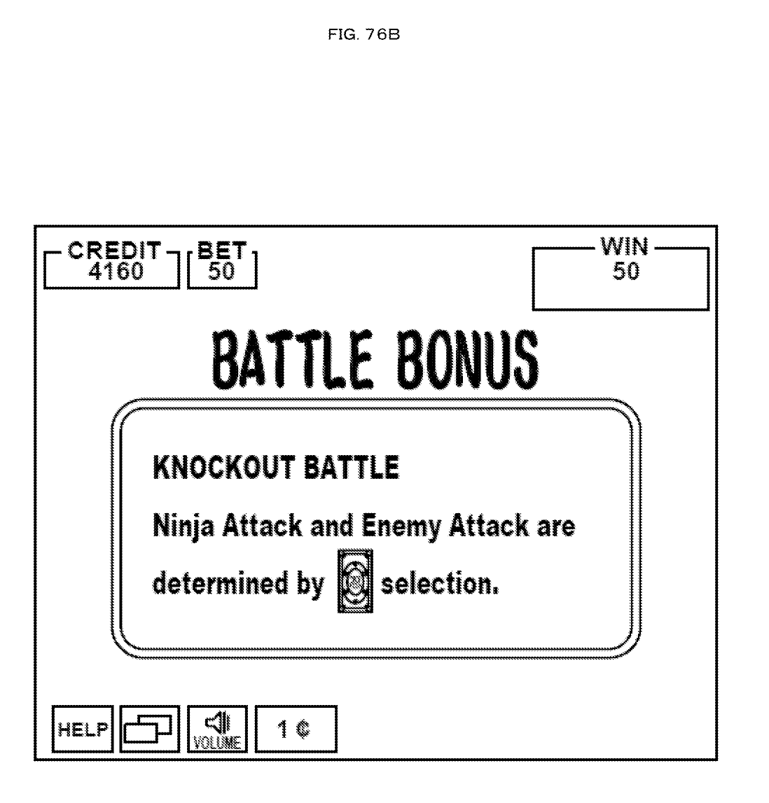

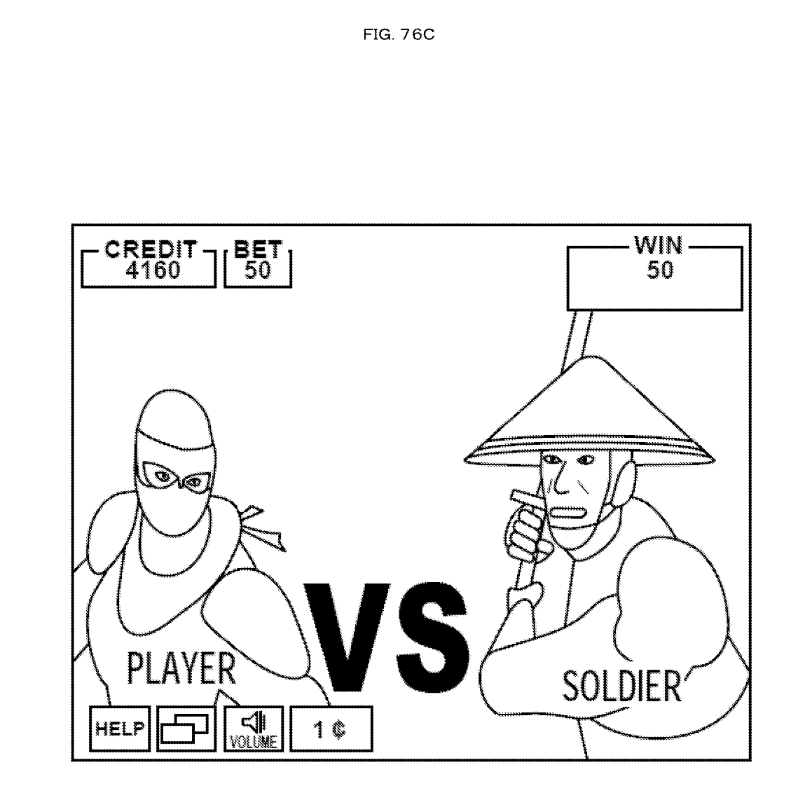

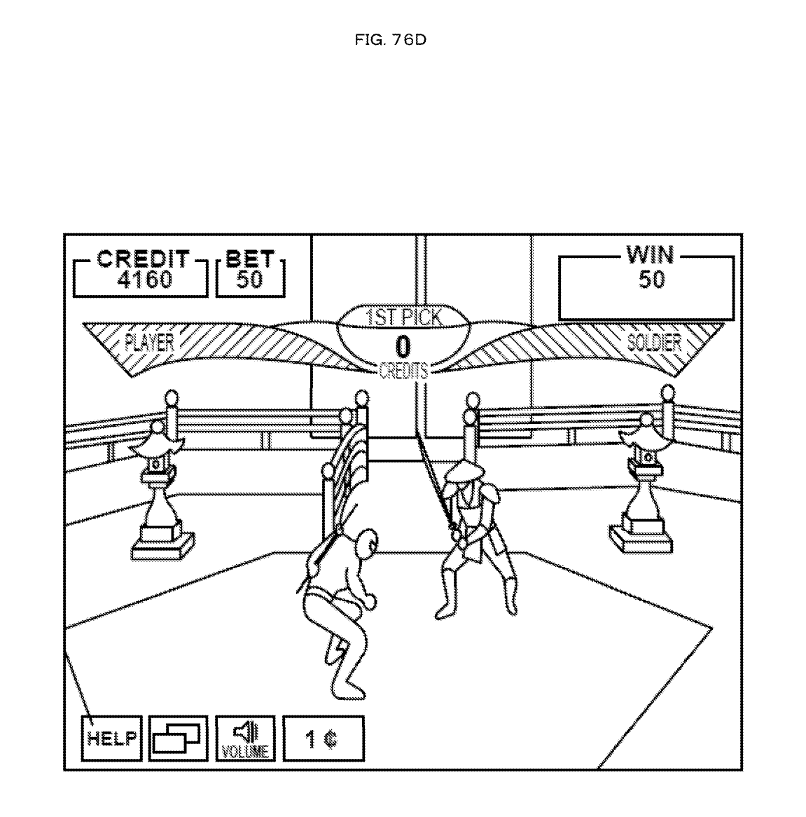

FIG. 76A is a diagram illustrating an example of an image displayed in a battle bonus process;

FIG. 76B is a diagram illustrating an example of an image displayed in the battle bonus process;

FIG. 76C is a diagram illustrating an example of an image displayed in the battle bonus process;

FIG. 76D is a diagram illustrating an example of an image displayed in the battle bonus process;

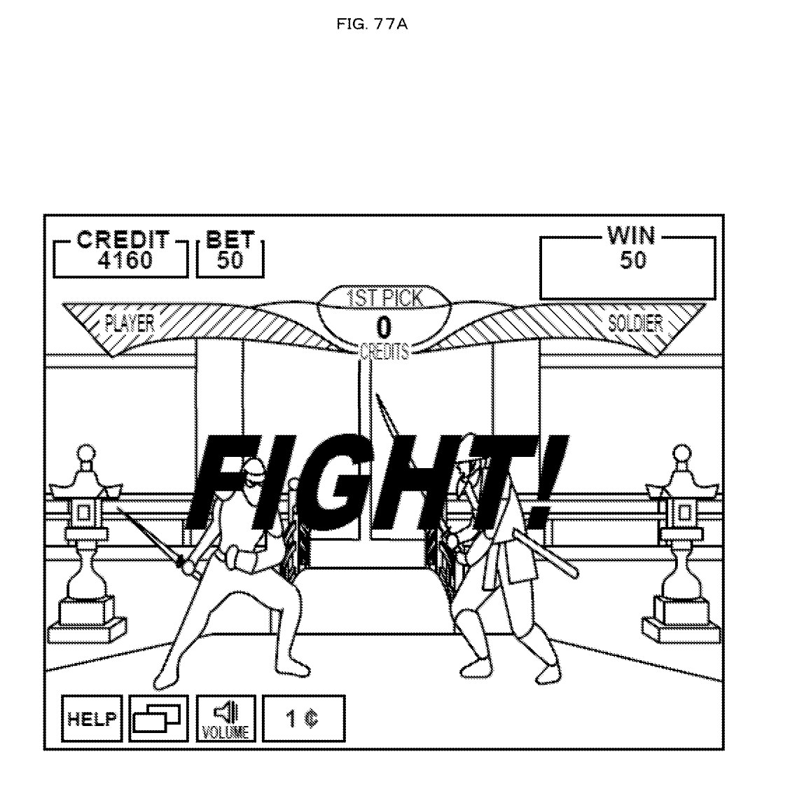

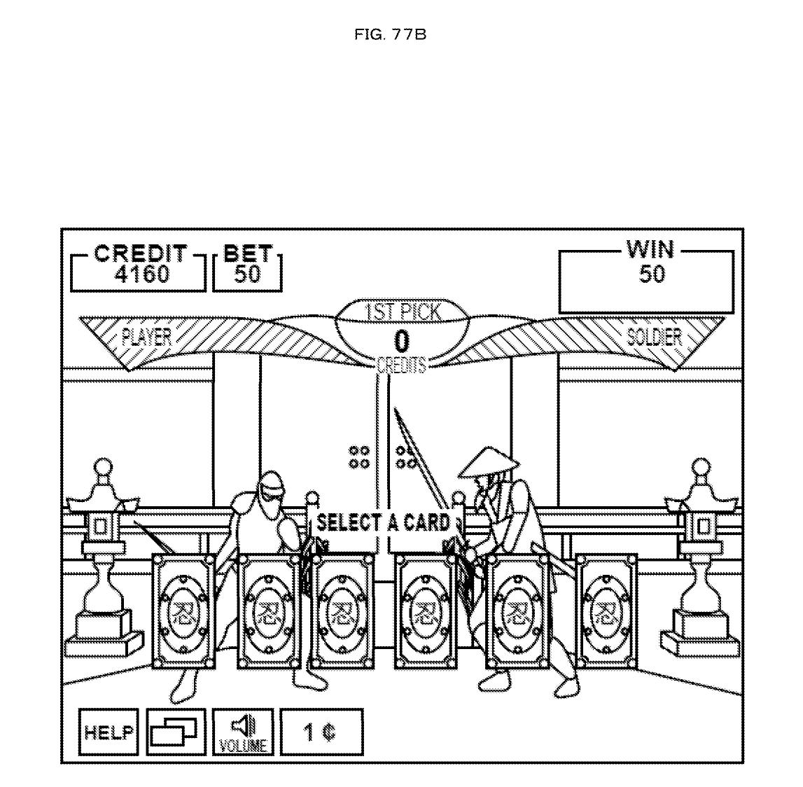

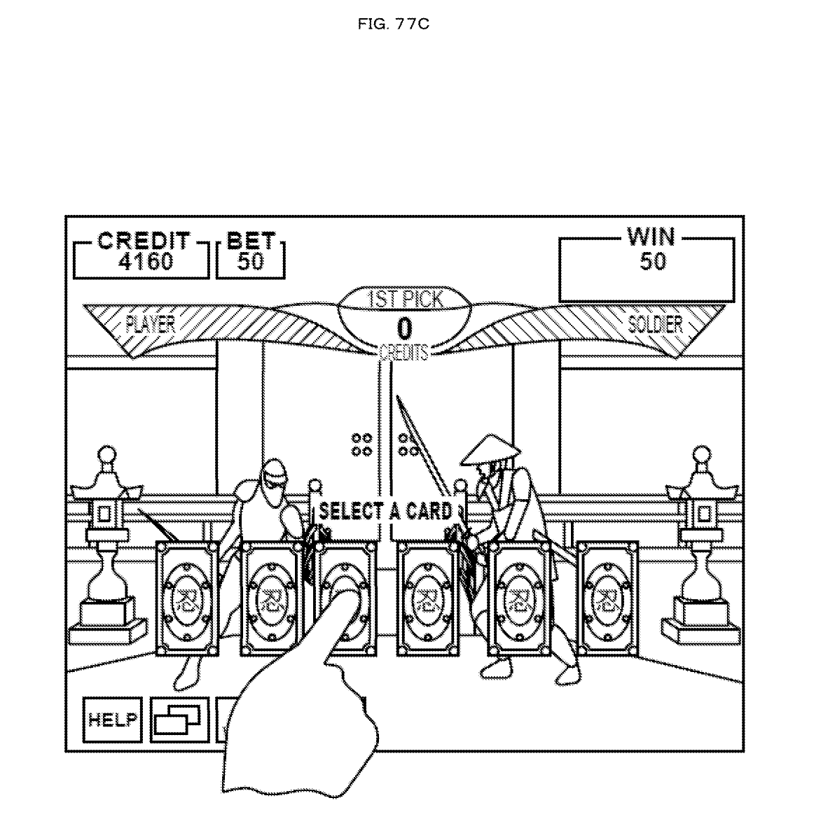

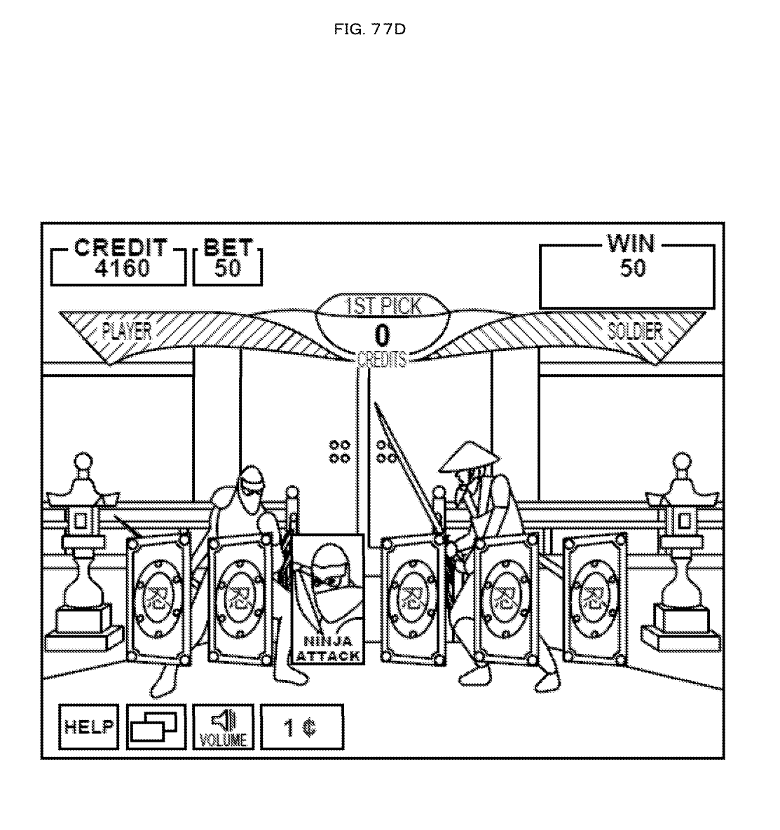

FIG. 77A is a diagram illustrating an example of an image displayed in the battle bonus process;

FIG. 77B is a diagram illustrating an example of an image displayed in the battle bonus process;

FIG. 77C is a diagram illustrating an example of an image displayed in the battle bonus process;

FIG. 77D is a diagram illustrating an example of an image displayed in the battle bonus process;

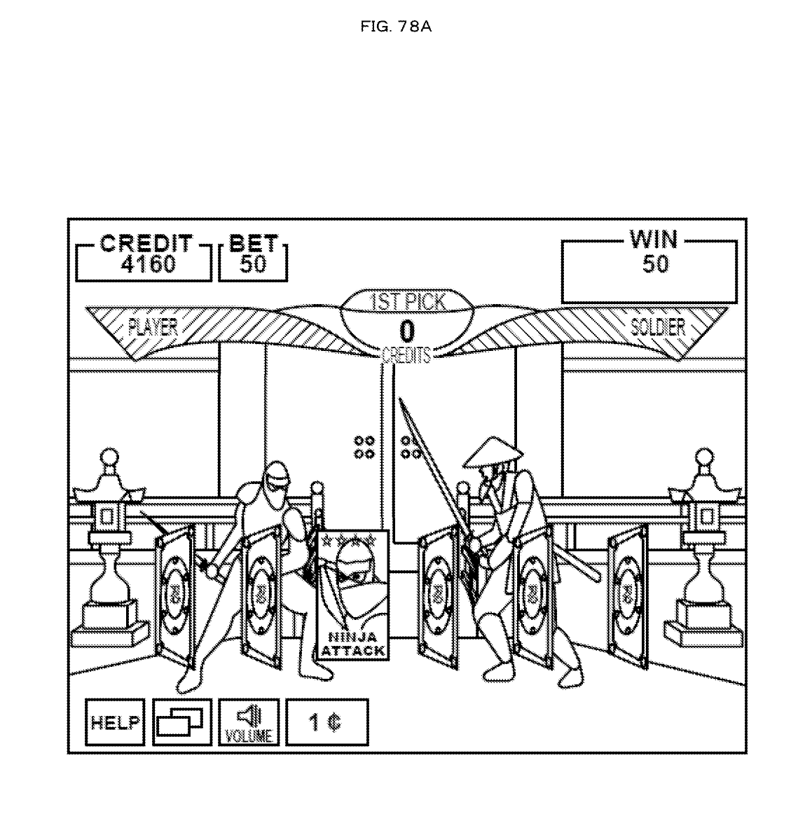

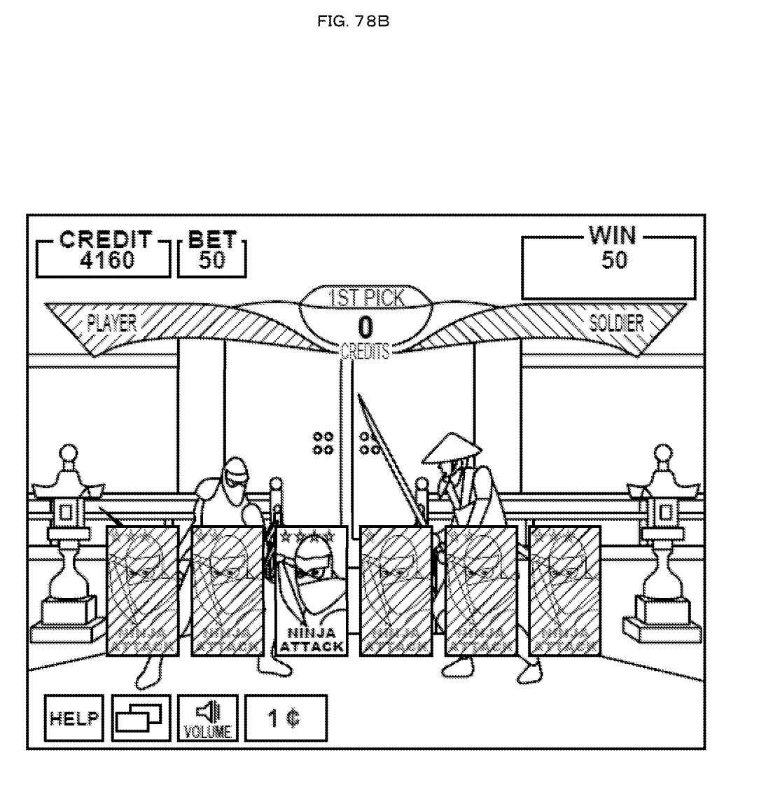

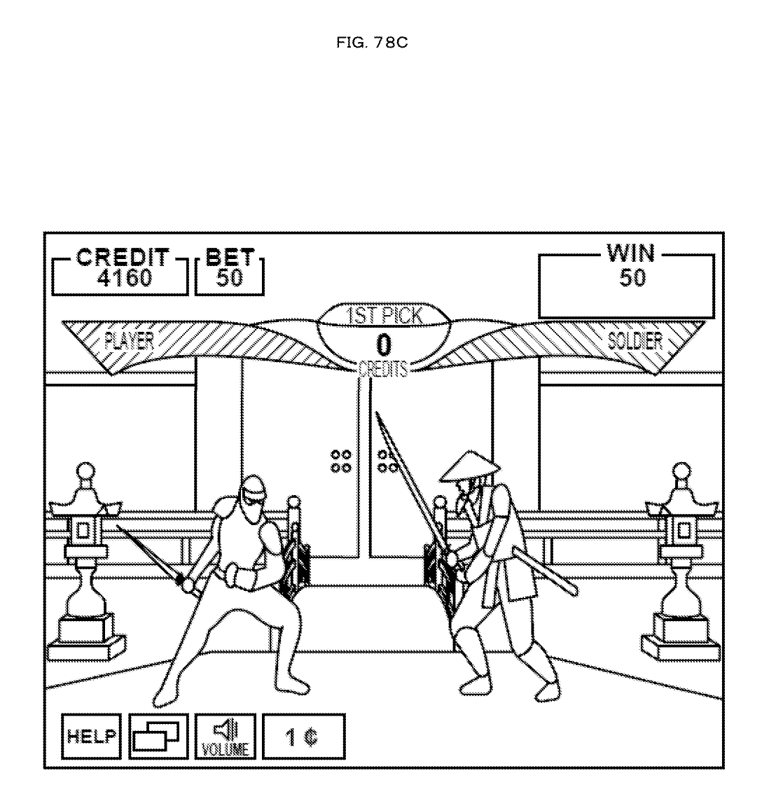

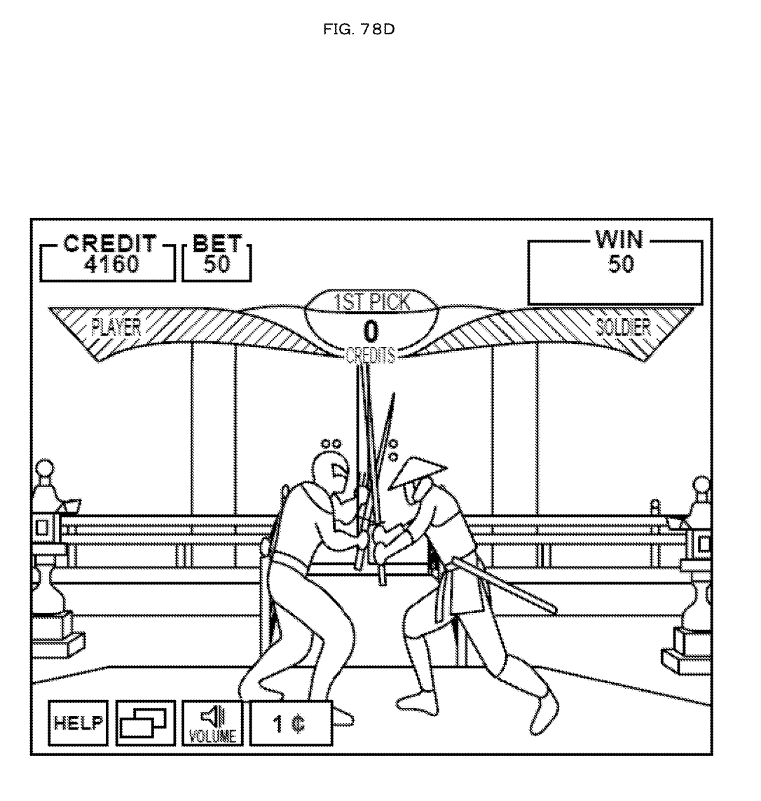

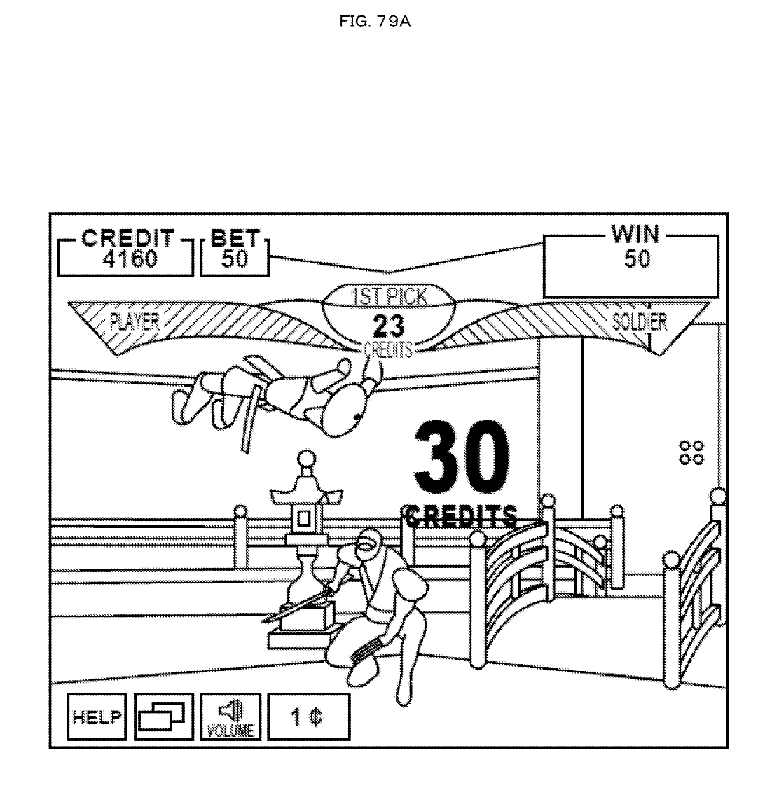

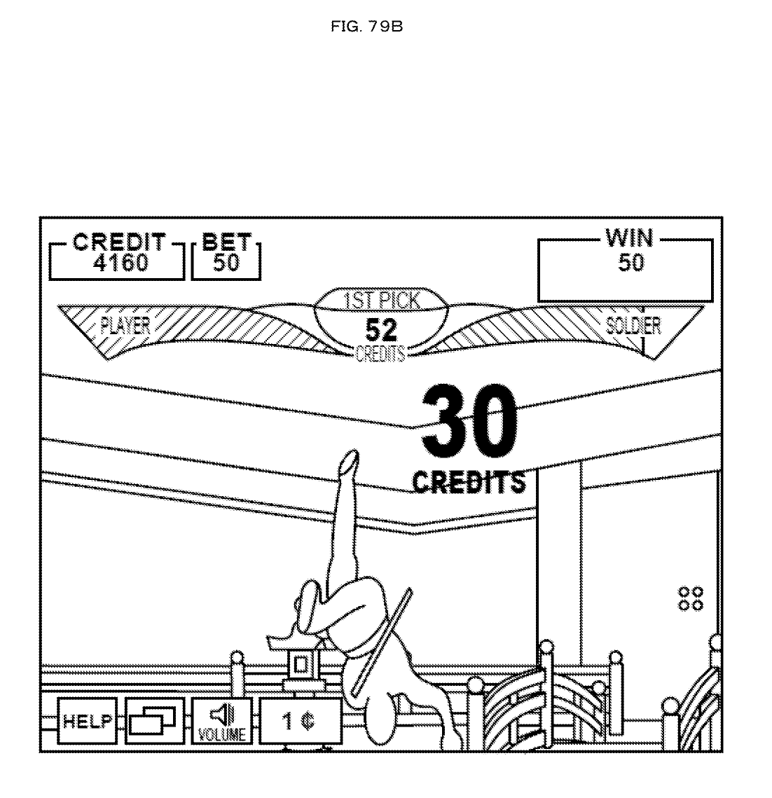

FIG. 78A is a diagram illustrating an example of an image displayed in the battle bonus process;

FIG. 78B is a diagram illustrating an example of an image displayed in the battle bonus process;

FIG. 78C is a diagram illustrating an example of an image displayed in the battle bonus process;

FIG. 78D is a diagram illustrating an example of an image displayed in the battle bonus process;

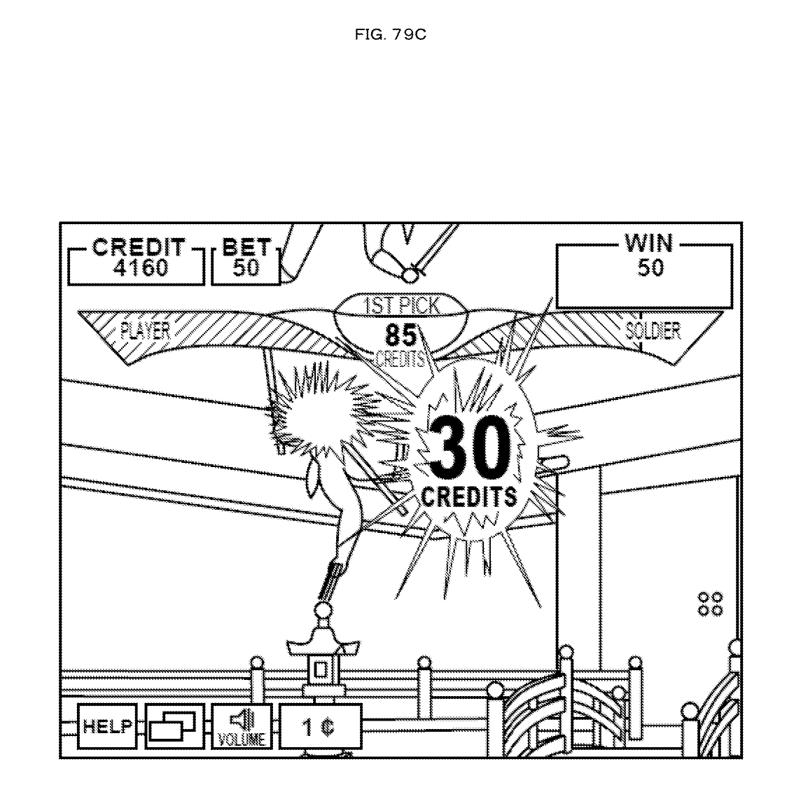

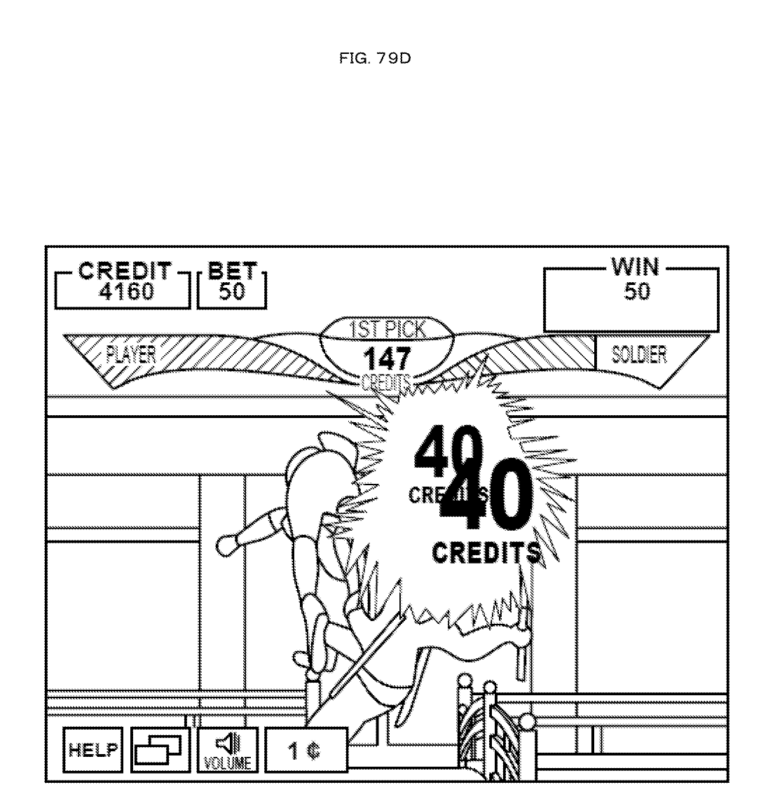

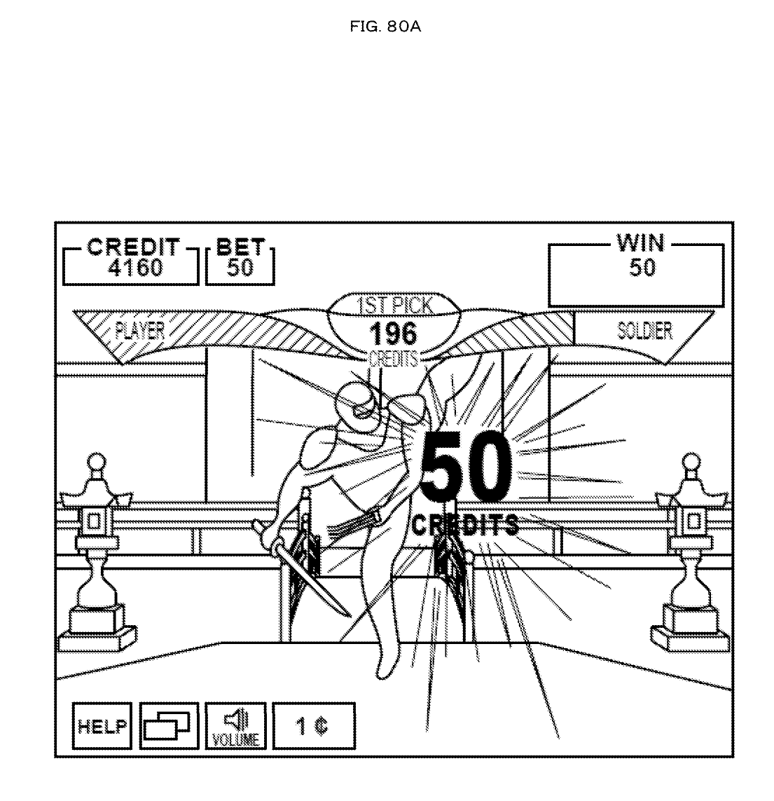

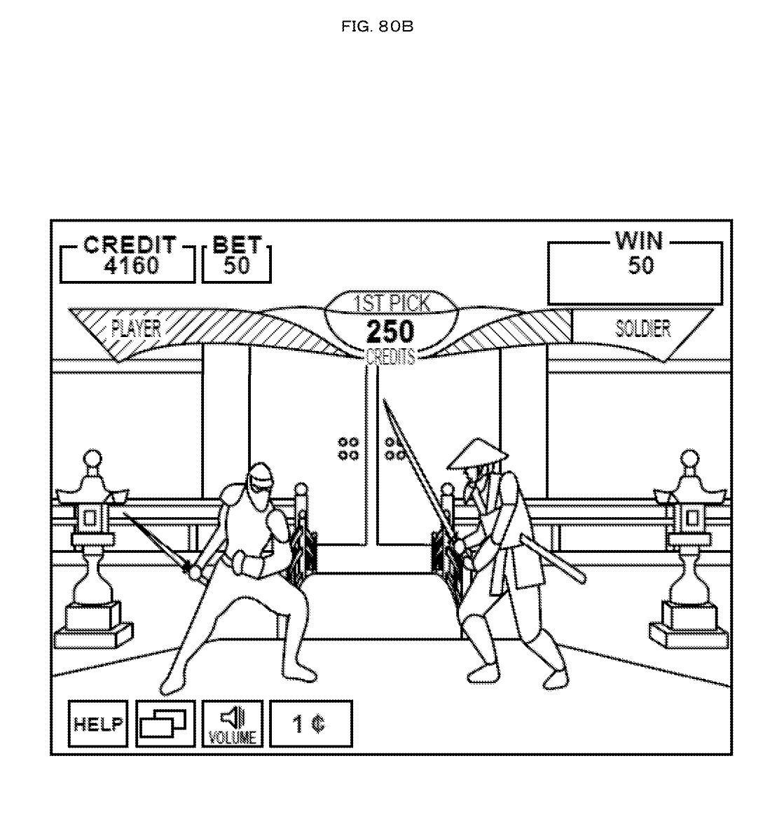

FIG. 79A is a diagram illustrating an example of an image displayed in the battle bonus process;

FIG. 79B is a diagram illustrating an example of an image displayed in the battle bonus process;

FIG. 79C is a diagram illustrating an example of an image displayed in the battle bonus process;

FIG. 79D is a diagram illustrating an example of an image displayed in the battle bonus process;

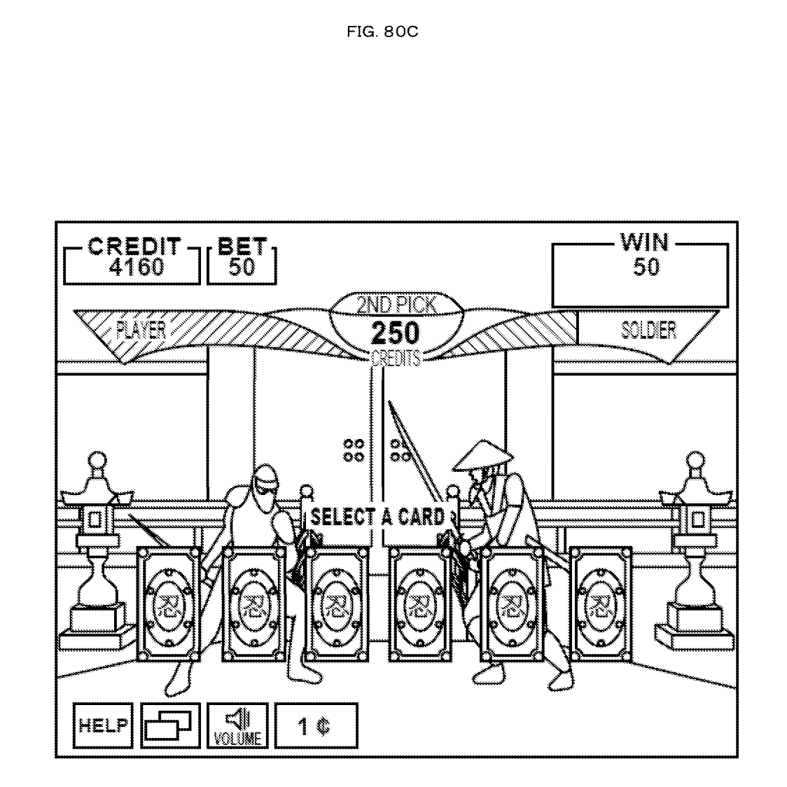

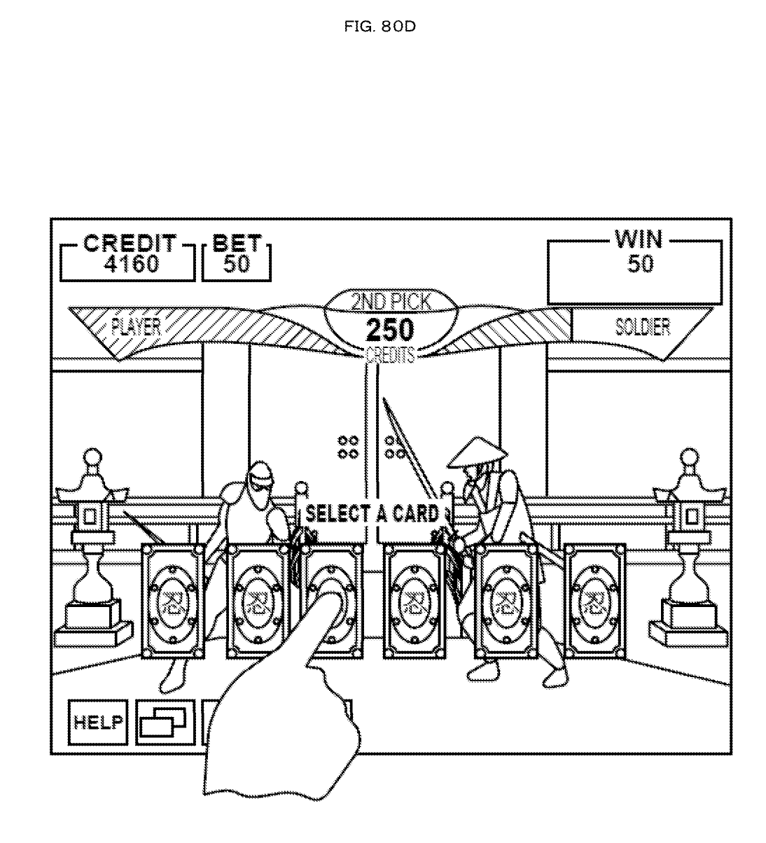

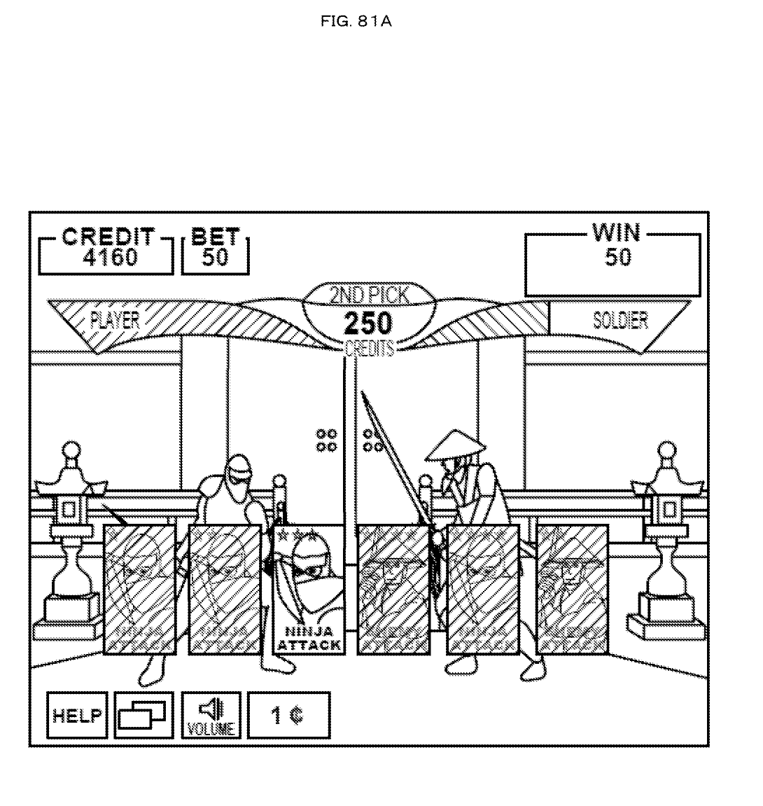

FIG. 80A is a diagram illustrating an example of an image displayed in the battle bonus process;

FIG. 80B is a diagram illustrating an example of an image displayed in the battle bonus process;

FIG. 80C is a diagram illustrating an example of an image displayed in the battle bonus process;

FIG. 80D is a diagram illustrating an example of an image displayed in the battle bonus process;

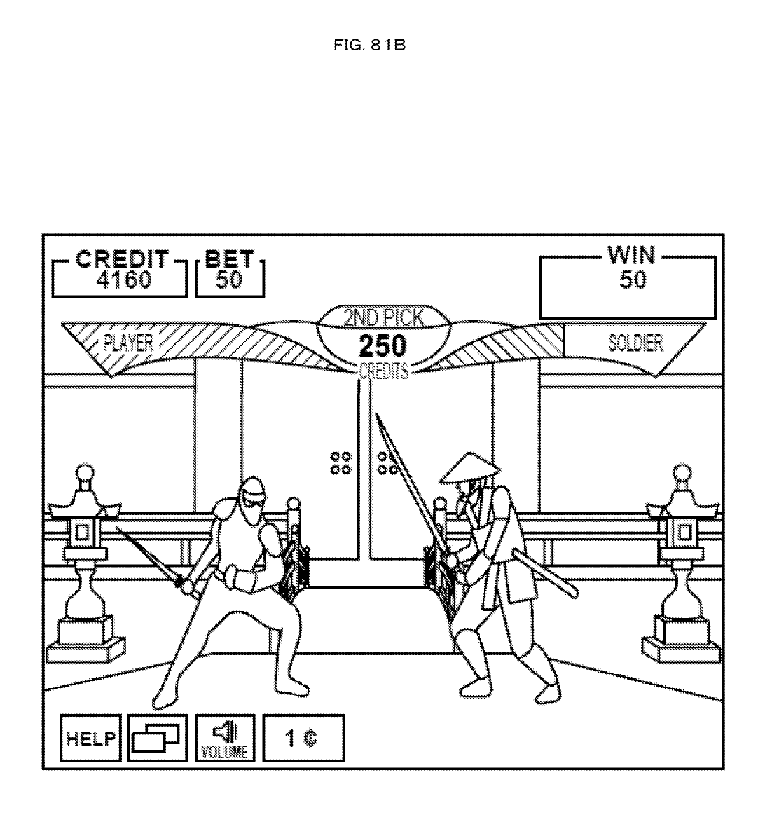

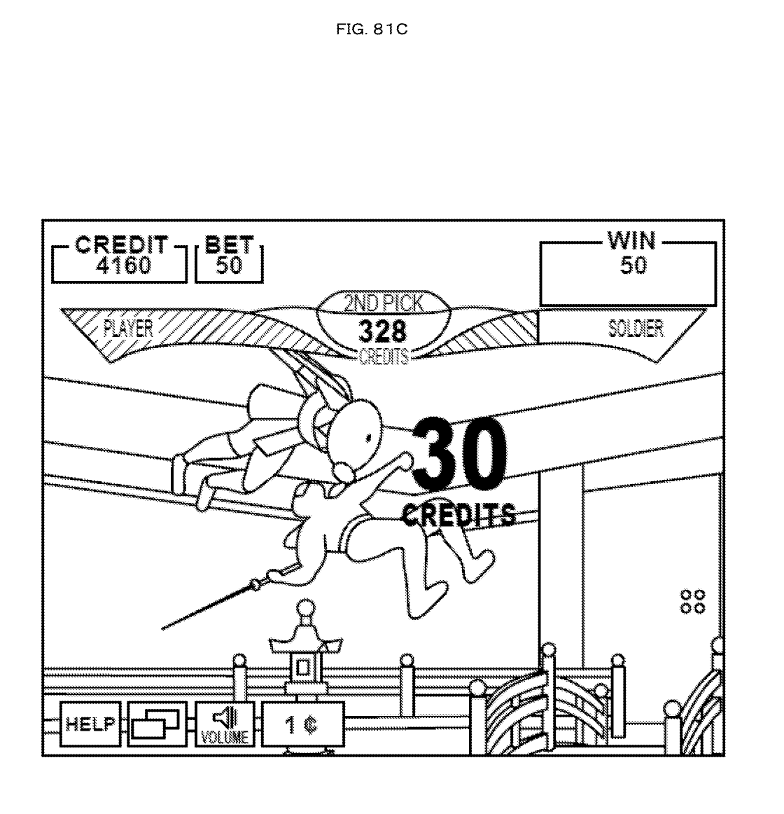

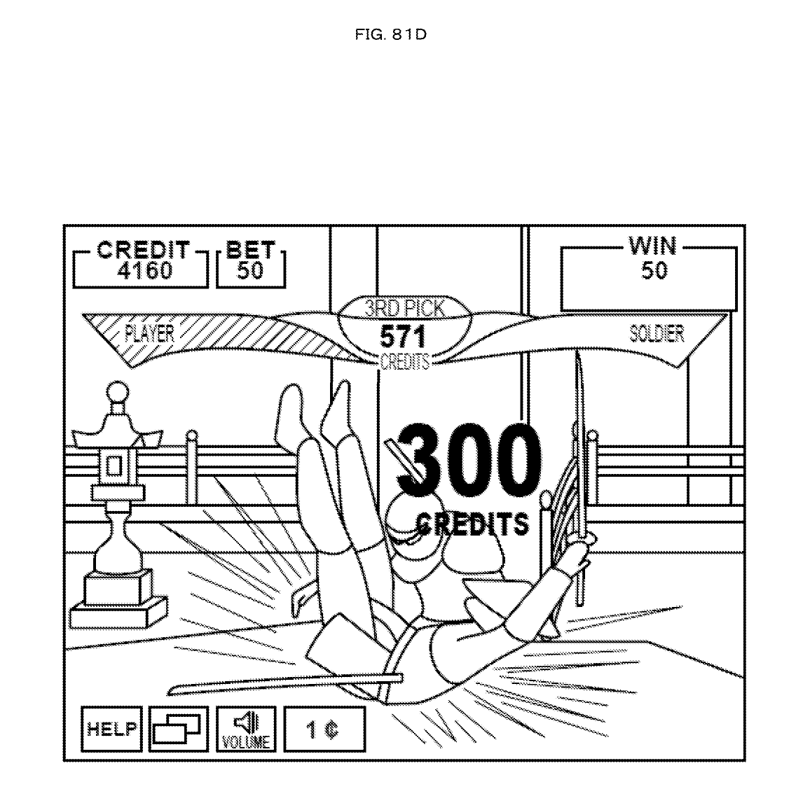

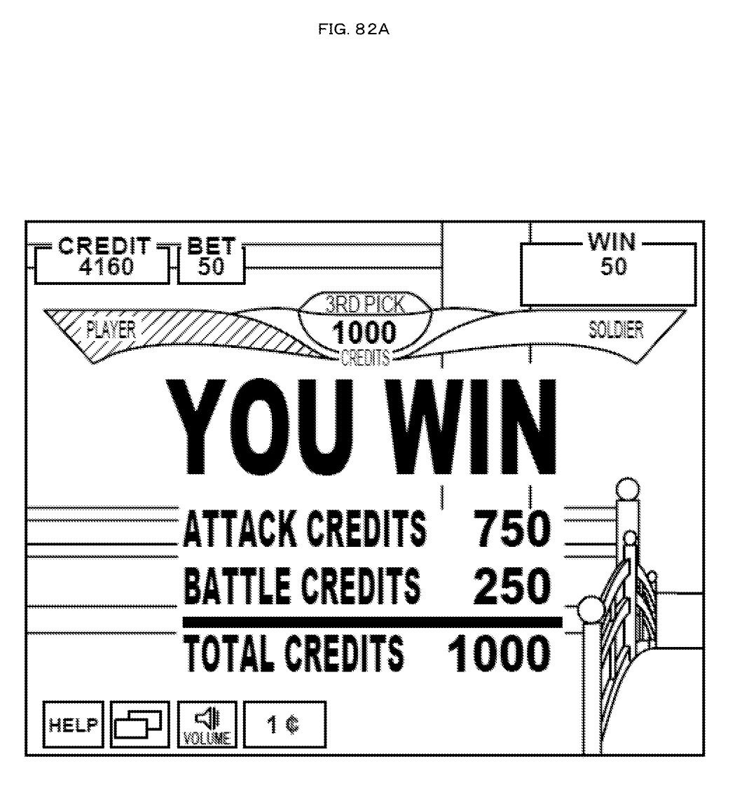

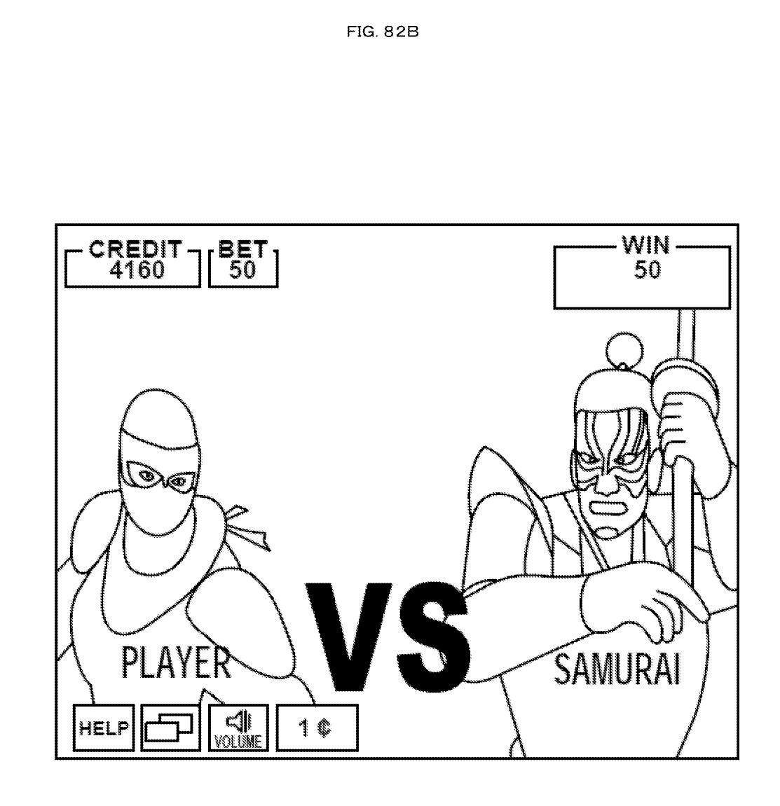

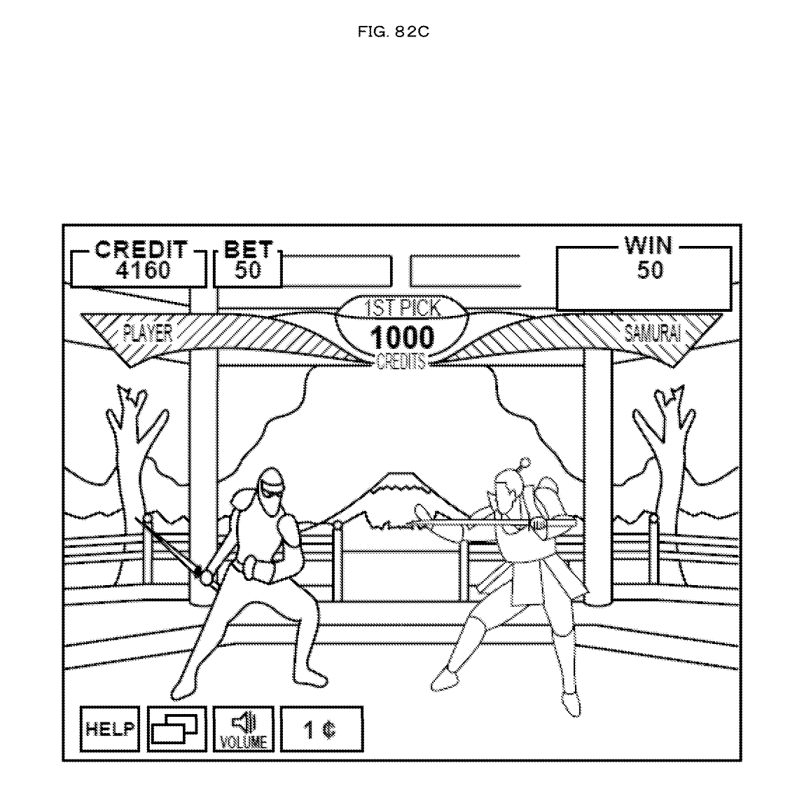

FIG. 81A is a diagram illustrating an example of an image displayed in the battle bonus process;

FIG. 81B is a diagram illustrating an example of an image displayed in the battle bonus process;

FIG. 81C is a diagram illustrating an example of an image displayed in the battle bonus process;

FIG. 81D is a diagram illustrating an example of an image displayed in the battle bonus process;

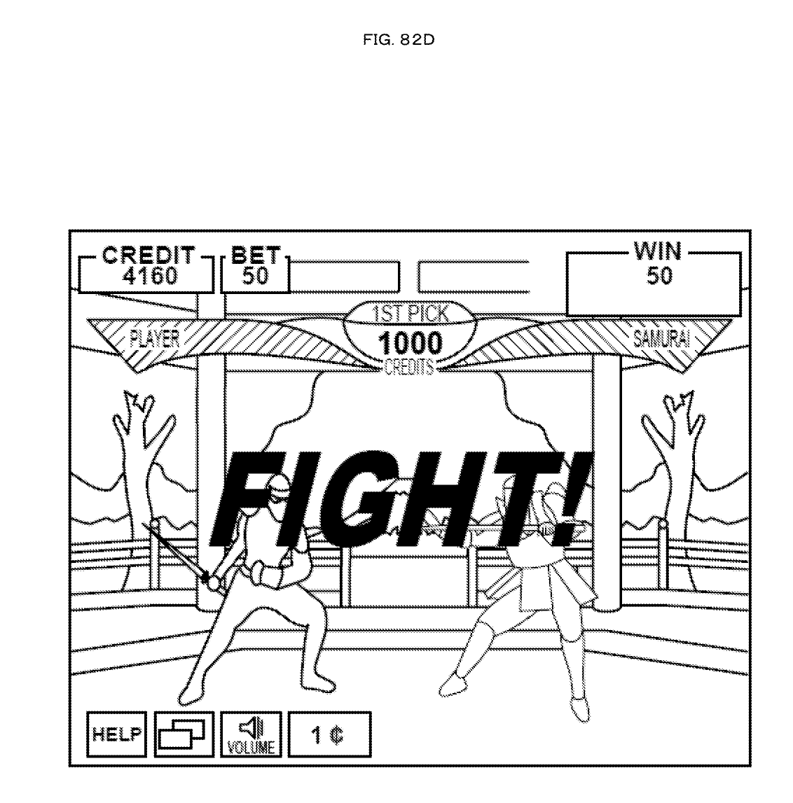

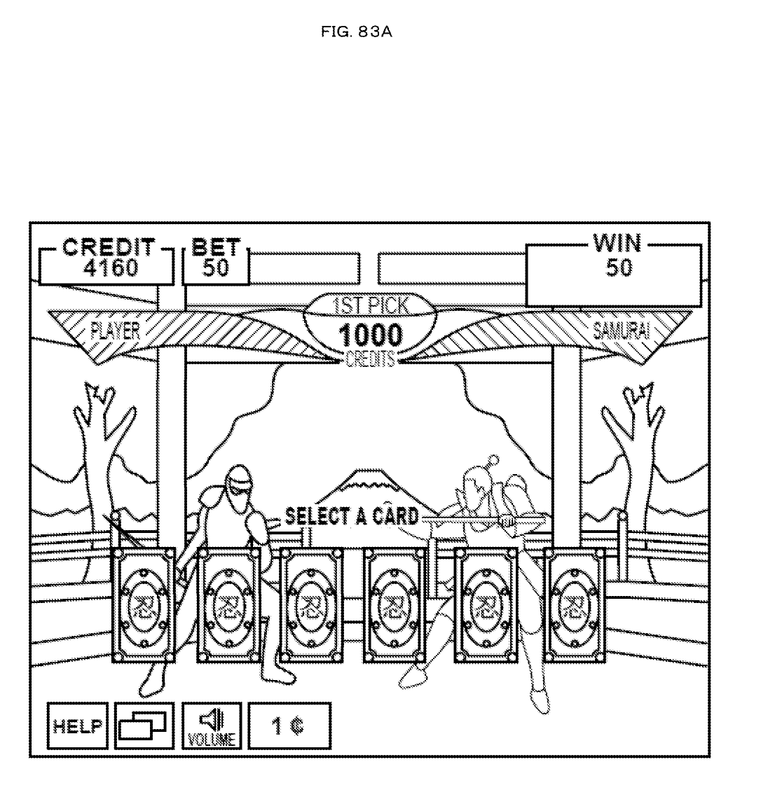

FIG. 82A is a diagram illustrating an example of an image displayed in the battle bonus process;

FIG. 82B is a diagram illustrating an example of an image displayed in the battle bonus process;

FIG. 82C is a diagram illustrating an example of an image displayed in the battle bonus process;

FIG. 82D is a diagram illustrating an example of an image displayed in the battle bonus process;

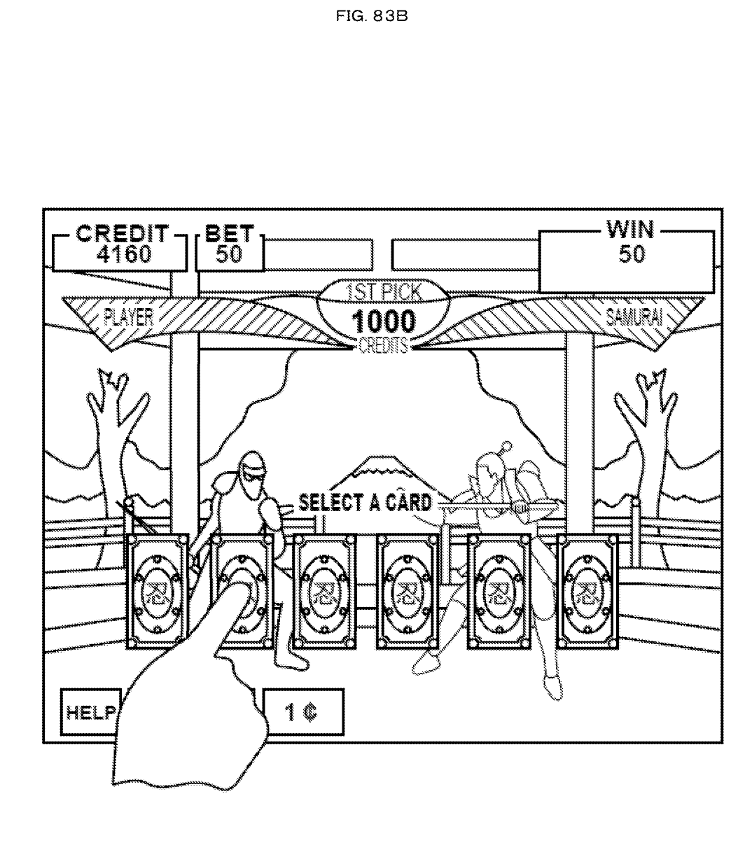

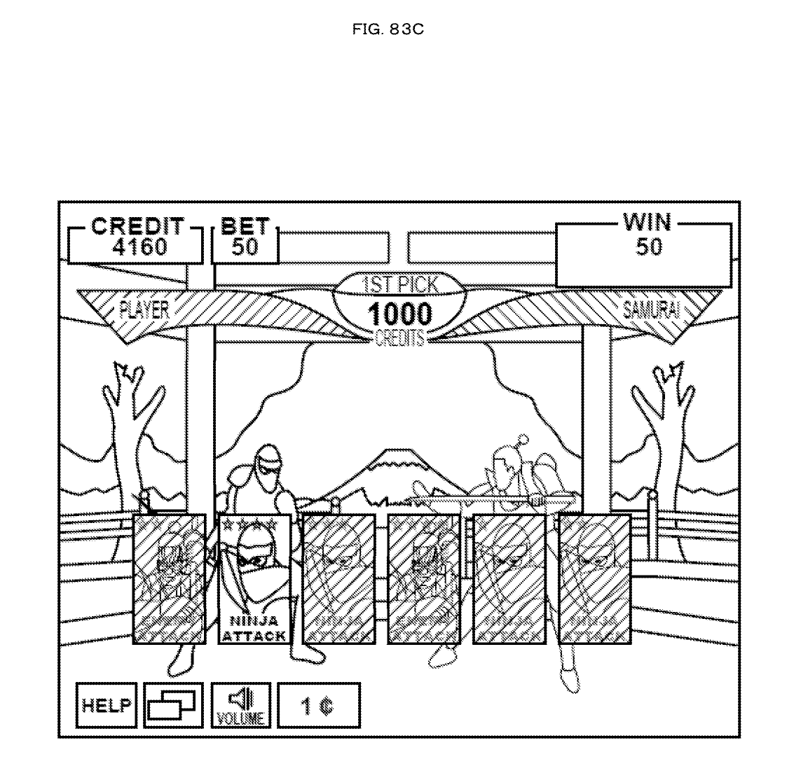

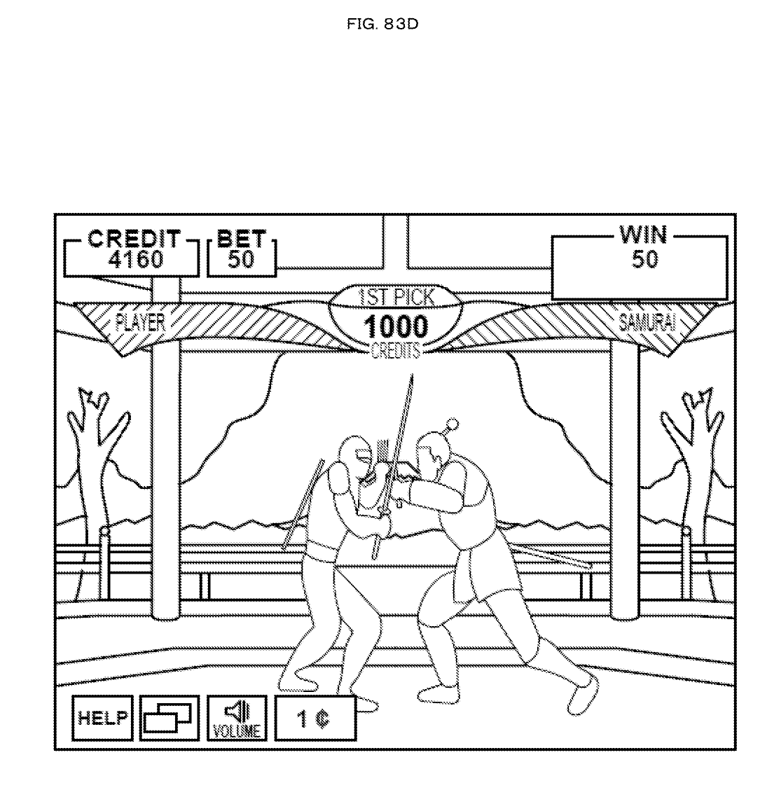

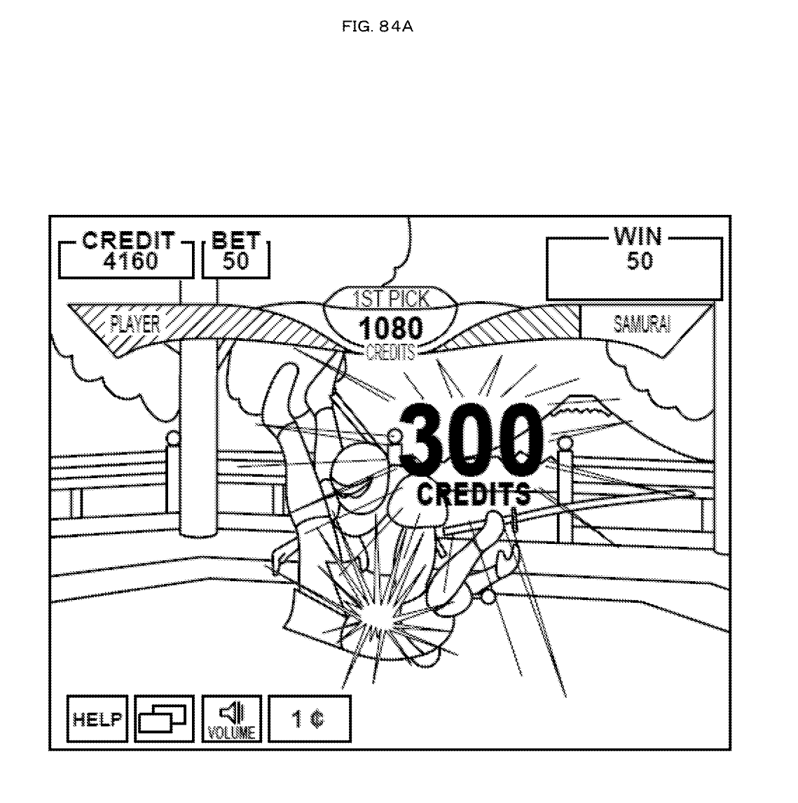

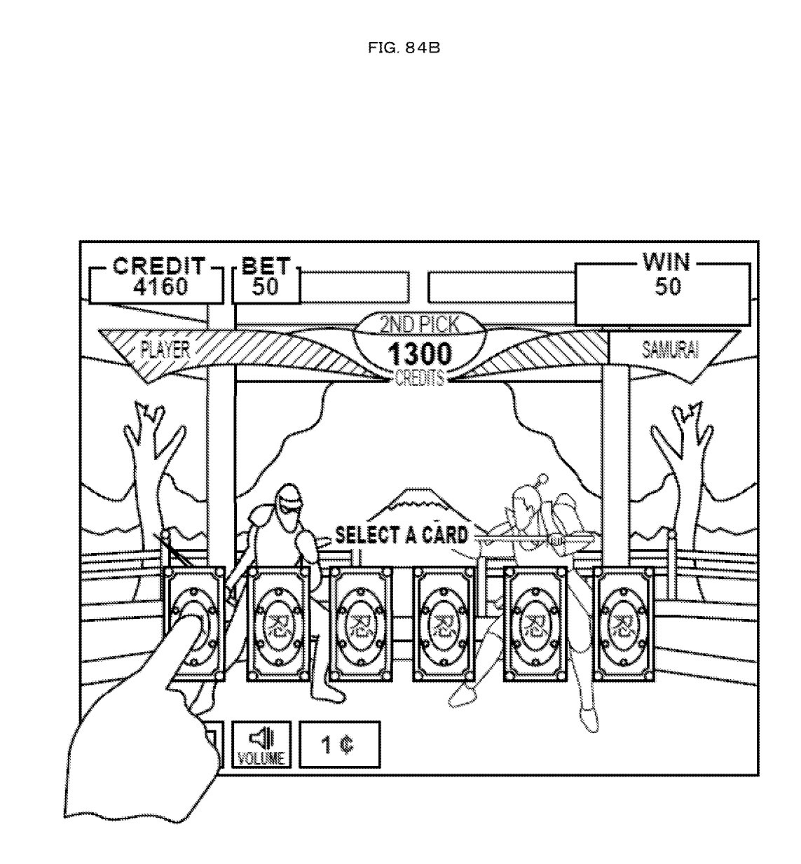

FIG. 83A is a diagram illustrating an example of an image displayed in the battle bonus process;

FIG. 83B is a diagram illustrating an example of an image displayed in the battle bonus process;

FIG. 83C is a diagram illustrating an example of an image displayed in the battle bonus process;

FIG. 83D is a diagram illustrating an example of an image displayed in the battle bonus process;

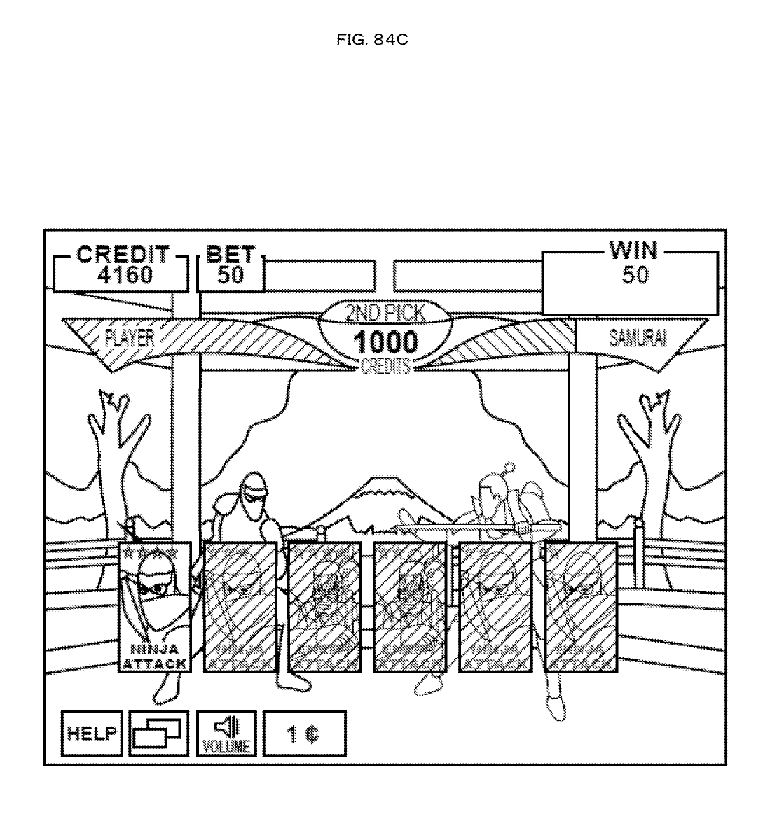

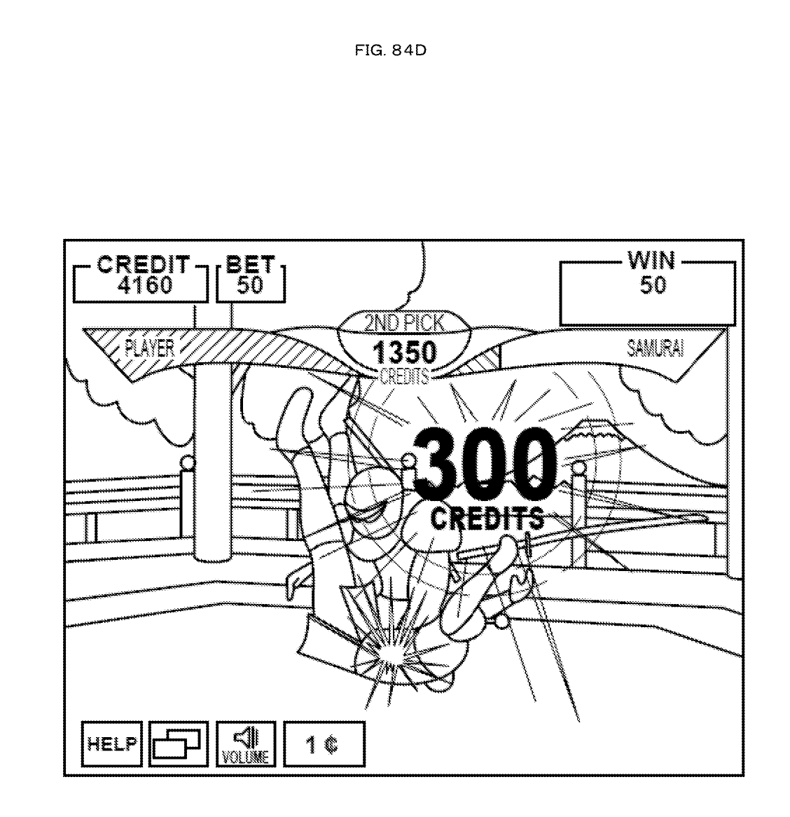

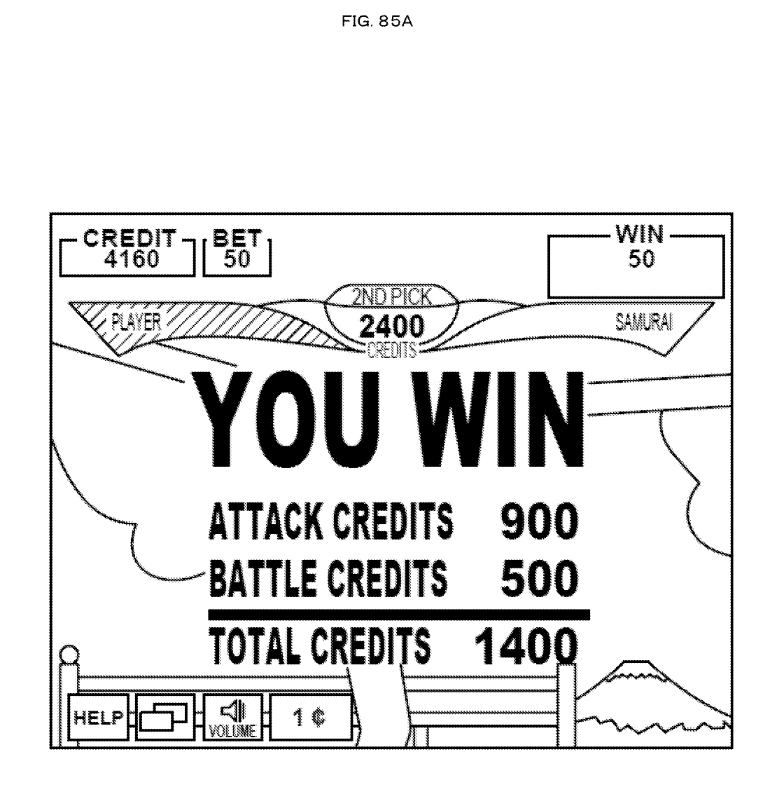

FIG. 84A is a diagram illustrating an example of an image displayed in the battle bonus process;

FIG. 84B is a diagram illustrating an example of an image displayed in the battle bonus process;

FIG. 84C is a diagram illustrating an example of an image displayed in the battle bonus process;

FIG. 84D is a diagram illustrating an example of an image displayed in the battle bonus process;

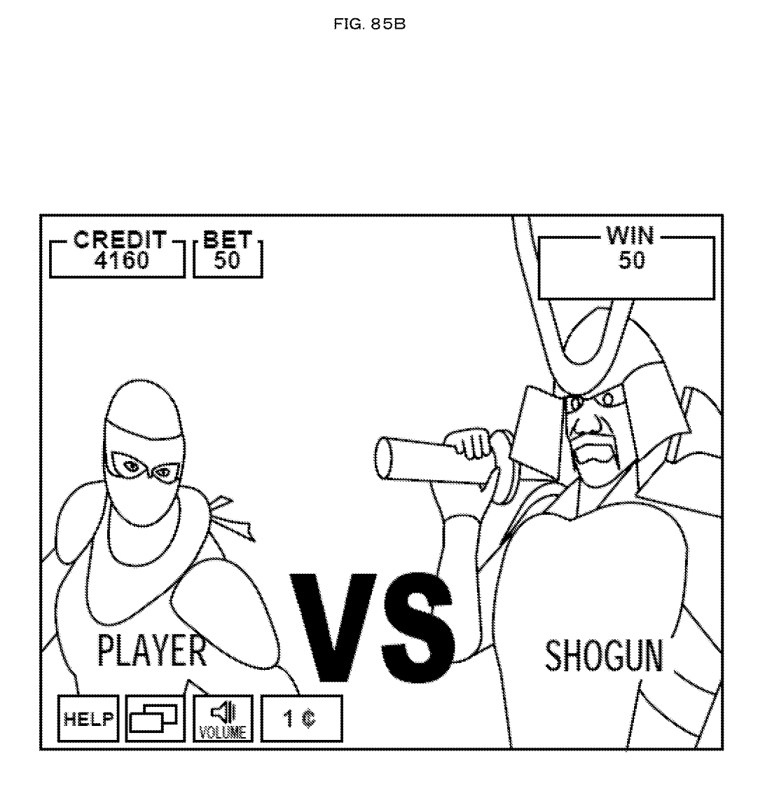

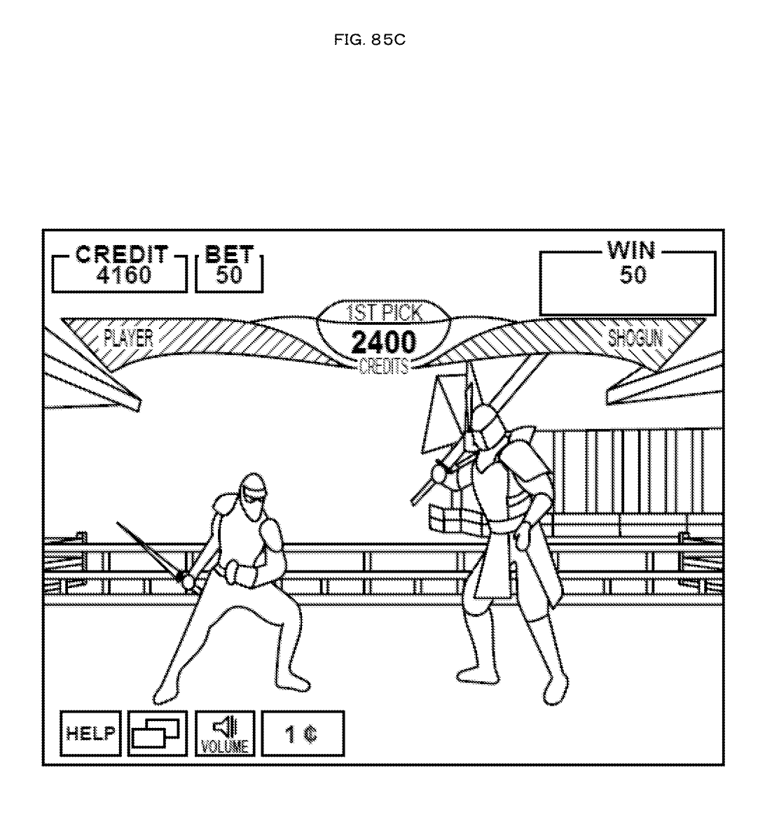

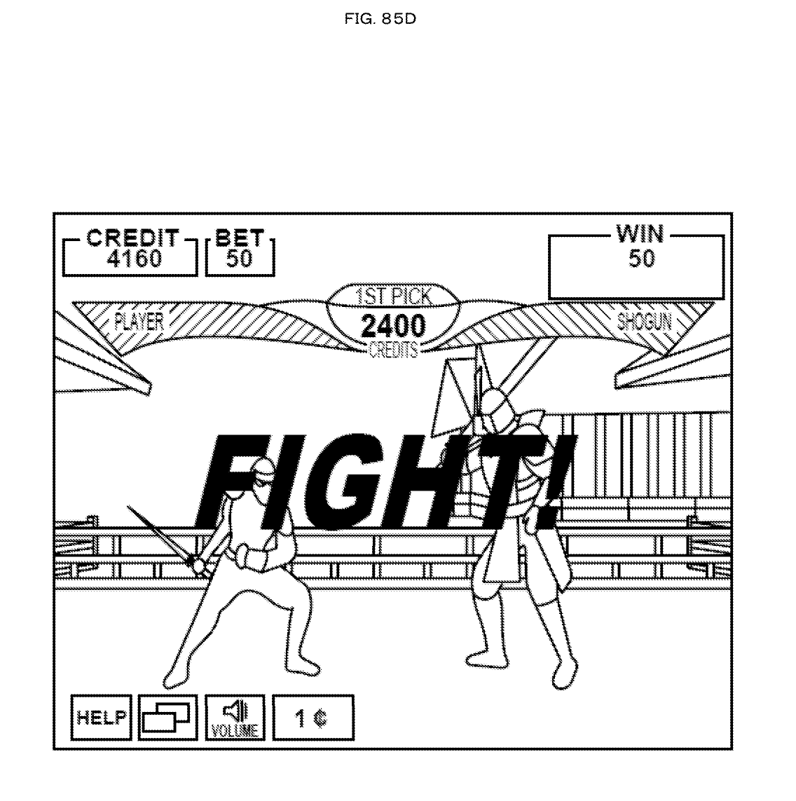

FIG. 85A is a diagram illustrating an example of an image displayed in the battle bonus process;

FIG. 85B is a diagram illustrating an example of an image displayed in the battle bonus process;

FIG. 85C is a diagram illustrating an example of an image displayed in the battle bonus process;

FIG. 85D is a diagram illustrating an example of an image displayed in the battle bonus process;

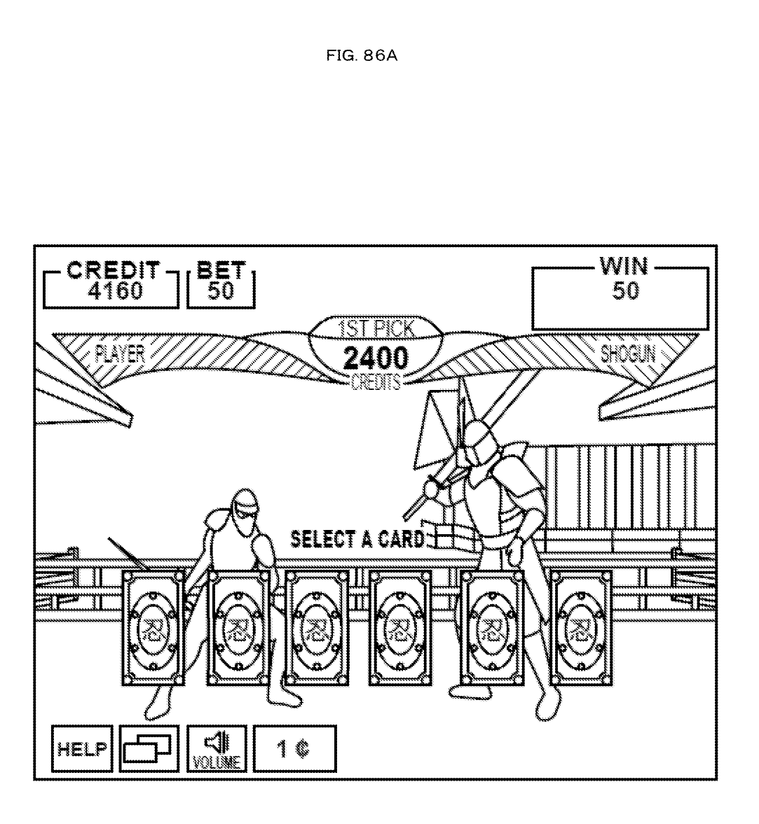

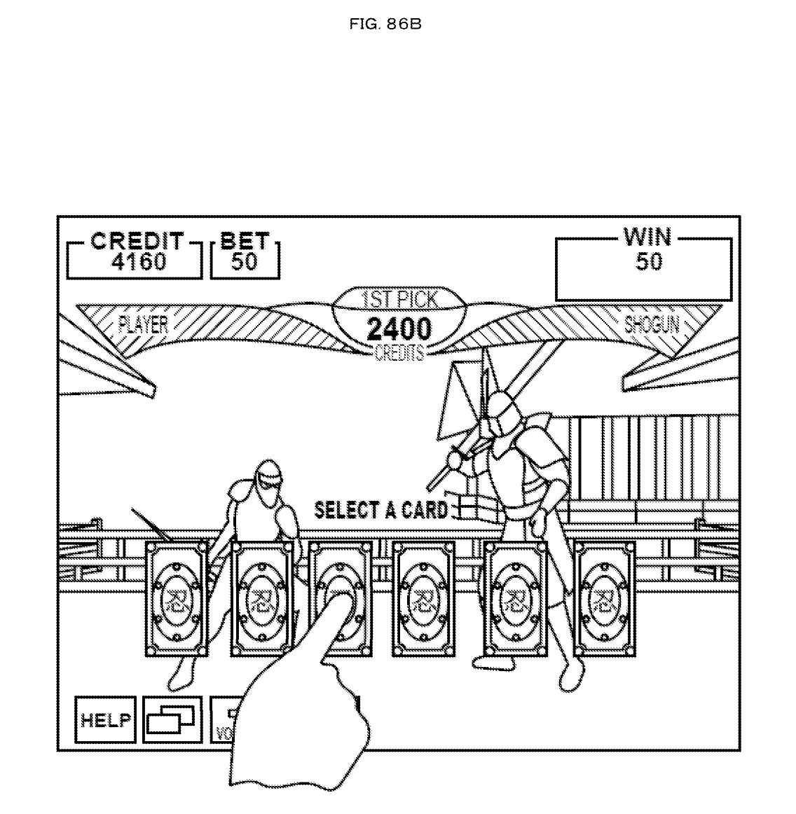

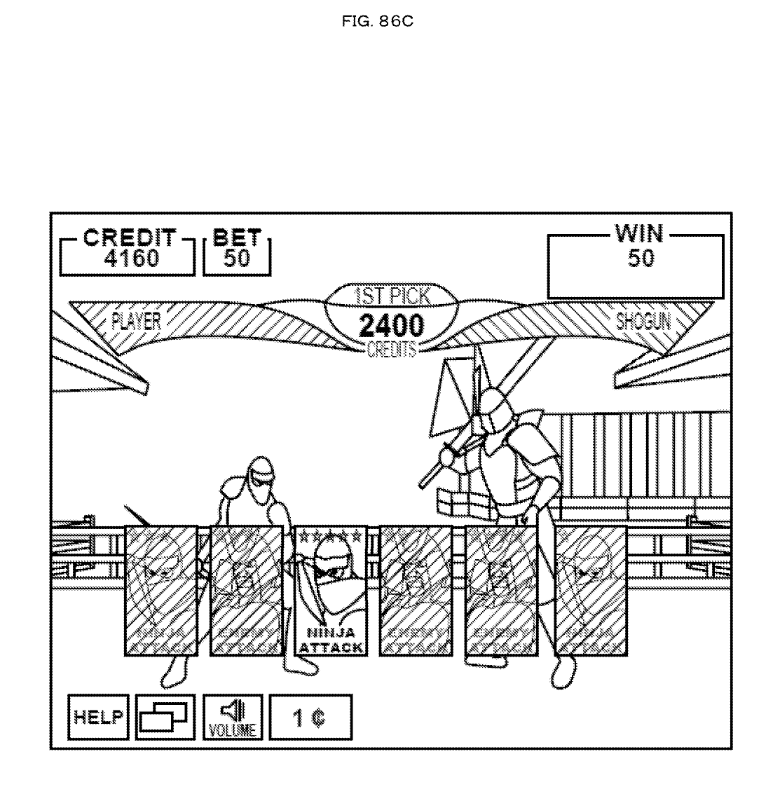

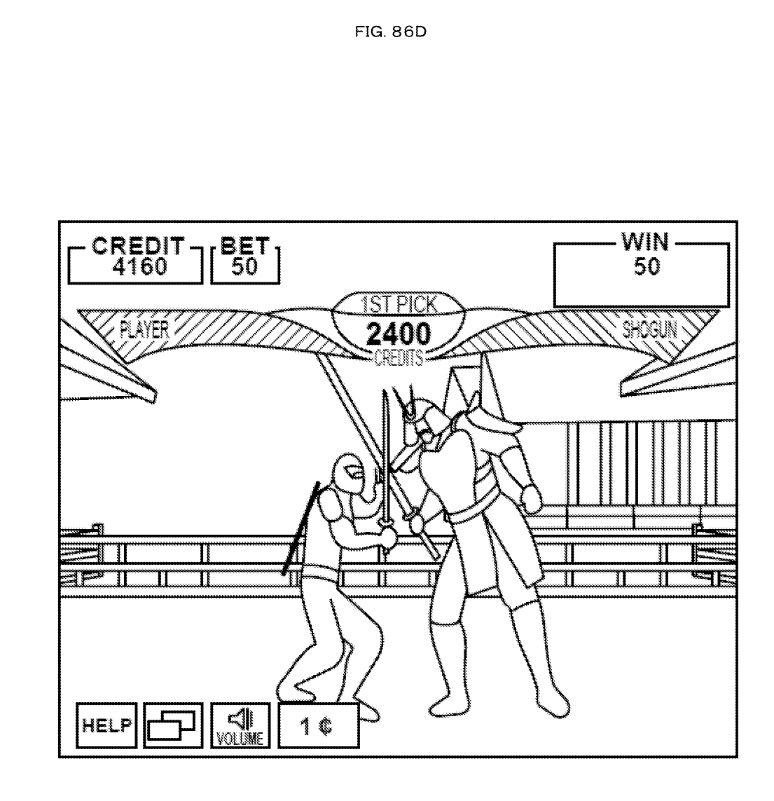

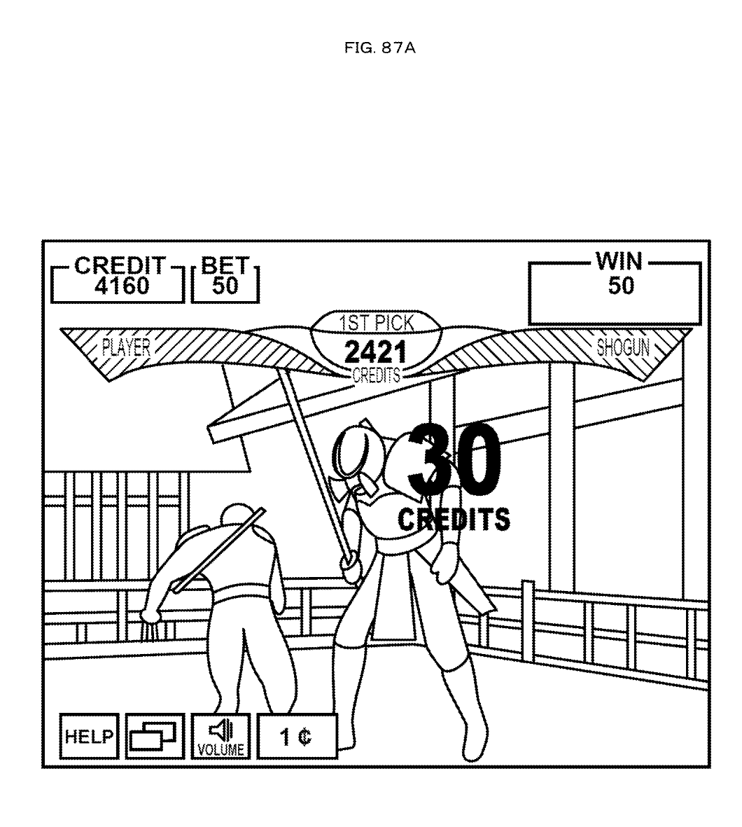

FIG. 86A is a diagram illustrating an example of an image displayed in the battle bonus process;

FIG. 86B is a diagram illustrating an example of an image displayed in the battle bonus process;

FIG. 86C is a diagram illustrating an example of an image displayed in the battle bonus process;

FIG. 86D is a diagram illustrating an example of an image displayed in the battle bonus process;

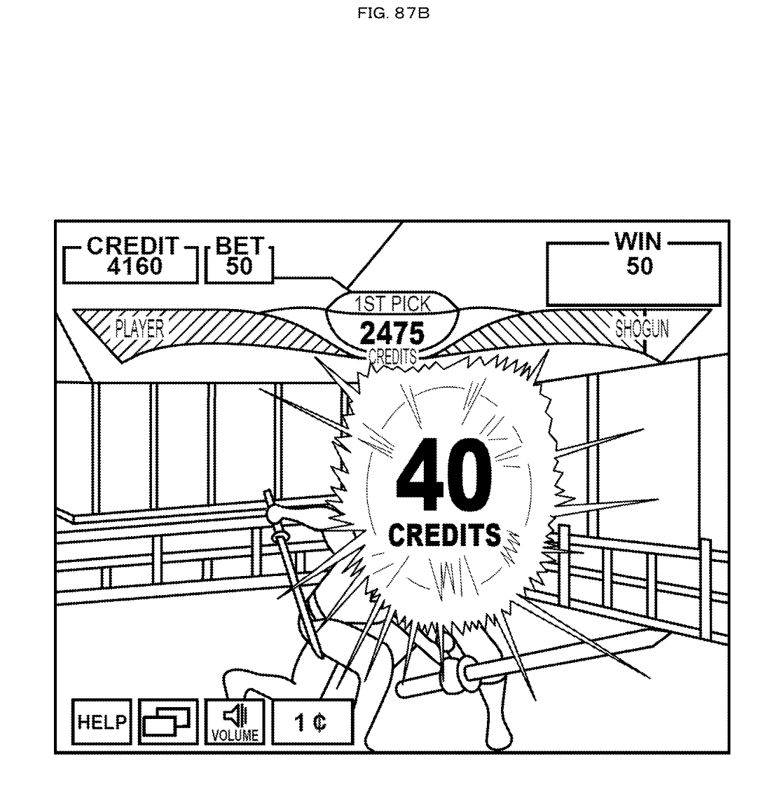

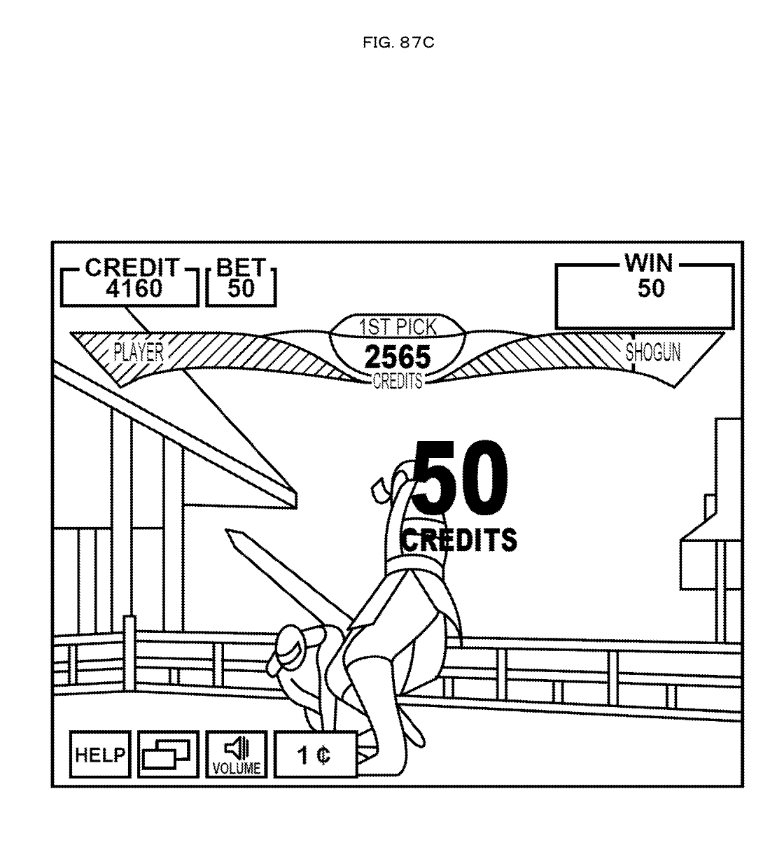

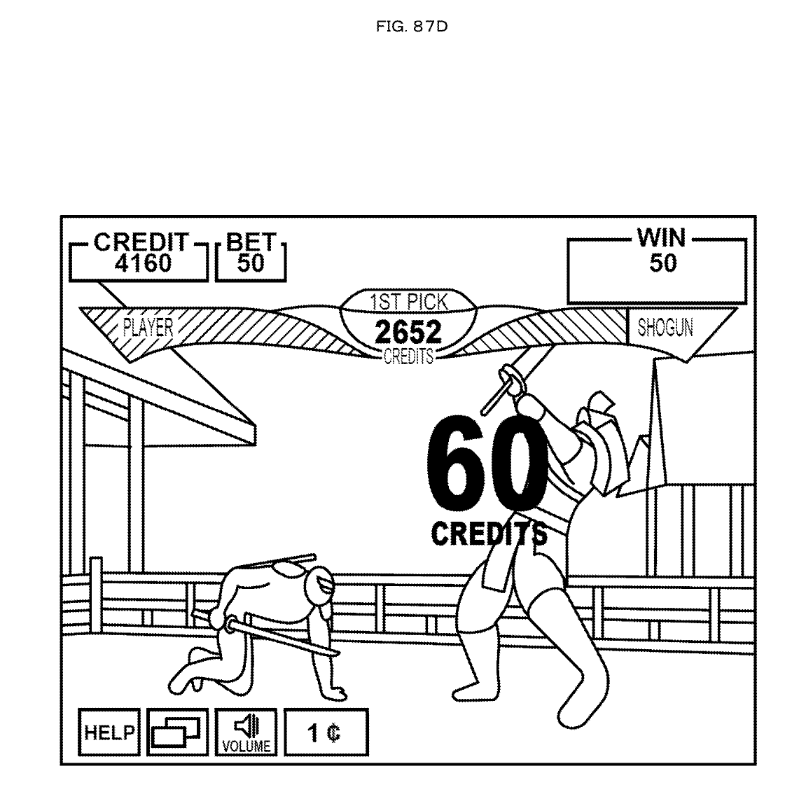

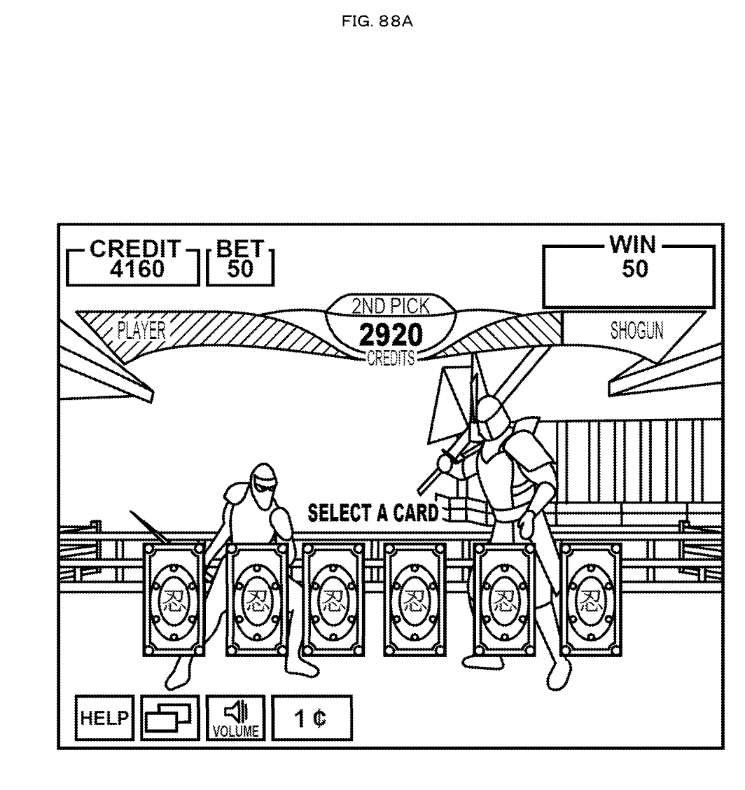

FIG. 87A is a diagram illustrating an example of an image displayed in the battle bonus process;

FIG. 87B is a diagram illustrating an example of an image displayed in the battle bonus process;

FIG. 87C is a diagram illustrating an example of an image displayed in the battle bonus process;

FIG. 87D is a diagram illustrating an example of an image displayed in the battle bonus process;

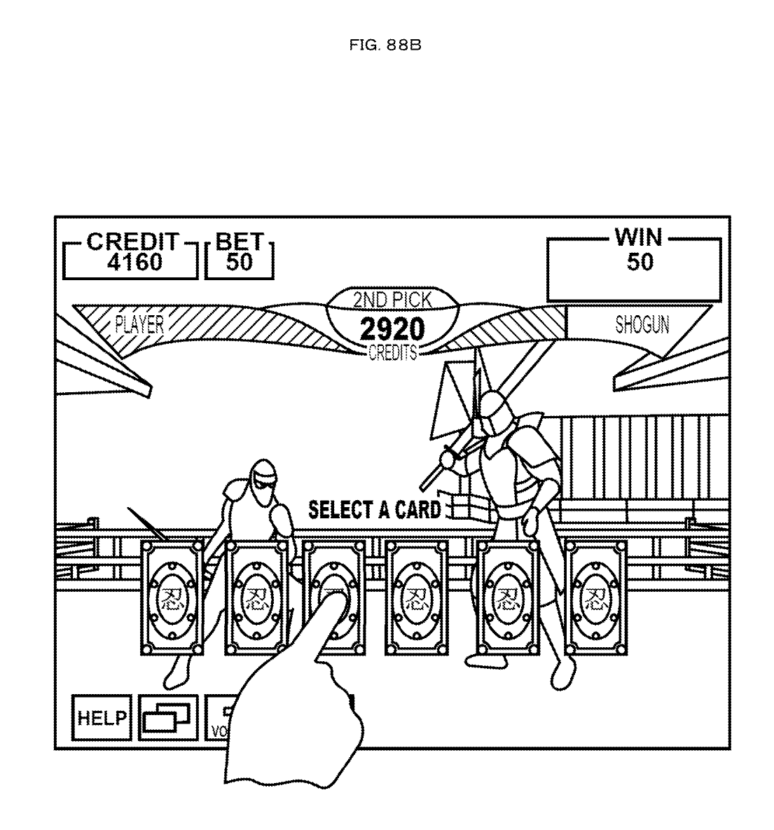

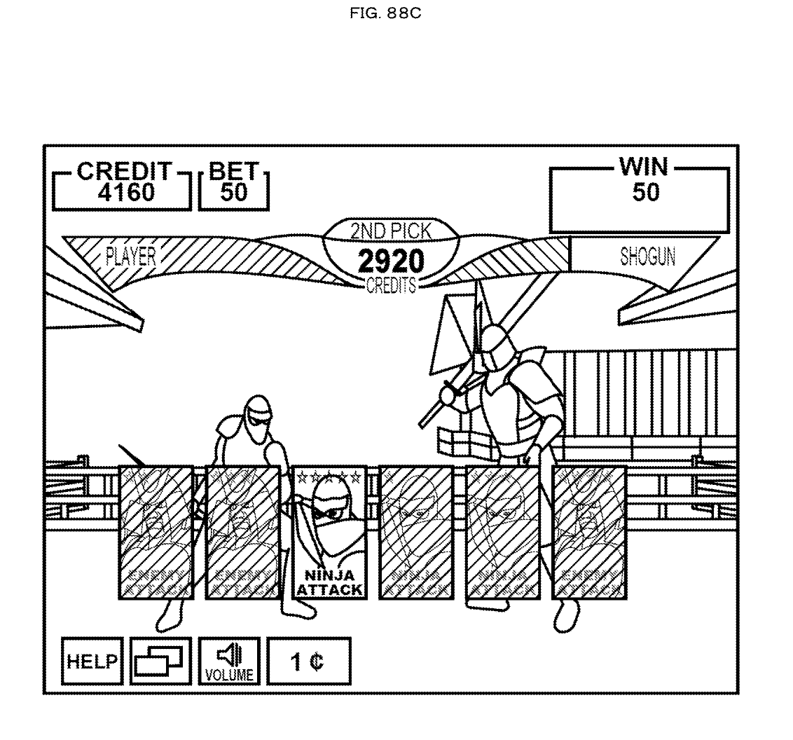

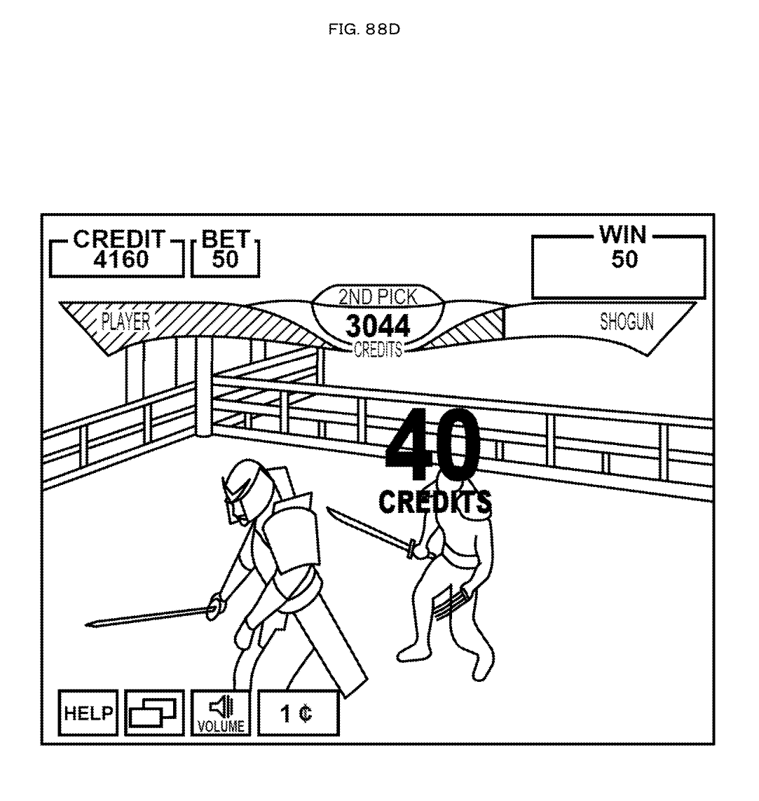

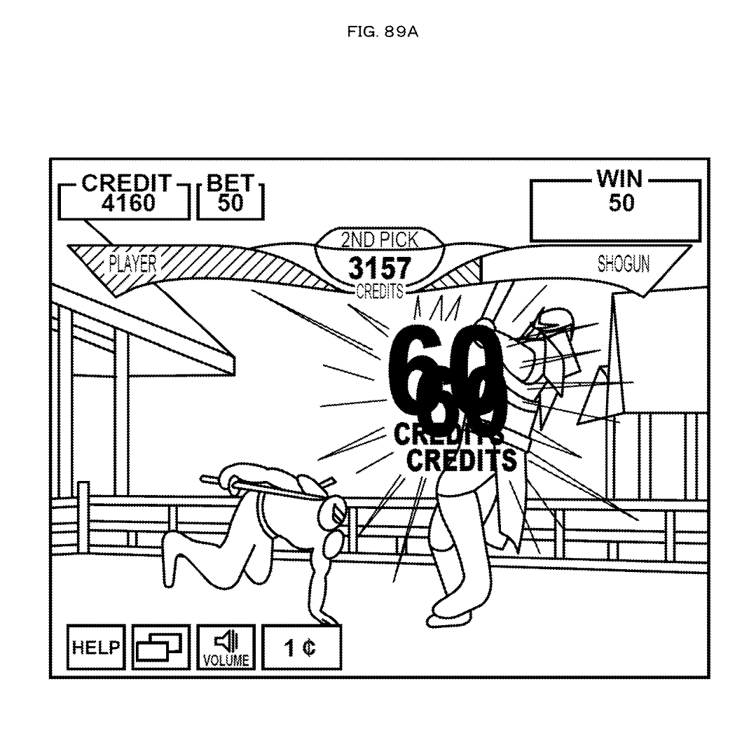

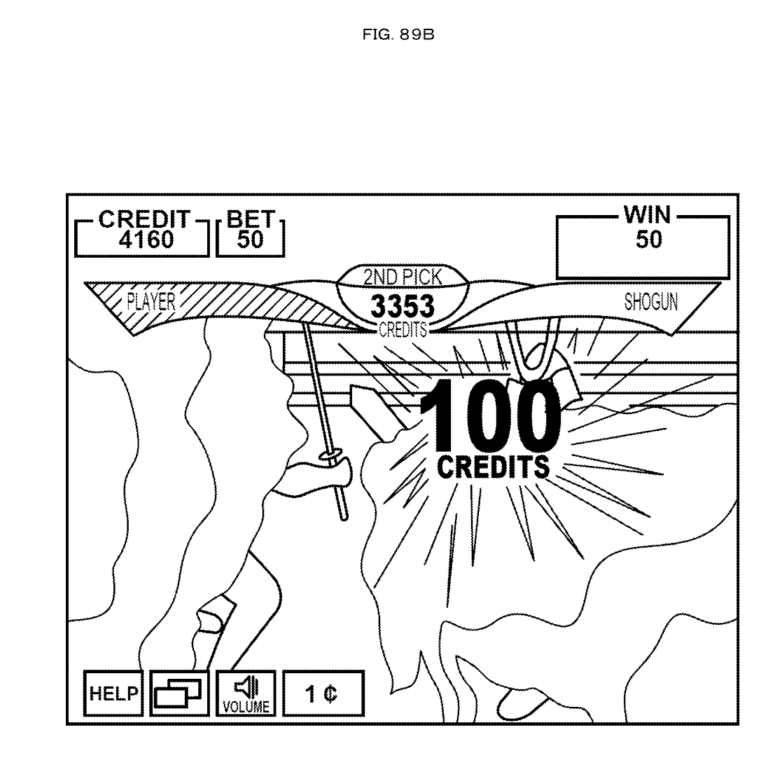

FIG. 88A is a diagram illustrating an example of an image displayed in the battle bonus process;

FIG. 88B is a diagram illustrating an example of an image displayed in the battle bonus process;

FIG. 88C is a diagram illustrating an example of an image displayed in the battle bonus process;

FIG. 88D is a diagram illustrating an example of an image displayed in the battle bonus process;

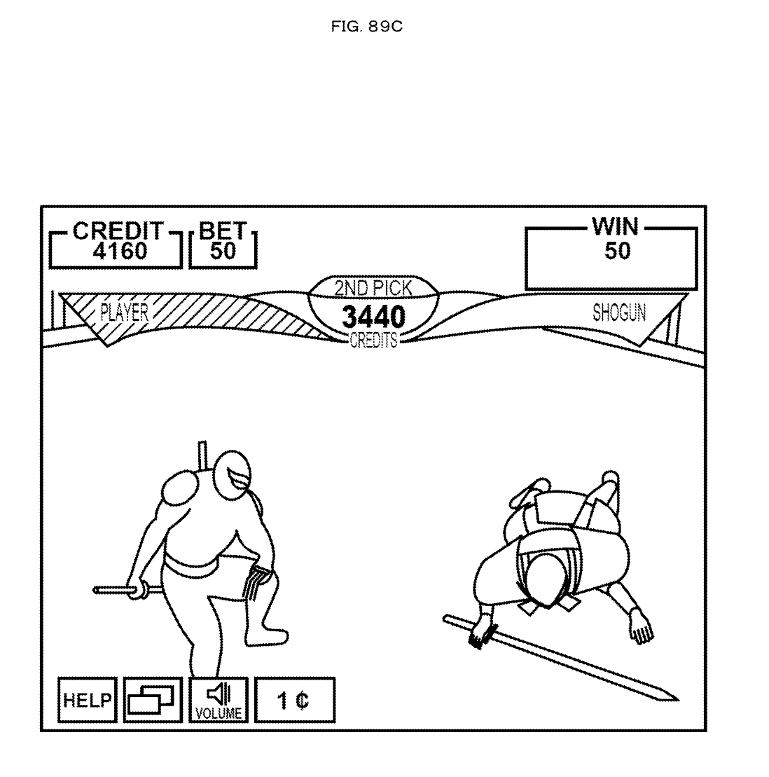

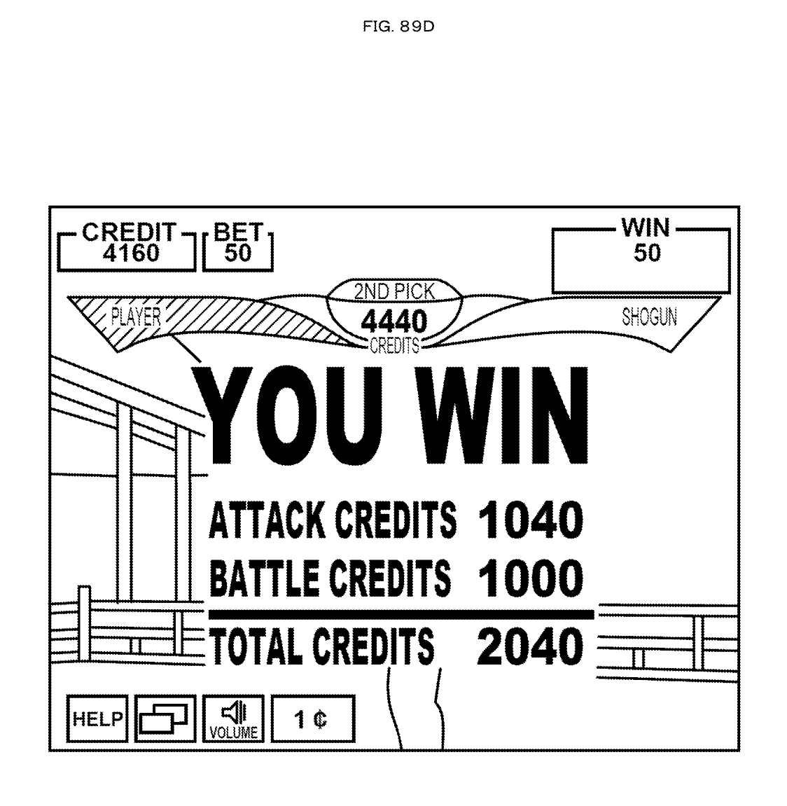

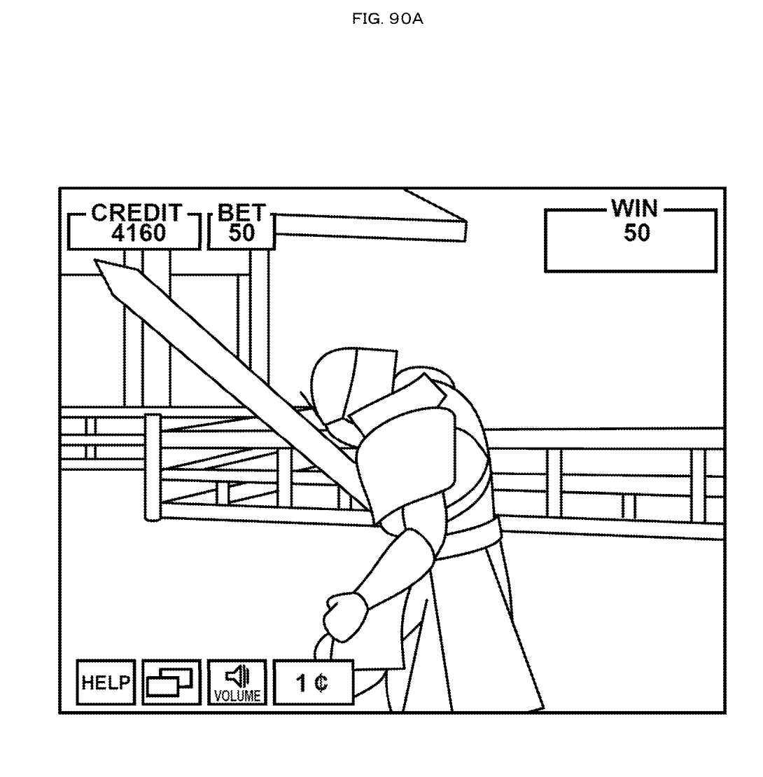

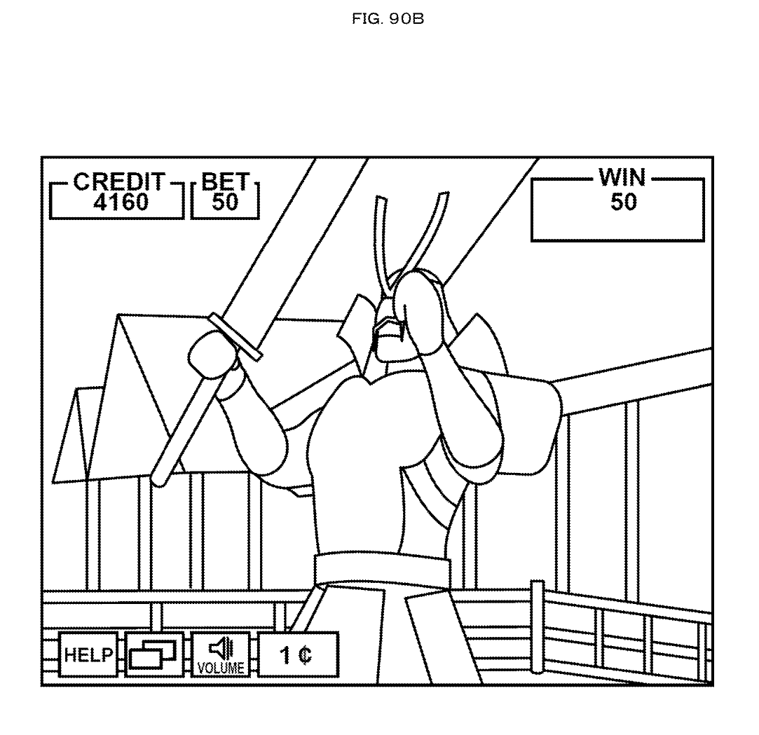

FIG. 89A is a diagram illustrating an example of an image displayed in the battle bonus process;

FIG. 89B is a diagram illustrating an example of an image displayed in the battle bonus process;

FIG. 89C is a diagram illustrating an example of an image displayed in the battle bonus process;

FIG. 89D is a diagram illustrating an example of an image displayed in the battle bonus process;

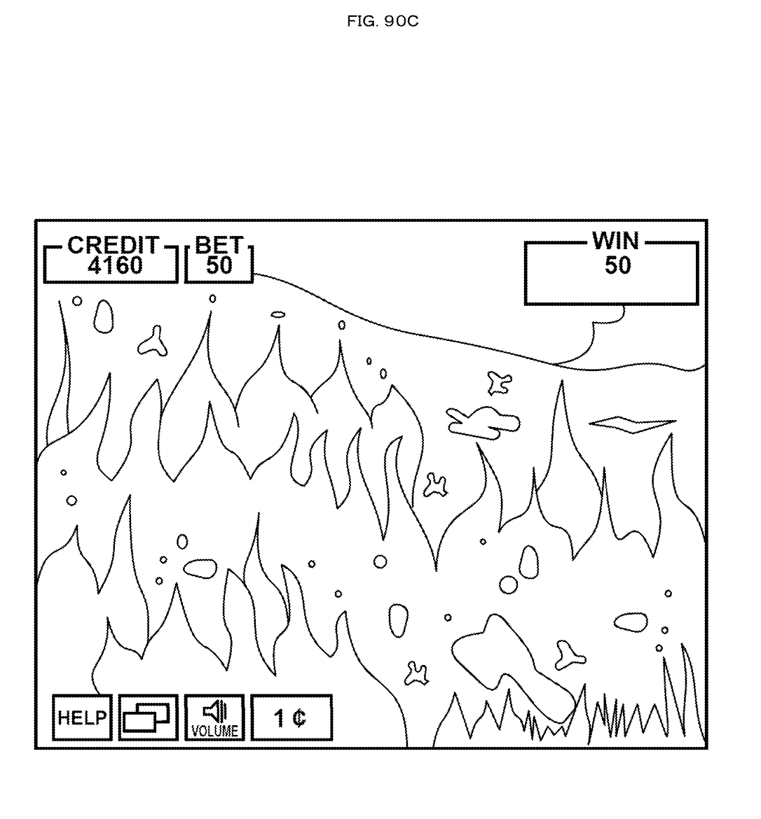

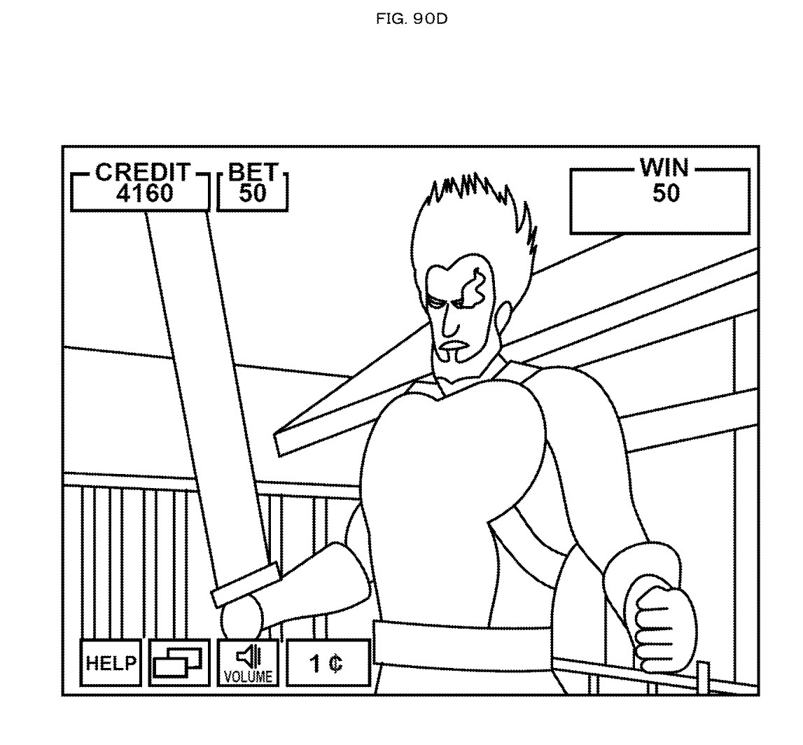

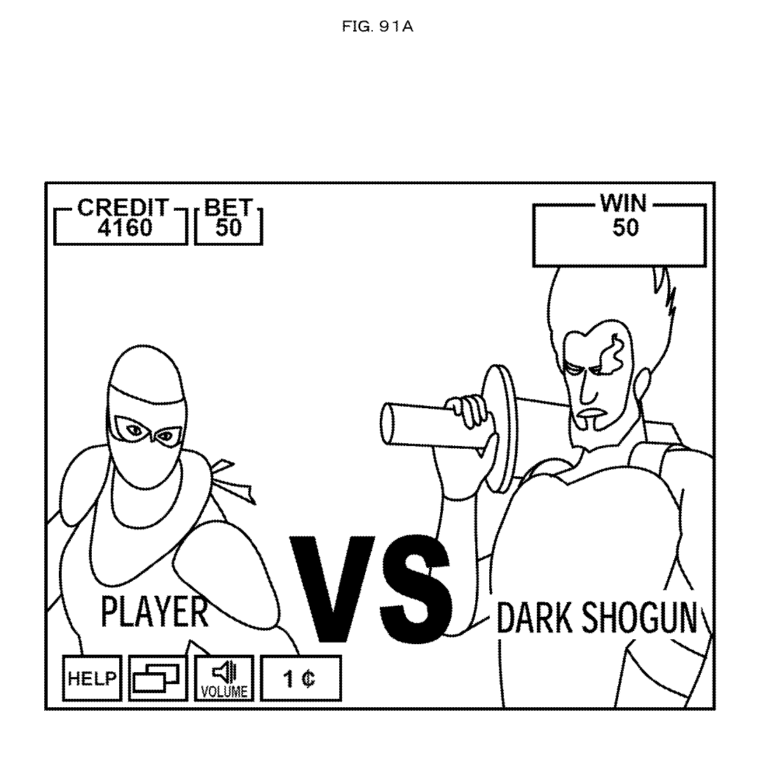

FIG. 90A is a diagram illustrating an example of an image displayed in the battle bonus process;

FIG. 90B is a diagram illustrating an example of an image displayed in the battle bonus process;

FIG. 90C is a diagram illustrating an example of an image displayed in the battle bonus process;

FIG. 90D is a diagram illustrating an example of an image displayed in the battle bonus process;

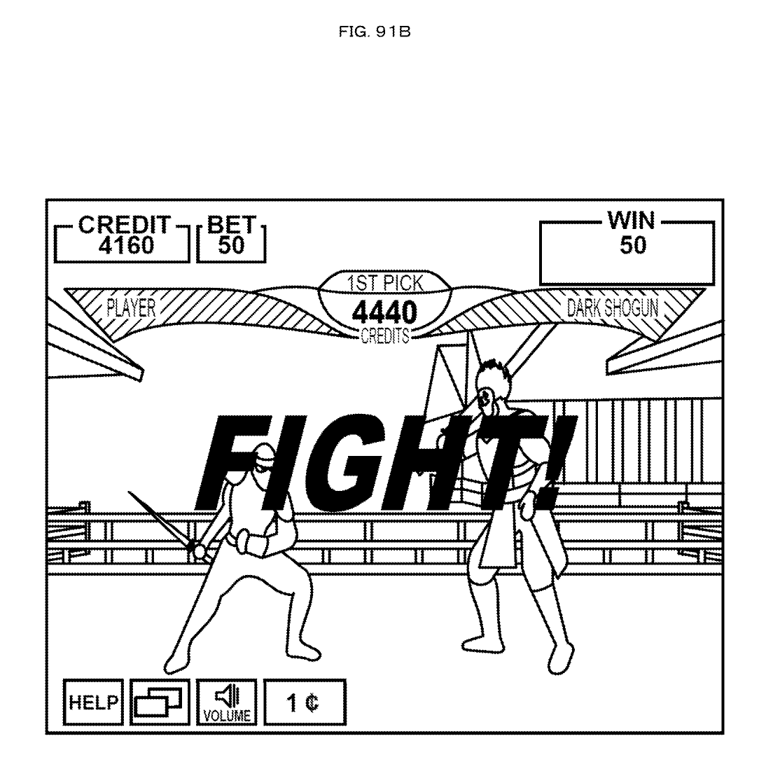

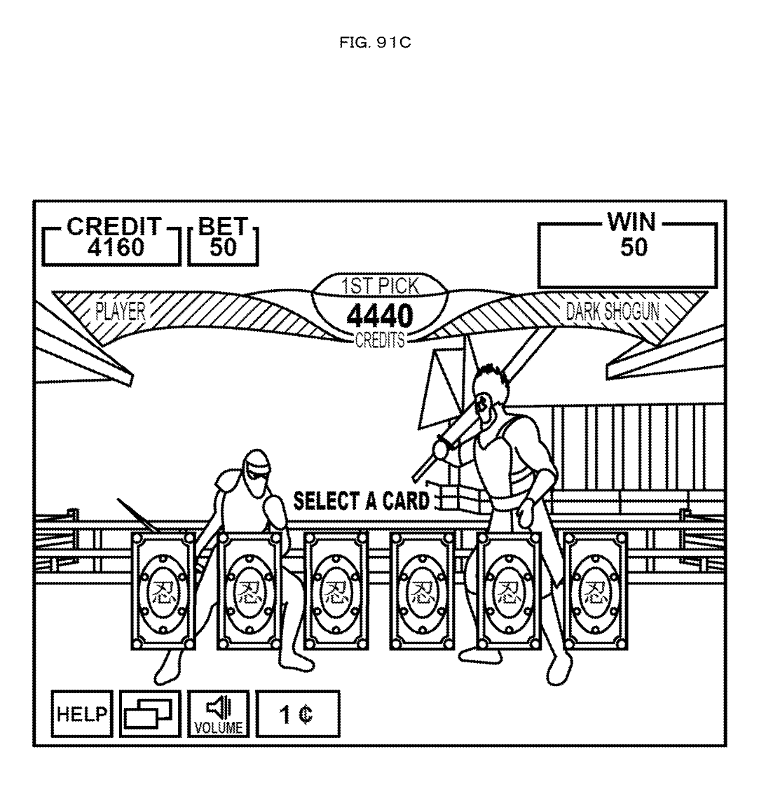

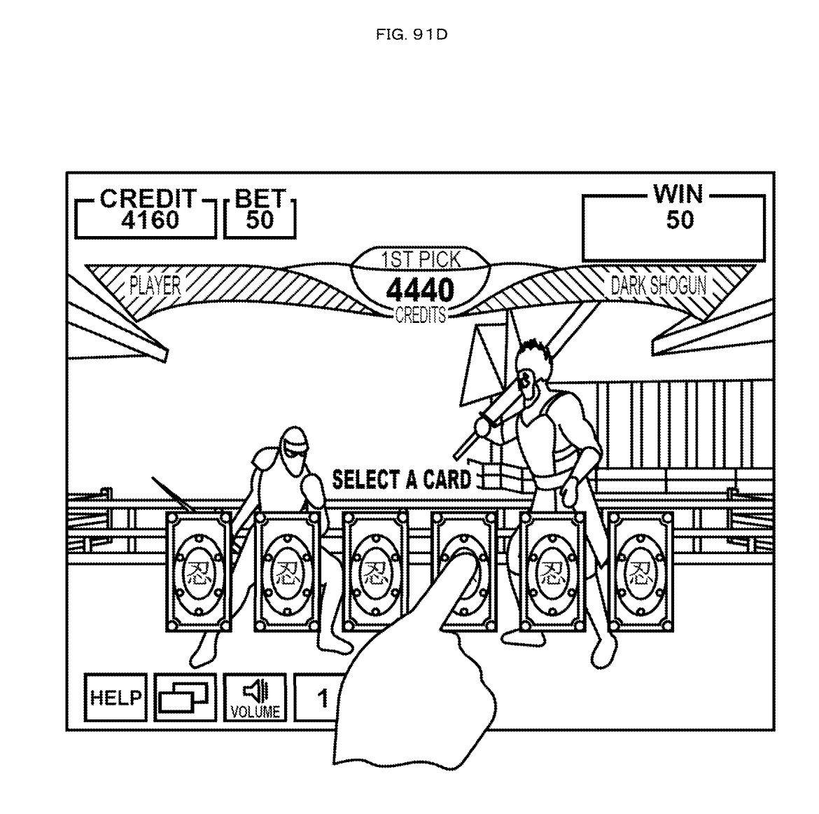

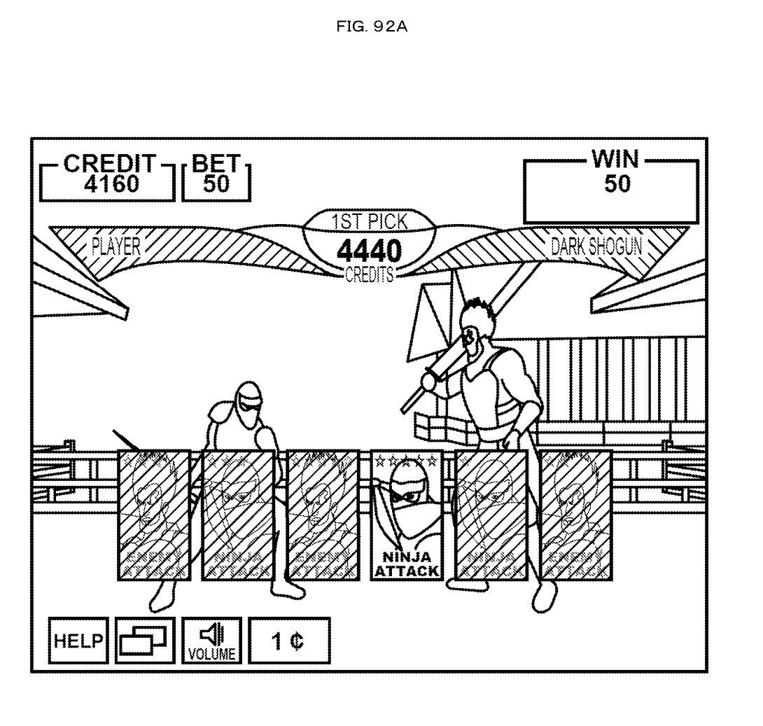

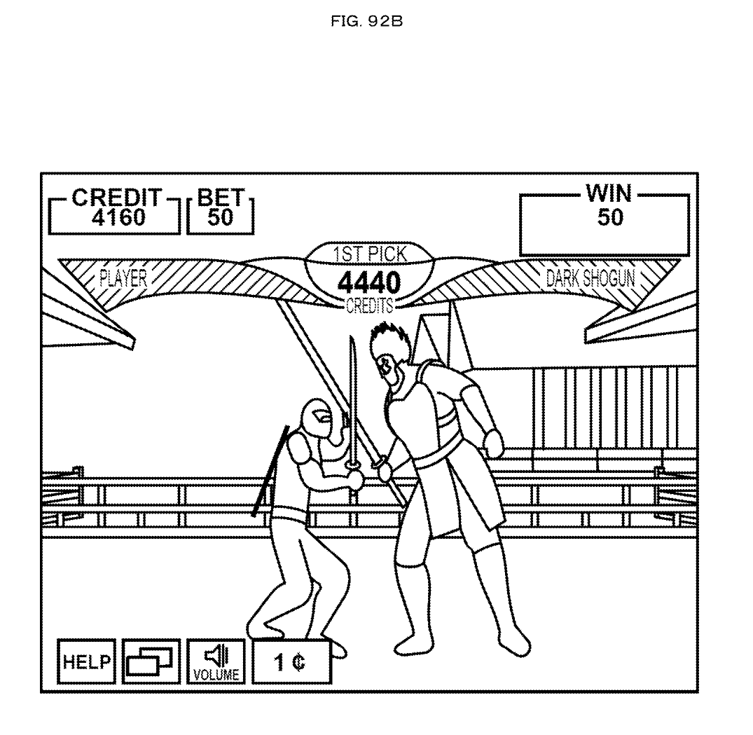

FIG. 91A is a diagram illustrating an example of an image displayed in the battle bonus process;

FIG. 91B is a diagram illustrating an example of an image displayed in the battle bonus process;

FIG. 91C is a diagram illustrating an example of an image displayed in the battle bonus process;

FIG. 91D is a diagram illustrating an example of an image displayed in the battle bonus process;

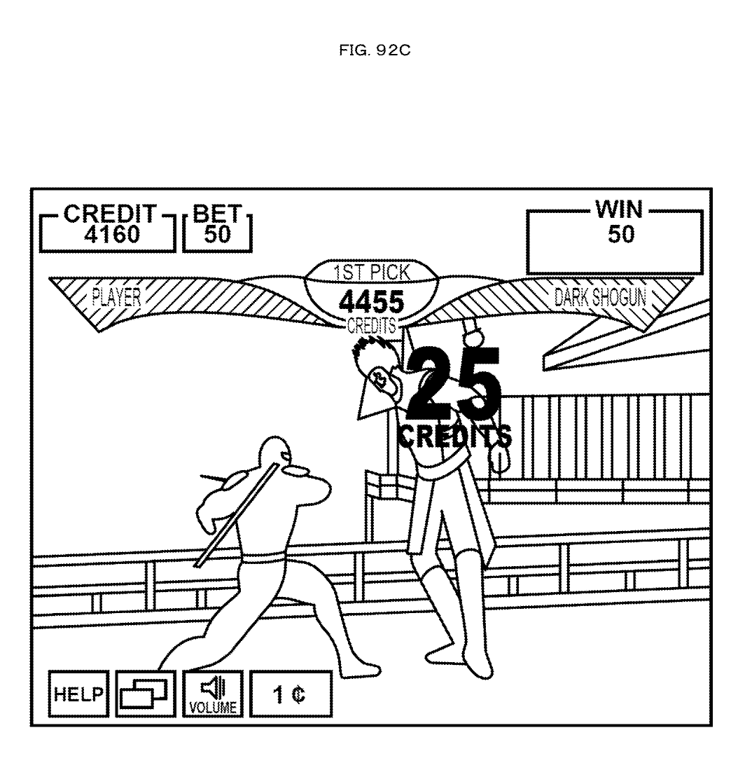

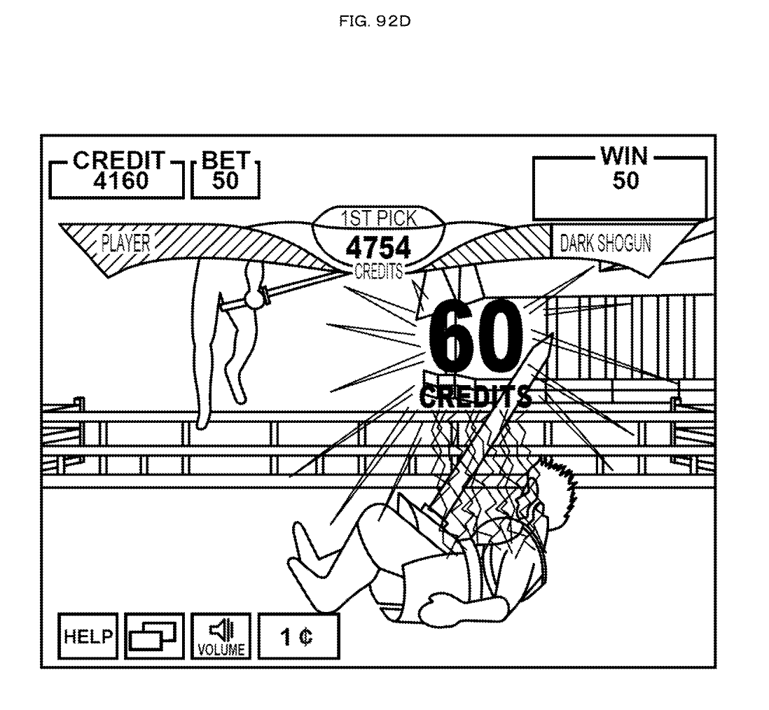

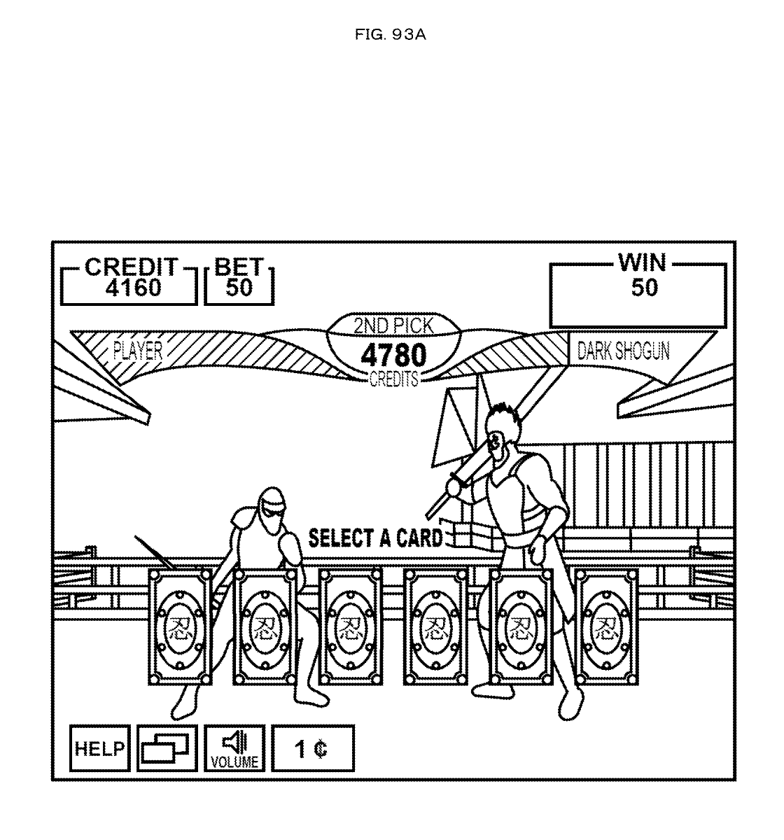

FIG. 92A is a diagram illustrating an example of an image displayed in the battle bonus process;

FIG. 92B is a diagram illustrating an example of an image displayed in the battle bonus process;

FIG. 92C is a diagram illustrating an example of an image displayed in the battle bonus process;

FIG. 92D is a diagram illustrating an example of an image displayed in the battle bonus process;

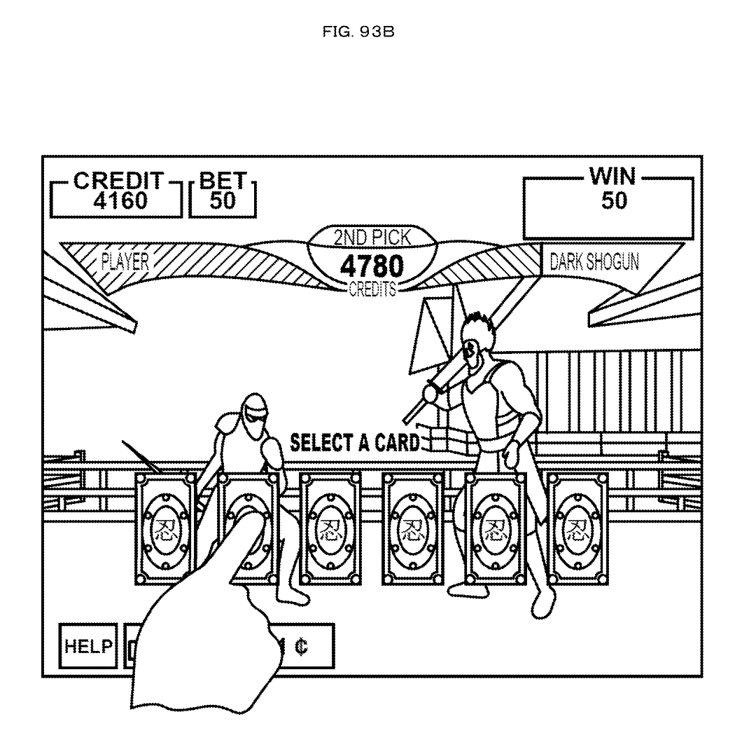

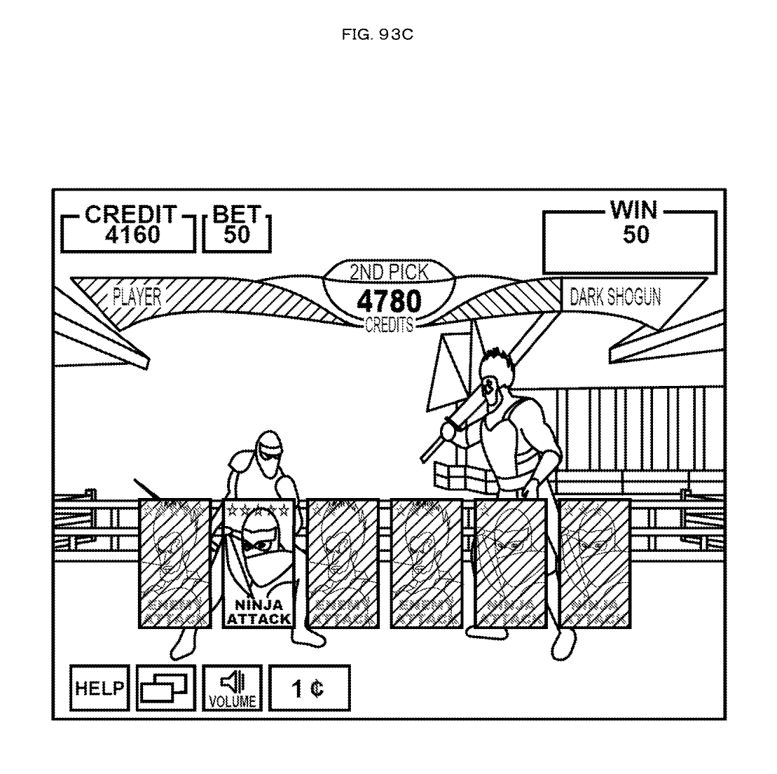

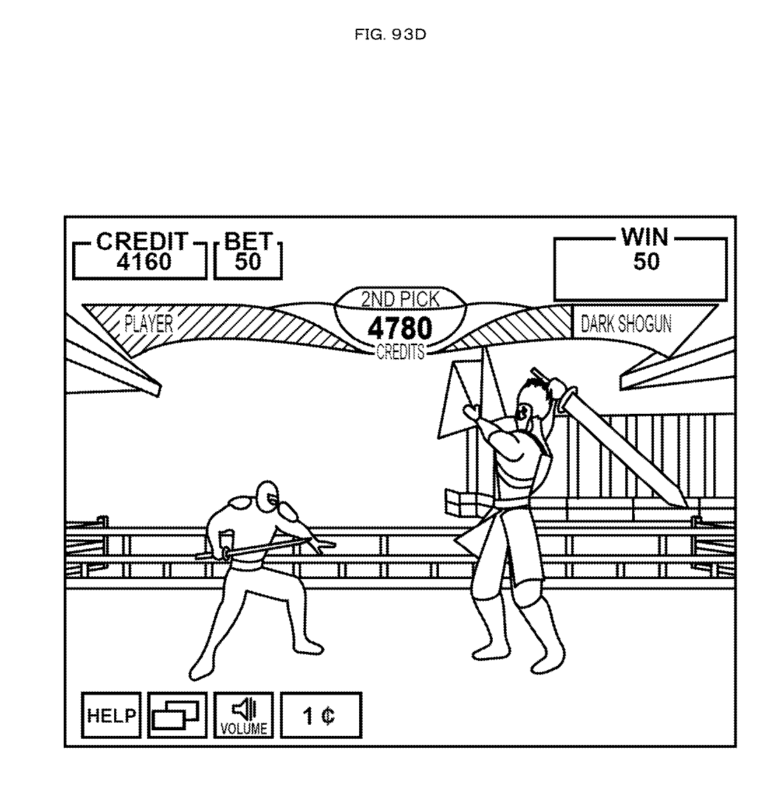

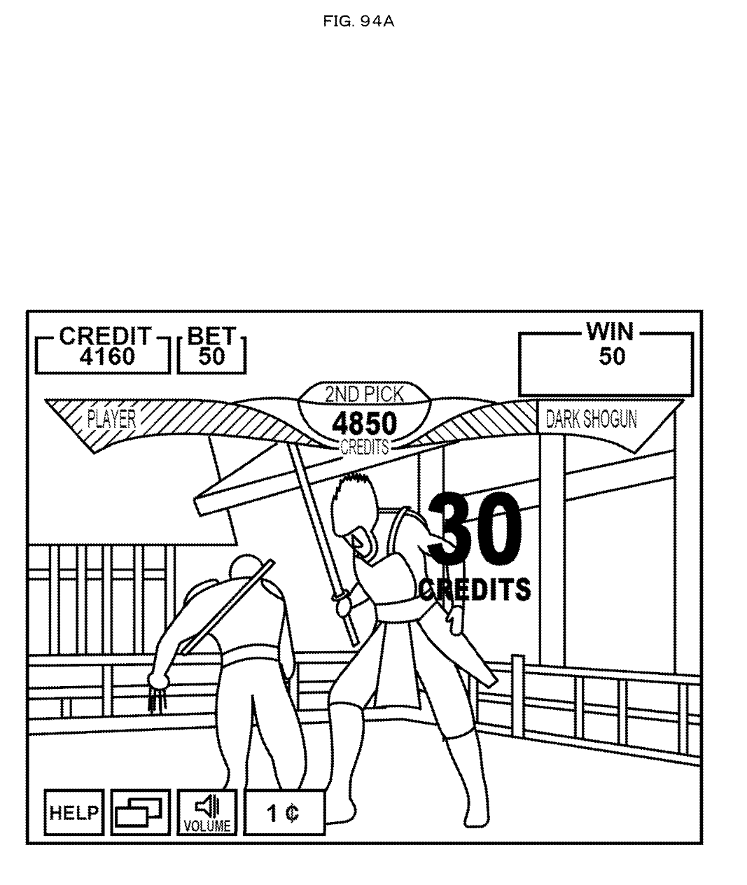

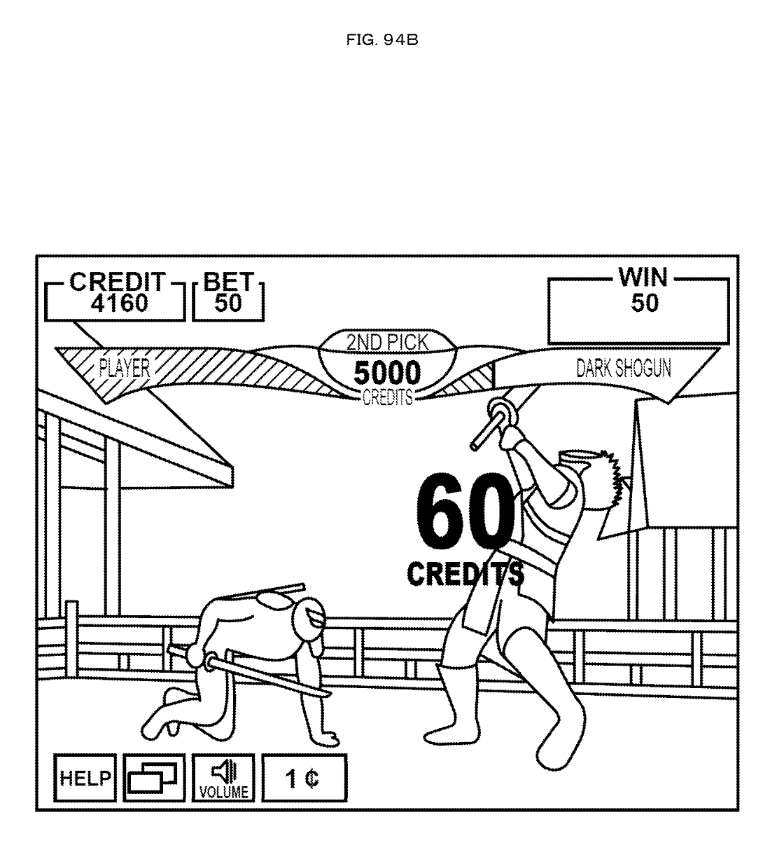

FIG. 93A is a diagram illustrating an example of an image displayed in the battle bonus process;

FIG. 93B is a diagram illustrating an example of an image displayed in the battle bonus process;

FIG. 93C is a diagram illustrating an example of an image displayed in the battle bonus process;

FIG. 93D is a diagram illustrating an example of an image displayed in the battle bonus process;

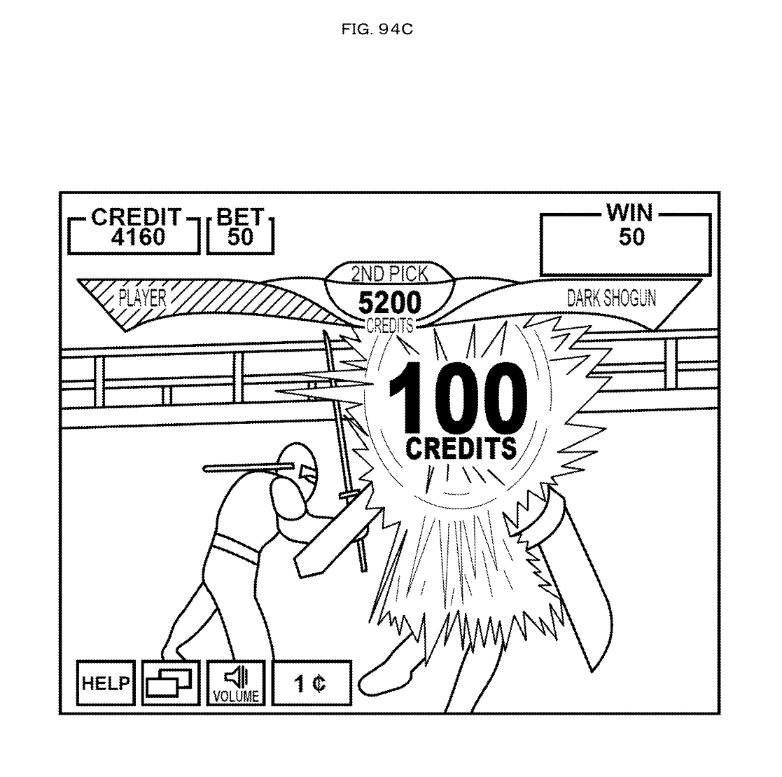

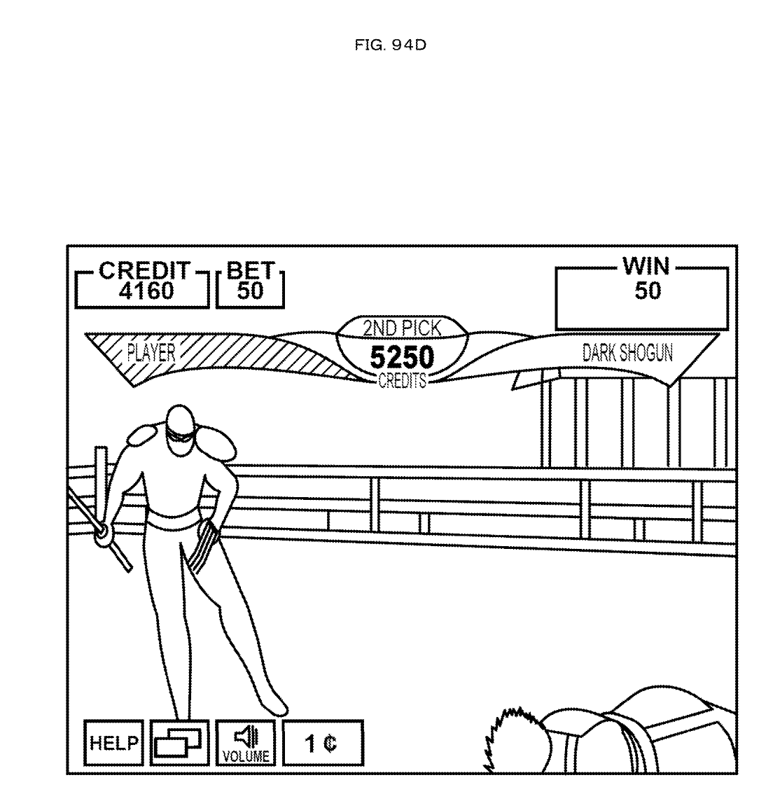

FIG. 94A is a diagram illustrating an example of an image displayed in the battle bonus process;

FIG. 94B is a diagram illustrating an example of an image displayed in the battle bonus process;

FIG. 94C is a diagram illustrating an example of an image displayed in the battle bonus process;

FIG. 94D is a diagram illustrating an example of an image displayed in the battle bonus process;

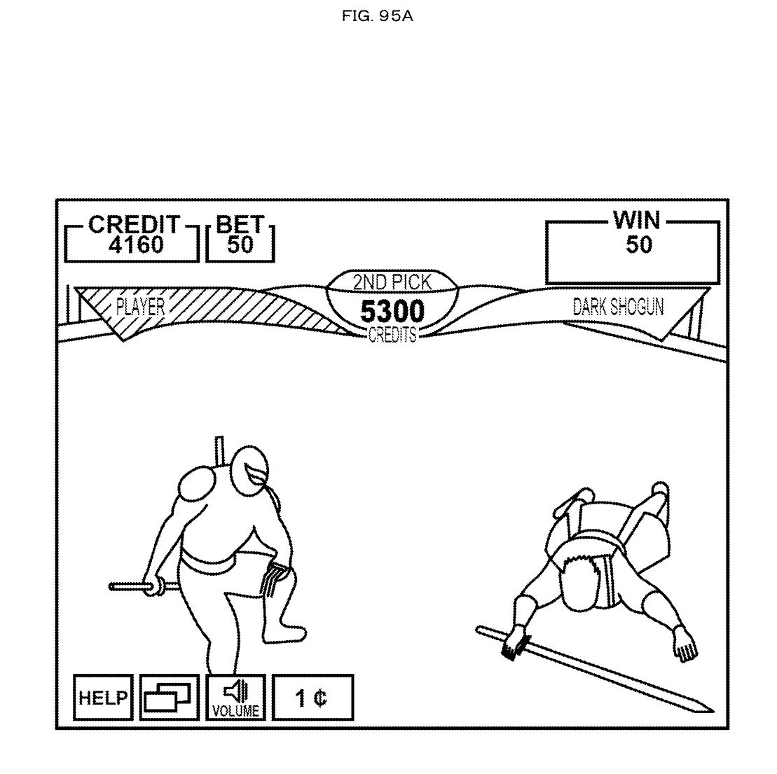

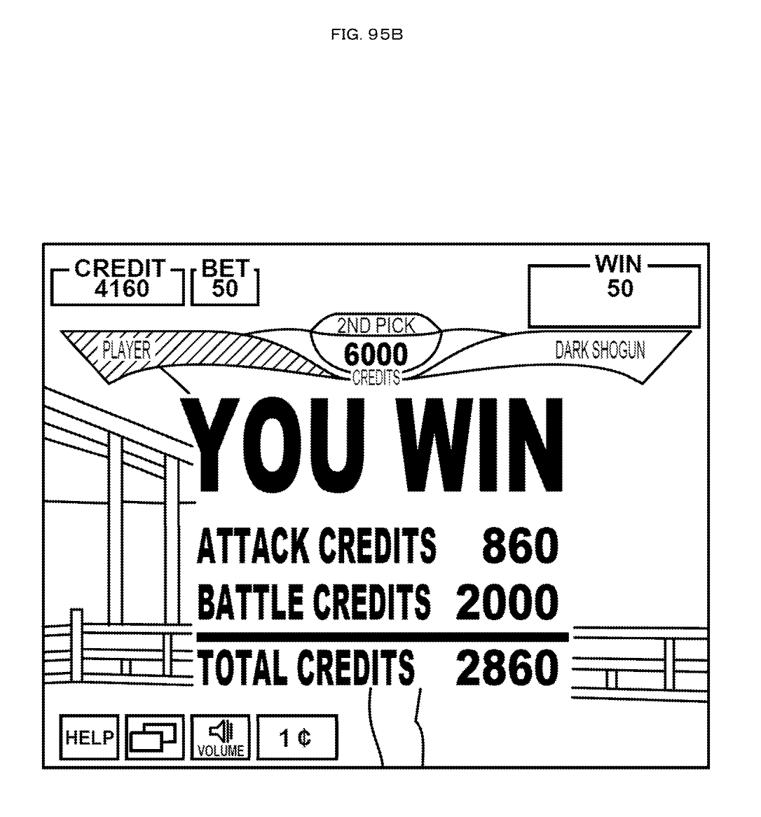

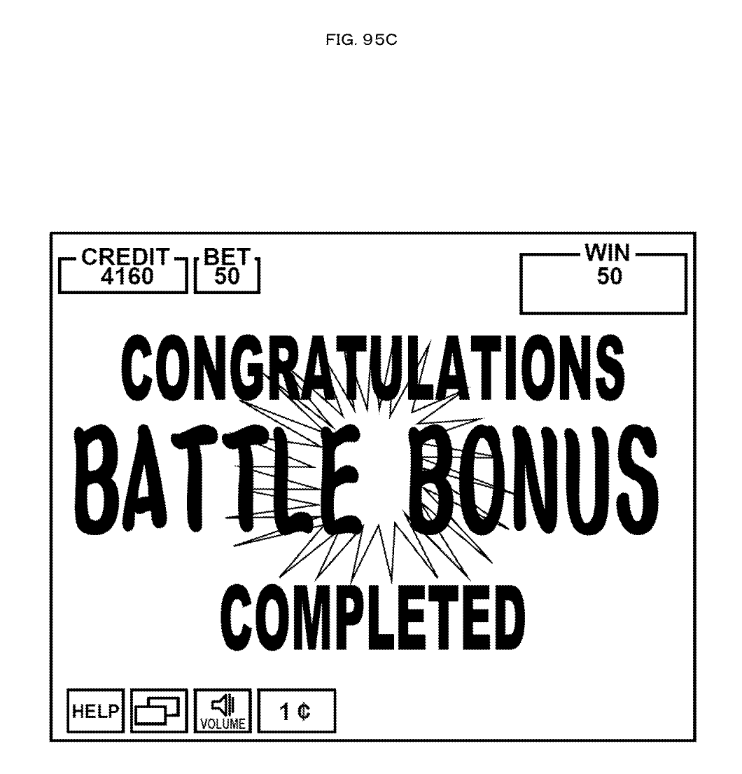

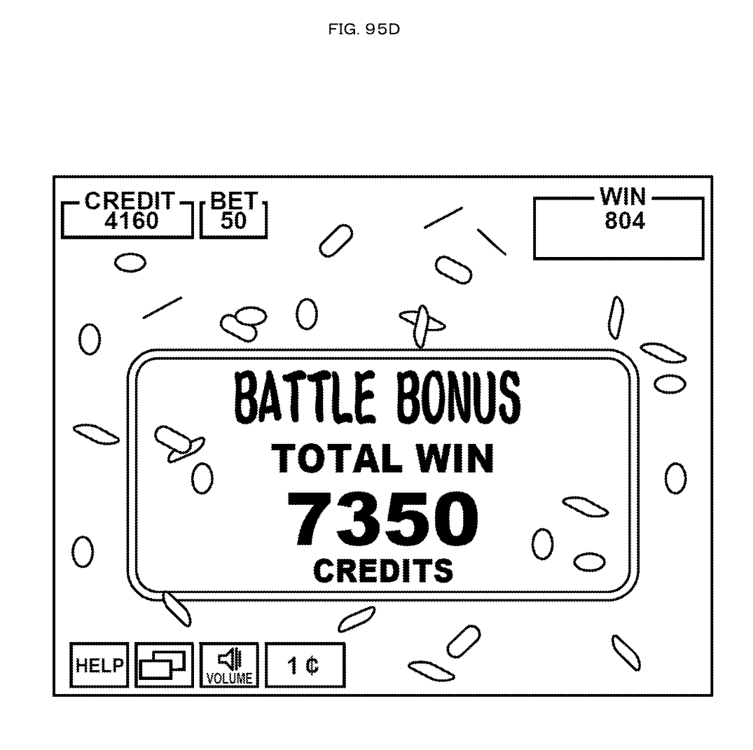

FIG. 95A is a diagram illustrating an example of an image displayed in the battle bonus process;

FIG. 95B is a diagram illustrating an example of an image displayed in the battle bonus process;

FIG. 95C is a diagram illustrating an example of an image displayed in the battle bonus process;

FIG. 95D is a diagram illustrating an example of an image displayed in the battle bonus process.

### DETAILED DESCRIPTION OF THE PREFERRED EMBODIMENT

### Outline of Gaming Machine of the Present Embodiment

FIG. 1A is a diagram illustrating an outline of a configuration of a gaming machine according to the present embodiment.

The gaming machine according to the present embodiment includes:

a display (for example, the later-described lower display device 141 (lower liquid crystal panel 141b) or the like) for sequentially displaying a plurality of moving body objects;

an input device (for example, the later-described lower touch panel 141a or the like) for detecting an operation by a player; and

a controller (for example, the later-described main CPU 71 or the like) for controlling the display and the input device, and

the controller is programmed to execute processes described below:

a process (A-1-1) in which when a predetermined operation is performed via the input device to each of the plurality of moving body objects displayed on the display, a predetermined payout is added, and when the predetermined operation is not performed, the payout is not added (for example, the later-described step S2317 to step S2323); and

a process (A-1-2) in which when the last moving body object among the plurality of moving body objects is displayed on the display and the payout added in the process (A-1-1) is smaller than a predetermined credit, a shortage is settled (for example, the later-described processes at step S2329, step S2429, and the like).

It is preferable that the moving body objects are objects of living creatures such as human beings and animals and living creature-like objects such as a variety of characters.

Images of the plurality of moving body objects are sequentially displayed on the display. It is preferable that some moving body objects of the plurality of moving body objects are gradually displayed. The number of moving body objects to be displayed at one time is not limited.

It is only required for the input device to be a device capable of detecting an operation by a player. In particular, a device allowing a player to easily operate the moving body objects displayed on the display is preferable.

A player operates via the input device the moving body objects displayed on the display. When the operation by a player is the predetermined operation, the predetermined payout is added. For example, in addition to an operation of attacking a moving body object, the predetermined operation can be an operation of defending against a moving body object, an operation of moving a moving body object, and an operation of accelerating a moving body object. In addition, the predetermined operation may be an operation of changing a color of a moving body object or of changing a size thereof.

As described above, although the operation to the moving body object may be any operation, it is determined whether or not the operation to the moving body object is an appropriate operation. When the operation thereto is the appropriate operation, the predetermined payout is added.

When the operation by a player is not the predetermined operation, the predetermined payout is not added. The payout is not added, thereby maintaining the payout. It is to be noted that when the operation by a player is not the predetermined operation, the payout may be reduced. Thus, a feeling of tension can be further provided for a player.

The plurality of moving body objects includes the last moving body object to be displayed last and the moving body objects to be displayed prior to displaying the last moving body object. The above-described process (A-1-1) is conducted for each of the moving body objects to be displayed prior to displaying the last moving body object. When the last moving body object is displayed on the display, in a case where the operation to each of the moving body objects to be displayed prior to displaying the last moving body object is insufficient, there may be a case where the payout added in the process (A-1-1) is smaller than the predetermined credit. In such a case, the shortage is settled when the last moving body object is displayed on the display.

Even in a case where a user has not performed the predetermined operation and therefore, any shortage is caused in the payout and the inconsistency with the internal process is thereby caused, the shortage is settled, thus allowing the consistency with the result of the internal process to be made.

Further, in the gaming machine according to the present embodiment,

the plurality of moving body objects includes a plurality of a first kind of moving body objects (for example, the later-described enemy characters which appear one after another, or the like) and a second kind of a moving body object (for example, the later-described last one enemy character or the like),

the controller executes:

a process (A-2-1) in which a first credit provided for a player with respect to each of all of the plurality of the first kind of the moving body objects is determined as the predetermined credit by a drawing process (for example, the later-described process at step S2213 and the like); and

a process (A-2-2) in which a second credit provided for a player with respect to the second kind of the moving body object is determined by a drawing process (for example, the later-described process at step S2415 and the like), and

the process (A-1-1) is a process (A-1-1-1) in which when a predetermined operation is performed via the input device to each of the first kind of the moving body objects displayed on the display, a predetermined payout is added, and when the predetermined operation is not performed, the payout is not added (for example, the later-described processes at step S2317 to step S2323),

the process (A-1-2) is a process (A-1-2-1) in which when the second kind of the moving body object is displayed as the last moving body object, in a case where the payout added in the process (A-1-1-1) is smaller than the first credit, a settlement is made based on a shortage, the payout added in the process (A-1-1-1), and the second credit (for example, the later-described process at step S2429 and the like).

The plurality of moving body objects includes the plurality of the first kind of the moving body objects and the second kind of the moving body object. These moving body objects may be the same as or different from one another in the appearance or form. When the appearance or form of each of the moving body objects is the same, it is only required that a player can visually recognize that the moving body objects are different from one another, by making the motions thereof different from one another or making positions where the moving body objects are displayed or sizes which the moving body objects have different from one another. It is to be noted that the number of the second kind of the moving body object may be single or plural.

The first credit provided for a player with respect to each of all of the plurality of the first kind of the moving body objects is determined by the drawing process. The first credit is determined for each of all of the plurality of the first kind of the moving body objects.

The second credit provided for a player with respect to the second kind of the moving body object is determined by the drawing process. As described above, the number of the second kind of the moving body object may be single or plural, and when there are the plurality of the second kind of the moving body objects, the second credit is determined for each of all of the plurality of the second kind of the moving body objects.

When the predetermined operation is performed to each of the first kind of the moving body objects, the predetermined payout is added. In addition to the operation of attacking each of the first kind of the moving body objects, the predetermined operation can be the operation of defending against the first kind of the moving body objects, the operation of moving the first kind of the moving body objects, and the operation of accelerating the first kind of the moving body objects. In addition, the predetermined operation may be the operation of changing the color of the first kind of the moving body objects or of changing the size thereof.

As described above, although the operation to each of the first kind of the moving body objects may be any operation, it is determined whether or not the operation to each of the first kind of the moving body objects is the appropriate operation. When the operation to is the appropriate operation, the predetermined payout is added.

When the second kind of the moving body object is displayed on the display, in a case where the operation to the first kind of the moving body objects is insufficient, there may be a case where the payout added in the process (A-1-1-1) is smaller than the predetermined credit. In such a case, the shortage is settled when the second kind of the moving body object is displayed on the display.

The shortage is paid out together when the payout corresponding to the operation with respect to the second kind of the moving body object is paid out, thereby allowing effects, by which a player hardly recognizes that the process is to settle the inconsistency with the result of the internal process, to be executed. The second credit is determined by the drawing process, thereby allowing the second credit to be hardly predicted and enabling that a player further hardly recognizes that the process is to settle the inconsistency.

Further, in the gaming machine according to the present embodiment,

the process (A-2-1) is a process (A-3-1) in which the first credit and the total number of the plurality of the first kind of the moving body objects are determined by a drawing process (for example, the later-described process at S2213 or the like).

The first credit and the total number of the plurality of the first kind of the moving body object are determined, thereby allowing the first credit and the total number of the first kind of the moving body objects to be each made different as a result of the game each time the game is executed and thus enabling the development of the game to be diversified.

Further, in the gaming machine according to the present embodiment,

the process (A-1-1-1) includes:

a process (A-4-1) in which a number of the first kind of the moving body objects to be displayed on the display among the plurality of the first kind of the moving body objects is determined by a drawing process (for example, the later-described process at S2215 or the like); and

a process (A-4-2) in which the first kind of the moving body objects whose number is determined in the process (A-4-1) are displayed at a predetermined timing on the display (for example, the later-described processes at step S2313 and S2315).

Since a part of the first kind of the moving body objects among the plurality of the first kind of the moving body objects are sequentially displayed on the display, it is needed for a player to perform an operation for each of the first kind of the moving body objects displayed one after another, thereby allowing a feeling of tension to be enhanced. The first kind of the moving body objects displayed one after another are determined by the drawing, thereby allowing the number of the first kind of the moving body objects displayed one after another to be hardly predicted and enabling a feeling of tension to be further enhanced.

Further, (A-5-1) it is preferable that in accordance with the number of the first kind of the moving body objects, positions where the first kind of the moving body objects are displayed on the display are determined by a drawing process.

Not only the number of the first kind of the moving body objects but also the positions where the first kind of the moving body objects are displayed are determined by the drawing processes, thereby allowing the numbers and the positions of the first kind of the moving body objects to be made different from one another and enabling the development of the games to be made different from one another.

FIG. 1B is a diagram illustrating an outline of the gaming machine according to the present embodiment.

A gaming machine according to the present embodiment includes:

a display (for example, the later-described lower display device 141 (lower liquid crystal panel 141b) or the like) for displaying a first moving body object and a second moving body object;

an input device (for example, the later-described lower touch panel 141a or the like) for detecting an operation by a player; and

a controller (for example, the later-described main CPU 71 or the like) for controlling the display and the input device, and

the controller is programmed to execute processes described below:

a process (B-1-1) in which a plurality of choices, in each of which the content of fighting between the first moving body object and the second moving body object is assigned, are displayed on the display so as not to allow a player to recognize the content of the fighting (for example, the later-described process at step S2613 or the like);

a process (B-1-2) in which when one choice among the plurality of choices is selected by a player, the content of the fighting assigned in the one choice is displayed so as to allow a player to recognize the content thereof (for example, the later-described process at step S2616); and

a process (B-1-3) in which based on the content of the fighting assigned in the one choice, a view in which the first moving body object and the second moving body object fight is displayed (for example, the later-described processes at step S2713 and step S2813 or the like).

It is preferable that the first moving body object and the second moving body object are objects of living creatures such as human beings and animals and living creature-like objects such as a variety of characters.

Images of the plurality of moving body objects are sequentially displayed on the display. It is preferable that some moving body objects of the plurality of moving body objects are gradually displayed.

The number of moving body objects to be displayed at one time is not limited.

It is only required for the input device to be a device capable of detecting an operation by a player. In particular, a device allowing a player to easily operate the choices displayed on the display is preferable.

On the display, the plurality of choices are displayed. In each of the plurality of choices, the content of the fighting between the first moving body object and the second moving body object is assigned. The contents of the fighting assigned in the choices may be different from one another or a part of the contents of the fighting assigned in the choices may be the same. It is preferable that the assignment of the content of the fighting in each of the choices is randomly determined by a drawing process or the like.

Initially, when the plurality of choices are displayed on the display, the plurality of choices are displayed so as not to allow a player to recognize the content of the fighting. For example, in a case where images of the choices are images of cards, initially, images of the cards are displayed face up.

A player operates the input device and thereby can select one choice among the plurality of choices. When the one choice among the plurality of choices is selected by a player, the content of the fighting assigned in the one choice is displayed so as to allow a player to recognize the content of the fighting. It is to be noted that it is preferable that not only the content assigned in the one choice but also the contents assigned in all of the plurality of choices are displayed so as to allow a player to recognize the contents assigned in all of the plurality of choices. The contents assigned in all of the plurality of choices are made visually recognizable by a player, thereby allowing a player to feel that the game is fair.

In particular, it is preferable that first, the content of the choice selected by a player is made visually recognizable and thereafter, a little later, the contents of the remaining choices are made visually recognizable. Thus, a feeling of expectation of a player can be satisfied and fairness of the game can be shown.

Based on the content of the fighting assigned in the one choice selected by a player, the view in which the first moving body object and the second moving body object fight is displayed. Thus, it is made possible to recognize a player that the fighting is conducted by the operation by a player.

Since a player selects the one choice among the plurality of choices, the content of the fighting is determined by the operation by a player and the fighting progresses, thereby allowing a player to actively participate in the game and enabling a player to hardly get bored.

Further, in the gaming machine according to the present embodiment,

the content of the fighting includes information pertinent to an attacking side of the first moving body object and the second moving body object and to an attacking strength of the attacking side, and

the process (B-1-3) includes:

a process (B-2-1) in which based on the attacking side, a pattern of attacking by the attacking side is determined (for example, the later-described processes in FIG. 29 or FIG. 30 or the like); and

a process (B-2-2) in which when the first moving body object attacks the second moving body object, a view in which after fighting in the pattern of attacking, the first moving body object wins is displayed (for example, the later-described process at step S2713 or the like), and when the second moving body object attacks the first moving body object, a view in which after fighting in the pattern of attacking, the second moving body object wins is displayed (for example, the later-described process at step S2813 or the like).

The content of fighting include the information pertinent to the attacking side and the attacking strength of the attacking side. When the first moving body object is the attacking side, the second moving body object is a defending side and the first moving body object attacks the second moving body object. An attacking strength in this case is an attacking strength which the first moving body object has. When the second moving body object is the attacking side, the first moving body object is a defending side and the second moving body object attacks the first moving body object. An attacking strength in this case is an attacking strength which the second moving body object has.

The pattern of attacking shows, for example, information that the attacking is singly attacking or combo attacking with which the attacking is performed at a plurality of times. In addition, in the pattern of attacking, differences in techniques of attacking and the like are also included.

In the fighting, either case of the case where the first moving body object attacks the second moving body object (the case of attacking) and the case where the second moving body object attacks the first moving body object (the case of defending) can be determined by the selection by a player, thereby allowing a feeling of tension to be imparted to the progress of a game.

Further, in the gaming machine according to the present embodiment,

the process (B-1-3) further includes:

a process (B-3-1) in which when the first moving body object attacks the second moving body object, a physical strength of the second moving body object is decreased in accordance with the attacking strength (for example, the later-described process at step S2715 or the like), and when the second moving body object attacks the first moving body object, a physical strength of the first moving body object is decreased in accordance with the attacking strength (for example, the later-described process step S2815 or the like);

a process (B-3-2) in which being superimposed on the display of the fighting in the process (B-2-2), information indicating the attacking strength is displayed (for example, the later-described processes step S2713 and S2813 or the like); and

a process (B-3-3) in which a payout based on the pattern of attacking is added (for example, the later-described step process at S2919 or the like).

The physical strength is gradually decreased by the attacking strength assigned in the choice selected by a player, thereby allowing a feeling of tension to be imparted to a player when a player selects any choice.

Further, in the gaming machine according to the present embodiment,

the second moving body object is composed of a plurality of kinds of second moving body objects whose attacking strengths are different from one another, and

the process (B-1-3) further includes:

a process (B-4-1) in which when a physical strength of a first kind of the second moving body object among the plurality of kinds of the second moving body objects comes to be zero, the first kind of the second moving body object is changed to a second kind of the second moving body object whose attacking strength is higher than that of the first kind of the second moving body object, and the changed kind of the second moving body object and the first moving body object fight (for example, the later-described process at step S2723 or the like); and

a process (B-4-2) in which the process (B-4-1) is repeatedly executed, the kind of the second moving body object is sequentially changed, and when each of physical strengths of all of the plurality of kinds of the second moving body objects comes to be zero, the game is finished (for example, the later-described process at step S2721 or the like).

Upon defeating the second moving body object, each of the second moving body objects whose attacking strengths are high sequentially appears, thereby allowing a feeling of tension and a feeling of expectation of a player to be gradually enhanced.

Further, in the gaming machine according to the present embodiment,

a payout based on the attacking strength is assigned to each of the plurality of kinds of the second moving body objects, and

the process (B-1-3) further includes

a process (B-5-1) in which when a physical strength of each of the second moving body objects comes to be zero, a payout assigned to each of the second moving body objects is added (for example, the later-described process at step S2719 or the like).

Upon defeating the second moving body object, the payout based on the attacking strength is added, thereby allowing a feeling of expectation of a player to be enhanced.

<<<Concept and Others>>>

A slot machine 10 is a kind of a gaming machine. In the present embodiment, the slot machine 10 is described as one example of the gaming machine. However, the present invention is not limited thereto. The slot machine 10 has a base game mode and a feature game mode. The slot machine 10 may be an apparatus in which a game in any base game mode is independently executed and a game mode is developed from the base game mode to the feature game mode. The feature game mode may be other game mode which is different from the base game mode.

A game executed in the base game mode in the present embodiment is executed on the slot machine 10. In the present embodiment, the game in the base game mode is referred to as a base game. The base game is a slot game in which a plurality of symbols are rearranged. The base game is a game whose concept is opposed to that of the feature game.

Specifically, the rearrangement of the symbols in the slot game is realized by five video reels 3a to 3e which are capable of varying and stopping. The rearranged symbols are displayed in a manner in which the symbols are stopped in a symbol display region 141d of a lower display device 141 (lower liquid crystal panel 141b).

A state of the rearrangement means a state in which after the arrangement of symbols has been released, symbols are again arranged in the symbol display region 141d. By initiating the unit game (slot game), the arrangement of symbols is released, and thereafter, symbols are again arranged (rearranged), and based on the rearranged symbols, an outcome of the unit game is determined, thereby finishing the unit game. A state of the “arrangement” means a state in which a player can visually confirm the symbols.

The base game mode is a game mode in which a unit game (base game), in which on the condition that a gaming value is bet, a plurality of symbols are rearranged in the symbol display region 141d and a normal payout in accordance with the rearranged symbols is paid out, is executed. The game in the base game mode is not limited to the slot game and may be a game which can be independently executed on a game terminal (gaming machine) such as the slot machine 10.

Upon initiating the unit game, five to-be-stopped symbols are determined by a drawing process. One symbol to be stopped with respect to each of the five video reels 3a to 3e is determined. Subsequently, the rearrangement of the plurality of symbols is once released. The rearrangement of the plurality of symbols is released, and the symbols are thereby displayed in a varying manner (the later-described scrolling display of symbol arrays). After the elapse of a predetermined period of time, the symbols to be stopped are displayed in a stopped manner in predetermined positions. By displaying the five to-be-stopped symbols in the stopped manner, the plurality of symbols are rearranged in the symbol display region 141d. By rearranging the plurality of symbols, an outcome of the unit game is displayed in the symbol display region 141d. In the present embodiment, the displaying of the symbols in the stopped manner is synonymous with the appearing and the rearrangement of the symbols.

The feature game mode is a game mode which is different from the base game mode and may be a game mode in which a larger profit than in the base game mode is likely to be obtained. The game in the feature game mode can be a game in which a plurality of kinds of slot games are combined. For example, a game mode in which a gaming value can be obtained at a higher probability than in the base game mode may be realized singly or in combination.

In the slot machine 10 according to the present embodiment, as the feature game mode, there are a variety of game modes, in each of which the determination is made by a wheel drawing. Specifically, in the feature game mode, there are a slash bonus mode, a battle bonus mode, a pick bonus mode, and a free game mode, and there are a small credit payout, a middle credit payout, and an extra-large credit payout. These kinds of the game modes will be described later.

As one example of a game in the feature game mode, there is a game (free game) in the free game mode. For example, the free game can be a game in which the unit game is repeated.

It is only required for the above-described symbols to be symbols which are rearranged in the symbol display region 141d so as to be viewable by a player, and kinds and numbers thereof are not limited. The symbols include specific symbols and normal symbols. There may be a case where the specific symbols are added to the normal symbols as needed.

For example, the specific symbols include wild symbols (for example, the later-described symbols of WILD or the like) and trigger symbols (for example, the later-described symbols of BONUS or the like). The wild symbols can serve as substitute symbols as other kinds of symbols. The wild symbols are replaced with other symbols so as to establish an advantageous winning pattern. The trigger symbols are symbols which serve as a trigger which shifts the game mode from the base game mode to the feature game mode. In addition, the trigger symbols may be symbols which serve as a retrigger which maintains the feature game mode (free game mode).

In the feature game mode, the gaming machine may have a function with which the specific symbols of at least one of: the trigger symbols; and the wild symbols are increased. In addition, in the feature game mode, the trigger symbols may have a function with which the number of games is increased.

In the present embodiment, as the symbols, there are WILD (wild symbols), SHOGUN, SAMURAI, SOLDIER, CLAW, NINJA_STAR, KNIFE, WIND, FOREST, FIRE, MOUNTAINF, BONUS (trigger symbols), and F_BONUS (retrigger symbols). The symbols WILD, BONUS, and F_BONUS are the specific symbols, and the symbols SHOGUN, SAMURAI, SOLDIER, CLAW, NINJA_STAR, KNIFE, WIND, FOREST, FIRE, and MOUNTAIN are the normal symbols.

The gaming value is coins, bills, or electrical valuable information corresponding to these. The gaming value in the present embodiment is not particularly limited, and for example, may be gaming media such as medals, a token, electronic money, and a ticket. The ticket is not particularly limited, and for example, may be the-later-described ticket with a barcode and the like.

<<<<Specific Outline of Slot Machine of the Present Embodiment>>>>

An outline of a slot machine of the present embodiment is as described below. The details thereof will be described later.

The slot machine 10 has five video reels 3a, 3b, 3c, 3d, and 3e. The five video reels 3a, 3b, 3c, 3d, and 3e are displayed by images on a lower liquid crystal display panel 141b of a lower display device 141. Along a longitudinal direction of each of the five video reels 3a to 3e, a plurality of symbols are arranged. The plurality of symbols arranged on each of the five video reels 3a to 3e are displayed by images.

One reel strip (one symbol array) is constituted of the plurality of symbols arranged on each of the video reels. As described above, since the plurality of symbols are displayed by the images, the reel strips in the present embodiment are virtual and are arrays of symbols, in each of which the plurality of symbols are arranged in a column state. The images of the plurality of symbols are displayed in the column state, thereby allowing one reel strip to be displayed as one video reel on the lower liquid crystal display panel 141b. The five reel strips (five symbol arrays) are constituted of the five video reels 3a to 3e. In the present embodiment, the reel strips are synonymous with symbol arrays, and the five reel strips and the plurality of reel strips are collectively referred to as a group of reel strips. The video reels 3a to 3e are displayed in the varying manner (displayed in the scrolling manner) and are displayed in the stopped manner, whereby scroll lines of the symbol arrays are configured.

As described above, in the present embodiment, there are two kinds of game modes, the base game mode and the feature game mode. Further, in the feature game mode, there are the slash bonus mode, the battle bonus mode, the pick bonus mode, and the free game mode, and there are the small credit payout, the middle credit payout, and the extra-large credit payout. In this way, in the feature game mode, the free game mode is included.

In the present embodiment, five reel strips used in each of the base game mode and the free game mode are different from each other. As described later, those shown in FIG. 9 to FIG. 11 are the five reel strips used in the base game mode. In the present embodiment, the five reel strips used in the base game mode are referred to as Reel Strip Base Game. Those shown in FIG. 12 to FIG. 14 are the five reel strips used in the free game mode. In the present embodiment, the five reel strips used in the free game mode are referred to as Reel Strip Free Game.

In the symbol display region 141d of the slot machine 10, 30 paylines are formed. The 30 paylines are fixed, irrespective of any BET. In other words, in each of the unit games, all of the 30 paylines are invariably activated. Accordingly, even when the number of BETs per one line is one, the total number of BETs are 30 and consumed.

In the present embodiment, in addition to the 30 paylines, there are 20 additional paylines. Accordingly, in the present embodiment, when the number of BETs per line is one, the total number of BETs is 50 (=1×(30+20)). When the number of BETs per line is two, the total number of BETs is 100 (=2×(30+20)). When the number of BETs per line is three, the total number of BETs is 150 (3×(30+20)). When the number of BETs per line is five, the total number of BETs is 250 (5×(30+20)). When the number of BETs per line is 10, the total number of BETs is 500 (=10×(30+20)).

The above-described pattern of the number of BETs per line is a pattern of 1, 2, 3, 5, and 10. However, the present invention is not limited thereto, and the pattern can be a pattern of 1, 2, 3, 4, and 5; a pattern of 1, 2, 5, 10, and 15; a pattern of 1, 2, 5, 10, and 20; or the like.

As described above, as the kinds of the symbols in the present embodiment, there are WILD (wild symbols), SHOGUN, SAMURAI, SOLDIER, CLAW, NINJA_STAR, KNIFE, WIND, FOREST, FIRE, MOUNTAIN, BONUS (trigger symbols), and F_BONUS (retrigger symbols) (refer to FIG. 8).

The symbols of WILD are symbols to be replaced with other symbols when a winning pattern along a payline is determined. The symbols of WILD are replaced with symbols other than symbols of BONUS so as to establish an advantageous winning pattern, and the winning pattern is determined. In the slot machine 10 according to the present embodiment, the symbols of WILD are present on all of the video reels 3a to 3e.

The symbols of BONUS and F_BONUS are scatter symbols. Irrespective of the 30 paylines, when it is determined by a symbol drawing process that a predetermined number of the symbols of BONUS and F_BONUS, for example, three symbols of BONUS and F_BONUS appear in the symbol display region 141d, a winning pattern is established. For example, when it is determined that two symbols of BONUS appear on the video reel 3a and one symbol of BONUS appears on the video reel 3d in the symbol display region 141d, the winning pattern is established.

The winning pattern by the symbols of BONUS is established, thereby triggering the feature game mode. The winning pattern by the symbols of BONUS is established only in the base game mode and is not established in the feature game mode. The feature game mode is triggered, thereby shifting the game mode from the base game mode to the feature game mode.

The winning pattern by the symbols of F_BONUS is established, thereby retriggering the free game mode. The winning pattern by the symbols of F_BONUS is established only in the free game mode and is not established in the base game mode. The free game mode is retriggered, thereby maintaining the free game mode.

In the slot machine 10 according to the present embodiment, the symbols of BONUS and F_BONUS are present on all of the video reels 3a to 3e.

<<Overall Game System>>

FIG. 2 is a diagram illustrating an outline of a game system including slot machines 10.

A game system 25 includes a plurality of slot machines 10 and an external control device 20 that is connected to each of the slot machines 10 through a communication line 22.

The external control device 20 is for controlling the plurality of slot machines 10. In the present embodiment, the external control device 20 is a so-called hall server which is installed in a game facility having the plurality of slot machines 10. Each of the slot machines 1 is provided with a unique identification number, and the external control device 20 identifies transmission sources of data transmitted from the respective slot machines 10 by using the identification numbers. Also in the case where the external control device 20 transmits data to a slot machine 10, the identification numbers are used for specifying the transmission destination.

It is to be noted that the game system 25 may be constructed within a single game facility where various games can be conducted, such as a casino, or may be constructed among a plurality of game facilities. Further, when the game system 25 is constructed in a single game facility, the game system 25 may be constructed in each floor or section of the game facility. The communication line 22 may be a wired or wireless line, and can adopt a dedicated line, an exchange line, or the like.

<<<Configuration of Slot Machine 10>>>

FIG. 3 is a diagram illustrating an overall configuration of a slot machine 10 according to the present embodiment.

A coin, a bill, or electrically valuable information corresponding to these is used as a game medium in the slot machine 10. Further, in the present embodiment, a later-described ticket with a barcode is also used. It is to be noted that the game medium is not limited to these, and for example a medal, a token, electric money, or the like can be adopted.

The slot machine 10 includes a cabinet 11, a top box 12 installed on the upper side of the cabinet 11, and a main door 13 provided at the front face of the cabinet 11.

<Lower Display Device 141>

A lower display device 141 is provided at the center of the main door 13. The lower display device 141 includes a lower liquid crystal display panel 141b, and forms the display. The lower display device 141 has a symbol display region 141d. In the symbol display region 141d, five video reels 3a, 3b, 3c, 3d, and 3e are displayed. In the present embodiment, a video reel depicts through videos the rotational and stop motions of a mechanical reel having a plurality of symbols drawn on the peripheral surface thereof. To each of the video reels 3a, 3b, 3c, 3d, and 3e, a symbol any comprised of a previously determined plurality of symbols is assigned (refer to FIG. 9 to FIG. 14 which are described later).

In the present embodiment, in the symbol display region 141d, as stop positions 28 for symbols of each of the video reels 3a to 3e, four regions which are an uppermost row (first row), an upper middle row (second row), a lower middle row (third row), and a lowermost row (fourth row) are defined. Accordingly, when the five video reels 3a to 3e (five reel strips) are displayed in a stopped manner, the total of 20 symbols, which is calculated by 5 reels×4 rows (5 columns×4 rows), appear (are displayed in the stopped manner) in the symbol display region 141d. Upon initiating a unit game, the five video reels 3a to 3e start varying. Thereafter, after the elapse of a predetermined period of time, the five video reels 3a to 3e are displayed in the stopped manner. This causes the 20 symbols to appear (to be displayed in the stopped manner) in the symbol display region 141d, thereby rearranging the symbols. In other words, each time a unit game is played, symbols are rearranged in the symbol display region 141d and an outcome of the unit game is displayed.

In the present embodiment, paylines are formed by lines formed by connecting the stop positions 28 in the four regions which are the uppermost row (first row), the upper middle row (second row), the lower middle row (third row), and the lowermost row (fourth row). FIG. 7 is a table showing the 30 paylines adopted in the slot machine 10 according to the present embodiment. These 30 paylines will be described later. It is to be noted that a specific form of each of the paylines can be arbitrarily adopted.

The symbol display region 141d has a number-of-credits display region and a number-of-payouts display region (refer to FIG. 59A to FIG. 95D) In the number-of-credits display region, the number of coins which a player has and is deposited inside of the slot machine 10 (hereinafter, referred to as the number of credits) is displayed. In addition, in the number-of-payouts display region, the number of coins to be paid out to a player when a winning pattern is established (hereinafter, referred to as the to-be-paid-out number) is displayed.

The number-of-credits display region displays the total number of credits. An initial value is zero. The value is increased or decreased by inputting of a gaming value, placing of any BET, and an outcome of a game.

On the other hand, below the symbol display region 141d, a help touch button, a language switching touch button, a volume switching touch button, a denomination button, a number-of-lines selection touch button, and a bet-per-line selection touch button are displayed. These buttons are located from a left end to a right end, viewed from a player. By pressing the later-described lower touch panel 141a, a player can operate these buttons.

Upon touching the help touch button, a help screen is displayed. The help touch button is darkened while being inactive, for example, while the reels are rotating. The help touch button is displayed while a normal screen is displayed.

Upon touching the language switching touch button, a language is switched between English and Chinese. The language switching touch button is active only during advertising and is darkened while being inactive, for example, while the reels are rotating.

The volume switching touch button is to switch a game volume in three stages, and each time the volume switching touch button is touched, the game volume is switched in a manner of a small volume→a middle volume→a large volume→a small volume→a middle volume . . . . The volume switching touch button is displayed while the normal screen is displayed.

The denomination button is to display a current denomination which is set with an audit screen. The denomination button is displayed while a screen other than the audit screen is displayed. In the present embodiment, the denomination can be set in a range of 0.01 dollar to 10 dollars. It is to be noted that the denomination of 0.01 dollar is recommended.

The number-of-lines selection touch button is used when the number of the paylines is increased or decreased.

The bet-per-line selection touch button is to allow a bet per line to be selected, and upon touching the bet-per-line selection touch button, five selection buttons related to a current bet configuration appear.

On a front face of the lower display device 141, a lower touch panel 141a is provided so as to be superposed on the lower liquid crystal panel 141b. By pressing the lower touch panel 141a, a player can input a desired instruction in accordance with an image displayed on the lower liquid crystal panel 141b. An input signal is transmitted from the lower touch panel 141a to a main CPU 71.

<Control Panel 30>

In addition, as shown in FIG. 3 and FIG. 4, below the lower display device 141, a variety of buttons located on a control panel 30 (input device), a coin entry 36 for accepting coins into a coin cabinet 11, and a bill entry 115 are provided.

On the control panel 30, a CHANGE button 31, a CASHOUT/TAKE WIN button 32, and a HELP button 33 are located in an upper section of a left side thereof, and a 1-BET button 34, a 2-BET button 35, a 3-BET button 37, a 4-BET button 38, a 5-BET button 39, a PLAY 2 LINES button 40, a PLAY 10 LINES button 41, a PLAY 20 LINES button 42, a PLAY 30 LINES button 43, and a GAMBLE button 44 are located in a lower section of the left side thereof. In addition, the coin entry 36 and the bill entry 115 for accepting bills or the like are located in an upper section of a right side thereof, and a MAX-BET button 45 and a spin button 46 are located in a lower section of the right side thereof.

The CHANGE button 31 is an operation button used upon leaving his or her seat or requesting exchange from a gaming house employee. The CASHOUT/TAKE WIN button 32 is an operation button used upon settling coins (credits) deposited inside of the slot machine 10. The HELP button 33 is a button pressed when a way of operating a game and the like are not known, and upon pressing the HELP button 33, a variety of pieces of help information are displayed on the upper display device 131 and the lower display device 141.

As described above, a pattern of the number of BETs per line can be changed. In accordance with a pattern of the number of BETs, assignment of the 1-BET button 34 to 5-BET button 39 and the MAX-BET button 45 can be set as described below.

When a pattern of the number of BETs per line is a pattern of 1, 2, 3, 5, and 10, the assignment is as described below. The 1-BET button 34 becomes a button for initiating a unit game with one BET with respect to each of the paylines. The 2-BET button 35 becomes a button for initiating a unit game with two BETs with respect to each of the paylines. The 3-BET button 37 becomes a button for initiating a unit game with three BETs with respect to each of the paylines. The 4-BET button 38 becomes a button for initiating a unit game with five BETs with respect to each of the paylines. The 5-BET button 39 becomes a button for initiating a unit game with 10 BETs with respect to each of the paylines. The MAX-BET button 45 becomes a button for initiating a unit game with 500 BETs with respect to each of the paylines.

When a pattern of the number of BETs per line is a pattern of 1, 2, 3, 4, and 5, the assignment is as described below. The 1-BET button 34 becomes a button for initiating a unit game with one BET with respect to each of the paylines. The 2-BET button 35 becomes a button for initiating a unit game with two BETs with respect to each of the paylines. The 3-BET button 37 becomes a button for initiating a unit game with three BETs with respect to each of the paylines. The 4-BET button 38 becomes a button for initiating a unit game with four BETs with respect to each of the paylines. The 5-BET button 39 becomes a button for initiating a unit game with five BETs with respect to each of the paylines. The MAX-BET button 45 becomes a button for initiating a unit game with 250 BETs with respect to each of the paylines.

When a pattern of the number of BETs per line is a pattern of 1, 2, 5, 10, and 15, the assignment is as described below. The 1-BET button 34 becomes a button for initiating a unit game with one BET with respect to each of the paylines. The 2-BET button 35 becomes a button for initiating a unit game with two BETs with respect to each of the paylines. The 3-BET button 37 becomes a button for initiating a unit game with five BETs with respect to each of the paylines. The 4-BET button 38 becomes a button for initiating a unit game with 10 BETs with respect to each of the paylines. The 5-BET button 39 becomes a button for initiating a unit game with 15 BETs with respect to each of the paylines. The MAX-BET button 45 becomes a button for initiating a unit game with 750 BETs with respect to each of the paylines.

When a pattern of the number of BETs per line is a pattern of 1, 2, 5, 10, and 20, the assignment is as described below. The 1-BET button 34 becomes a button for initiating a unit game with one BET with respect to each of the paylines. The 2-BET button 35 becomes a button for initiating a unit game with two BETs with respect to each of the paylines. The 3-BET button 37 becomes a button for initiating a unit game with five BETs with respect to each of the paylines. The 4-BET button 38 becomes a button for initiating a unit game with 10 BETs with respect to each of the paylines. The 5-BET button 39 becomes a button for initiating a unit game with 20 BETs with respect to each of the paylines. The MAX-BET button 45 becomes a button for initiating a unit game with 1000 BETs with respect to each of the paylines.

Accordingly, by pressing each of the 1-BET button 34, the 2-BET button 35, the 3-BET button 37, the 4-BET button 38, the 5-BET button 39, and the MAX-BET button 45, the number of BETs to be bet on one line of the paylines is determined.

The PLAY 2 LINES button 40 is a button for activating paylines when pressed. By pressing the PLAY 2 LINES button 40, the number of activated paylines comes to be “2”. The PLAY 10 LINES button 41 is a button for activating paylines when pressed. By pressing the PLAY 10 LINES button 41, the number of activated paylines comes to be “10”. The PLAY 20 LINES button 42 is a button for activating paylines when pressed. By pressing the PLAY 20 LINES button 42, the number of activated paylines comes to be “20”. The PLAY 30 LINES button 43 is a button for activating paylines when pressed. By pressing the PLAY 30 LINES button 43, the number of activated paylines comes to be “30”.

The GAMBLE button 44 is an operation button used upon shifting to a gamble game after finishing a slot game or the like. Here, the gamble game is a game played by using the obtained credit.

The spin button 46 is a button used upon starting scrolling of the video reels 3a to 3e.

The coin entry 36 is to accept coins into the coin cabinet 11. The bill entry 115 is to identify whether or not each bill is genuine and accepts genuine bills into the cabinet 11.

The upper display device 131 is provided at the front face of the top box 12. The upper display device 131 includes a liquid crystal panel, and forms the display. The upper display device 131 displays images related to effects and images showing introduction of the game contents and explanation of the game rules. Further, the top box 12 is provided with a speaker 112 and a lamp 111. The slot machine 10 produces effects by displaying images, outputting sounds, and outputting the light.

A ticket printer 120, a card slot 176, a data display 124, and a keypad 125 are provided on the lower side of the upper display device 131.

The ticket printer 120 prints on a ticket a barcode representing encoded data of the number of credits, date, the identification number of the slot machine 10, and the like, and outputs the ticket as the ticket 175 with a barcode. A player can make the slot machine 10 read the ticket 175 with a barcode so as to play a game thereon, and can also exchange the ticket 175 with a barcode with a bill or the like at a predetermined place (e.g. a cashier in a casino) in a game facility.

The card slot 176 is for inserting a card in which predetermined data is stored. For example, the card stores data for identifying a player, and data about the history of games played by a player. When the card is inserted into the card slot 176, the later-described IC card reader 60 reads data from the card or writes data into the card. It is to be noted that the card may store data corresponding to a coin, a bill or a credit.

The data display 124 includes a fluorescent display, LEDs and the like, and displays the data read by the IC card reader 60 or the data inputted by a player via the keypad 125, for example. The keypad 125 is for inputting an instruction and data related to ticket issuance or the like.

Although herein, the slot machine 10 according to the embodiment of the present invention is a type of a slot machine which controls the displaying of the video reels on the display, the slot machine 10 may be a type of a slot machine which displays symbols to a player by driving mechanical reels by using a stepping motor or the like.

<<Configuration of Circuitry Included in Gaming Machine>>

FIG. 5 a block diagram illustrating an internal configuration of the slot machine 10 according to the present embodiment.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a non-volatile memory, and stores a game program and a game system program. The game program includes a program related to game progression, a drawing program, and a program for producing effects by images and sounds (for example, refer to FIG. 15 to FIG. 38) which are described later). Further, the aforementioned game program includes data (refer to FIG. 9 to FIG. 14) specifying the configuration of the symbol array assigned to each video reel 3.

The drawing program is a program for determining the to-be stopped symbols of the five video reels 3a to 3e by a drawing. The data pertinent to three symbols, among symbols constituting the symbol arrays, displayed by the symbol display region 4 is determined for the to-be stopped symbols. Specifically, in a case of the video reel 3a, three symbols are determined as the to-be stopped symbols from the symbols constituting the video reel 3a. In a case of the video reel 3b, three symbols are determined as the to-be stopped symbols from the symbols constituting the video reel 3b. In a case of the video reel 3c, three symbols are determined as the to-be stopped symbols from the symbols constituting the video reel 3c. In a case of the video reel 3d, three symbols are determined as the to-be stopped symbols from the symbols constituting the video reel 3d. In a case of the video reel 3e, three symbols are determined as the to-be stopped symbols from the symbols constituting the video reel 3e.

It is to be noted that it is only required for the drawing program of the slot machine 10 according to the present embodiment to determine one symbol to be displayed in a predetermined region (for example, the middle row) of the symbol display region 4 as the to-be stopped symbol. In other words, the drawing program determines, as the to-be stopped symbol, one symbol to be displayed in the middle row of the symbol display region 4 with respect to each of the video reels 3a to 3e. Five symbols are determined as the to-be stopped symbols by this processing. It is to be noted that the drawing program determines code Nos. as the to-be stopped symbols with respect to the video reels 3a to 3e (refer to FIG. 9 to FIG. 14).

The above-mentioned drawing program includes symbol determination data. The symbol determination data is data that defines random values so that each of the symbols constituting the symbol array is determined at an equal probability, for each of the video reels 3a to 3e.

Further, the card slot 55 is configured so that the memory card 54 can be inserted thereinto and removed therefrom, and is connected to a motherboard 70 by an IDE bus.

The GAL 56 is a type of PLD (Programmable Logic Device) having a fixed OR any structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents of the game to be played on the slot machine 10 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like. The authentication program is a program (tamper check program) for authenticating the game program and the game system program. The pre-authentication program is a program for authenticating the aforementioned authentication program. The authentication program and the pre-authentication program are written along a procedure (authentication procedure) for proving that the program to be the subject has not been tampered.

The motherboard 70 is provided with a main CPU 71, a ROM 72, a RAM 73, and a communication interface 82.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted; and further, through the gaming board 50, processing of loading the game program and the game system program stored in the memory card 54 is started.

The RAM 73 stores data and programs which are used in operation of the main CPU 71. For example, when the processing of loading the aforementioned game program, game system program or authentication program is conducted, the RAM 73 can store the program. The RAM 73 is provided with working areas used for operations in execution of these programs. Examples of the areas include: an area that stores the number of games, the number of BETs, the number of payouts, the number of credits and the like; and an area that stores symbols (code numbers) determined by a drawing.

The communication interface 82 is for communicating with the external control device 20 such as a server, through the communication line 22. Further, the motherboard 70 is connected with a later-described door PCB (Printed Circuit Board) 90 and a body PCB 110 by respective USBs. The motherboard 70 is also connected with a power supply unit 81. When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the body PCB 110 are connected with input devices such as a switch and a sensor, and peripheral devices, the operations of which are controlled by the main CPU 71. The door PCB 90 is connected with a control panel 30 and a cold cathode tube 93.

On the control panel 30, a 1-BET switch 34S, a 2-BET switch 35S, a 3-BET switch 37S, a 4-BET switch 38S, a 5-BET switch 39S, a MAX-BET switch 45S, a PLAY 2 LINES switch 40S, a PLAY 10 LINES switch 41S, a PLAY 20 LINES switch 42S, a PLAY 30 LINES switch 43S, a SPIN switch 46S, and the like are provided so as to correspond to the above-described respective buttons. Each of the switches detects that any corresponding button is pressed by a player and outputs a signal to the main CPU 71.

The cold cathode tube 93 functions as a backlight installed on the rear face sides of an upper image display panel 131 and the lower image display panel 141, and lights up based on a control signal outputted from the main CPU 71.

The body PCB 110 is connected with the lamp 111, the speaker 112, a coin detection part 113S, the touch panel 114, the bill validator 115, a graphic board 130, the ticket printer 171, the IC card reader 60, a key switch 122S, and the data display 124.

The lamp 111 lights up based on a control signal outputted from the main CPU 71. The speaker 112 outputs sounds such as BGM, based on a control signal outputted from the main CPU 71.

The touch panel 114 detects a position, on the lower image display panel, touched by a player's finger or the like, and outputs to the main CPU 71 a signal corresponding to the detected place. In addition, similarly, the upper image display panel 131 can be configured as a touch panel. Upon acceptance of a valid bill, the bill validator 115 outputs to the main CPU 71 a signal corresponding to the face amount of the bill.

The graphic board 130 controls display of images conducted by the respective upper image display panel 131 and lower image display panel 141, based on a control signal outputted from the main CPU 71. The symbol display region 4 of the lower image display panel 141 displays the five video reels 3 by which the scrolling (moving) and stop motions of the symbol arrays included in the respective video reels 3 are displayed. The graphic board 130 is provided with a VDP generating image data, a video RAM temporarily storing the image data generated by the VDP, and the like. A credit meter of the lower image display panel 141 displays the number of credits stored in the RAM 73. A win meter of the lower image display panel 141 displays the number of coins to be paid out.

The graphic board 130 is provided with the VDP (Video Display Processor) generating image data based on a control signal outputted from the main CPU 71, the video RAM temporarily storing the image data generated by the VDP, and the like. It is to be noted that the image data used in generation of image data by the VDP is included in the game program that has been read from the memory card 54 and stored into the RAM 73.

Based on a control signal outputted from the main CPU 71, the ticket printer 120 prints on a ticket a barcode representing encoded data of the number of credits stored in the RAM 73, date, the identification number of the slot machine 10, and the like, and then outputs the ticket as the ticket 175 with a barcode.

The IC card reader 60 reads data stored in a card inserted into the card slot 176 and transmits the data to the main CPU 71, or writes data into the card based on a control signal outputted from the main CPU 71.

The key switch 122S is provided in the keypad 125, and outputs a predetermined signal to the main CPU 71 when the keypad 125 has been operated by a player.

The data display 124 displays data read by the IC card reader 60 and data inputted by a player through the keypad 125, based on a control signal outputted from the main CPU 71.

<<Game State Transition>>

FIG. 6 is a diagram illustrating state transition in a slot machine 10. Specifically, FIG. 6 shows the state transition in a base game mode and a feature game mode.

The slot machine 10 has two kinds of game modes including the base game mode and the feature game mode. On the slot machine 10, a unit game is executed in the base game mode as a main game mode, and when a trigger (event) of a feature game has occurred in the base game mode, the game mode is shifted to the feature game mode.

As shown in FIG. 6, in the base game mode, the unit game is repeated until the trigger of the feature game is established. The game in the base game mode is a game in which the unit game can be played by consuming (betting) gaming media such as medals or the like. In this base game mode, when any of winning patterns shown in FIG. 8 is established, an amount of a payout in accordance with a payout corresponding to that winning pattern is paid out.

In the base game mode, a winning pattern by symbols of BONUS is established, thereby triggering the feature game mode. Specifically, three symbols of BONUS have appeared, thereby establishing the winning pattern by the symbols of BONUS. The symbols of BONUS are scatter symbols, by which a winning pattern is established, irrespective of any payline. It is determined by the number of symbols of BONUS appearing in the symbol display region 141d that the winning pattern is established or is not established.

The feature game mode is triggered, thereby shifting the game mode to the feature game mode. On the slot machine 10 according to the present embodiment, as a process in the feature game mode, first, a wheel drawing process is executed. By executing the wheel drawing process, any of an extra-large credit payout, a middle credit payout, a small credit payout, a slash bonus mode, a battle bonus mode, a pick bonus mode, and a free game mode is selected and executed.

When the extra-large credit payout is won in the wheel drawing process, a credit of 5000 is provided as a payout. When the middle credit payout is won in the wheel drawing process, a credit of 200 is provided as a payout. When the small credit payout is won in the wheel drawing process, a credit of 100 is provided as a payout. Thereafter, the game mode returns to the base game mode.

When the slash bonus mode is won in the wheel drawing process, a slash bonus game is executed by the later-described processes shown in FIG. 22 to FIG. 24 and a predetermined payout is provided. Thereafter, the game mode returns to the base game mode.

When the pick bonus mode is won in the wheel drawing process, a pick bonus game is executed by the later-described process shown in FIG. 38 and a predetermined payout is provided. Thereafter, the game mode returns to the base game mode.

When the battle bonus mode is won in the wheel drawing process, a battle bonus game is executed by the later-described processes shown in FIG. 25 to FIG. 31 and a predetermined payout is provided. Thereafter, the game mode returns to the base game mode.

When the free game mode is won in the wheel drawing process, a free game is executed by the later-described processes shown in FIG. 32 to FIG. 37 and a predetermined payout is provided. Thereafter, the game mode returns to the base game mode.

In the present embodiment, the game in the free game mode is a game in which the unit game is played without consuming any gaming media such as medals. A player can play the unit game at up to a maximum number of times (eight times) in the free game mode.

In the free game mode, the free game mode is retriggered, thereby maintaining the free game mode as the game mode. In the base game mode, a winning pattern by the symbols of BONUS is established, thereby retriggering the free game mode. Specifically, three symbols of BONUS have appeared, thereby establishing the winning pattern by the symbols of BONUS. The free game mode is retriggered, thereby adding eight times as the maximum number of times at which the unit game is played.

<Payline>

FIG. 7 shows an example of a payline definition table which defines paylines adopted in a slot machine 10. As described above, in the slot machine 10 according to the present embodiment, in a symbol display region 141d, as stop positions 28 of symbols of five video reels 3a to 3e, four rows which are an uppermost row (first row=0), an upper middle row (second row=1), a lower middle row (third row=2), and a lowermost row (fourth row=3) are defined. In the slot machine 10, 30 paylines are set in a symbol matrix of five arrays×4 rows (5 columns×4 rows). The payline definition table defines the paylines formed by connecting four regions in the uppermost row, the upper middle row, the lower middle row, and the lowermost row of the respective five video reels 3a to 3e in the symbol display region 141d.

For example, a region in the uppermost row of the video reel 3a (first reel strip), a region in the uppermost row of the video reel 3b (second reel strip), a region in the uppermost row of the video reel 3c (third reel strip), a region in the uppermost row of the video reel 3d (fourth reel strip), and a region in the uppermost row of the video reel 3e (fifth reel strip) constitute one payline (payline No. 1 in FIG. 7).

In the slot machine 10 according to the present embodiment, all of the 30 paylines are active, irrespective of a bet amount and any selection by a player. It is to be noted that the paylines may be made active in accordance of the selection by a player. In addition, a total number of the paylines can be appropriately determined in accordance with a size of the symbol matrix.

<Payout Table>

FIG. 8 is a table showing an example of a payout table. The payout table shown in FIG. 8 defines 13 kinds of winning patterns.

The payout table shows a relationship of the winning patterns, the numbers of Kinds of symbols, and payouts. The numbers of Kinds are the numbers of symbols constituting the winning patterns and represent the numbers of symbols which are respectively arranged in succession from a left side to a right side along a payline. As described above, in the slot machine 10 according to the present embodiment, except for the symbols of BONUS and F_BONUS, winning is determined by symbols arranged in a LEFT TO RIGHT manner. Accordingly, a payout is determined by a kind and a number of symbols which are arranged in succession along a payline. It is to be noted that even in a case where the symbols are not arranged in succession, a winning pattern may be determined by a number of symbols arranged along a payline, instead of the symbols arranged in the LEFT TO RIGHT manner.

The first winning pattern is a pattern in which symbols of WILD are arranged. Specifically, the first winning pattern is a pattern in which three to five symbols of WILD are arranged along a payline. For example, a payout obtained when five symbols of WILD are arranged along a payline is defined as 1000.

In addition, the symbols of WILD are replaced with other symbols so as to establish an advantageous winning pattern. When the symbols of WILD are replaced with other symbols and the final winning pattern is established, a payout corresponding to that winning pattern is determined. It is to be noted that in the present embodiment, the symbols of WILD are not replaced with the symbols of BONUS and F_BONUS.

The second winning pattern is a pattern in which three to five symbols of SHOGUN are arranged along a payline. For example, a payout obtained when five symbols of SHOGUN are arranged along a payline is defined as 300.

The third winning pattern is a pattern in which three to five symbols of SAMURAI are arranged along a payline. For example, a payout obtained when five symbols of SAMURAI are arranged along a payline is defined as 250.

The fourth winning pattern is a pattern in which three to five symbols of SOLDIER are arranged along a payline. For example, a payout obtained when five symbols of SOLDIER are arranged along a payline is defined as 200.

The fifth winning pattern is a pattern in which three to five symbols of CLAW are arranged along a payline. For example, a payout obtained when five symbols of CLAW are arranged along a payline is defined as 120.

The sixth winning pattern is a pattern in which three to five symbols of NINJA_STAR are arranged along a payline. For example, a payout obtained when five symbols of NINJA_STAR are arranged along a payline is defined as 120.

The seventh winning pattern is a pattern in which three to five symbols of KNIFE are arranged along a payline. For example, a payout obtained when five symbols of KNIFE are arranged along a payline is defined as 120.

The eighth winning pattern is a pattern in which three to five symbols of WIND are arranged along a payline. For example, a payout obtained when five symbols of WIND are arranged along a payline is defined as 100.

The ninth winning pattern is a pattern in which three to five symbols of FOREST are arranged along a payline. For example, a payout obtained when five symbols of FOREST are arranged along a payline is defined as 100.

The 10th winning pattern is a pattern in which three to five symbols of FIRE are arranged along a payline. For example, a payout obtained when five symbols of FIRE are arranged along a payline is defined as 100.

The 11th winning pattern is a pattern in which three to five symbols of MOUNTAIN are arranged along a payline. For example, a payout obtained when five symbols of MOUNTAIN are arranged along a payline is defined as 100.

The 12th winning pattern is a pattern in which three to five symbols of BONUS have appeared. As described above, the symbols of BONUS are the scatter symbols. Accordingly, the arrangement of the symbols of BONUS along a payline is not a condition for the establishment of a winning pattern, and the establishment of the 12th winning pattern is determined by the number of symbols of BONUS which have appeared. A payout obtained when three symbols of BONUS have appeared is defined as one.

As described above, on the condition that it is determined by the symbol drawing process that the three symbols of BONUS are to appear in the symbol display region 141d, the feature game mode is triggered. Accordingly, when it is determined by the symbol drawing process that the three symbols of BONUS are to appear in the symbol display region 141d, a player is provided with both benefits of the provision of a payout and the shifting to the feature game mode.

The 13th winning pattern is a pattern in which three to five symbols of F_BONUS have appeared. As described above, the symbols of F_BONUS are the scatter symbols. Accordingly, the arrangement of the symbols of F_BONUS along a payline is not a condition for the establishment of a winning pattern, and the establishment of the 13th winning pattern is determined by the number of symbols of F_BONUS which have appeared. A payout obtained when three symbols of F_BONUS have appeared is defined as one.

As described above, on the condition that it is determined by the symbol drawing process that the three symbols of F_BONUS are to appear in the symbol display region 141d, the free game mode is retriggered. Accordingly, when it is determined by the symbol drawing process that the three symbols of F_BONUS are to appear in the symbol display region 141d, a player is provided with both benefits of the provision of a payout and the maintaining of the free game mode.

<Configuration of Reel Strips>

Each of FIG. 9 to FIG. 14 is a table showing a group of reel strips (symbol arrays) which constitute five video reels 3a to 3e. Code Nos. showing symbols shown in FIG. 9 to FIG. 14 are made into data and are stored in a RAM 73. These tables shown in FIG. 9 to FIG. 14 function as symbol determination tables for determining five to-be-stopped symbols in symbol drawing processes shown in FIG. 17 and FIG. 33. In other words, random number values are extracted and the symbol determination tables shown in FIG. 9 to FIG. 14 are referenced, thereby determining the five code Nos. and determining symbols corresponding to the code Nos. as the five to-be-stopped symbols.

FIG. 9 to FIG. 11 is a table showing a group of reel strips used in a base game mode. FIG. 12 to FIG. 14 is a table showing a group of reel strips used in a free game mode of a feature game mode.

As shown in FIG. 9 to FIG. 11, 12 kinds of symbols which are symbols of WILD, SHOGUN, SAMURAI, SOLDIER, CLAW, NINJA_STAR, KNIFE, WIND, FOREST, FIRE, MOUNTAIN, and BONUS are assigned to the group of reel strips used in the base game mode. For example, the symbol of SOLDIER is assigned to code No. 10 of the video reel 3c. The symbols of BONUS are assigned to the group of reel strips used in the base game mode. A winning pattern by the symbols of BONUS is established, thereby triggering the feature game mode.

As shown in FIG. 12 to FIG. 14, 12 kinds of symbols which are symbols of WILD, SHOGUN, SAMURAI, SOLDIER, CLAW, NINJA_STAR, KNIFE, WIND, FOREST, FIRE, MOUNTAIN, and F_BONUS are assigned to the group of reel strips used in the free game mode. The symbols of F_BONUS are assigned to the group of reel strips used in the free game mode. A winning pattern by the symbols of F_BONUS is established, thereby retriggering the free game mode.

In each of the base game mode and the free game mode, 63 symbols are assigned to the reel strip of the video reel 3a. In each of the base game mode and the free game mode, 87 symbols are assigned to the reel strip of the video reel 3b. In the base game mode, 57 symbols are assigned to the reel strip of the video reel 3c, and in the free game mode, 59 symbols are assigned to the reel strip of the video reel 3c. In each of the base game mode and the free game mode, 102 symbols are assigned to the reel strip of the video reel 3d.

In each of the base game mode and the free game mode, 105 symbols are assigned to the reel strip of the video reel 3e. By the symbol drawing processes shown in FIG. 17 and FIG. 33, one to-be stopped symbol is selected at an equal probability with respect to each of the five video reels 3a to 3e.

<<Contents of Programs>>

Next, with reference to FIG. 15 to FIG. 38, programs executed by a slot machine 10 will be described.

<Main Control Process>

FIG. 15 is a flowchart of a main control process in a slot machine 10 according to the embodiment of the present invention. This game mode in the main control process shown in FIG. 15 is a base game mode.

First, when power is supplied to the slot machine 10, a main CPU 71 reads out a game program and a game system program, which have been authenticated, from a memory card 54 via a gaming board 50 and writes the game program and the game system program into a RAM 73 (step S1511).

Next, the main CPU 71 conducts an at-one-game-termination initialization process (step S1513). For example, data that becomes unnecessary after each game in the working areas of the RAM 73, such as the number of BETs and the symbols determined by a drawing, is cleared.

The main CPU 71 conducts a coin-insertion/start-check process which is described later with reference to FIG. 16 (step S1515). In this process, input or the like from the BET button and the spin button is checked.

Next, the main CPU 71 conducts a symbol drawing process which is described later with reference to FIG. 17 (step S1517). In this process, to-be stopped symbols are determined based on the random number values for symbol determination. When as a result of the symbol drawing process, a winning pattern by symbols of BONUS is established, a feature game mode is triggered. It is to be noted that in the present embodiment, the trigger of the feature game mode is a trigger of a wheel drawing process.

Next, the main CPU 71 conducts an effect contents start process (step S1519). In the process at step S1519, the main CPU 71 extracts random number values for effects, determines any of a predetermined plurality of effect contents by a drawing, and executes the effect contents at the timing of the determined effect contents. For example, the main CPU 71 displays video for effects on an upper display device 131, outputs audio from a loudspeaker 112, lights a lamp 111, and performs the control, for example, by subjecting these to effect processes.

Next, the main CPU 71 conducts a symbol display control process which is described later with reference to FIG. 18 (step S1521). In this process, scrolling of five video reels 3a to 3e (five reel strips) is started, and the to-be stopped symbols determined in the symbol drawing process at step S1517 are stopped in predetermined positions.

Next, the main CPU 71 conducts a to-be-paid-out number determination process which is described later with reference to FIG. 19 (step S1523). In this process, it is determined from the five to-be-stopped symbols stored in a symbol storage area by the later-described symbol drawing process whether or not a winning pattern in the payout table (refer to FIG. 8) is established. A to-be-paid-out number based on the payout table (refer to FIG. 8) in accordance with the winning pattern is determined and is stored in a to-be-paid-out number storage area (to-be-paid-out number counter) provided in the RAM 73.

Next, the main CPU 71 determines whether or not the feature game mode is triggered (step S1525). In other words, the main CPU 71 determines whether or not the wheel drawing process is triggered. When the main CPU 71 determines that the feature game mode is triggered, the main CPU 71 executes the wheel drawing process shown in FIG. 20 (step S1527) and returns the processing to step S1513.

Next, when the main CPU 71 determines at step S1525 that the feature game trigger is not established, the main CPU 71 conducts a paying-out process (step S1529). The main CPU 71 adds a value stored in the to-be-paid-out number storage area (to-be-paid-out number counter) to a value stored in a number-of-credits storage area (number-of-credits counter) provided in the RAM 73. It is to be noted that the driving of a hopper (not shown) may be controlled, thereby discharging coins in accordance with the to-be-paid-out number counter from a coin payout exit. In addition, the driving of a ticket printer 120 may be controlled, thereby issuing a ticket with a barcode having the to-be-paid-out number counter registered thereon.

Next, the main CPU 71 returns the processing to step S1513.

<Coin-Insertion/Start-Check Process>

FIG. 16 is a flowchart of a coin-insertion/start-check process in a slot machine 10 according to the embodiment of the present invention.

First, the main CPU 71 determines whether or not insertion of coins has been detected by a coin counter (step S1611). When the main CPU 71 determines that the insertion of coins has been detected, the main CPU 71 adds a value of inserted coins to a value stored in the number-of-credits storage area (number-of-credits counter) (step S1613). It is to be noted that in addition to the determination of the insertion of coins, the main CPU 71 may determine whether or not insertion of bills has been detected based on bill validation data (for example, by a PTS terminal (not shown) or the like), and when the main CPU 71 determines that the insertion of bills has been detected, the main CPU 71 may add a value in accordance with the bills to a value of the number-of-credits counter.

After step S1613 or when at step S1611, the main CPU 71 determines that the insertion of coins has not been detected, the main CPU 71 determines whether or not a value of the number-of-credits counter is zero (step S1615). When the main CPU 71 determines that the value of the number-of-credits counter is not zero, the main CPU 71 permits acceptance of an operation of any of BET buttons (step S1617).

Next, the main CPU 71 determines whether or not the operation of any of the BET buttons has been detected (step S1619). When the main CPU 71 determines by a BET switch that any of the BET buttons has been pressed by a player, based on a kind of the pressed button among the BET buttons, the main CPU 71 performs addition of a value stored in a number-of-BETs storage area (number-of-BETs counter) provided in the RAM 73 and performs subtraction for the number-of-credits counter (step S1621).

Next, the main CPU 71 determines whether or not a value of the number-of-BETs counter is at its maximum (step S1623). When the main CPU 71 determines that the value of the number-of-BETs counter is at its maximum, the main CPU 71 prohibits updating of the number-of-BETs counter and the value of the number-of-BETs counter is stored in the RAM 73 (step S1625).

In the free game mode, without consuming any gaming media such as medals, the free games (unit games) can be played. Accordingly, without placing any BET, the free games can be initiated, and a value of the number-of-BETs counter cannot be determined by the BET operation. Therefore, upon shifting to the free game mode, a value of the number-of-BETs counter in the base game mode immediately prior to shifting thereto is used. The value of the number-of-BETs counter stored at step S1625 is read out and used upon shifting to the free game mode.

Next, when the main CPU 71 determines after step S1625 or at step S1623 that the value of the number-of-BETs counter is not at its maximum, the main CPU 71 permits acceptance of an operation of the spin button (step S1627).

After step S1627, or when at step S1619, the main CPU 71 determines that the operation of any of the BET buttons has not been detected, or when at step S1615, the main CPU 71 determines that the value of the number-of-credits counter is zero, the main CPU 71 determines whether or not the operation of the spin button has been detected (step S1629). When the main CPU 71 determines that the operation of the spin button has not been detected, the main CPU 71 returns the processing to step S1611.

When the main CPU 71 determines that the operation of the spin button has been detected, the main CPU 71 finishes the coin-insertion/start-check process.

<Symbol Drawing Process>

FIG. 17 is a flowchart of a symbol drawing process in a slot machine 10 according to the embodiment of the present invention.

First, the main CPU 71 extracts five random number values for the determination of symbols (step S1711). Next, the main CPU 71 determines to-be-stopped symbols of the five video reels 3a to 3e from the five random number values by a drawing (step S1713).

In the process at step S1713, with reference to a symbol determination table, the five to-be-stopped symbols are determined. In the present embodiment, the symbol determination table is a symbol determination table for the base game mode and is shown in FIG. 9 to FIG. 11.

In other words, the main CPU 71 extracts five random number values for symbol determination and with reference to the symbol determination table for the base game mode shown in FIG. 9 to FIG. 11, one symbol with respect to each of the five video reels 3a to 3e is determined as a to-be stopped symbol. In the present embodiment, each of the five to-be-stopped symbols is determined at an equal probability.

By conducting the process at step S1713, the five to-be-stopped symbols corresponding to the five video reels 3a to 3e are determined. The stopping of the five video reels 3a to 3e is controlled such that the determined five to-be-stopped symbols stop in an uppermost row of a symbol matrix (uppermost row of the symbol display region 141d) (refer to step S1813 in FIG. 18).

Next, the main CPU 71 stores the determined to-be stopped symbols of the five video reels 3a to 3e in a symbol storage area provided in the RAM 73 (step S1715).

In the present embodiment, each of the five to-be-stopped symbols is determined by the symbol drawing process at the equal probability. In contrast to this, predetermined weights may be defined with respect to the plurality of symbols constituting the respective five video reels 3a to 3e, and in accordance with the weights, the five to-be-stopped symbols may be determined.

<Symbol Display Control Process>

FIG. 18 is a flowchart of a symbols display control process in a slot machine 10 according to the present embodiment.

The main CPU 71 starts the scrolling of five video reels 3a to 3e displayed in a symbol display region 141d of a lower display device 141 (step S1811).

A speed, a direction, and the like of the scrolling of the five video reels 3a to 3e are controlled by a variety of parameters for predictive and ready-to-win effects.

In the present embodiment, the five video reels 3a to 3e shown in FIG. 9 to FIG. 11 are displayed as the reel strips.

Next, based on the symbol storage area, the main CPU 71 stops the scrolling of any predetermined video reel among the five video reels 3a to 3e (step S1813). The video reel to be stopped and the timing of the stopping are determined by a variety of parameters for predictive and ready-to-win effects.

Next, the main CPU 71 determines whether or not all of the five video reels 3a to 3e have been stopped (step S1815). When the main CPU 71 determines that all of the five video reels 3a to 3e have not been stopped, the main CPU 71 returns the processing to step S1813. On the other hand, when the main CPU 71 determines that all of the five video reels 3a to 3e have been stopped, the main CPU 71 finishes this sub-routine.

In the present embodiment, for a period of time from when the scrolling of the five video reels 3a to 3e is started to when the scrolling of the five video reels 3a to 3e is stopped, the main CPU 71 controls the speed, the direction, a period of time, and the like of the scrolling of the five video reels 3a to 3e, thereby allowing the predictive and ready-to-win effects to be executed.

<To-be-Paid-Out Number Determination Process>

FIG. 19 is a flowchart of a to-be-paid-out number determination process in a slot machine 10 according to the embodiment of the present invention.

First, with reference to a payout table shown in FIG. 8, the main CPU 71 determines a winning pattern based on the symbols stored in a symbol storage area (step S1911).

Next, in accordance with a kind of the symbols determined at step S1911, the main CPU 71 determines whether or not a winning pattern has been established (step S1913).

Next, when the winning pattern is established, based on the symbol storage area and the payout table (FIG. 8), the main CPU 71 determines a to-be-paid-out number based on a payout which satisfies the winning pattern (step S1915).

Next, the main CPU 71 stores the determined to-be-paid-out number in the to-be-paid-out number counter of the to-be-paid-out number storage area (step S1917), finishing this sub-routine.

When in the determination processing at step S1913, the main CPU 71 determines that the winning pattern has not been established, the main CPU 71 immediately finishes this sub-routine.

<Wheel Drawing Process>

Each of FIG. 20 and FIG. 21 is a flowchart of a wheel drawing process in a slot machine 10 according to the present embodiment. In a base game mode, it is determined by a symbol drawing process that three symbols of BONUS appear and a winning pattern by the symbols of BONUS is established, thereby executing the wheel drawing process. A wheel drawing is a roulette game, and a bonus corresponding to any one of cells is provided. In the present embodiment, the bonuses, each of which is determined by the wheel drawing process, include shifting to a variety of feature game modes and the provision of payouts.

First, the main CPU 71 extracts random number values for a roulette drawing (step S2011).

Next, by using the random number values extracted in the process at step S2011, with reference to a roulette drawing table (FIG. 40), the main CPU 71 determines a bonus (step S2013).

Next, in accordance with a result at step S2013, the main CPU 71 executes wheel effects shown in FIG. 39 (step S2015).

As shown in FIG. 39, a wheel is constituted of 16 cells with ID=0 to 15. Each of the 16 cells has a trapezoidal shape, and the 16 cells are concentrically arranged. The wheel is provided in an upper portion of an upper display device 131 (not shown). It is to be noted that a wheel may be provided, instead of the upper display device 131.

Numerical values shown in FIG. 39 are ID numbers. A lamp (not shown) is arranged behind each of the 16 cells. The wheel is configured by a lamp box, and the main CPU 71 controls turning-on and turning-off of a lamp. A lamp behind one cell corresponding to a result at step S2013 is turned on, thereby allowing the result at step S2013 to be shown to a player.

Specifically, turning-on and turning-off of the lamp of each of the 16 cells are sequentially repeated, thereby allowing roulette effects to be executed. Finally, the lamp behind one cell corresponding to the result at step S2013 is turned on.

FIG. 40 shows an example of the roulette drawing table used at step S2013. The IDs shown in FIG. 40 indicate the 16 cells of the wheel shown in FIG. 39.

For ID=0, the content is a small credit (payout=100) and a weight is five. For ID=1, the content is an extra-large credit (payout=5000) and a weight is one. For ID=2, the content is a middle credit (payout=200) and a weight is five. For ID=3, the content is a pick bonus and a weight is 11. For ID=4, the content is a small credit (payout=100) and a weight is one. For ID=5, the content is a free game and a weight is 10. For ID=6, the content is a middle credit (payout=200) and a weight is one. For ID=7, the content is a slash bonus and a weight is 11. For ID=8, the content is a small credit (payout=100) and a weight is two. For ID=9, the content is a battle bonus and a weight is 15. For ID=10, the content is a middle credit (payout=200) and a weight is three. For ID=11, the content is a pick bonus and a weight is 11. For ID=12, the content is a small credit (payout=100) and a weight is two. For ID=13, the content is a free game and a weight is nine. For ID=14, the content is a middle credit (payout=200) and a weight is two. For ID=15, the content is a slash bonus and a weight is 11.

The main CPU 71 determines whether or not the result at step S2013 is credit winning (step S2017). When the main CPU 71 determines that the result is the credit winning, the main CPU 71 determines whether or not the credit winning is winning of a small credit (step S2111).

When the main CPU 71 determines that the credit winning is the winning of the small credit, the main CPU 71 determines a payout of 100 (step S2113), finishing this sub-routine.

When in the determination process at step S2111, the main CPU 71 determines that the credit winning is not the winning of the small credit, the main CPU 71 determines whether or not the credit winning is winning of a middle credit (step S2115).

When the main CPU 71 determines that the credit winning is the winning of the middle credit, the main CPU 71 determines a payout of 200 (step S2117), finishing this sub-routine.

When in the determination process at step S2113, the main CPU 71 determines that the credit winning is not the winning of the middle credit, the main CPU 71 determines a payout of winning of a large credit of 5000 (step S2119), finishing this sub-routine.

Specifically, payouts are determined as described below. It is to be noted that a value calculated by multiplying a number of BETs per line by each of the below payouts is provided as a credit.

Upon winning the small credit of ID=0, 100 is determined as a payout. Upon winning the extra-large credit of ID=1, 5000 is determined as a payout. Upon winning the middle credit of ID=2, 200 is determined as a payout. Upon winning the small credit of ID=4, 100 is determined as a payout. Upon winning the middle credit of ID=6, 200 is determined as a payout. Upon winning the small credit of ID=8, 100 is determined as a payout. Upon winning the middle credit of ID=10, 200 is determined as a payout. Upon winning the small credit of ID=12, 100 is determined as a payout. Upon winning the middle credit of ID=14, 200 is determined as a payout.

When in the determination process at step S2017, the main CPU 71 determines that no credit is won, the main CPU 71 determines whether or not a slash bonus is won (step S2019).

When the main CPU 71 determines that the slash bonus is won, the main CPU 71 executes a slash bonus process shown in FIG. 22 to FIG. 24 (step S2021), finishing this sub-routine.

When in the determination process at step S2019, the main CPU 71 determines that no slash bonus is won, the main CPU 71 determines whether or not a battle bonus is won (step S2023).

When the main CPU 71 determines that the battle bonus is won, the main CPU 71 executes a battle bonus process shown in FIG. 25 to FIG. 31 (step S2025), finishing this sub-routine.

When in the determination process at step S2023, the main CPU 71 determines that no battle bonus is won, the main CPU 71 determines whether or not a pick bonus is won (step S2027).

When the main CPU 71 determines that the pick bonus is won, the main CPU 71 executes a pick bonus process shown in FIG. 38 (step S2029), finishing this sub-routine.

When in the determination process at step S2027, the main CPU 71 determines that no pick bonus is won, the main CPU 71 determines whether or not a free game bonus is won (step S2031).

When the main CPU 71 determines that the free game bonus is won, the main CPU 71 executes a free game bonus process shown in FIG. 32 to FIG. 37 (step S2033), finishing this sub-routine.

When the main CPU 71 determines that no free game bonus is won, the main CPU 71 immediately finishes this sub-routine.

Specifically, the variety of bonus processes are executed as described below. Upon winning ID=7 or ID=15, the slash bonus process is executed (FIG. 22 to FIG. 24). Upon winning ID=9, the battle bonus process is executed (FIG. 25 to FIG. 31). Upon winning ID=5 or ID=13, the free game process is executed (FIG. 32 to FIG. 37). Upon winning ID=3 or ID=11, the pick bonus process is executed (FIG. 38).

<Slash Bonus Process>

Each of FIG. 22 to FIG. 24 is a flowchart of a slash bonus process in a slot machine 10 according to the present embodiment.

As shown in FIG. 61A to FIG. 67D, in the slash bonus process, enemy characters are displayed on a lower display device 141 (lower liquid crystal panel 141b) one after another, and a player touches or slides the displayed enemy character on a lower touch panel 141a within a time limit, thereby defeating the enemy character and obtaining a credit. Based on a number of enemy characters defeated by a user, credits are provided.

The operation by a user is performed by touching or sliding the lower touch panel 141a. It is to be noted that a provided credit is determined by a drawing process and as described later, differences made by operations by a user are finally settled.

As shown in FIG. 41, the enemy characters are displayed at 14 timings (each one second) of No. 1 to No. 14. As described later, a number of enemy characters displayed at each of the timings is one to three.

First, the main CPU 71 extracts random number values for enemy appearing patterns (step S2211).

Next, with reference to an enemy appearing pattern drawing table, the main CPU 71 determines any enemy appearing pattern (step S2213). In the present embodiment, each of the enemy appearing patterns includes a number of enemy characters and a payout credit corresponding thereto.

FIG. 42 shows an example of the enemy appearing pattern drawing table. The enemy appearing patterns shown in FIG. 42 are three kinds of A, B, and C. In ID=0 of an enemy appearing pattern A, a total number of a number of appearing enemies is 30, a payout credit is 450, and a weight is one. In ID=1 of an enemy appearing pattern B, a total number of a number of appearing enemies is 32, a payout credit is 480, and a weight is one. In ID=2 of an enemy appearing pattern C, a total number of a number of appearing enemies is 34, a payout credit is 510, and a weight is one. In the above-described process at step S2213, any appearing pattern among the enemy appearing patterns A to C is determined.

Next, in accordance with the enemy appearing pattern determined in the process at step S2213, the main CPU 71 rearranges numbers of appearing enemies at the 14 appearing timings (step S2215).

Specifically, based on numbers of enemy characters shown in FIG. 43, numbers of appearing enemies are rearranged. FIG. 43 is a table which defines numbers of enemy characters to be displayed at each of the appearing timings with respect to each of the enemy appearing patterns A to C. In FIG. 43, reference numbers of enemy characters are shown, and by executing the process at step S2215, the 14 appearing timings of No. 1 to No. 14 are rearranged by a drawing process, thereby rearranging the numbers of appearing enemies.

For example, in the case of the enemy appearing pattern A, the appearing timings are rearranged by the drawing process as in the order: No. 10→8→4→12→3→1→5→ . . . →9, thereby allowing the numbers of appearing enemies to be rearranged as in the order 3→2→1→3→1→1→2→ . . . →3. By rearranging the appearing timings as described above, the number of appearing enemies can be arranged such that after one second, three enemy characters appear; after two seconds, two enemy characters appear; after three seconds, one enemy character appears; after four seconds, three enemy characters appear; after five seconds, one enemy character appears; after six seconds, one enemy character appears; and finally, after 14 seconds, three enemy characters appear. Thus, by rearranging the numbers of appearing enemies, even when the enemy appearing pattern is the same, the slash bonus can be differently developed, thereby allowing a player to hardly get bored.

As shown in FIG. 43, in the case of the enemy appearing pattern A, a number of timings, at each of which a number of enemies concurrently appearing is one, is four; a number of timings, at each of which a number of enemies concurrently appearing is two, is four; and a number of timings, at each of which a number of enemies concurrently appearing is three, is six. In the case of the enemy appearing pattern B, a number of timings, at each of which a number of enemies concurrently appearing is one, is three; a number of timings, at each of which a number of enemies concurrently appearing is two, is four; and a number of timings, at each of which a number of enemies concurrently appearing is three, is seven. In the case of the enemy appearing pattern C, a number of timings, at each of which a number of enemies concurrently appearing is one, is one; a number of timings, at each of which a number of enemies concurrently appearing is two, is six; and a number of timings, at each of which a number of enemies concurrently appearing is three, is seven.

Next, the main CPU 71 initializes a first obtained credit, for example, to 0 (step S2217). The first obtained credit is a credit which can be obtained upon defeating each of the enemy characters appearing one after another. On the other hand, the later-described second obtained credit is a credit which can be obtained upon defeating the last one enemy character.

Next, the main CPU 71 initializes a number of timings, at each of which enemies appear, for example, to 1 (step S2219).

Next, in accordance with the number of appearing enemies determined at step S2215, the main CPU 71 determines a position, in which each of the enemy characters is displayed, by a drawing process (step S2311). As described above, since the position in which each of the enemy characters is displayed is determined by the drawing process, even when the number of appearing enemies is the same, it is likely that the enemy characters are displayed in different positions, thereby allowing positions touched or slid on the lower touch panel 141a to be made different and enabling a feeling of tension to be provided for a player.

Next, the main CPU 71 determines whether or not it is a timing at which the enemy characters are caused to appear (step S2313). This process is to determine whether or not it is any of the appearing timings shown in the table in FIG. 41. When the main CPU 71 determines that it is not the timing at which the enemy characters are caused to appear, the main CPU 71 returns the processing to step S2313.

When the main CPU 71 determines that it is the timing at which the enemy characters are caused to appear, the main CPU 71 displays enemy characters of the number of appearing enemies determined in the process at step S2215 in the positions determined in the process at step S2311 (step S2315). This process is executed, thereby allowing the enemy characters to be displayed and caused to appear one after another on the lower display device 141, as shown in FIG. 61D to FIG. 64B.

Next, the main CPU 71 determines whether or not a user touches or slides the lower touch panel 141a (step S2317). When the main CPU 71 determines that a user does not touch or slide the lower touch panel 141a, the main CPU 71 returns the processing to step S2317.

When the main CPU 71 determines that a user touches or slides the lower touch panel 141a, the main CPU 71 determines whether or not the touching or sliding is an appropriate input to each of the enemy characters (step S2319). The appropriate input is an input (touching) with which each of the enemy characters is stabbed or an input (sliding) with which each of the enemy characters is slashed down.

When the main CPU 71 determines that the touching or sliding is not the appropriate input to each of the enemy characters, the main CPU 71 determines whether or not a time-out occurs (step S2321). The time-out is a timing at which each of the enemy characters disappears from a screen. In other words, a user touches or slides the lower touch panel 141a for a period of time from when each of the enemy characters appears to when each of the enemy characters disappears, thereby allowing a user to attack each of the enemy characters. Such a time limit is set, thereby allowing a feeling of tension to be provided for a player.

When the main CPU 71 determines that the time-out does not occur, the main CPU 71 returns the processing to step S2317.

When in the determination process at step S2319, the main CPU 71 determines that the touching or sliding is the appropriate input to each of the enemy characters, the main CPU 71 adds 15 to the first obtained credit (step S2323).

After executing the process at step S2323, when in the determination process at step S2321, the main CPU 71 determines that the time-out occurs, the main CPU 71 increases only by one the number of times at which the enemy characters appear (step S2325).

Next, the main CPU 71 determines whether or not the number of times comes to be a maximum number of times, for example, 14 (step S2327). When the main CPU 71 determines that the number of times does not come to be the maximum number of times, the main CPU 71 returns the processing to step S2311.

When the main CPU 71 determines that the number of times has come to the maximum number of times, the main CPU 71 subtracts the first obtained credit from a payout credit, thereby calculating the remaining credit (step S2329).

The payout credit is a credit determined in the above-described process at step S2213 and a credit defined in accordance with each of the enemy appearing patterns. The first obtained credit is a credit obtained when a user attacks each of the enemy characters (FIG. 61D to FIG. 64B) appearing one after another at each of the appearing timings shown in the table in FIG. 41.

As described above, it is required for a user to defeat each of the enemy characters one after another within the time limit by touching or sliding the lower touch panel 141a. Therefore, any enemy character or characters which a user cannot defeat is or are likely to be present. Since a payout is determined upon defeating each of the enemy characters, when a user cannot defeat any enemy character, no payout is provided.

When a user has defeated all of the enemy characters, the first obtained credit matches the payout credit. On the other hand, when any enemy character which a user cannot defeat is present, the first obtained credit is smaller than the payout credit. The remaining credit is a difference between the payout credit and the first obtained credit and is a payout corresponding to the enemy character which a user cannot defeat.

Next, the main CPU 71 initializes the second obtained credit, for example, to 0 (step S2411).

Next, the main CPU 71 extracts random number values for a bonus payout (step S2413).

Next, with reference to a bonus payout drawing table, the main CPU 71 determines the bonus payout (step S2415).

FIG. 44 is a table showing an example of the bonus payout drawing table. A bonus payout of ID=0 is 100 and a weight thereof is one. A bonus payout of ID=1 is 120 and a weight thereof is one. A bonus payout of ID=2 is 140 and a weight thereof is one. A bonus payout of ID=3 is 160 and a weight thereof is one. A bonus payout of ID=4 is 180 and a weight thereof is one. A bonus payout of ID=5 is 200 and a weight thereof is one. A bonus payout of ID=6 is 220 and a weight thereof is one. A bonus payout of ID=7 is 240 and a weight thereof is one. A bonus payout of ID=8 is 260 and a weight thereof is one. A bonus payout of ID=9 is 280 and a weight thereof is one. A bonus payout of ID=10 is 300 and a weight thereof is one. A bonus payout of ID=11 is 320 and a weight thereof is one.

The process at step S2415 is executed, thereby allowing one bonus payout among the bonus payouts corresponding to ID=0 to 11 to be determined.

Next, the main CPU 71 determines a part of the bonus payout determined in the process at step S2415 as a predetermined credit (step S2417). In this process, the bonus payout is divided into a plurality of bonus payouts, and each of the divided bonus payouts is determined as the predetermined credit. A number of divided bonus payouts can be determined based on the bonus payout. For example, the determination can be made such that in accordance with an increase in the bonus payout, the number of divided bonus payouts is easily increased. In addition, irrespective of the bonus payout, the number of divided bonus payouts can be randomly determined.

Next, the main CPU 71 displays the last enemy character (step S2419). In the present embodiment, a number of the last enemy character is one. A user can attack at a plurality of times up to when a user defeats the last one enemy character. By conducting this process, as shown in FIG. 64C to FIG. 67A, the last one enemy character can be displayed and caused to appear on the lower display device 141. Upon finally defeating the last one enemy character, the bonus payout determined in the process at step S2415 is provided.

The predetermined credit determined in the process at step S2417 is a partial payout to be added in each of the plurality of attacks. It is preferable that the predetermined credit is determined in accordance with the bonus payout by a drawing process.

Next, the main CPU 71 determines whether or not a user has touched or slid the lower touch panel 141a (step S2421). When the main CPU 71 determines that a user has not touched or slid the lower touch panel 141a, the main CPU 71 returns the processing to step S2421.

When the main CPU 71 determines that a user has touched or slid the lower touch panel 141a, the main CPU 71 determines whether or not the touching or sliding is an appropriate input to the last enemy character (step S2423). The appropriate input is an input (touching) with which the last enemy character is stabbed or an input (sliding) with which the last enemy character is slashed down.

When the main CPU 71 determines that the touching or sliding is not the appropriate input to the last enemy character, the main CPU 71 returns the processing to step S2417. By returning the processing to step S2417, a user can attack the last enemy character at a plurality of times, thereby allowing effects shown in FIG. 64C to FIG. 67A to be conducted.

When the main CPU 71 determines that the touching or sliding is the appropriate input to the last enemy character, the main CPU 71 adds the predetermined credit determined in the process at step S2417 to the second obtained credit (step S2425). Thus, each time the appropriate inputting is conducted to the last enemy character, a part of the bonus payouts divided in the process at step S2417, which is the predetermined credit, can be each gradually added.

Next, the main CPU 71 determines whether or not the second obtained credit has reached the bonus payout determined in the process at step S2415 (step S2427).

When the main CPU 71 determines that the second obtained credit has not reached the bonus payout, the main CPU 71 returns the processing to step S2417. Thus, the attacking can be repeated until a user finally defeat the last one enemy character and the attacking can be conducted until the second obtained credit reaches the bonus payout.

As described above, in the process at step S2417, the bonus payout is divided, and in the process at step S2425, only in the case where the appropriate inputting is conducted, each of the divided bonus payouts is added. Therefore, in the case where the appropriate inputting is not conducted to the last enemy character in the process at step S2425, the part of the divided bonus payouts (predetermined credit) is not added. Thus, by the process at step S2417, an opportunity at which a player can attack the enemy character until the second obtained credit reaches the bonus payout can be provided for a player, thereby allowing the bonus payout determined in the process at step S2415 to be provided as the second obtained credit for sure.

When the main CPU 71 determines that the second obtained credit has reached the bonus payout, a payout calculated by adding the first obtained credit, the remaining credit, and the second obtained credit is provided as a credit (step S2429), finishing this sub-routine.

As described above, the first obtained credit is the credit which can be obtained upon defeating each of the enemy characters appearing one after another. When a user cannot defeat any enemy character, the first obtained credit is smaller than the payout credit. On the other hand, the second obtained credit is the credit which can be obtained upon defeating the last one enemy character. The attacking can be repeated until a user finally defeats the last one enemy character. Accordingly, the second obtained credit can be arranged to invariably match the bonus payout.

In other words, equations of payout credit=first obtained credit+remaining credit; and bonus payout=second obtained credit result.

Since in the process at step S2429, the first obtained credit and the remaining credit are provided, in the process at step S2311 to S2327, even in the case where any enemy character which a user cannot defeat is present, the remaining credit is also included to be provided, and as a result, the payout credit is provided.

As described above, upon finishing the attacking to the last enemy character, the remaining credit is settled to be paid out. Therefore, in the case where a user cannot defeat all of the enemy characters and the first obtained credit does not match the payout credit which is a result of the drawing process, the payout credit is finally provided, thereby allowing the result of the drawing process to be made consistent therewith. Thus, even if any difference between an operation by a user and a result of an internal process occurs, consistency with the result of the internal process can be finally made. In addition, upon finishing the attacking to the last enemy character, the consistency is made, thereby allowing the processing to be conducted without making a player feel any unnaturalness.

In the above-described example, the case where upon finishing the attacking to the last enemy character, the remaining credit is settled is described. However, in the process at step S2425, when the part of the divided bonus payouts (predetermined credit) is added, the remaining credit may be settled. In this case, the remaining credit may be settled each time the part of the divided bonus payouts is added or may be settled at one time. In the case where the remaining credit is settled at a plurality of times, it is only required for a number of the plurality of times to be determined based on a number of times at which the bonus payout is divided. For example, the number of the plurality of times can be a number of times which is equal to or less than the number of times at which the bonus payout is divided.

<Battle Bonus Process>

Each of FIG. 25 to FIG. 31 is a flowchart of a battle bonus process in a slot machine 10 according to the present embodiment.

As shown in FIG. 76A to FIG. 95D, a battle bonus game is a game in which an ally character and an enemy character and six cards are displayed on a lower display device 141 (lower liquid crystal panel 141b). A player selects one card from among the six cards and performs an attack associated with the selected card to either of the ally character or the enemy character, thereby causing the game to proceed. The ally character is a character of a player side.

There are four kinds of enemy characters: a common foot soldier, a samurai, a shogun, and a dark shogun. The ally character has a one-to-one battle with any one of these common foot soldier, samurai, shogun, and dark shogun. When a physical strength of the enemy character first comes to be zero, the battle results in winning of the ally character (player), and when a physical strength of the ally character first comes to be zero, the battle results in losing of the ally character (player).

When the ally character (player) wins, a bonus payout can be obtained, and the enemy character is changed as in the order, common foot soldier→samurai→shogun→dark shogun, and the ally character can win through in a knockout manner. FIG. 76C to FIG. 82A show images, in each of which the ally character has a battle with the common foot soldier; FIG. 82B to FIG. 85A show images, in each of which the ally character has a battle with the samurai; FIG. 85B to FIG. 89D show images, in each of which the ally character has a battle with the shogun; and FIG. 91A to FIG. 95B show images, in each of which the ally character has a battle with the dark shogun.

First, the main CPU 71 sets the common foot soldier as an enemy character (step S2511). As described above, each time the ally character knocks out the enemy character, the enemy character is changed from “common foot soldier”, then “samurai”, then “shogun”, and then “dark shogun”. First, the ally character has the battle with the common foot soldier.

Next, the main CPU 71 displays a battle initial screen (step S2513). This displaying allows a player to visually recognize that the battle bonus game is initiated.

Next, the main CPU 71 sets a physical strength of the ally character to 10 (step S2515).

Next, the main CPU 71 sets a physical strength of the enemy character to 10 (step S2517).

In this way, each of the physical strength of the ally character and the physical strength of the enemy character is set to the same fixed value of 10. However, the physical strength of the ally character and the physical strength of the enemy character may be set to values which are different from each other. In addition, the physical strength of the ally character and the physical strength of the enemy character may be determined by a drawing process or the like.

Next, the main CPU 71 determines whether or not the enemy character is the common foot soldier and a current battle is an initial battle (step S2519).

When the main CPU 71 determines that the enemy character is the common foot soldier and the current battle is the initial battle, with reference to a table for the common foot soldier in the initial battle, the main CPU 71 determines contents of the six cards (step S2521).

FIG. 45A shows the table for the common foot soldier in the initial battle. As shown in FIG. 45A, in ID=1, a player attacks and a physical strength is one; in ID=2, a player attacks and a physical strength is two; in ID=3, a player attacks and a physical strength is two; in ID=4, a player attacks and a physical strength is three; in ID=5, a player attacks and a physical strength is three; and in ID=6, a player attacks and a physical strength is four. As described above, a number of cards with which the ally character can attack is six and a number of cards with which the enemy character can attack is zero.

In a pattern of a player's attack, the ally character attacks the enemy character. A value of the physical strength is a value which can decrease a physical strength of the opponent, and in accordance with an increase in the physical strength, the physical strength of the opponent which can be decreased becomes larger.

As shown in FIG. 45A, when the enemy character is the common foot soldier and the current battle is the initial battle, the ally character invariably can attack the enemy character, and it does not occur that the ally character is attacked by the enemy character.

Next, when the main CPU 71 determines that the enemy character is the common foot soldier and the current battle is not the initial battle, the main CPU 71 determines whether or not the enemy character is the common foot soldier (step S2523).

When the main CPU 71 determines that the enemy character is the common foot soldier, with reference to a table for the common foot soldier in the second battle or battles subsequent thereto, the main CPU 71 determines contents of the six cards (step S2525).

FIG. 45B shows an example of a table for the common foot soldier in the second battle and battles subsequent thereto. As shown in FIG. 45B, in ID=1, a player attacks and a physical strength is one; in ID=2, a player attacks and a physical strength is two; in ID=3, a player attacks and a physical strength is three; in ID=4, a player attacks and a physical strength is four; in ID=5, the enemy attacks and a physical strength is two; and in ID=6, the enemy attacks and a physical strength is four. As described above, a number of cards with which the ally character can attack is four and a number of cards with which the enemy character can attack is two.

As shown in FIG. 45B, the enemy character is the common foot soldier and in the second battle and the battles subsequent thereto, there is the case where the enemy attacks and the ally character is attacked by the enemy character. A value of the physical strength of the enemy's attack is a value which can decrease the physical strength of the ally character, and in accordance with an increase in the physical strength, the physical strength of the ally character which can be decreased becomes larger.

Next, when the main CPU 71 determines that the enemy character is not the common foot soldier, the main CPU 71 determines whether or not the enemy character is the samurai (step S2527).

When the main CPU 71 determines that the enemy character is the samurai, with reference to a table for the samurai, the main CPU 71 determines contents of the six cards (step S2529).

FIG. 46 shows an example of the table for the samurai. As shown in FIG. 46, in ID=1, a player attacks and a physical strength is one; in ID=2, a player attacks and a physical strength is two; in ID=3, a player attacks and a physical strength is three; in ID=4, a player attacks and a physical strength is four; in ID=5, the enemy attacks and a physical strength is two; and in ID=6, the enemy attacks and a physical strength is four. As described above, a number of cards with which the ally character can attack is four and a number of cards with which the enemy character can attack is two.

Next, when the main CPU 71 determines that the enemy character is not the samurai, the main CPU 71 determines whether or not the enemy character is the shogun (step S2531).

When the main CPU 71 determines that the enemy character is the shogun, with reference to a table for the shogun, the main CPU 71 determines contents of the six cards (step S2533).

FIG. 47 shows an example of the table for the shogun. As shown in FIG. 47, in ID=1, a player attacks and a physical strength is one; in ID=2, a player attacks and a physical strength is three; in ID=3, a player attacks and a physical strength is five; in ID=4, the enemy attacks and a physical strength is two; in ID=5, the enemy attacks and a physical strength is three; and in ID=6, the enemy attacks and a physical strength is four. As described above, a number of cards with which the ally character can attack is three and a number of cards with which the enemy character can attack is three. When the enemy character becomes the shogun, a half of the six cards are the cards, with each of which the ally character attacks, and the remaining half thereof are the cards, with each of which the enemy character attacks.

Next, when the main CPU 71 determines that the enemy character is not the shogun, with reference to a table for the dark shogun, the main CPU 71 determines contents of the six cards (step S2535).

FIG. 48 shows an example of the table for the dark shogun. As shown in FIG. 48, in ID=1, a player attacks and a physical strength is one; in ID=2, a player attacks and a physical strength is three; in ID=3, a player attacks and a physical strength is five; in ID=4, the enemy attacks and a physical strength is two; in ID=5, the enemy attacks and a physical strength is three; and in ID=6, the enemy attacks and a physical strength is five. As described above, a number of cards with which the ally character can attack is three and a number of cards with which the enemy character can attack is three. When the enemy character becomes the dark shogun, a half of the six cards are the cards, with each of which the ally character attacks, and the remaining half thereof are the cards, with each of which the enemy character attacks. Further, as with the card in ID=6, the physical strength of the enemy's attack becomes large.

As shown in FIG. 45A and FIG. 45B to FIG. 48, each of the six cards is a card for displaying information pertinent to the character of the attacking side and a damage force.

Next, the main CPU 71 displays a battle initiation screen (step S2611). This screen allows the enemy character with which the ally character has a battle to be introduced.

Next, the main CPU 71 displays the six cards (step S2613). At this point in time, the displaying is conducted so as not to allow a player to visually recognize contents of the six cards.

Next, the main CPU 71 determines whether or not a user has touched the lower touch panel 141a (step S2615). In this determination process, it is determined whether or not a user has touched the lower touch panel 141a and has thereby selected one card from among the six cards. When the main CPU 71 determines that a user has not touched the lower touch panel 141a, the main CPU 71 returns the processing to step S2615.

Next, the main CPU 71 displays the six cards so as to allow a player to visually recognize the contents of the six cards (step S2616).

Next, the main CPU 71 determines whether or not the card touched by a user is the card with which the ally character attacks (step S2617).

When the main CPU 71 determines that the card touched by a user is any card with which the ally character attacks, the main CPU 71 invokes and executes a sub-routine of the later-described ally character attack pattern determination process (step S2711).

Next, the main CPU 71 displays a screen in which the ally character attacks the enemy character in the attack pattern determined in the process at step S2711 (step S2713). A numerical value indicating a payout determined in accordance with the attack (refer to FIG. 50 and FIG. 51) is displayed so as to be superimposed.

Next, the main CPU 71 subtracts a physical strength of the selected card from a physical strength of the enemy character (step S2715).

Next, the main CPU 71 determines whether or not a physical strength of the enemy character is zero (step S2717).

When the main CPU 71 determines that the physical strength of the enemy character is not zero, the main CPU 71 returns the processing to step S2519. Since the physical strength of the enemy character is not zero, the battle with the same enemy character is continued.

When the main CPU 71 determines that the physical strength of the enemy character is zero, main CPU 71 makes addition of a payout associated with each of the enemy characters (step S2719). In other words, when the ally character defeats the enemy character, a winning bonus credit is added. Upon defeating the common foot soldier, a winning bonus credit is 250; upon defeating the samurai, a winning bonus credit is 500; upon defeating the shogun, a winning bonus credit is 1000; and upon defeating the dark shogun, a winning bonus credit is 2000.

Next, the main CPU 71 determines whether or not the enemy character is the dark shogun (step S2721).

When the main CPU 71 determines that the enemy character is not the dark shogun, the main CPU 71 selects a next enemy character (step S2723) and returns the processing to step S2513. Specifically, when the enemy character is the common foot soldier, the samurai is selected, and the enemy character is the samurai, the shogun is selected, and when the enemy character is the shogun, the dark shogun is selected.

When in the determination process at step S2617 in FIG. 26, the main CPU 71 determines that the card touched by a user is not the card with which the ally character attacks, the main CPU 71 determines whether or not the card touched by a user is the card with which the enemy character attacks (step S2619).

When the main CPU 71 determines that the card touched by a user is the card with which the enemy character attacks, the main CPU 71 invokes and executes a sub-routine of the later-described enemy character attack pattern determination process (step S2811).

Next, the main CPU 71 displays a screen in which the enemy character attacks the ally character in the attack pattern determined in the process at step S2811 (step S2813). A numerical value (refer to FIG. 50 and FIG. 51) indicating a payout determined in accordance with the attack is displayed so as to be superimposed.

Next, the main CPU 71 subtracts a physical strength of the selected card from the physical strength of the ally character (step S2815).

Next, the main CPU 71 determines whether or not the physical strength of the ally character is zero (step S2817).

When the main CPU 71 determines that the physical strength of the ally character is not zero, the main CPU 71 returns the processing to step S2519. Since the physical strength of the ally character is not zero, the battle with the same enemy character is continued.

When in the determination process at step S2619, the main CPU 71 determines that the card touched by a user is not the card with which the enemy character attacks; when in the determination process at step S2721, the main CPU 71 determines that the enemy character is the dark shogun; and when in the determination process at step S2817, the main CPU 71 determines that the physical strength of the ally character is zero, the main CPU 71 displays a screen for finishing the battle (step S2621), finishing this sub-routine.

As described above, since the game can be caused to proceed by the contents of the attack assigned to the card selected by a player, a game in which a player's intention is reflected can be realized, thereby allowing a player to actively participate in the progress of the game.

<Ally Character Attack Pattern Determination Process>

FIG. 29 is a flowchart of an ally character attack pattern determination process in a slot machine 10 according to the present embodiment.

First, the main CPU 71 extracts random number values for attack pattern determination (step S2911).

Next, the main CPU 71 determines whether or not a current battle is a battle in which a physical strength of an enemy character comes to be zero (step S2913).

When the main CPU 71 determines that the current battle is the battle in which the physical strength of the enemy character comes to be zero, with reference to an attack pattern determination table A, the main CPU 71 determines an attack pattern (step S2915).

The attack pattern determination table A is used in the battle in which the physical strength of the enemy character comes to be zero. FIG. 49 shows the attack pattern determination table A. When the physical strength is one, one attack is selected from among single attacks S1 to S3 and a single attack S. When the physical strength is two, one attack is selected from among single attacks S and M and a combo C 3-continuous-attack combo. When the physical strength is three, one attack is selected from among single attacks M and L and a combo A 5-continuous-attack combo. When the physical strength is four, one attack is selected from among a single attack L and a combo B 7-continuous-attack combo. When the physical strength is five, one attack is selected from among a combo A 10-continuous-attack combo, a combo B 10-continuous-attack combo, and a combo C 10-continuous-attack combo.

Each of the single attacks is an attack which is finished after the enemy character is attacked only once. Each of the combos is an attack which is finished after the enemy character is attacked at a plurality of times, whose number is 0 to 10.

When the main CPU 71 determines that the current battle is not the battle in which the physical strength of the enemy character comes to be zero, with reference to an attack pattern determination table B, the main CPU 71 determines an attack pattern (step S2917).

The attack pattern determination table B is used in the battle in which the physical strength of the enemy character does not come to be zero. FIG. 50 shows the attack pattern determination table B. When the physical strength is one, one attack is selected from among the single attacks S1 to S3, a combo A 1-continuous-attack combo, a combo A 2-continuous-attack combo, a combo B 1-continuous-attack combo, a combo B 2-continuous-attack combo, a combo C 1-continuous-attack combo, and a combo C 2-continuous-attack combo. When the physical strength is two, one attack is selected from among the single attack S, a combo A 3-continuous-attack combo, a combo A 4-continuous-attack combo, a combo B 3-continuous-attack combo, a combo B 4-continuous-attack combo, the combo C 3-continuous-attack combo, and a combo C 4-continuous-attack combo. When the physical strength is three, one attack is selected from among the single attack M, the combo A 5-continuous-attack combo, a combo A 6-continuous-attack combo, a combo B 5-continuous-attack combo, a combo B 6-continuous-attack combo, a combo C 5-continuous-attack combo, and a combo C 6-continuous-attack combo. When the physical strength is four, one attack is selected from among the single attack L, a combo A 7-continuous-attack combo, a combo A 8-continuous-attack combo, the combo B 7-continuous-attack combo, a combo B 8-continuous-attack combo, a combo C 7-continuous-attack combo, and a combo C 8-continuous-attack combo. When the physical strength is five, one attack is selected from among the combo A 10-continuous-attack combo, the combo B 10-continuous-attack combo, and the combo C 10-continuous-attack combo.

After executing the process at step S2915 or step S2917, the main CPU 71 determines a payout based on an attack pattern corresponding payout table (step S2919). The determined payout is displayed in the process at step S2713 or step S2813.

FIG. 51 to FIG. 52 show the attack pattern corresponding payout table. Payouts are defined with respect to the single attacks S1 to S3, the single attacks S, M, and L, the combo A 0-continuous-attack combo to A 10-continuous-attack combo, the combo B 0-continuous-attack combo to B 10-continuous-attack combo, and the combo C 0-continuous-attack combo to C 10-continuous-attack combo. With respect to the 1-continuous-attack combo to 10-continuous-attack combo of each of the combos A to C, payouts are defined, respectively. When the ally character attacks the enemy character, each payout defined in the attack pattern corresponding payout table is displayed. Upon finishing all of the attacks in that battle, a total payout in FIG. 51 to FIG. 52 is displayed.

The main CPU 71 adds the determined payout (step S2921), finishing this sub-routine.

<Enemy Character Attack Pattern Determination Process>

FIG. 30 is a flowchart of an enemy character attack pattern determination process in a slot machine 10 according to the present embodiment.

First, the main CPU 71 determines whether or not an enemy character is a common foot soldier (step S3011).

When the main CPU 71 determines that the enemy character is the common foot soldier, the main CPU 71 invokes and executes a sub-routine of an attack pattern selection process shown in FIG. 31 (step S3013), finishing this sub-routine.

When the main CPU 71 determines that the enemy character is not the common foot soldier, the main CPU 71 determines whether or not the enemy character is a samurai (step S3015).

When the main CPU 71 determines that the enemy character is the samurai, the main CPU 71 invokes and executes the sub-routine of the attack pattern selection process shown in FIG. 31 (step S3017), finishing this sub-routine.

When the main CPU 71 determines that the enemy character is not the samurai, the main CPU 71 determines whether or not the enemy character is a shogun (step S3019).

When the main CPU 71 determines that the enemy character is the shogun, the main CPU 71 invokes and executes the sub-routine of the attack pattern selection process shown in FIG. 31 (step S3021), finishing this sub-routine.

When the main CPU 71 determines that the enemy character is not the shogun, the main CPU 71 determines that the enemy character is a dark shogun and invokes and executes the sub-routine of the attack pattern selection process shown in FIG. 31 (step S3023), finishing this sub-routine.

<Attack Pattern Selection Process>

FIG. 31 is a flowchart of the attack pattern selection process in a slot machine 10 according to the present embodiment. FIG. 53 is a table showing attack patterns of enemy characters. The below-described process is executed based on the attack patterns of the enemy characters shown in FIG. 53.

First, the main CPU 71 determines whether or not a physical strength is 1 to 3 (step S3111).

When the main CPU 71 determines that the physical strength is 1 to 3, the main CPU 71 selects a weak attack pattern (step S3113), finishing this sub-routine.

When the main CPU 71 determines that the physical strength is not 1 to 3, the main CPU 71 selects a strong attack pattern (step S3115), finishing this sub-routine.

<Free Game Mode Process>

FIG. 32 is a flowchart of a free game mode process in a slot machine 10 according to the present embodiment. In a free game in the present embodiment, as in the game in the base game mode, a slot game (unit game) is conducted. In the game in the free game mode, a slot game (unit game) can be initiated without placing any bet.

In the free game mode in the present embodiment, free game mode dedicated reel strips are used (FIG. 12 to FIG. 14). In a unit game which can be initially played at eight times, when three symbols of BONUS have appeared, a retrigger is established and eight unit games are added.

In the free game mode, a WILD expand or a WILD scatter selectively occurs. The WILD expand or the WILD scatter occurs when to-be stopped symbols satisfy a predetermined condition. Specifically, when no symbols of BONUS appear on video reels 3b, 3c, and 3d, the WILD expand or the WILD scatter is determined by a drawing process. The contents of the WILD expand and the WILD scatter will be described later.

First, the main CPU 71 sets a number of games to eight (step S3211).

Next, the main CPU 71 executes upon-free-game-initiation effects (step S3213). This allows a player to visually recognize that the free game mode is initiated.

Next, the main CPU 71 conducts an at-one-game-termination initialization process (step S3215). For example, data that becomes unnecessary after each game in a working areas of a RAM 73, such as the symbols determined by a drawing, is cleared.

Next, the main CPU 71 invokes and executes a sub-routine of a free game mode symbol drawing process shown in FIG. 33 (step S3217). By this process, to-be stopped symbols are determined based on random number values for symbol determination.

Specifically, the main CPU 71 extracts five first to fifth random number values for the symbol determination. Next, the main CPU 71 determines a to-be stopped symbol of the first video reel 3a by the first random number value; determines a to-be stopped symbol of the second video reel 3b by the second random number value; determines a to-be stopped symbol of the third video reel 3c by the third random number value; determines a to-be stopped symbol of the fourth video reel 3d by the fourth random number value; and determines a to-be stopped symbol of the fifth video reel 3e by the fifth random number value. The determined to-be stopped symbols of the five video reels 3a to 3e are stored in a symbol storage area provided in the RAM 73.

Next, the main CPU 71 conducts an effect contents start process (step S3219). In the process at step S3219, the main CPU 71 extracts random number values for effect determination, determines any of a predetermined plurality of effect contents by a drawing, and executes the effect contents at the timing of the determined effect contents. For example, the main CPU 71 displays video for effects on an upper display device 131, outputs audio from a loudspeaker 112, lights a lamp 111, and performs the control, for example, by subjecting these to effect processes.

Next, the main CPU 71 conducts a free game mode symbol display control process shown in FIG. 35 (step S3221). In this process, scrolling of five video reels 3a to 3e (five reel strips) is started, and the to-be stopped symbols determined in the symbol drawing process at step S3217 are stopped in predetermined positions.

Next, the main CPU 71 conducts a to-be-paid-out number determination process shown in FIG. 19 (step S3223). In this process, it is determined from the five to-be-stopped symbols stored in the symbol storage area by the free game mode symbol drawing process whether or not a winning pattern in the payout table (refer to FIG. 8) is established. A to-be-paid-out number based on the payout table (refer to FIG. 8) in accordance with the winning pattern is determined and is stored in a to-be-paid-out number storage area (to-be-paid-out number counter) provided in the RAM 73.

Next, the main CPU 71 subtracts one from a number of games (step S3225).

Next, the main CPU 71 determines whether or not the free game mode is retriggered (step S3227). Specifically, the main CPU 71 determines whether or not a winning pattern by symbols of F_BONUS is established.

When the main CPU 71 determines that the retrigger of the free game mode is established, the main CPU 71 adds eight to the number of games (step S3229) and returns the processing to step S3215.

When the main CPU 71 determines that the retrigger of the free game mode is not established, the main CPU 71 determines whether or not the number of games is larger than zero (step S3231).

When the main CPU 71 determines that the number of games is larger than zero, the main CPU 71 returns the processing to step S3215.

When the main CPU 71 determines that the number of games is less than or equal to zero, the main CPU 71 finishes this sub-routine.

<Free Game Mode Symbol Drawing Process>

FIG. 33 is a flowchart of a free game mode symbol drawing process in a slot machine 10 according to the present embodiment.

First, the main CPU 71 extracts five random number values for symbol determination (step S3311). Next, with reference to a symbol determination table, the main CPU 71 determines to-be stopped symbols of five video reels 3a to 3e from the five random number values by a drawing (step S3313).

In the process at step S3313, with reference to the symbol determination table, the five to-be-stopped symbols are determined. In the present embodiment, the symbol determination table is the free game mode symbol determination table and the table shown in FIG. 12 to FIG. 14.

In other words, the main CPU 71 extracts the five random number values for the symbol determination and with reference to the free game mode symbol determination table shown in FIG. 12 to FIG. 14, the main CPU 71 determines one symbol as the to-be stopped symbol with respect to each of the five video reels 3a to 3e. In the present embodiment, each of the five to-be-stopped symbols is determined at an equal probability.

By conducting the process at step S3313, the five to-be-stopped symbols respectively corresponding to the five video reels 3a to 3e are determined. The stopping of the five video reels 3a to 3e is controlled such that the determined five to-be-stopped symbols stop in an uppermost row of a symbol matrix (uppermost row of a symbol display region 141d) (refer to step S3515 in FIG. 35).

Next, the main CPU 71 stores the determined to-be stopped symbols of the five video reels 3a to 3e in a symbol storage area provided in a RAM 73 (step S3315).

Next, the main CPU 71 determines whether or not symbols of BONUS appear on three video reels 3b, 3c, and 3d (step S3317).

When the main CPU 71 determines that the symbols of BONUS appear on the three video reels 3b, 3c, and 3d, the main CPU 71 finishes this sub-routine.

When in the determination process at step S3317, the main CPU 71 determines that the symbols of BONUS do not appear on the three video reels 3b, 3c, and 3d, the main CPU 71 invokes and executes a sub-routine of a WILD effect process shown in FIG. 34 (step S3319), finishing this sub-routine.

<WILD Effect Process>

FIG. 34 is a flowchart of a WILD effect process in a slot machine 10 according to the present embodiment. As described above, when as a result of the execution of the free game mode symbol drawing process, symbols of BONUS do not appear on three video reels 3b, 3c, and 3d, this sub-routine is executed.

First, the main CPU 71 extracts random number values for WILD effect generation (step S3411).

Next, with reference to a WILD effect generation table, the main CPU 71 determines WILD effects (step S3413).

FIG. 54 is the WILD effect generation table. A weight with which no WILD effects are generated is 19; a weight with which WILD expand effects are generated is 15; and a weight with which WILD scatter effects are generated is 17.

Next, the main CPU 71 determines whether or not a WILD expand occurs (step S3415).

Next, when the main CPU 71 determines that the WILD expand occurs, the main CPU 71 extracts random number values for the WILD expand (step S3417).

Next, with reference to a WILD expand table, the main CPU 71 determines reels (step S3419), finishing this sub-routine.

FIG. 55 is the WILD expand table. In FIG. 55, WI indicates a reel which is changed to the WILD expand and ¥WI indicates which is not changed to the WILD expand. By conducting the drawing process at step S3419, any one of ID=0 to 24 is determined. For example, when ID=11 is determined by the drawing process at step S3419, since ¥WI, ¥WI, WI, ¥WI, and WI are determined, the video reel 3a is not changed to the WILD expand, the video reel 3b is not changed to the WILD expand, the video reel 3c is changed to the WILD expand, the video reel 3d is not changed to the WILD expand, and the video reel 3e is changed to the WILD expand.

When each of the reels is changed to the WILD expand, all of the symbols of that reel are changed to symbols of WILD. In other words, four symbols in an uppermost row (first row), an upper middle row (second row), a lower middle row (third row), and a lowermost row (fourth row) are changed to the symbols of WILD. For example, when the video reel 3b is changed to the WILD expand, all of four symbols in an uppermost row, an upper middle row, a lower middle row, and a lowermost row of the video reel 3b are changed to the symbols of WILD, and the symbols of WILD are replaced with other symbols so as to establish an advantageous winning pattern, thereby determining a payout.

Next, when in the determination process at step S3415, the main CPU 71 determines that the WILD expand does not occur, the main CPU 71 determines whether or not a WILD scatter occurs (step S3420).

When the main CPU 71 determines that the WILD scatter does not occur, the main CPU 71 finishes this sub-routine.

When the main CPU 71 determines that the WILD scatter occurs, the main CPU 71 determines whether or not the symbols of WILD appear on the video reel 3c (step S3421).

When the main CPU 71 determines that the symbols of WILD appear on the video reel 3c, the main CPU 71 finishes this sub-routine.

When the main CPU 71 determines that the symbols of WILD do not appear on the video reel 3c, the main CPU 71 extracts random number values for the WILD scatter (step S3423).

Next, with reference to a WILD scatter table, the main CPU 71 determines a number of symbols of WILD (step S3425), finishing this sub-routine.

FIG. 56 is the WILD scatter table. A weight with which three symbols are changed to the symbols of WILD is 10; a weight with which four symbols are changed to the symbols of WILD is 22; a weight with which five symbols are changed to the symbols of WILD is 34; a weight with which six symbols are changed to the symbols of WILD is 18; a weight with which seven symbols are changed to the symbols of WILD is 10; a weight with which eight symbols are changed to the symbols of WILD is 4; a weight with which nine symbols are changed to the symbols of WILD is one; and a weight with which 10 symbols are changed to the symbols of WILD is one.

As described later, a position of each of the symbols which are changed to the symbols of WILD is determined at an equal probability. In other words, in accordance with the number of symbols, which are changed to the symbols of WILD, among 20 stop positions 28 (5 reels×4 rows) in a symbol display region 141d, each of stop positions 28 of the symbols is determined at the equal probability.

<Free Game Mode Symbol Display Control Process>

FIG. 35 is a flowchart of a free game mode symbol display control process in a slot machine 10 according to the present embodiment.

First, the main CPU 71 starts scrolling of five video reels 3a to 3e (step S3511).

Next, the main CPU 71 determines whether or not a WILD expand occurs (step S3513).

When the main CPU 71 determines that no WILD expand occurs, the main CPU 71 stops a predetermined video reel based on a symbol storage area (step S3515).

The main CPU 71 determines whether or not all of the video reels 3a to 3e are stopped (step S3517).

When the main CPU 71 determines that all of the video reels 3a to 3e are not stopped, the main CPU 71 returns the processing to step S3515.

When the main CPU 71 determines that all of the video reels 3a to 3e are stopped, the main CPU 71 determines whether or not a WILD scatter occurs (step S3519).

When the main CPU 71 determines that the WILD scatter occurs, the main CPU 71 invokes and executes a sub-routine of a WILD scatter process in FIG. 37 (step S3521), finishing this sub-routine. On the other hand, when the main CPU 71 determines that no WILD scatter occurs, the main CPU 71 immediately finishes this sub-routine.

When in the determination process at step S3513, the main CPU 71 determines that the WILD expand occurs, the main CPU 71 invokes and executes a sub-routine of a WILD expand process in FIG. 36 (step S3523), finishing this sub-routine.

<WILD Expand Process>

FIG. 36 is a flowchart of a WILD expand process in a slot machine 10 according to the present embodiment.

First, the main CPU 71 displays an image in which a ninja appears along a video reel 3c (step S3611).

Next, The main CPU 71 displays an image in which ninjas appear along video reels 3a to 3e (step S3613).

Next, the main CPU 71 displays an image in which a ninja appears on a video reel on which symbols of WILD appear (step S3615).

Next, the main CPU 71 displays the symbols of WILD in a stopped manner on the video reel on which the symbols of WILD appear (step S3617).

Next, based on a symbol storage area, the main CPU 71 displays the remaining video reels in the stopped manner (step S3619), finishing this sub-routine.

<WILD Scatter Process>

FIG. 37 is a flowchart of a WILD scatter process in a slot machine 10 according to the present embodiment.

First, in accordance with a number of symbols of WILD, the main CPU 71 determines positions in which the symbols of WILD are displayed by conducting a drawing process (step S3711). By conducting this process, in accordance with the number of symbols, which are changed to the symbols of WILD, among 20 stop positions 28 (5 reels×4 rows) in a symbol display region 141d, each of stop positions 28 of the symbols is determined at an equal probability.

Next, the main CPU 71 displays an image in which changing to the symbols of WILD is conducted (step S3713), finishing this sub-routine.

<Pick Bonus Process>

FIG. 38 is a flowchart of a pick bonus process in a slot machine 10 according to the present embodiment.

A pick game is constituted of games at a total of seven stages. A player selects one choice from among a plurality of choices in each of the games at the stages. In the plurality of choices, there are a “credit payout” and “END”.

When a player selects a “credit payout”, a player obtains the credit payout and can proceed to a game at the next stage. When a player selects “END”, the pick bonus game is finished.

In a game at the final stage 7, there is no END, and a larger credit than in each of the games at the stages preceding the stage 7 can be obtained. Upon finishing the selection in the game at the stage 7, the pick bonus game is finished.

A credit which is calculated by multiplying the payout by the number of BETs per line is provided for a player.

First, the main CPU 71 displays a pick bonus initial screen (step S3811).

Next, the main CPU 71 initializes stage No., for example, sets to 1 (step S3813).

Next, the main CPU 71 determines whether or not the stage No. is 7 (step S3815).

When the main CPU 71 determines that the stage No. is 7, the main CPU 71 sets a number of picks to 5 (step S3817).

When the main CPU 71 determines that the stage No. is not 7, the main CPU 71 determines as a number of picks a value calculated by subtracting the stage No. from 8 (step S3819).

Next, after executing the process at step S3817 or step S3819, the main CPU 71 assigns a payout in accordance with the number of picks (step S3821).

FIG. 57A is a table showing contents of choices available when a stage No. is 1. There are a total of seven choices, and in a process at step S3825, an image for picking in which the corresponding the seven choices are shown is displayed. A payout of ID=1 is 200; a payout of ID=2 is 150; a payout of ID=3 is 120; a payout of ID=4 is 100; a payout of ID=5 is 80; a payout of ID=6 is 60; and a payout of ID=7 is 50. The seven choices are randomly assigned to the image for picking by a drawing process. In a game played when the stage No. is 1, there is no END, a payout is invariably provided, a player can proceed to a game at stage 2.

FIG. 57B is a table showing contents of choices available when a stage No. is 2. There are a total of six choices, and in the process at step S3825, an image for picking in which the corresponding the six choices are shown is displayed. A payout of ID=1 is 200; a payout of ID=2 is 150; a payout of ID=3 is 120; a payout of ID=4 is 100; a payout of ID=5 is 80; and the content of ID=6 is END. The six choices are randomly assigned to the image for picking by the drawing process. In a game played when the stage No. is 2, there is END, and when a player selects the END, the pick bonus game is finished.

FIG. 57C is a table showing contents of choices available when a stage No. is 3. There are a total of five choices, and in the process at step S3825, an image for picking in which the corresponding the five choices are shown is displayed. A payout of ID=1 is 200; a payout of ID=2 is 150; a payout of ID=3 is 120; a payout of ID=4 is 100; and the content of ID=5 is END. The five choices are randomly assigned to the image for picking by the drawing process. In a game played when the stage No. is 3, there is END, and when a player selects the END, the pick bonus game is finished.

FIG. 58A is a table showing contents of choices available when a stage No. is 4. There are a total of four choices, and in the process at step S3825, an image for picking in which the corresponding the four choices are shown is displayed. A payout of ID=1 is 250; a payout of ID=2 is 200; a payout of ID=3 is 150; and the content of ID=4 is END. The four choices are randomly assigned to the image for picking by the drawing process. In a game played when the stage No. is 4, there is END, and when a player selects the END, the pick bonus game is finished. Each of the payouts in the games at stage No. 4 and at the stages subsequent thereto is set to be larger than each of those at stage Nos. preceding stage No. 4.

FIG. 58B is a table showing contents of choices available when a stage No. is 5. There are a total of three choices, and in the process at step S3825, an image for picking in which the corresponding the three choices are shown is displayed. A payout of ID=1 is 250; a payout of ID=2 is 200; and the content of ID=3 is END. The three choices are randomly assigned to the image for picking by the drawing process. In a game played when the stage No. is 5, there is END, and when a player selects the END, the pick bonus game is finished.

FIG. 58C is a table showing contents of choices available when a stage No. is 6. There are a total of two choices, and in the process at step S3825, an image for picking in which the corresponding the two choices are shown is displayed. A payout of ID=1 is 250; and the content of ID=2 is END. In a game played when the stage No. is 6, there is END, and when a player selects the END, the pick bonus game is finished.

FIG. 58D is a table showing contents of choices available when a stage No. is 7. There are a total of five choices, and in the process at step S3825, an image for picking in which the corresponding the five choices are shown is displayed. A payout of ID=1 is 2000; a payout of ID=2 is 1000; a payout of ID=3 is 800; a payout of ID=4 is 600; and a payout of ID=5 is 500. The five choices are randomly assigned to the image for picking by the drawing process. In a game played when the stage No. is 7, there is no END, and a payout is invariably provided. Each of the payouts in the game played when the stage No. is 7 is set to be larger than each of those in the games at stage Nos. preceding the stage No. 7.

Next, the main CPU 71 displays a pick bonus initiation screen (step S3823).

Next, the main CPU 71 displays the image for picking, in which the choices are shown, in accordance with the number of picks (step S3825). For example, when stage No. is 5, an image for picking in which three samurai characters are shown is displayed.

Next, the main CPU 71 determines whether or not a user has made a selection on the image for picking by touching a lower touch panel 141a (step S3827). When the main CPU 71 determines that a user has not made the selection on the image for picking by touching the lower touch panel 141a, the main CPU 71 returns the processing to step S3827.

When the main CPU 71 determines that a user has made the selection on the image for picking by touching the lower touch panel 141a, the main CPU 71 determines whether or not the choice selected by a user is END (step S3829).

When the main CPU 71 determines that the choice selected by a user is the END, the main CPU 71 finishes this sub-routine.

When the main CPU 71 determines that the choice selected by a user is not the END, the main CPU 71 adds a payout in accordance with the choice selected by a user (step S2831).

Next, the main CPU 71 adds 1 to the stage No. (step S2833) and returns the processing to step S3815.

<<Example of Effect Screen>>

Each of FIG. 59A to FIG. 95D is a diagram illustrating an image of one example of effects. Each of an image shown in each of FIG. 59A to FIG. 95D is displayed on a lower display device 141.

As shown in each of FIG. 59A to FIG. 95D, in a left upper portion, the latest numerical values of CREDIT and BET are displayed, and in a right upper portion, the latest numerical value of WIN is displayed. As a game proceeds, the numerical values are changed, thereby updating the numerical values.

<Example of Image Displayed Before Wheel Drawing Process is Started>

Each of FIG. 59A to FIG. 60D is a diagram illustrating an example of an image displayed before a wheel drawing process is started.

As shown in FIG. 59A, symbols of BONUS are displayed in a stopped manner on video reels 3a, 3c, and 3e, and the three symbols of BONUS thereby appear, thereby establishing a feature game trigger.

When in a determination process at step S1525, the feature game trigger is established, a wheel drawing process is executed.

As shown in FIG. 59B, upon executing the wheel drawing process, letters “NINJA WHEEL BONUS” and an image of a ninja character are displayed on a lower display device 141.

Next, as shown in FIG. 59C, letters “SPIN THE WHEEL” and “TOUCH & SLIDE”, an image of an upward arrow, an image of a ninja star are displayed on the lower display device 141.

As shown in FIG. 59D to FIG. 60C, by touching and sliding the displayed ninja star (lower touch panel 141a), a player can freely move the ninja star within a screen of the lower display device 141. The ninja star rotates while moving.

As shown in FIG. 60D, when the finger of a player is lifted from the ninja star, letters “LOOK UP” and images of two upward arrows are displayed on the lower display device 141.

Thus, the wheel drawing process is executed (step S2011 and S2013).

<Diagrams of Examples of Images Displayed in Slash Bonus Process>

Each of FIG. 61A to FIG. 67D is a diagram illustrating a slash bonus game. The slash bonus game is a game in which a player touches or slides a lower touch panel 141a, thereby defeating an enemy character.

FIG. 61A is a diagram illustrating an image displayed on a lower display device 141 upon winning a slash bonus by a wheel drawing process. Letters “SLASH BONUS” and an image of a samurai are displayed.

As shown in FIG. 61B, letters “SLASH BONUS” and brief description of a rule of a game “Defeat arising enemies by touching them within the time limit. Credit is won by defeating enemies” are displayed.

As shown in FIG. 61C, in a central portion of the lower display device 141, letters “START” and an image of a corridor are displayed.

As shown in FIG. 61D, a view in which enemy characters are gradually approaching from a depth side toward a front side is displayed.

As shown in FIG. 62A, a player touches or slides the displayed enemy characters, thereby defeating the enemy characters. As shown in FIG. 62B, when a player can appropriately touch or slide each of the enemy characters, a player can defeat each of the enemy characters, and a numerical value “15” indicating a payout is displayed.

As shown in FIG. 61D to FIG. 64B, enemy characters appear one after another from the depth side toward the front side of the corridor. One to three enemy characters concurrently appear. Each of FIG. 62B and FIG. 62C shows a state in which three enemy characters concurrently appear. FIG. 62D shows a state in which one enemy character concurrently appear. It is to be noted that as shown in FIG. 62D, in the depth side of the corridor, three enemy characters have already appeared. In this way, from the depth side toward the front side, the enemy characters appear one after another.

As shown in FIG. 62C to FIG. 64B, each time a player can defeat each of the enemy characters, the numerical value “15” indicating the payout in accordance with the defeated enemy character is displayed, and each payout is added (step S2317 to S2325).

When a player cannot appropriately touch or slide each of the enemy characters, a player cannot defeat each of the enemy characters, and the payout is not added (step S2317 to S2325).

After the enemy characters have appeared one after another from the depth side toward the front side of the corridor (step S2311 to S2327), as shown in FIG. 64C to FIG. 67A, the last one enemy character appears on a frontmost side of the corridor (step S2419). A player also touches or slides this last enemy character, thereby defeating the last enemy character.

As shown in FIG. 64C to FIG. 67B, when a player can appropriately touch or slide the last enemy character, a player can attack the enemy character. It is to be noted that although a number of the last enemy character is only one, a player cannot defeat the last enemy character by touching or sliding the last enemy character once, and a player can attack and defeat the last enemy character by touching or sliding the last enemy character at a plurality of times.

Each time the last enemy character is attacked, a predetermined payout is displayed. This payout is not fixed. As shown in FIG. 65A and FIG. 65B, 90 is provided, as shown in FIG. 65C, 25 is provided, as shown in FIG. 66A, 95 is provided, or as shown in FIG. 66C, 40 provided (step S2417 to S2429). When a player can finally defeat the last enemy character, each payout which is not provided when a player cannot defeat each of the enemy characters appearing one after another from the depth side toward the front side of the corridor is settled and provided (step S2429).

As shown in FIG. 67B, when a player has finally managed to defeat the last enemy character, an image in which only the corridor is shown is once displayed.

Next, as shown in FIG. 67C, letters “FINISH” are displayed, thereby indicating that the slash bonus game is finished.

At the end, as shown in FIG. 67D, letters “SLASH BONUS”, “ENEMIES DEFEATED: 26”, and “TOTAL WIN 740 CREDITS” are displayed, thereby indicating that 26 enemy characters are defeated and a total of 740 credits is obtained.

<Diagrams of Examples of Images Displayed in Pick Bonus Process>

Each of FIG. 68A to FIG. 71D is a diagram illustrating a pick bonus game. The pick bonus game is constituted of games at a total of 7 stages, a player selects one choice from among a plurality of choices in each of the games at the respective stages, and a payout corresponding to the selected choice is provided.

FIG. 68A is a diagram illustrating an image displayed on a lower display device 141 upon winning a pick bonus by a wheel drawing process. Letters “CASTLE BONUS” and an image of a 1000-ryou-box are displayed (step S3811).

As shown in FIG. 68B, letters “CASTLE BONUS” and brief description of a rule of a game “Aim to reach the final stage by selecting (an image of a samurai) before END appears. There are maximum of 7 stages.” are displayed (step S3811).

As shown in FIG. 68C, letters “1st STAGE” and an image in which seven samurais are standing in a tatami-mat-room are displayed (step S3823 and S3825). This initiates a pick bonus game at stage No.=1.

As shown in FIG. 68D, a player touches one samurai among the seven samurais (step S3827). It is displayed that a payout of the samurai touched by a player is 80.

Next, as shown in FIG. 69A, the samurai touched by a player disappear, and images of the remaining six samurais become dark and are displayed. This finishes the pick bonus game at stage No.=1 and the payout corresponding to the touched samurai is added (step S3831).

Next, as shown in FIG. 69B, an image in which only the tatami-mat-room is shown is once displayed.

Next, as shown in FIG. 69C, letters “2nd STAGE” and an image in which six samurais are standing in the tatami-mat-room are displayed (step S3823 and S3825). This initiates a pick bonus game at stage No.=2.

As shown in FIG. 69D, a player touches one samurai among the six samurais (step S3827). It is displayed that a payout of the samurai touched by a player is 150.

In this way, games at stage No.=3 and stage No.=4 proceed (not shown). As shown in FIG. 70A, letters “5th STAGE” and an image in which three samurais are standing in the tatami-mat-room are displayed (step S3823 and S3825). This initiates a pick bonus game at stage No.=5.

As shown in FIG. 70B, a player touches one samurai among the three samurais (step S3827). It is displayed that a payout of the samurai touched by a player is 250.

As shown in FIG. 70C, letters “6th STAGE” and an image in which two samurais are standing in the tatami-mat-room are displayed (step S3823 and S3825). This initiates a pick bonus game at stage No.=6.

As shown in FIG. 70D, a player touches one samurai among the two samurais (step S3827). It is displayed that a payout of the samurai touched by a player is 250.

As shown in FIG. 71A, an image in which 1000-ryou-boxes are shown is once displayed. As shown in FIG. 71B, letters “FINAL STAGE” and an image in which five 1000-ryou-boxes are shown on the front side of the tatami-mat-room are displayed (step S3823 and S3825).

As shown in FIG. 71C, a player touches one 1000-ryou-box among the five 1000-ryou-boxes (step S3827). It is displayed that a payout of the 1000-ryou-box touched by a player is 500.

At the end, as shown in FIG. 71D, letters “CASTLE BONUS” and “TOTAL WIN 1580 CREDITS are displayed, thereby indicating that a total of 1580 credits is obtained.

<Diagrams of Examples of Images Displayed in WILD Scatter Process>

Each of FIG. 72A to FIG. 73D is a diagram illustrating an image displayed in a WILD scatter process.

FIG. 72A is a diagram illustrating an image displayed on a lower display device 141 upon winning a free game bonus by a wheel drawing process. Letters “NINJA FREE GAMES” and an image of an samurai are displayed.

FIG. 72B is a diagram illustrating a state in which a free game is initiated, among five video reels 3a to 3e, two video reels 3a and 3b are stopped, and three video reels 3c to 3e are rotating.

FIG. 72C is a diagram illustrating a state in which all of the five video reels 3a to 3e are stopped and 20 symbols are rearranged.

Next, as shown in FIG. 72D, the 20 symbols which have become dark are once displayed and one ninja appears in front of the 20 symbols.

Next, as shown in FIG. 73A and FIG. 73B, a screen in which the ninja throws ninja stars is displayed, and a screen in which the ninja stars are hit onto five symbols among the 20 symbols is displayed. Specifically, the ninja stars are hit onto the five symbols in a lowermost row (fourth row) of the video reel 3a, an uppermost row (first row) of the video reel 3c, an upper middle row (second row) of the video reel 3d, and an uppermost row (first row) and an upper middle row (second row) of the video reel 3e.

Next, as shown in FIG. 73C, a screen in which the ninja stars hit onto the five symbols of symbols are scattered is displayed, and as shown in FIG. 73D, a screen in which the five symbols having the ninja stars hit thereonto are changed to symbols of WILD is displayed (step S3713).

FIG. 74A is a diagram illustrating a state in which the five video reels 3a to 3e are rotating in the free game.

As shown in FIG. 74B, in the state in which the five video reels 3a to 3e are rotating, one ninja is displayed along the video reel 3c.

Next, as shown in FIG. 74C, in the state in which the five video reels 3a to 3e are rotating, the one ninja is divided into five ninjas through a shadow cloning technique, and the five ninjas are displayed so as to appear along the five video reels 3a to 3e, respectively.

Next, as shown in FIG. 74D, the five video reels 3a to 3e are displayed in an illuminated manner.

Next, as shown in FIG. 75A, a view in which one ninja jumps down from above along the video reel 3c is displayed, and a state in which the four video reels 3a, 3b, 3d, and 3e are rotating is displayed.

Next, as shown in FIG. 75B, the five video reels 3a to 3e are stopped, and along the video reel 3c, four symbols of WILD are displayed. In other words, the four symbols of WILD are displayed in four regions in an uppermost row (first row), an upper middle row (second row), a lower middle row (third row), and a lowermost row (fourth row) of the video reel 3c.

Next, as shown in FIG. 75C, a payline on which a winning pattern is established is displayed.

As shown in FIG. 75D, letters “NINJA FREE GAMES” and “TOTAL WIN 135 CREDITS” are displayed, thereby indicating that a total of 135 credits is obtained.

<Diagrams of Examples of Images Displayed in Battle Bonus Process>

Each of FIG. 76A to FIG. 95D is a diagram illustrating an example of an image displayed in a battle bonus process. A battle bonus game is a game which proceeds by effects in which an ally character on a player side and an enemy character have a battle.

FIG. 76A is a diagram illustrating an image displayed on a lower display device 141 upon winning a battle bonus by a wheel drawing process. Letters “BATTLE BONUS” and images of a plurality of characters are displayed (step S2513).

As shown in FIG. 76B, letters “BATTLE BONUS” and “KNOCKOUT BATTLE” and brief description of a rule of a game “Ninja Attack and Enemy Attack are determined by (an image of a card) selection.” are displayed (step S2513).

<Battle with Common Foot Soldier as Enemy Character>

Each of FIG. 76C to FIG. 81D is a diagram illustrating a view of a battle between an ally character and a common foot soldier which is one of kinds of enemy characters.

As shown in FIG. 76C to 76D, an image in which the ally character and the enemy character (common foot soldier) are shown is displayed, thereby introducing the ally character and the enemy character to a player (step S2611).

As shown in FIG. 77A, letters “FIGHT!” and images of the ally character and the enemy character are displayed (step S2611).

As shown in FIG. 77B, in a lower portion of the images of the ally character and the enemy character, six cards are displayed (step S2613).

As shown in FIG. 77C, a player touches and selects one among the six cards (step S2615).

As shown in FIG. 77D, the card selected by a player rotates and a back side thereof is displayed (step S2616). In a central portion of the back side, an ally character is displayed, thereby indicating that the one card selected by a player is the ally character. In other words, in the battle at this time, the ally character can attack the enemy character.

As shown in FIG. 78A, in an upper portion of the back side of the card selected by a player, a physical strength of the ally character is displayed (displayed with four stars in FIG. 78A). Further, the remaining five cards not selected by a player also rotate (step S2616).

As shown in FIG. 78B, the back sides of the six cards are displayed, thereby allowing a player to recognize what cards are arranged. The one card selected by a player is displayed in a brightened manner and the five cards not selected by a player are displayed in a darkened manner. As described above, the characters assigned to all of the six cards and the physical strengths are displayed.

As shown in FIG. 78C, the six cards disappear, and as shown in FIG. 78D, the battle is started (step S2713).

As shown in FIG. 79A, by the attack of the ally character, “30 CREDITS” is displayed. Thus, 30 is added as a payout (step S2719). As shown in FIG. 79B and FIG. 79C, each time the ally character attacks the enemy character, “30 CREDITS” is displayed, and 30 is each added as a payout (step S2719).

As shown in FIG. 79D, by the attack of the ally character, “40 CREDITS” is displayed, and as shown in FIG. 80A, by the attack of the ally character, “50 CREDITS” is displayed.

As shown in FIG. 80B, the battle is once suspended.

As shown in FIG. 80C, in the lower portion of the images of the ally character and the enemy character, six cards are again displayed (step S2613).

As shown in FIG. 80D, a player touches and selects one among the six cards (step S2615).

As shown in FIG. 81A, the card selected by a player rotates and a back side thereof is displayed (step S2616). In a central portion of the back side, an ally character is displayed, thereby indicating that the one card selected by a player is the ally character. In other words, in the battle at this time, the ally character can attack the enemy character. In an upper portion of the back side of the card selected by a player, a physical strength of the ally character is displayed (displayed with three stars in FIG. 81A). Further, the remaining five cards not selected by a player also rotate and the back sides thereof are displayed (step S2616).

As shown in FIG. 81A, the back sides of the six cards are displayed, thereby allowing a player to recognize what cards are arranged. The one card selected by a player is displayed in the brightened manner and the five cards not selected by a player are displayed in the darkened manner. As described above, the characters assigned to all of the six cards and the physical strengths are displayed.

Next, as shown in FIG. 81B to FIG. 81D, each time the ally character attacks the enemy character, 30 and 300 are added as payouts (step S2719).

Next, as shown in FIG. 82A, the ally character wins in the battle with the common foot soldier which is one of the kinds of enemy characters, “YOU WIN”, “ATTACK CREDITS 750”, “BATTLE CREDITS 250”, and “TOTAL CREDITS 1000” are displayed, thereby indicating that 1000 is obtained as a payout.

As shown in FIG. 76D to FIG. 81D, while the ally character and the enemy character (common foot soldier) are having the battle, on a left side and a right side of a screen, belt-like indicators are displayed. The indicator (PLAYER) on the left side of the screen indicates the remaining physical strength of the ally character, and the indicator (SOLDIER) on the right side of the screen indicates the remaining physical strength of the enemy character. In the example shown in FIG. 76D to FIG. 81D, as the battle proceeds, the remaining physical strength of the enemy character is gradually decreasing.

<Battle with Samurai as Enemy Character>

Each of FIG. 82B to FIG. 85A is a diagram illustrating a view of a battle between an ally character and a samurai which is one of kinds of enemy characters.

As shown in FIG. 82B and FIG. 82C, an image in which the ally character and the enemy character (samurai) are shown is displayed, thereby introducing the ally character and the enemy character to a player (step S2611).

As shown in FIG. 82D, letters “FIGHT!” and images of the ally character and the enemy character are displayed.

As shown in FIG. 83A, in a lower portion of the images of the ally character and the enemy character, six cards are displayed (step S2613).

As shown in FIG. 83B, a player touches and selects one among the six cards (step S2615).

As shown in FIG. 83C, the card selected by a player rotates and a back side thereof is displayed (step S2616). In a central portion of the back side, an ally character is displayed, thereby indicating that the one card selected by a player is the ally character. In other words, in the battle at this time, the ally character can attack the enemy character. In an upper portion of the back side of the card selected by a player, a physical strength of the ally character is displayed (displayed with four stars in FIG. 83C). Further, the remaining five cards not selected by a player also rotate and the back sides thereof are displayed (step S2616).

Next, as shown in FIG. 83D, the six cards disappear, and the battle is started (step S2713).

As shown in FIG. 84A, by the attack of the ally character, “300 CREDITS” is displayed. Thus, 300 is added as a payout (step S2719).

As shown in FIG. 84B, the battle is once suspended, and in the lower portion of the images of the ally character and the enemy character, six cards are again displayed (step S2613). A player touches and selects one among the six cards (step S2615).

As shown in FIG. 84C, the card selected by a player rotates and a back side thereof is displayed (step S2616). In a central portion of the back side, an ally character is displayed, thereby indicating that the one card selected by a player is the ally character. In other words, in the battle at this time, the ally character can attack the enemy character. In an upper portion of the back side of the card selected by a player, a physical strength of the ally character is displayed (displayed with four stars in FIG. 84C). Further, the remaining five cards not selected by a player also rotate and the back sides thereof are displayed (step S2616).

As shown in FIG. 84D, by the attack of the ally character, “300 CREDITS” is displayed. Thus, 300 is added as a payout (step S2719).

Next, as shown in FIG. 85A, the ally character wins in the battle with the samurai which is one of the kinds of enemy characters, “YOU WIN”, “ATTACK CREDITS 900”, “BATTLE CREDITS 500”, and “TOTAL CREDITS 1400” are displayed, thereby indicating that 1400 is obtained as a payout.

As shown in FIG. 82C to FIG. 84D, while the ally character and the enemy character (samurai) are having the battle, on a left side and a right side of a screen, belt-like indicators are displayed. The indicator (PLAYER) on the left side of the screen indicates the remaining physical strength of the ally character, and the indicator (SAMURAI) on the right side of the screen indicates the remaining physical strength of the enemy character. In the example shown in FIG. 82C to FIG. 84D, as the battle proceeds, the remaining physical strength of the enemy character is gradually decreasing.

<Battle with Shogun as Enemy Character>

Each of FIG. 85B to FIG. 89C is a diagram illustrating a view of a battle between an ally character and a shogun which is one of kinds of enemy characters.

As shown in FIG. 85B and FIG. 85C, an image in which the ally character and the enemy character (shogun) are shown is displayed, thereby introducing the ally character and the enemy character to a player (step S2611).

As shown in FIG. 85D, letters “FIGHT!” and images of the ally character and the enemy character are displayed.

As shown in FIG. 86A, in a lower portion of the images of the ally character and the enemy character, six cards are displayed (step S2613).

As shown in FIG. 86B, a player touches and selects one among the six cards (step S2615).

As shown in FIG. 86C, the card selected by a player rotates and a back side thereof is displayed (step S2616). In a central portion of the back side, an ally character is displayed, thereby indicating that the one card selected by a player is the ally character. In other words, in the battle at this time, the ally character can attack the enemy character. In an upper portion of the back side of the card selected by a player, a physical strength of the ally character is displayed (displayed with five stars in FIG. 86C). Further, the remaining five cards not selected by a player also rotate and the back sides thereof are displayed (step S2616).

Next, as shown in FIG. 86D, the six cards disappear, and the battle is started (step S2713).

As shown in FIG. 87A, by the attack of the ally character, “30 CREDITS” is displayed. Thus, 30 is added as a payout (step S2719).

As shown in FIG. 87B, by the attack of the ally character, “40 CREDITS” is displayed. Thus, 40 is added as a payout (step S2719).

As shown in FIG. 87C, by the attack of the ally character, “50 CREDITS” is displayed. Thus, 50 is added as a payout (step S2719).

As shown in FIG. 87D, by the attack of the ally character, “60 CREDITS” is displayed. Thus, 60 is added as a payout (step S2719).

As shown in FIG. 88A, the battle is once suspended, and in the lower portion of the images of the ally character and the enemy character, six cards are again displayed (step S2613).

As shown in FIG. 88B, a player touches and selects one among the six cards (step S2615).

As shown in FIG. 88C, the card selected by a player rotates and a back side thereof is displayed (step S2616). In a central portion of the back side, an ally character is displayed, thereby indicating that the one card selected by a player is the ally character. In other words, in the battle at this time, the ally character can attack the enemy character. In an upper portion of the back side of the card selected by a player, a physical strength of the ally character is displayed (displayed with five stars in FIG. 88C). Further, the remaining five cards not selected by a player also rotate and the back sides thereof are displayed (step S2616).

As shown in FIG. 88D, by the attack of the ally character, “40 CREDITS” is displayed. Thus, 40 is added as a payout (step S2719).

As shown in FIG. 89A, by the attack of the ally character, “60 CREDITS” is displayed. Thus, 60 is added as a payout (step S2719).

As shown in FIG. 89B, by the attack of the ally character, “100 CREDITS” is displayed. Thus, 100 is added as a payout (step S2719).

As shown in FIG. 89C, a screen in which the ally character has defeated the enemy character is displayed.

As shown in FIG. 89D, the ally character wins in the battle with the shogun which is one of the kinds of enemy characters, “YOU WIN”, “ATTACK CREDITS 1040”, “BATTLE CREDITS 1000”, and “TOTAL CREDITS 2040” are displayed, thereby indicating that 2040 is obtained as a payout.

As shown in FIG. 85C to FIG. 89C, while the ally character and the enemy character (shogun) are having the battle, on a left side and a right side of a screen, belt-like indicators are displayed. The indicator (PLAYER) on the left side of the screen indicates the remaining physical strength of the ally character, and the indicator (SHOGUN) on the right side of the screen indicates the remaining physical strength of the enemy character. In the example shown in FIG. 85C to FIG. 89C, as the battle proceeds, the remaining physical strength of the enemy character is gradually decreasing.

<Transformation from Shogun to Dark Shogun>

As shown in FIG. 90A to FIG. 90D, a dark shogun which is one of kinds of enemy characters appear so as to be transformed from a shogun to the dark shogun.

As shown in FIG. 90A, an image in which the shogun once falls down is displayed, and as shown in FIG. 90B, an image in which the shogun is revived is displayed. Thereafter, as shown in FIG. 90C, an image in which the whole surface is engulfed in flames is displayed, and as shown in FIG. 90D, after the flames have died down, the dark shogun to which the shogun is transformed appears.

<Battle with Dark Shogun as Enemy Character>

Each of FIG. 91A to FIG. 95B is a diagram illustrating a view of a battle between an ally character and a dark shogun which is one of kinds of enemy characters.

As shown in FIG. 91A, an image in which the ally character and the enemy character (dark shogun) are shown is displayed, thereby introducing the ally character and the enemy character to a player (step S2611).

As shown in FIG. 91B, letters “FIGHT!” and images of the ally character and the enemy character are displayed.

As shown in FIG. 91C, in a lower portion of the images of the ally character and the enemy character, six cards are displayed (step S2613).

As shown in FIG. 91D, a player touches and selects one among the six cards (step S2615).

As shown in FIG. 92A, the card selected by a player rotates and a back side thereof is displayed (step S2616). In a central portion of the back side, an ally character is displayed, thereby indicating that the one card selected by a player is the ally character. In other words, in the battle at this time, the ally character can attack the enemy character. In an upper portion of the back side of the card selected by a player, a physical strength of the ally character is displayed (displayed with five stars in FIG. 92A). Further, the remaining five cards not selected by a player also rotate and the back sides thereof are displayed (step S2616).

Next, as shown in FIG. 92B, the six cards disappear, and the battle is started (step S2713).

As shown in FIG. 92C, by the attack of the ally character, “25 CREDITS” is displayed. Thus, 25 is added as a payout (step S2719).

As shown in FIG. 92D, by the attack of the ally character, “60 CREDITS” is displayed. Thus, 60 is added as a payout (step S2719).

As shown in FIG. 93A, the battle is once suspended, and in the lower portion of the images of the ally character and the enemy character, six cards are again displayed (step S2613).

As shown in FIG. 93B, a player touches and selects one among the six cards (step S2615).

As shown in FIG. 93C, the card selected by a player rotates and a back side thereof is displayed (step S2616). In a central portion of the back side, an ally character is displayed, thereby indicating that the one card selected by a player is the ally character. In other words, in the battle at this time, the ally character can attack the enemy character. In an upper portion of the back side of the card selected by a player, a physical strength of the ally character is displayed (displayed with five stars in FIG. 93C). Further, the remaining five cards not selected by a player also rotate and the back sides thereof are displayed (step S2616).

Next, as shown in FIG. 93D, the six cards disappear, and the battle is restarted (step S2713).

As shown in FIG. 94A, by the attack of the ally character, “30 CREDITS” is displayed. Thus, 30 is added as a payout (step S2719).

As shown in FIG. 94B, by the attack of the ally character, “60 CREDITS” is displayed. Thus, 60 is added as a payout (step S2719).

As shown in FIG. 94C, by the attack of the ally character, “100 CREDITS” is displayed. Thus, 100 is added as a payout (step S2719).

As shown in FIG. 94D and FIG. 95A, a screen in which the ally character has defeated the enemy character is displayed.

As shown in FIG. 95B, the ally character wins in the battle with the dark shogun which is one of the kinds of enemy characters, “YOU WIN”, “ATTACK CREDITS 860”, “BATTLE CREDITS 2000”, and “TOTAL CREDITS 2860” are displayed, thereby indicating that 2860 is obtained as a payout.

As shown in FIG. 95C, “CONGRATULATIONS, BATTLE BONUS, COMPLETED” is displayed, thereby indicating that the battle bonus game is finished (step S2621).

As shown in FIG. 95D, “BATTLE BONUS, TOTAL WIN 7350 CREDITS” is displayed, thereby indicating that 7350 credits are obtained in the battle bonus game.

As shown in FIG. 91B to FIG. 95B, while the ally character and the enemy character (dark shogun) are having the battle, on a left side and a right side of a screen, belt-like indicators are displayed. The indicator (PLAYER) on the left side of the screen indicates the remaining physical strength of the ally character, and the indicator (DARK SHOGUN) on the right side of the screen indicates the remaining physical strength of the enemy character. In the example shown in FIG. 91B to FIG. 95B, as the battle proceeds, the remaining physical strength of the enemy character is gradually decreasing.

### REFERENCE SIGNS LIST

1 gaming machine
10 slot machine
3a, 3b, 3c, 3d, and 3e video reels
71 main CPU
73 RAM
131 upper display device
141 lower display device
141a lower touch panel
141b lower liquid crystal panel
141d symbol display region

What is claimed is:

1. A gaming machine comprising:
a display for displaying a first moving body object and a second moving body object;
an input device for detecting an operation by a player; and
a controller for controlling the display and the input device,
the controller being programmed to execute processes described below:
a process (1-1) in which a plurality of choices, in each of which the content of fighting between the first moving body object and the second moving body object is assigned, are displayed on the display so as not to allow a player to recognize the content of the fighting;
a process (1-2) in which when one choice among the plurality of choices is selected by a player, the content of the fighting assigned in the one choice is displayed so as to allow a player to recognize the content of the fighting; and
a process (1-3) in which based on the content of the fighting assigned in the one choice, a view in which the first moving body object and the second moving body object fight is displayed.

2. The gaming machine according to claim 1, wherein
the content of the fighting includes information pertinent to an attacking side of the first moving body object and the second moving body object and to an attacking strength of the attacking side, and
the process (1-3) includes:
a process (2-1) in which based on the attacking side, a pattern of attacking by the attacking side is determined; and
a process (2-2) in which when the first moving body object attacks the second moving body object, a view in which after fighting in the pattern of attacking, the first moving body object wins is displayed, and when the second moving body object attacks the first moving body object, a view in which after fighting in the pattern of attacking, the second moving body object wins is displayed.

3. The gaming machine according to claim 2, wherein
the process (1-3) further includes:
a process (3-1) in which when the first moving body object attacks the second moving body object, a physical strength of the second moving body object is decreased in accordance with the attacking strength, and when the second moving body object attacks the first moving body object, a physical strength of the first moving body object is decreased in accordance with the attacking strength;
a process (3-2) in which being superimposed on the display of the fighting in the process (2-2), information indicating the attacking strength is displayed; and
a process (3-3) in which a payout based on the pattern of attacking is added.

4. The gaming machine according to claim 2, wherein
the second moving body object includes a plurality of kinds of second moving body objects whose attacking strengths are different from one another, and
the process (1-3) further includes:
a process (4-1) in which when a physical strength of a first kind of the second moving body object among the plurality of kinds of the second moving body objects comes to be zero, the first kind of the second moving body object is changed to a second kind of the second moving body object whose attacking strength is higher than the attacking strength of the first kind of the second moving body object, and the changed kind of the second moving body object and the first moving body object fight; and
a process (4-2) in which the process (4-1) is repeatedly executed, the kind of the second moving body object is sequentially changed, and when each of physical strengths of all of the plurality of kinds of the second moving body objects comes to be zero, the game is finished.

5. The gaming machine according to claim 4, wherein
a payout based on the attacking strength is assigned to each of the plurality of kinds of the second moving body objects, and
the process (1-3) further includes
a process (5-1) in which when a physical strength of each of the second moving body objects comes to be zero, a payout assigned to each of the second moving body objects is added.
